(19) United States
(12) Patent Application Publication
(10) Pub. No.: US 2026/0050231 A1
(43) Pub. Date: Feb. 19, 2026

(54) PROCESS CARTRIDGE

(71) Applicant: CANON KABUSHIKI KAISHA, Tokyo (JP)

(72) Inventors: TAKASHI HIRAMATSU, Tokyo (JP); RIEKO TAKABE, Tokyo (JP); NAOYA SAWAMURA, Kanagawa (JP); AKIHISA MATSUKAWA, Tokyo (JP); KATSUICHI ABE, Kanagawa (JP); YASUKAZU IKAMI, Tokyo (JP); ATSUSHI NOGUCHI, Shizuoka (JP); YOSHITAKA SUZUMURA, Shizuoka (JP); AKIO NISHI, Tokyo (JP); HIROKI TANAKA, Kanagawa (JP); KAZUNARI HAGIWARA, Kanagawa (JP); YOSHIAKI SHIOTARI, Shizuoka (JP); RYO SUGIYAMA, Shizuoka (JP)

(21) Appl. No.: 19/289,310

(22) Filed: Aug. 4, 2025

(30) Foreign Application Priority Data
Aug. 13, 2024 (JP) 2024-134775
Aug. 13, 2024 (JP) 2024-134776
Aug. 13, 2024 (JP) 2024-134785
Aug. 13, 2024 (JP) 2024-134787

(51) Int. Cl. G03G 15/08; G03G 9/113; G03G 15/02; G03G 21/18

(52) U.S. Cl. CPC G03G 15/0818; G03G 9/1136; G03G 15/0291; G03G 15/0808; G03G 15/0812; G03G 21/1814; G03G 2215/026

(57) ABSTRACT

Provided is a process cartridge including a developing roller having a resin layer formed on an outer surface of a conductive substrate, wherein the resin layer of the developing roller contains a polyurethane having a polycarbonate structure, when a specific AC voltage is applied to an outer surface of the developing roller while being varied within a specific frequency range, an impedance at a certain frequency is 1.0×10⁶Ω or more, when a corona discharger is relatively moved along an axial direction of the developing roller at a speed of 400 mm/sec to charge the outer surface of the developing roller, and a potential of the outer surface is measured 0.06 seconds after the outer surface passes through a grid portion, a maximum value of the potential is less than 20.0 V.

### BACKGROUND

### Field of the Technology

The present disclosure relates to a process cartridge.

### Description of the Related Art

Conventionally, in a developing device of an image forming apparatus, a spherical toner is widely used as a toner shape of a developer from the viewpoint of developability and transferability. In addition, in the developing device, a developing blade as a developer regulating member is used to control the amount of developer on a developing roller as a developer carrying member. Generally, the amount of toner on the developing roller can be uniformly controlled by bringing the developing blade into contact with the developing roller and applying an appropriate contact pressure. In addition, when the amount of toner is regulated to an appropriate amount, the toner passing through the contact portion between the developing roller and the developing blade is rubbed, and a desired triboelectric charge is imparted. By imparting triboelectric charge to the toner, an electrostatic latent image can be developed by the toner.

Japanese Patent Laid-Open No. 2017-191316 discloses that it is possible to suppress charge leakage to the developing roller and a decrease in the triboelectric charge of the toner by increasing the resistance of the developing roller in relation to imparting of the triboelectric charge by a voltage (blade bias) applied to the developing blade.

Conventionally, in an image forming apparatus using an electrophotographic method such as a laser printer, a copier, or a facsimile machine, an electrostatic latent image formed on an image carrying member such as a photosensitive drum represented by an electrophotographic photosensitive member is generally visualized with a developer (toner).

In addition, conventionally, an image forming apparatus using a contact development method, in which a developing roller, which is a developer carrying member that carries toner during image formation, and a photosensitive drum are brought into contact with each other at a developing region to form an image is widely used. Since the image forming apparatus using a contact development method does not require a magnetic carrier or a magnetic sleeve for controlling a magnetic field in the developing region, the image forming apparatus using a contact development method can contribute to size reduction of the image forming apparatus and a reduction of maintenance frequency.

In the image forming apparatus using a contact development method, while the developing roller and the photosensitive drum are brought into contact with each other in the developing region, a potential difference acts in the developing region in a direction in which normally charged toner moves from the developing roller to the photosensitive drum. In a non-printing area, a potential difference acts in a direction in which the normally charged toner is pressed from the photosensitive drum to the developing roller. Thus, image formation is performed.

In order to perform stable image formation, it is necessary to appropriately maintain a potential difference between the developing roller and the photosensitive drum. However, as the image forming apparatus is used, a low-resistance substance may be mixed into the developing region or may adhere to a surface of the photosensitive drum or the developing roller. As a result, charge easily moves from the photosensitive drum to the developing roller in the developing region, which may lower the potential of the photosensitive drum and make it difficult to maintain the potential difference. As a result, “fogging” in which toner is developed in a non-printing area (white background area) or image density unevenness in which gradation appears in the image due to a potential variation caused by a rotation cycle of the photosensitive drum of the developing roller, may occur.

In order to suppress a drop in the potential of the photosensitive drum even in a case where a low-resistance substance is mixed or attached, it is conceivable to increase the electrical resistance of the developing roller. Japanese Patent Laid-Open No. 2017-191316 discloses that the resistance of the developing roller can be increased by introducing a specific structure having a polycarbonate structure into the surface layer.

In recent years, high image quality and high durability are required for printers and copiers. At the same time, particularly in printers, size reduction and waste free are required.

Focusing on a cleaning device, a cleaner-less system that does not originally include the cleaning device is highly suitable for size reduction of the process cartridge. In many printers, the toner remaining on the electrostatic latent image carrying member after a transfer process is scraped off by a cleaning blade or the like and collected into a cleaning container and treated as waste toner. On the other hand, in a cleaner-less system, there is no cleaning blade or cleaning container, and transfer residual toner is recovered again by the developing device and used for development. Therefore, the process cartridge can be greatly reduced in size, and there is no generation of waste toner, which greatly contributes to the waste free.

However, there are also problems inherent to the cleaner-less system. One of them is that a filler or additive, such as paper as a medium, adheres to the surface of the photosensitive member and is collected by the developing device as foreign substances. When these foreign substances adhere to each member in the process cartridge, the toner is not appropriately charged. This may cause image defects to easily occur. In particular, in a case where paper containing talc (talc paper) is used as a medium, when talc is collected by the developing device, the talc is easily attached to a toner carrier due to its cleavability, and at the same time, the chargeability makes it easy to reduce a charge amount of the toner. As a result, an image defect known as “fogging”, in which the toner with a reduced charge amount undergoes abnormal development in a non-image area, easily occurs. This fogging phenomenon is particularly likely to occur under high temperature and high humidity conditions where the charge amount of the toner is relatively low.

In a conventional process cartridge including a cleaning device, the foreign substances are scraped off by the cleaning blade and collected together with the waste toner into a cleaner container, such that the image defect as described above hardly occurs.

As a method for suppressing image defects on an image when talc paper is used as a medium, a method, in which brush cleaning is performed on an intermediate transfer member to prevent talc from reaching a toner carrier, has been proposed (Japanese Patent Laid-Open No. 2011-059280).

In recent years, high image quality and high durability are required for printers and copiers. In particular, printers are further required to be reduced in size and made more waste-free.

Focusing on a cleaning device, a cleaner-less system that does not originally include the cleaning device is highly suitable for size reduction of the process cartridge. In many printers, the toner remaining on the electrostatic latent image carrying member after a transfer process is scraped off by a cleaning blade or the like and collected into a cleaning container and treated as waste toner. On the other hand, in a cleaner-less system, there is no cleaning blade or cleaning container, and transfer residual toner is recovered again by the developing device and used for development. Therefore, the process cartridge can be greatly reduced in size, and there is no generation of waste toner, which greatly contributes to the waste free.

However, there are also problems inherent to the cleaner-less system. One of them is that the toner is hardly charged due to deformation of the toner due to long-term use, remains as transfer residual toner, and accumulates in the developing device, which tends to cause image defects. Conventionally, as a toner charging process, triboelectric charging of applying charge to toner by rubbing between the toner and a member such as a regulating member is widely performed. However, as described above, the deformed toner generated by long-term use is not sufficiently rubbed, and the charge amount tends to decrease. Therefore, an image defect known as “fogging”, which is caused by abnormal development in a non-image area, easily occurs. This fogging phenomenon is particularly likely to occur under high temperature and high humidity conditions where the charge amount of the toner is relatively low.

As a countermeasure against the reduction in charge amount of toner due to long-term use, an injection process has been studied. The injection process is a process of charging the toner by injecting charge into the toner by a potential difference between the toner and the member such as the regulating member. In this case, when a conductive path exists in the toner, charge can be applied to the entire toner without rubbing the toner.

Japanese Patent Laid-Open No. 2006-058745 proposes an injection process in which charge is injected into a toner by using a conductive toner and an injection member.

### SUMMARY

However, in a developing device using a developing blade, toner to which triboelectric charge is easily applied is consumed by being developed, and toner to which triboelectric charge is not easily applied remains in the developing device because the toner is hardly developed. In particular, as the toner is consumed due to image formation, the remaining amount of the toner in the developing device decreases, and a ratio of the toner to which triboelectric charge is hardly applied increases. As a result, a defect may occur in a printed image. Here, the toner to which triboelectric charge is less likely to be applied in the developing device using a spherical toner is typically a toner that is difficult to be rubbed and is less likely to rotate due to a shape being far from a spherical shape (irregular-shaped toner). On the other hand, the toner to which triboelectric charge is easily imparted is a toner which is close to a spherical shape and easily rotates.

In Japanese Patent Laid-Open No. 2017-191316, the resistance of the developing roller is increased to improve the triboelectric charge imparting property to the irregular-shaped toner. However, depending on the state of the developing device and the use environment, the effect of triboelectric charge imparting cannot be exhibited, or conversely, image defects may occur due to an excessively high triboelectric charge caused by triboelectric charge imparting.

The present disclosure has been made in view of the above problems, and an object of the present disclosure is to provide an image forming apparatus capable of effectively imparting triboelectric charge to an irregular-shaped toner.

In the image forming apparatus using the developing roller described in Japanese Patent Laid-Open No. 2017-191316, there is an effect of suppressing charge leakage in the regulating section that brings the developing blade into contact with the developing roller to thin the toner. On the other hand, in the developing region which is a contact area between the developing roller having a wider contact width than the regulating section and the photosensitive drum, charge may leak from the photosensitive drum to the developing roller. As a result, the potential of the photosensitive drum decreases, and fogging in which toner is transferred to a non-printing area or image density unevenness in which a density of a halftone image periodically changes may occur.

In particular, it has been found that the above problems are likely to occur in a process cartridge having a so-called cleaner-less configuration in which the transfer residual toner on the photosensitive drum is not recovered by the cleaning member. This is presumed to be because a low-resistance substance adheres to the developing roller or the photosensitive drum when printing is continued, or the low-resistance substance is mixed in the toner recovered by the developing roller and then supplied to the developing region again.

The present disclosure has been made in view of the above problems, and an object of the present disclosure is to suppress image defects such as fogging and image density unevenness caused by a decrease in potential of a photosensitive drum in a developing region of an image forming apparatus.

However, in Japanese Patent Laid-Open No. 2011-059280, it is difficult to reduce the printer in size because a member is added. In addition, since it is also necessary to remove the collected talc, it is also difficult to make the printer waste-free. In addition, the present disclosure is not applicable to a direct transfer method in which a recording material is conveyed between a photosensitive member and a transfer member, and a toner image formed on a surface of the photosensitive member is transferred onto the recording material by a transfer unit.

As described above, although there is an effective method called a cleaner-less system for implementing size reduction and waste free of the printer, in the cleaner-less system, the problems related to the image defects have not yet been solved.

The present disclosure has been made in view of the above problems, and an object of the present disclosure is to suppress occurrence of image defects such as toner charging failure and fogging, which occur when a transfer material containing a filler and an additive is used.

However, Japanese Patent Laid-Open No. 2006-058745 has the following problems. In Japanese Patent Laid-Open No. 2006-058745, the surface of the low-resistance conductive toner is covered with an insulating layer, and when the electric field strength is high, the resistance of the toner decreases significantly, and charge is injected into the toner. However, since the resistance of the insulating layer on the surface of the conductive toner or the developing roller is affected by the environment, there is a case where a sufficient charge cannot be applied to the toner due to a change in the amount of charge injected into the toner or leakage of the charge injected into the toner. In particular, in a high temperature and high humidity environment, the charge injected into the toner often leaks.

In addition, the charge injected into the toner may decrease due to long-term use. This is presumed to be because the state of the insulating layer on the surface of the conductive toner changes due to long-term use, and the charge injected into the toner decreases. As described above, also in the injection system, there is a problem that the fogging phenomenon remarkably occurs due to a high-temperature and high-humidity environment or long-term use.

The present disclosure has been made in view of the above problems, and an object of the present disclosure is to provide an image forming apparatus capable of effectively injecting charge into a toner for a long period of time.

The present disclosure provides a process cartridge comprising:
a developer carrying member configured to carry a developer;
a developing container configured to accommodate the developer carrying member and a developer containing developer particles;
a developing blade configured to regulate the developer on the developer carrying member;
an image carrying member configured to carry a developer image; and
a charging member configured to charge the image carrying member,
wherein the developer carrying member includes a substrate having a conductive outer surface and a resin layer formed on the outer surface of the substrate,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more,
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion,
a surface of the developer particles is coated with surface particles having an electrical conductivity of 1×10⁻¹⁵ S/m or more different from that of a developer base, a coverage of the surface particles is 35% or more, and an adhesion rate of the surface particles is 80% or more, and
a voltage is applied to the developing blade with a predetermined potential difference with respect to the developer carrying member, and the predetermined potential difference has the same polarity as a normal charging polarity of the developer.

According to the present disclosure, it is possible to provide an image forming apparatus capable of effectively imparting triboelectric charge to an irregular-shaped toner.

According to the present disclosure, it is possible to suppress image defects such as fogging and image density unevenness caused by a decrease in potential of a photosensitive drum in a developing region of an image forming apparatus.

According to the present disclosure, it is possible to suppress occurrence of image defects such as toner charging failure and fogging, which occur when a transfer material containing a filler and an additive is used.

According to the present disclosure, it is possible to provide an image forming apparatus capable of effectively injecting charge into a toner for a long period of time.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic cross-sectional view illustrating an example of an image forming apparatus in an example;

FIG. 2 is a schematic cross-sectional view illustrating an example of a process cartridge in an example;

FIG. 3 is a schematic cross-sectional view illustrating an example of a developing roller in an example;

FIG. 4 is a schematic cross-sectional view illustrating another example of the developing roller in an example;

FIG. 5 is a schematic view of a state in which measurement electrodes are formed on a developing roller in an example;

FIG. 6 is a cross-sectional view of a developing roller and measurement electrodes in an example;

FIG. 7 is a schematic view of an impedance measurement system in an example;

FIG. 8 is a schematic view illustrating an example of an apparatus for measuring a surface potential of a developing roller in an example;

FIG. 9 is a schematic diagram of a circuit that measures a leakage current flowing from toner to an electrophotographic roller;

FIG. 10 is a view illustrating a modification of the voltage contact between the process cartridge and the image forming apparatus;

FIG. 11 is a view illustrating a modification of the voltage contact between the process cartridge and the image forming apparatus;

FIG. 12 is a schematic cross-sectional view illustrating an example of an image forming apparatus in Example 1;

FIG. 13 is a schematic cross-sectional view illustrating an example of a process cartridge in Example 1;

FIG. 14 is a schematic cross-sectional view illustrating an example of a developing roller in Example 1;

FIG. 15 is a schematic cross-sectional view illustrating another example of the developing roller in Example 1;

FIG. 16 is a schematic view of a state in which measurement electrodes are formed on a developing roller in Example 1;

FIG. 17 is a cross-sectional view of a developing roller and measurement electrodes in Example 1;

FIG. 18 is a schematic view of an impedance measurement system in Example 1;

FIG. 19 is a schematic view illustrating an example of an apparatus for measuring a surface potential of a developing roller in Example 1;

FIGS. 20A to 20C are schematic views illustrating contact states of a developer carrying member, a developer, and an image carrying member in a developing region;

FIG. 21 is a schematic cross-sectional view illustrating an example of an image forming apparatus in Example 1;

FIG. 22 is a schematic cross-sectional view illustrating an example of a process cartridge in Example 1;

FIG. 23 is a schematic cross-sectional view illustrating an example of a developing roller in Example 1;

FIG. 24 is a schematic cross-sectional view illustrating another example of the developing roller in Example 1;

FIG. 25 is a schematic view of a state in which measurement electrodes are formed on a developing roller in Example 1;

FIG. 26 is a cross-sectional view of a developing roller and measurement electrodes in Example 1;

FIG. 27 is a schematic view of an impedance measurement system in Example 1;

FIG. 28 is a schematic view illustrating an example of an apparatus for measuring a surface potential of a developing roller in Example 1;

FIG. 29 is a schematic diagram of a circuit that measures a leakage current flowing from toner to an electrophotographic roller;

FIG. 30 is a schematic cross-sectional view illustrating an example of an image forming apparatus in Example 1;

FIG. 31 is a schematic cross-sectional view illustrating an example of a process cartridge in Example 1;

FIG. 32 is a schematic cross-sectional view illustrating an example of a developing roller in Example 1;

FIG. 33 is a schematic cross-sectional view illustrating another example of the developing roller in Example 1;

FIG. 34 is a schematic view of a state in which measurement electrodes are formed on a developing roller in Example 1;

FIG. 35 is a cross-sectional view of a developing roller and measurement electrodes in Example 1;

FIG. 36 is a schematic view of an impedance measurement system in Example 1;

FIG. 37 is a schematic view illustrating an example of an apparatus for measuring a surface potential of a developing roller in Example 1;

FIG. 38 is a schematic diagram of a circuit that measures a leakage current flowing from toner to a developing roller;

FIG. 39 is a schematic view of a toner electrical conductivity measurement system in Example 1;

FIG. 40 is a diagram illustrating an influence of impedance of the developing roller and an electrical conductivity of surface particles;

FIG. 41 is a diagram illustrating an influence on an evaluation value of toner shape irregularity;

FIG. 42 is a diagram illustrating an influence on a charge amount per unit area; and

FIG. 43 is a diagram illustrating an influence on a charge amount per unit area.

### DESCRIPTION OF THE EMBODIMENTS

Hereinafter, preferred examples of the present disclosure will be exemplarily described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

In the present disclosure, the description “XX or more and YY or less” or “XX to YY” representing a numerical range means a numerical range including a lower limit and an upper limit which are endpoints, unless otherwise specified. When the numerical ranges are listed in stages, the upper limit and the lower limit of each numerical range can be combined as appropriate. In addition, in the present disclosure, the description such as “at least one selected from the group consisting of XX, YY and ZZ” means any of XX, YY, ZZ, a combination of XX and YY, a combination of XX and ZZ, a combination of YY and ZZ, or a combination of XX and YY and ZZ.

The present inventors consider details of solving the problem by the methods described above as follows.

First, the present inventors presumed as follows: the reason why triboelectric charge is not sufficiently imparted to the irregular-shaped toner when the developing roller according to Japanese Patent Laid-Open No. 2017-191316 is mounted in a process cartridge as a developing device.

Since irregular-shaped toner is less susceptible to triboelectric charge by friction between a developing blade and a developing roller, it is effective to impart triboelectric charge by providing a potential difference (blade bias) between the developing blade and the developing roller as disclosed in Japanese Patent Laid-Open No. 2017-191316. In the developing roller according to Japanese Patent Laid-Open No. 2017-191316, a specific structure having a polycarbonate structure is introduced into polyurethane in order to increase the resistance of the surface layer. On the other hand, while the hardness of the surface layer is increased due to the introduction of the specific structure having the polycarbonate structure, a specific structure having an oxyalkylene structure is introduced.

The present inventors have estimated that the oxyalkylene structure causes charge leakage from the toner to the developing roller, such that triboelectric charge may decrease. That is, it was estimated that, in the case of irregular-shaped toner, it is originally difficult to impart triboelectric charge by triboelectric charging, the triboelectric charge imparted by the blade bias is reduced by the oxyalkylene structure. This was considered that the oxyalkylene structure promotes the movement of charge in the polyurethane. Therefore, the present inventors have considered a combination of a developing roller in which a surface layer is formed using a polyurethane having only a polycarbonate structure (hereinafter, referred to as polycarbonate urethane), obtained by removing the specific structure having the oxyalkylene structure from the polyurethane of Japanese Patent Laid-Open No. 2017-191316, with a developing blade to which a voltage is applied.

As a result, although it was possible to suppress a decrease in triboelectric charge, a new problem that the excessively charged toner adhered to the surface of the developing roller occurred due to the excessively high electrical resistance of the surface layer.

Therefore, the present inventors have studied removal of excess charge from an excessively charged developing roller. For example, as a result of examining inclusion of a conductive filler in the surface layer, the present inventors have found a new issue that it is difficult to sufficiently disperse the conductive filler in polycarbonate urethane that does not have an oxyalkylene structure. When the dispersibility of the conductive filler is insufficient, a conductive path formed by the conductive filler in the surface layer may cause charge leakage and a decrease in triboelectric charge, or conversely, the expected effect of removing excess charge by the conductive filler may be insufficient.

That is, it is necessary to solve, at a high level, the conflicting problems of suppressing the decrease in triboelectric charge in the surface layer containing polycarbonate urethane and removing excess charge from the excessively charged toner. That is, the present inventors have recognized that it is necessary to develop a novel surface layer capable of removing excess charge while maintaining high electrical resistance of the surface layer. Based on such recognition, the present inventors have further studied.

As a result, the present inventors have recognized that, for a developing roller including a substrate having a conductive outer surface and a resin layer containing a polyurethane having a polycarbonate structure, the resin layer being provided on the outer surface of the substrate, it is effective to satisfy the following two requirements in order to solve the above two conflicting problems at a high level.

### Requirement (1)

A metal film is directly provided on an outer surface of a developing roller, and in an environment of a temperature of 23° C. and a relative humidity of 50%, a DC voltage of 50 V is applied between the outer surface of the substrate and the metal film, while an AC voltage having an amplitude of 50 V is applied with a frequency varied in a range of 1.0×10⁻¹ to 1.0×10⁵ Hz. At this time, the impedance at the frequency of 1.0×10⁰ to 1.0×10¹ Hz is 1.00×10⁶Ω or more.

### Requirement (2)

In an environment of a temperature of 23° C. and a relative humidity of 50%, a corona discharger having a grid portion having a width of 3.0 mm is disposed so that a distance between the grid portion and the outer surface of the developing roller is 1.0 mm, and a direction of the width of the grid coincides with an axial direction of the developing roller. Then, a voltage of 8 kV is applied to the grid portion, the corona discharger is relatively moved at a speed of 400 mm/sec along the axial direction of the developing roller to charge the outer surface of the developing roller, and a potential of the outer surface after 0.06 seconds from the passage of the grid is measured. The maximum value of the potential at this time is less than 20.0 V.

Hereinafter, the requirements (1) and (2) will be described in detail.

### <Technical Significance of Requirement (1)>

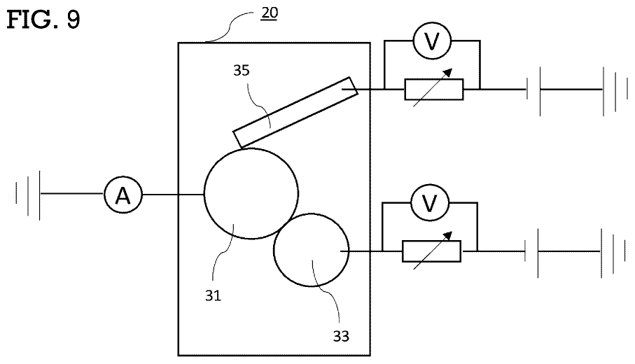

In the requirement (1), a numerical value of the impedance of the developing roller is defined. The impedance is a physical property value expressing charge leakage from the toner to the developing roller, that is, a degree of decrease in triboelectric charge. The present inventors measured a current value (leakage current value) flowing from the developing blade to the developing roller in a non-image forming area according to the circuit diagram illustrated in FIG. 9. As a result, it was found that the current value has a higher correlation with the impedance value of the developing roller than the electrical resistance value of the developing roller.

That is, the charge leakage indicates that it is necessary to consider the influence of not only a resistance component of the developing roller but also an electrostatic capacitance component. This is considered to be because when the electrical characteristics of the developing roller are represented in a pseudo manner by an RC parallel circuit, charge is sufficiently stored in a capacitor component, and a transient state until reaching a steady state in which the resistance component is dominant greatly affects charge leakage.

The voltage application condition for impedance measurement is obtained by superimposing an AC voltage of 50 V on a DC voltage of 50 V. That is, a sine wave having a minimum value and a maximum value of the applied voltage of 0 V and 100 V (Vpp 100 V), respectively, is applied.

The impedance shows bias dependency, and has a property that the impedance decreases as the bias increases, but it is known that the degree of decrease varies depending on the developing roller. In the conventional impedance measurement of the developing roller, the condition that the voltage application condition is the AC voltage of 1 V is generally used, but under the application condition of the AC voltage of 1 V, the voltage application condition is clearly smaller than the potential difference (generally several hundred V) at the developing region where the photosensitive drum and the developing roller are brought into contact with each other in the actual electrophotographic image forming apparatus. Therefore, since there is a case where the behavior in the developing region in the electrophotographic image forming apparatus cannot be simulated, Vpp 100 V closer to the actual potential difference in the developing region is adopted.

In the present disclosure, the impedance at the frequency of 1.0×10⁰ to 1.0×10¹ Hz is specified, and a low frequency range of the frequency of 1.0×10⁰ to 1.0×10¹ Hz is a region where the transient state is completed and a steady state in which the resistance component is dominant is reached. That is, the influence of both the electrostatic capacitance component and the resistance component is reflected, and the region is suitable for grasping the charge leakage property from the toner to the developing roller. When the impedance at the frequency of 1.0×10⁰ to 1.0×10¹ Hz is 1.00×10⁶Ω or more, the charge leakage property is low, such that it is possible to suppress triboelectric charge held by the toner from leaking to the developing roller. As a result, it is possible to impart triboelectric charge to the irregular-shaped toner, and thus, it is possible to suppress accumulation of the irregular-shaped toner even when the amount of toner in a developing container decreases, thereby suppressing occurrence of printed image defects.

The impedance at the frequency of 1.0×10⁰ to 1.0×10¹ Hz is preferably 1.40×10⁶Ω or more. The impedance value is preferably as high as possible. Although an upper limit of the impedance value is not particularly limited, the upper limit may be, for example, 5.00×10⁷Ω or less.

In addition, the minimum value of the impedance at the frequency of 1.0×10⁰ to 1.0×10¹ Hz is preferably 1.40×10⁶Ω or more, more preferably 2.00×10⁶Ω or more, particularly preferably 3.00×10⁶Ω or more, and still more preferably 5.00×10⁶Ω or more. A preferred range of the impedance is 1.00×10⁶Ω or more and 5.00×10⁷Ω or less, preferably 1.40×10⁶Ω or more and 5.00×10⁷Ω or less, more preferably 2.00×10⁶Ω or more and 5.00×10⁷Ω or less, particularly preferably 3.00×10⁶Ω or more and 5.00×10⁷Ω or less, and still more preferably 5.00×10⁶Ω or more and 5.00×10⁷Ω or less.

### <Technical Significance of Requirement (2)>

In the requirement (2), the surface potential of the developing roller is defined. The surface potential of the developing roller indicates a residual charge on the surface of the developing roller, and is a physical property value indicating a degree of excessive charging (charge-up) of the surface of the developing roller. When the surface potential is high, the charge of the excessively charged toner cannot be appropriately controlled, and defects may occur in the printed image. As a defect of the printed image, a decrease in image density or so-called fogging in which toner is developed in a white background area may occur.

The cause of the decrease in image density is that a development electric field for developing the excessively charged toner increases (the potential difference required for development increases). In addition, the cause of the fogging is that an electric field (back contrast) with respect to an effective white background area of the image decreases due to the charge-up of the developing roller.

In the present disclosure, when a voltage of 8 kV is applied to the grid portion and the corona discharger is relatively moved at a speed of 400 mm/sec along the axial direction of the developing roller, the potential of the outer surface of the developing roller is checked 0.06 seconds after the outer surface passes through the grid portion of the corona discharger. When the maximum value of the potential of the outer surface is less than 20.0 V, the charge-up of the surface of the developing roller can be suppressed.

The maximum value of the potential of the outer surface is preferably 15.0 V or less, and more preferably 10.0 V or less. The maximum value of the potential of the outer surface is preferably as low as possible. A lower limit of the maximum value is not particularly limited.

As a preferred range of the maximum value of the potential of the outer surface, for example, 0 V or more and less than 20.0 V, particularly, 0 V or more and 15.0 V or less, and further, 0 V or more and 10.0 V or less are preferable.

By satisfying the requirements (1) and (2), it is possible to solve, at a high level, the conflicting problems such as suppression of a decrease in triboelectric charge by preventing charge leakage from the toner to the developing roller, suppression of charge-up on the surface of the developing roller, and removal of an excessively charged toner charge.

There are no particular limitations on the methods for satisfying the requirements (1) and (2). Specifically, as will be described below, examples thereof include methods for improving the dispersibility of the conductive filler by using the following resin layer materials, conductive filler materials, and additives.

### Example 1

### 1. Image Forming Apparatus

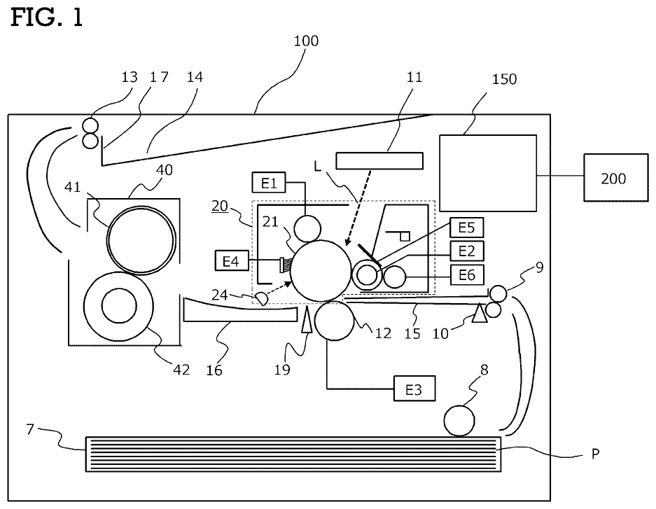

FIG. 1 is a schematic view of an image forming apparatus 100 of the present example. The image forming apparatus 100 of the present example is an electrophotographic laser printer, and can form an image on a recording material P (transfer material) according to image information input from an external device 200 such as a personal computer. Examples of the recording material P include various sheet materials of different materials, for example, paper such as plain paper or cardboard, a plastic film such as a sheet for an overhead projector, a sheet having a special shape such as an envelope and index paper, and cloth. First, the configuration of the image forming apparatus 100 of the present example will be described.

The image forming apparatus 100 includes an image forming unit including a scanner unit 11, a process cartridge 20 integrating an electrophotographic process centered around a photosensitive drum 21 that forms an electrostatic latent image and develops a toner image, and a transfer roller 12 that transfers the formed toner image to a recording material P. The image forming apparatus 100 also includes a recording material conveying unit that conveys the recording material to the transfer unit together with the operation of the image forming unit, a fixing device 40 that fixes the toner image formed on the recording material in the transfer unit onto the recording material, and a control unit 150 that controls the operation of the image forming apparatus.

When an image forming command is input to the image forming apparatus 100, an image forming process by the image forming unit is started on the basis of image information input from an external device 200 such as a personal computer connected to the image forming apparatus 100.

The control unit 150 is a controller that integrally controls the operation of the image forming apparatus 100. The control unit 150 executes a predetermined image forming sequence by controlling transmission and reception of various electrical information signals, drive timing, and the like. Each unit of the image forming apparatus 100 is connected to the control unit 150. For example, in relation to the present example, a charging power supply E1, a developing power supply E2, a transfer power supply E3, a brush power supply E4, a blade power supply E5, a supply roller power supply E6, a scanner unit 11 (exposure unit), a power supply of a fixing device (not illustrated), a drive motor, and the like are connected to the control unit 150.

### Image Forming Unit

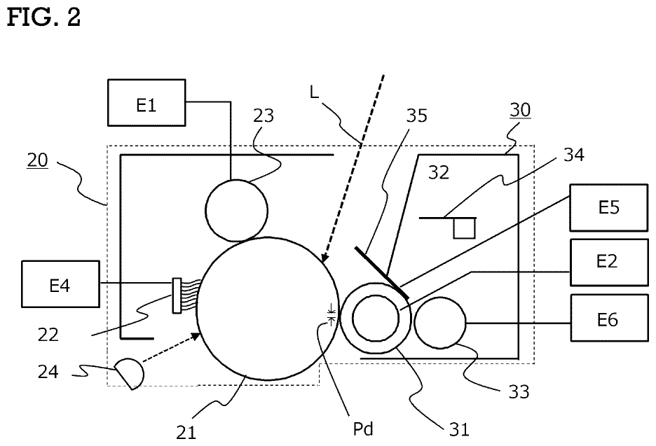

A cross-sectional view of the process cartridge 20 is illustrated in FIG. 2. The process cartridge 20 includes a developing device 30, a photosensitive drum 21, and the like. The developing device 30 includes a developing roller 31 that carries a toner, a developing container 32 that serves as a frame of the developing device 30, a supply roller 33 that can supply a developer to the developing roller 31, a stirring member 34 that stirs toner in the developing container 32, and a developing blade 35 that uniformizes a toner layer on the developing roller 31. The developing roller 31, the supply roller 33, and the stirring member 34 are rotatably supported by the developing container 32. In addition, the developing roller 31 is disposed in an opening of the developing container 32 so as to face the photosensitive drum 21. The supply roller 33 is rotatably brought into contact with the developing roller 31, and the toner stored in the developing container 32 is applied to a surface of the developing roller 31 by the supply roller 33.

The stirring member 34 as a stirrer is provided inside the developing container 32. The stirring member 34 is driven to rotate, thereby stirring the toner in the developing container 32 and feeding the toner toward the developing roller 31 and the supply roller 33. In addition, the stirring member 34 has a role of circulating the toner not used for development but peeled off from the developing roller 31 in the developing container and evening the toner in the developing container.

In addition, the developing blade 35 for regulating the amount of toner carried on the developing roller 31 is disposed in the opening of the developing container 32 in which the developing roller 31 is disposed. The developing blade 35 is formed of a stainless steel plate, and regulates the amount of toner by bringing a leading end of the plate into contact with the developing roller 31.

The developer supplied to the surface of the developing roller 31 passes through a portion facing the developing blade 35 with the rotation of the developing roller 31, such that the developer is uniformly thinned and has a charge amount suitable for image formation.

The developing device 30 of the present example uses a contact development method as a developing method. That is, the toner layer carried on the developing roller 31 is brought into contact with the photosensitive drum 21 in developing region (developing area Pd) where the photosensitive drum 21 and the developing roller 31 face each other. A developing voltage is applied to the developing roller 31 by a high-voltage developing power supply E2 as a developing voltage application unit. A blade voltage is applied to the developing blade 35 by the high-voltage blade power supply E5 which serves as a blade voltage application unit. In addition, a supply voltage is applied to the supply roller 33 by the high-voltage supply roller power supply E6 which serves as a supply voltage application unit. As a result, the charge amount of the developer can be controlled to a state suitable for image formation. A common supply source can be used for these voltage application units as necessary.

The toner carried on the developing roller 31 is transferred from the developing roller 31 to a surface of the photosensitive drum 21 in accordance with the electrostatic latent image, which is a potential distribution on the surface of the photosensitive drum 21, such that the electrostatic latent image is developed into a toner image. In the present example, the surface of the developing roller 31 is set to −300 V by the developing power supply E2. −400 V is applied to the blade power supply E5, and −300 V is applied to the supply roller power supply E6. In addition, a reversal development method is adopted in which a drum surface potential is uniformly charged to −500 V by a charging unit to be described below, the drum surface potential is attenuated through exposure by a scanner unit to be described below in the printing unit, and then, negatively charged toner adheres to an exposed area.

A back contrast Vback, which is the absolute value of the potential difference between the surface of the photosensitive drum 21 of a non-exposed area Vd, which is the non-image area, and the developing roller 31 before passing through the developing area, is 200 V.

In the present example, the surface of the photosensitive drum 21 rotates at a speed of 150 mm/sec, and a difference between the surface speed of the developing roller 31 and the surface speed of the photosensitive drum 21 (hereinafter, referred to as a development peripheral speed difference) is 40%. That is, the developing roller 31 rotates at 150×1.4=210 mm/sec. As a result, the photosensitive drum 21 and the developing roller 31 are brought into contact with each other with a speed difference of 60 mm/sec.

In addition, in the present example, toner having a volume average particle diameter of 7 μm and a normal charge polarity that is negative is used. As the toner, for example, a spherical polymerized toner generated by a polymerization method is employed. The toner does not contain a magnetic component, and is a so-called non-magnetic single-component developer in which the toner is mainly carried on the developing roller 31 by an intermolecular force or electrostatic force (image force). The volume average particle diameter of the toner can be measured by, for example, the Coulter method.

Toner particles contain a wax for adjusting the melting characteristics of the toner during the fixing process and the adhesion between the recording material P and a fixing film 41.

Fine particles having a submicron-order particle diameter are added to the surface of the toner particles to adjust the fluidity and chargeability of the toner. In the present example, toner to which fine particles are added is defined as a developer.

In the present example, although a non-magnetic single-component developer is used as an example, a single-component developer containing a magnetic component may be used.

The photosensitive drum 21 is a photosensitive member formed into a cylindrical shape. The photosensitive drum 21 as an image carrying member is rotationally driven at a predetermined process speed in a predetermined direction (clockwise direction in FIGS. 1 and 2) by a motor (not illustrated).

A paper dust collection brush 22 and a charging roller 23 are in contact with the photosensitive drum 21 with a predetermined pressing force. An arbitrary charging roller voltage is applied to the charging roller 23 from the charging power supply E1 to uniformly charge the surface of the photosensitive drum 21 to a predetermined potential. In the present example, the drum surface potential is finally charged to −500 V by the charging roller 23. In addition, by equalizing the drum surface potential after the transfer using a pre-exposure device 24 in advance, the drum surface potential can be made more uniform when charged by the charging roller 23.

An arbitrary brush voltage is applied to the paper dust collection brush 22 from E4, and paper dust and the like detached from the recording material P and attached to the photosensitive drum are collected. As a result, it is possible to prevent paper dust or the like from interfering with the charging of the photosensitive drum when passing through the charging unit.

The scanner unit 11 as an exposure unit scans and exposes the surface of the photosensitive drum 21 by irradiating the photosensitive drum 21 with a laser beam L corresponding to image information input from an external device using a polygon mirror. By this exposure, an electrostatic latent image corresponding to image information is formed on the surface of the photosensitive drum 21. Note that the scanner unit 11 is not limited to a laser scanner device, and for example, an LED exposure device having an LED array in which a plurality of LEDs are arranged along a longitudinal direction of the photosensitive drum 21 may be adopted. In the present example, a drum surface potential in a solid black portion attenuates to −50 V due to laser exposure by the scanner unit 11.

### Recovery of Transfer Residual Toner

In the present example, a so-called cleaner-less configuration is adopted in which transfer residual toner remaining on the photosensitive drum 21 without being transferred to the recording material P is recovered to the developing device 30 and reused. The transfer residual toner is reused in the following steps. The transfer residual toner includes a mixture of toner charged with a positive polarity, which is opposite to the normal polarity in the present example, non-spherical toner that are negatively charged and have strong adhesion to the drum, and the like.

By charging these toners to the normal polarity again when passing through the paper dust collection brush 22 and before reaching the contact portion between the charging roller 23 and the photosensitive drum 21, the transfer residual toner is not attached to the charging roller 23 and is along conveyed with the rotation of the photosensitive drum 21. As a result, the charging roller 23 can maintain excellent chargeability.

The transfer residual toner adhering to the surface of the photosensitive drum 21 that has passed through the contact portion with the paper dust collection brush 22 and the contact portion with the charging roller 23 reaches the developing region Pd with the rotation of the photosensitive drum 21. Here, the behavior of the transfer residual toner that has reached the developing region will be described separately for the exposed area and the non-exposed area of the photosensitive drum 21. In the non-exposed area of the photosensitive drum 21, that is, a dark potential portion Vd, the surface potential of the photosensitive drum 21 is greater on the negative polarity side than the developing voltage applied to the developing roller 31. Therefore, the transfer residual toner having a sufficient negative charge moves to the developing roller 31 by Coulomb force due to the electric field and is recovered into the developing container 32. Here, the dark potential portion Vd of the photosensitive drum 21 is not limited to the non-exposed area, and weak exposure may be performed when the surface potential of the photosensitive drum 21 is greater on the negative polarity side than the developing voltage applied to the developing roller 31.

The toner recovered in the developing container 32 is stirred with and dispersed in the toner in the developing container 32 by the stirring member 34, and is carried by the developing roller 31 to be used again in the developing process.

On the other hand, in an exposed area V1 of the photosensitive drum 21, since the surface potential of the photosensitive drum 21 is smaller on the negative polarity side than the developing voltage applied to the developing roller 31, the transfer residual toner remains on the surface of the photosensitive drum 21 without being transferred from the photosensitive drum 21 to the developing roller 31 in the developing region. The transfer residual toner remaining on the surface of the photosensitive drum 21 is carried on the photosensitive drum 21 together with other toner transferred from the developing roller 31 to the exposed area, moves to the transfer unit, and is transferred to the recording material P in the transfer unit.

Note that, in the present example, although the technique is disclosed by taking the cleaner-less configuration as an example, the present disclosure is not limited thereto, and a configuration in which a cleaning member of a photosensitive drum is further provided may be used.

### Recording Material Feeding Unit

In parallel with the image forming process described above, the recording material P stored in a paper tray 7 serving as a recording material storage unit is fed in synchronization with the transfer timing of the toner image. Describing the conveying process of the recording material P, first, a paper feed roller 8 feeds the recording material P stored in the paper tray 7. Next, the recording material P is fed to a pair of conveying rollers 9 by the paper feed roller 8, and abuts against the nip of the pair of conveying rollers 9 to correct skew. Then, the pair of conveying rollers 9 is driven in synchronization with the transfer timing of the toner image on the basis of the detection result of the leading end in the conveyance direction of the recording material P by a top sensor 10 as the recording material detector, and conveys the recording material P toward a transfer nip formed by the transfer roller 12 and the photosensitive drum 21 along a conveyance guide 15.

An electric field in a direction in which regularly-charged toner moves from the photosensitive drum to the transfer roller at the transfer nip is formed on the transfer roller 12 by the transfer power supply E3. When the recording material P is conveyed to the transfer nip in synchronization with the image forming timing, the toner image formed on the photosensitive drum 21 is transferred to the recording material P.

The excess charge on the surface of the recording material P to which the toner image is transferred is removed by a discharging needle 19. The recording material P that has passed through the discharging needle 19 is conveyed to the fixing device 40 along a transfer-to-fixing transport guide 16 as a guide member.

### Fixing Unit

The recording material P conveyed along the transfer-to-fixing transport guide 16 is conveyed to the fixing device 40. The fixing device 40 includes a fixing film 41, a fixing heater such as a ceramic heater that heats the fixing film 41, a thermistor that measures a temperature of the fixing heater, and a pressure roller 42 that comes into pressure contact with the fixing film 41. When the recording material P passes between the fixing film 41 and the pressure roller 42, the toner on the recording material P is heated and pressurized and fixed to the recording material P.

The recording material P that has passed through the fixing device 40 is discharged to the outside of the image forming apparatus 100 by a discharge roller pair 13, and is stacked on a discharge tray 14. The discharge tray 14 is inclined upward toward the downstream side in the discharge direction of the recording material, and the recording material discharged to the discharge tray 14 slides down the discharge tray 14, such that a trailing end is aligned by a regulation surface 17.

Note that, in the present example, although the process cartridge 20 detachably attached to a main body of the image forming apparatus is used, the present disclosure is not limited thereto, and it is sufficient that a predetermined image forming process can be performed. For example, the process cartridge may be a developing cartridge to which the developing device 30 is detachable, a drum cartridge to which the drum unit is detachable, or a toner cartridge for externally supplying toner to the developing device 30, may have a configuration without a detachable cartridge.

In addition, in the present example, although the technique using a monochrome printer as an example is disclosed, the present disclosure can also be applied to a full-color printer including process cartridges for a plurality of colors and forming a full-color image on the recording material P.

### 2. Developing Roller

The developing roller 31 as a developing roller will be described below with reference to the drawings.

A developing roller according to at least one aspect of the present disclosure includes a conductive substrate and at least one resin layer provided on an outer peripheral surface of the substrate.

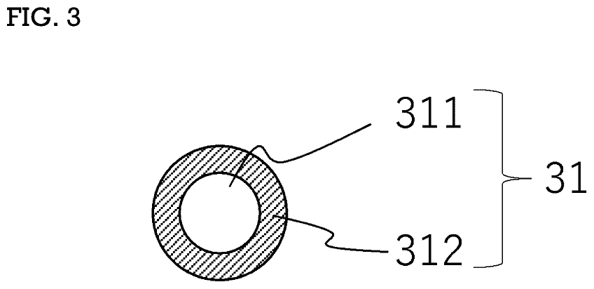

An example of the developing roller is illustrated in FIG. 3. In the developing roller 31, a resin layer 312 is laminated on an outer peripheral surface of a columnar or hollow cylindrical substrate 311.

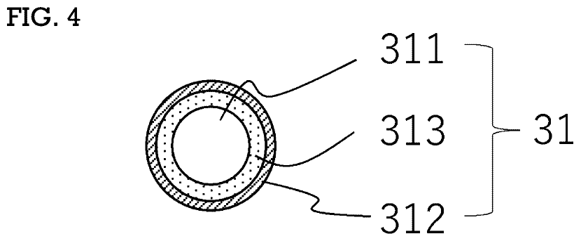

Note that the configuration of the layer of the developing roller is not limited to the form illustrated in the above drawing. As another form of the developing roller, as illustrated in FIG. 4, an elastic layer 313 may be provided between the substrate 311 and the resin layer 312 provided on the outer peripheral surface thereof.

### [Substrate]

The substrate has a conductive outer surface, and functions as a support member of the developing roller and, in some cases, as an electrode. As a specific example of the substrate, a solid columnar shape or a hollow cylindrical shape is preferable.

The material constituting the substrate can be appropriately selected from materials known in the field of conductive members for electrophotography and materials that can be used as the developing roller. Examples thereof include metals represented by aluminum and stainless steel, carbon steel alloys, conductive synthetic resins, and metals or alloys such as iron and copper alloys.

Furthermore, the material constituting the substrate may be subjected to an oxidation treatment or a plating treatment with chromium, nickel, or the like. As the type of plating, either electroplating or electroless plating can be used. From the viewpoint of dimensional stability, electroless plating is preferable. Examples of the electroless plating used here include nickel plating, copper plating, gold plating, and various other alloy plating. A plating thickness is preferably 0.05 μm or more, and the plating thickness is preferably 0.1 to 30 μm in consideration of a balance between work efficiency and rust prevention capability.

A primer may be applied to the surface of the substrate in order to improve adhesiveness between the substrate and the resin layer. As the primer, a known primer can be selected and used according to the rubber material for forming the conductive layer, the material of the support, and the like. Examples of the material of the primer include a thermosetting resin and a thermoplastic resin, and specifically, materials such as a phenolic resin, polyurethane, an acrylic resin, a polyester resin, a polyether resin, and an epoxy resin can be used.

### [Resin Layer]

The developing roller has a resin layer provided on the outer surface of the substrate. For example, the resin layer is present on the outer surface of the developing roller. The resin layer may contain a binder resin. As the binder resin of the resin layer in the developing roller, a polyurethane having a polycarbonate structure is preferably used in order to suppress charge leakage from the toner to the developing roller. That is, the resin layer contains a polyurethane having a polycarbonate structure. Furthermore, in order to sufficiently maintain a light load on the toner and abrasion resistance of the resin layer while suppressing charge leakage from the toner to the developing roller, it is more preferable to use a polyurethane having a structure described below as the binder resin of the resin layer.

It is preferable that the resin layer contains a polyurethane having a polycarbonate structure, and the polyurethane satisfies at least two of the following (A), (B), and (C). All of the following (A), (B), and (C) may be satisfied:
(A) the polyurethane has a structure represented by the following Structural Formula (1) in a molecule;
(B) the polyurethane has, in a molecule, either or both of a structure represented by the following Structural Formula (2) and a structure represented by the following Structural Formula (3);
(C) the polyurethane has a structure represented by the following Structural Formula (4) in a molecule.

That is, the polyurethane preferably satisfies at least one of the following conditions.
The polyurethane has at least a structure represented by Structural Formula (1) and a structure represented by Structural Formula (2).
The polyurethane has at least a structure represented by Structural Formula (1) and a structure represented by Structural Formula (3).
The polyurethane has at least a structure represented by Structural Formula (1) and a structure represented by Structural Formula (4).
The polyurethane has at least a structure represented by Structural Formula (2) and a structure represented by Structural Formula (4).
The polyurethane has at least a structure represented by Structural Formula (3) and a structure represented by Structural Formula (4).

In particular, the polyurethane more preferably has at least the structure represented by Structural Formula (1) and the structure represented by Structural Formula (4) in the molecule from the viewpoint of excellent fogging suppression and image density stability.

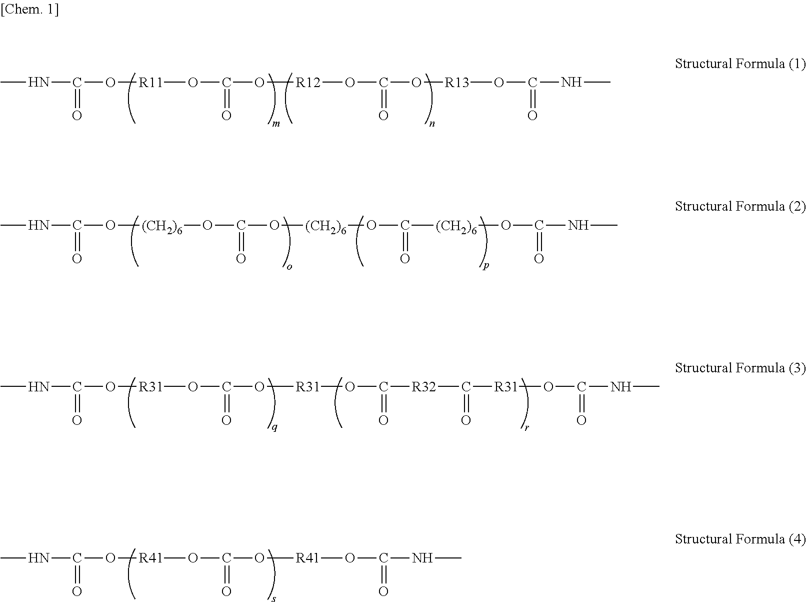

In Structural Formula (1), R11, R12, and R13 each represent a divalent hydrocarbon group having 3 to 9 carbon atoms. However, R11 and R12 are different from each other, and R13 is the same as at least one selected from the group consisting of R11 and R12. m and n are average numbers of added moles and each independently represent a number of 1.0 or more (preferably from 1.0 to 20.0, and more preferably from 2.0 to 12.0).

In Structural Formula (2), o and p are average numbers of added moles and each independently represent a number of 1.0 or more (preferably 1.0 to 15.0, and more preferably 4.0 to 10.0).

In Structural Formula (3), R31 and R32 each independently represent a divalent hydrocarbon group having 3 to 8 carbon atoms. q and r are average numbers of added moles and each independently represent a number of 1.0 or more (preferably from 1.0 to 20.0, and more preferably from 2.0 to 14.0).

In Structural Formula (4), R41 represents a divalent hydrocarbon group having 6 to 9 (preferably 5 to 8) carbon atoms. s is an average number of added moles and represents a number of 1.0 or more (preferably 1.0 to 22.0, and more preferably 4.0 to 18.0).

The structure represented by Structural Formula (1) is a structure obtained by reacting an isocyanate with a copolymerized polycarbonate polyol in which crystallinity is suppressed by linking two carbonate groups via two different hydrocarbon groups. Since the crystallinity is suppressed, the cohesive energy in the soft segment is low, and flexibility and a high volume resistivity can be imparted to the resin layer.

By using the structure of Structural Formula (1) in combination with the structures (2) to (4) described above for the resin layer, the adhesiveness of the resin layer can be reduced. Therefore, adhesion of toner, powder, or the like to the surface of the resin layer can be suppressed, an increase in the electrical resistance value of the surface of the resin layer due to contamination is suppressed, and uniform charging of the toner is easily performed.

In Structural Formula (1), R11 and R12 are each independently a divalent hydrocarbon group having 3 to 9 carbon atoms. R11 and R12 are different from each other, and R13 is the same as at least one selected from the group consisting of R11 and R12.

When the number of carbon atoms in R11 and R12 is 3 or more, in the polyurethane having a polycarbonate structure, the amount of carbonate groups which are polar functional groups and have strong cohesive energy is not excessively increased, and it becomes easier to maintain the resin layer in a flexible state and with a high electrical resistance.

In addition, when the number of carbon atoms in R11 and R12 is 9 or less, the amount of carbonate groups in the polyurethane is not excessively reduced, and the strength of the polymer can be maintained. In addition, since R11 and R12 have different structures, crystallinity of the polymer can be suppressed, and flexibility can be imparted to the resin layer. m and n each independently represent a number of 1.0 or more. The hydrocarbon groups represented by R11, R12, and R13 may have a branched structure or a cyclic structure.

The structures represented by Structural Formula (2) and Structural Formula (3) are structures obtained by reacting an isocyanate with a copolymerized polyol in which a polycarbonate structure and a polyester structure are copolymerized. The crystallinity of the polymer is suppressed by copolymerizing the polycarbonate structure and the polyester structure, and the soft segment is moderately reinforced by introducing an ester group having stronger cohesive energy than the carbonate group, such that abrasion resistance can be imparted to the resin layer.

When the resin layer is formed using a polymer in which the structure represented by Structural Formula (2) and/or Structural Formula (3) is combined with the structure of Formula (1) or (4) described above, a sufficient volume resistivity can be imparted to the resin layer while having an ester group having polarity, and charge leakage from the toner to the developing roller is more easily suppressed.

In Structural Formula (2), o and p each independently represent a number of 1.0 or more.

In Structural Formula (3), R31 and R32 each independently represent a divalent hydrocarbon group having 3 to 8 carbon atoms, and q and r each independently represent a number of 1.0 or more. When the number of carbon atoms in each of R31 and R32 is 3 or more, the amount of the carbonate group and the ester group which are polar functional groups and have strong cohesive energy in the polyurethane is not excessively increased, and the flexibility of the resin layer can be maintained. In addition, when the number of carbon atoms in R31 and R32 are 8 or less, the amount of carbonate groups and ester groups in the polyurethane is not excessively reduced, and abrasion resistance can be imparted to the resin layer.

The structure represented by Structural Formula (4) is a structure obtained by reacting an isocyanate with a highly crystalline polycarbonate polyol in which two carbonate groups are linked via a single hydrocarbon group.

Since this structure has high crystallinity and is easily aligned in the soft segment, abrasion resistance and a high volume resistivity can be imparted to the resin layer. By forming the resin layer using a polymer in which the structure represented by Structural Formula (4) is combined with the structures of Formulas (1) to (3) described above, the hardness of the resin layer does not become excessively high and can be appropriately controlled with ease.

In Structural Formula (4), R41 represents a divalent hydrocarbon group having 6 to 9 carbon atoms, and s represents a number of 1.0 or more. When the number of carbon atoms in R41 is 6 or more, crystallinity is easily exhibited, and abrasion resistance and a high volume resistivity can be imparted to the resin layer. When the number of carbon numbers in R41 is 9 or less, excessive crystallinity can be suppressed, and therefore, by further incorporating at least one of the structures represented by Structural Formulas (1), (2), and (3) in the polymer, an increase in hardness of the resin layer can be suppressed.

The resin layer preferably contains a polymer having a urethane bond, that is, a polyurethane having a polycarbonate structure as a binder resin, and the polymer preferably satisfies at least two selected from the group consisting of (A), (B), and (C) described above. As a result, the resin layer becomes flexible and is less likely to wear.

The structure of the polymer contained in the resin layer of the developing roller can be confirmed by, for example, analysis by pyrolysis GC/MS, FT-IR, or NMR.

The polyurethane having a polycarbonate structure can be produced using (A) a polyol compound (A) and (B) a polyisocyanate compound (B). Usually, the following methods (1) and (2) are used for the synthesis of polyurethane:
(1) a one-shot method of mixing and reacting a polyol component and a polyisocyanate component; and
(2) a method of reacting an isocyanate-terminated prepolymer obtained by reacting a portion of the polyol with an isocyanate, with a chain extender such as a low-molecular-weight diol or a low-molecular-weight triol.

In the present disclosure, the polyurethane may be synthesized by any of the methods described above, but a method of thermally curing a hydroxyl-terminated prepolymer obtained by reacting a raw material polyol with isocyanate and an isocyanate-terminated prepolymer obtained by reacting a raw material polyol with isocyanate is more preferable.

The polyurethane having a polycarbonate structure is preferably a reaction product of a mixture containing a hydroxyl-terminated prepolymer and an isocyanate-terminated prepolymer. The mixture can be used as a coating liquid for forming a resin layer. The polyurethane having a polycarbonate structure is more preferably a reaction product of a mixture containing a hydroxyl-terminated prepolymer and an isocyanate-terminated prepolymer, and a conductive filler and an additive.

When hydroxyl groups, isocyanate groups, or a large number of urea bonds, allophanate bonds, isocyanurate bonds, and the like are present, since a large number of polar functional groups are present in the polyurethane; thus, the water absorption of the polymer increases, and the volume resistivity of the resin layer decreases, and there is a risk of causing charge leakage from the toner to the developing roller. On the other hand, by thermally curing the hydroxyl-terminated prepolymer and the isocyanate-terminated prepolymer, it is possible to obtain a polyurethane having low contents of unreacted polyol and polar functional groups without excessively using isocyanate.

### (A) Polyol Compound

The polyol is selected from known polycarbonate polyols and polyester polycarbonate copolymerized polyols.

Examples of the polycarbonate polyol include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester polycarbonate copolymerized polyol include the following: copolymers obtained by polycondensing the polycarbonate polyols with lactones such as ε-caprolactone, or copolymers with polyesters obtained by polycondensing diols such as 1,4-butanediol, 1,5-pentanediol, 1,6-hexanediol, 3-methylpentanediol, or neopentyl glycol, and dicarboxylic acids such as adipic acid or sebacic acid.

### (B) Polyisocyanate Compound

The polyisocyanate is selected from commonly used known polyisocyanates, and examples thereof include the following polyisocyanates: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, aromatic isocyanates such as toluene diisocyanate (TDI), diphenylmethane diisocyanate (MDI), polymeric diphenylmethane polyisocyanate, and polymeric MDI are more preferably used. Other polyisocyanates can also be used as long as they do not affect an impedance value and a surface potential.

A ratio of the number of isocyanate groups to the number of hydroxyl groups (hereinafter, also referred to as “ratio of NCO/OH”) is preferably 1.0 to 2.0. When the ratio of NCO/OH is 1.0 to 2.0, a crosslinking reaction proceeds, and bleeding of unreacted components and low-molecular-weight polyurethane, so-called “bleed” is suppressed. The ratio of NCO/OH is more preferably 1.0 to 1.6. When the ratio of NCO/OH is 1.0 to 1.6, bleed is suppressed, and the hardness of the polymer can be suppressed.

A content of the polyurethane in the resin layer is not particularly limited, but is preferably 50 to 95 mass %, more preferably 60 to 80 mass %, and still more preferably 65 to 75 mass %.

### (Conductive Filler)

The resin layer preferably contains a conductive filler in order to obtain electrical conductivity. As the conductive filler in the resin layer, it is more preferable to use an electron conductive agent. The electron conductive agent is a conductive particle exhibiting electronic conductivity, and preferably has a surface functional group capable of interacting with a functional group present in an additive to be described below.

Examples of the electron conductive agent exhibiting these properties include at least one selected from the group consisting of carbon black such as furnace black, thermal black, acetylene black, and Ketjen Black, metal oxide-based conductive particles such as titanium oxide having a surface treated with an acidic functional group, and metal-based conductive particles such as aluminum and iron having a surface treated with an acidic functional group.

Among them, at least one selected from the group consisting of carbon blacks having high stability of surface functional groups is preferably used. The conductive filler preferably contains carbon black. Furthermore, in order to obtain a desired impedance value and surface potential, carbon black having a number average diameter of primary particles capable of achieving higher dispersion in the resin layer of 30 nm or less, a DBP absorption of 90 ml/100 g or less, and a pH of 4.0 or less is particularly preferably used.

When the number average diameter of primary particles of carbon black is 30 nm or less, an aggregate (primary aggregate), which is a minimum unit in which carbon black can be dispersed, becomes small, and a structure (size of connection of particles) also becomes small, such that a conductive path is hardly formed. Therefore, a sufficiently high impedance is easily obtained. Note that a primary particle diameter of carbon black can be calculated by a transmission electron microscope (TEM). The number average diameter is preferably as low as possible, and a lower limit of the number average diameter is not particularly limited. For example, the number average diameter of primary particles of carbon black is more preferably 5 to 30 nm or 20 to 28 nm.

When the DBP absorption of the carbon black is 90 ml/100 g or less, the structure of the carbon black becomes small, and a conductive path is hardly formed, such that a sufficiently high impedance is easily obtained. The DBP absorption is preferably as low as possible, and a lower limit of the DBP absorption is not particularly limited. For example, the DBP absorption of carbon black is more preferably 30 to 90 ml/100 g or 40 to 60 ml/100 g.

When the pH of the carbon black is 4.0 or less, an effect of dispersion stability is obtained by repulsion of the surface functional group of the carbon black, and aggregation of the carbon black hardly occurs, such that sufficiently high impedance is easily obtained. The pH of the carbon black is preferably as low as possible, and a lower limit of the pH is not particularly limited. For example, the pH of the carbon black is more preferably 2.0 to 4.0 or 2.2 to 2.8.

However, even when the number average diameter, DBP absorption, and pH of the primary particles of carbon black are within the above ranges, when polycarbonate urethane is used as a binder resin, the carbon black cannot be sufficiently dispersed, and a desired impedance may not be obtained. The reason why the carbon black having the desired material properties cannot be dispersed when polycarbonate urethane is used as a binder resin is not clearly known, but is presumed as follows.

Hydroxyl groups, which are surface functional groups of carbon black, are likely to interact with terminal hydroxyl groups of polycarbonate diol. On the other hand, a structure in which a carbonate bond and a hydrocarbon group are bonded, which is present between two hydroxyl groups of polycarbonate diol, is hydrophobic due to the presence of the hydrocarbon group, and hardly interacts with carbon black. Since hydrophobic groups and hydrophilic groups tend to be structurally more stable when located near other hydrophobic groups and near other hydrophilic groups, respectively, hydrophilic carbon black tends to be located in the vicinity of other hydrophilic carbon black. As a result, it is considered that the carbon black is easily aggregated and hardly dispersed.

In order to sufficiently disperse carbon black in which the number average diameter of primary particles, the DBP absorption, and the pH are in the above numerical ranges using polycarbonate urethane as a binder resin, it is more preferable to add an additive described below.

A content of the carbon black is preferably 30 parts by mass or less with respect to 100 parts by mass of the polyurethane forming the resin layer although it is desirable to add the carbon black so as to have a desired volume resistivity. The content of the carbon black is more preferably 10 to 30 parts by mass and still more preferably 15 to 25 parts by mass.

When the content is 30 parts by mass or less, the distance between the carbon blacks in the coating liquid is appropriately maintained, the collision probability due to Brownian motion or the like of the carbon black is reduced, and the carbon black is less likely to aggregate. Therefore, carbon black is easily dispersed, and dispersion stability is also improved. As a result, carbon black is well dispersed in the resin layer formed by forming the coating liquid.

In order to achieve the specific impedance and surface potential, it is preferable to control the dispersion of carbon black. As a dispersion particle diameter of the carbon black, an arithmetic mean value Rc of equivalent circle diameters of the carbon black in the resin layer is preferably 60.0 nm or less.

When the standard deviation of the equivalent circle diameter is defined as ac [nm], σc/Rc is more preferably 0.000 to 0.650.

In addition, as the distance between the carbon blacks, when an arithmetic mean value d of wall-to-wall distances of the carbon black in the resin layer is 80.0 to 150.0 nm and the standard deviation of the distances between the wall surfaces is defined as σd [nm], σd/d is more preferably 0.000 to 0.600.

The reason why the high impedance and the low surface potential are more easily compatible when the equivalent circle diameter and the wall-to-wall distance are in the above numerical ranges is estimated as follows.

When the dispersion particle diameter is large, there is a place where the wall-to-wall distance is short, and a conductive path is easily formed, such that the impedance and the surface potential are low. On the other hand, when the dispersion particle diameter is reduced, the wall-to-wall distance becomes uniform, it is difficult to form a conductive path, the resistance increases, and the capacitance also decreases, such that the impedance increases. In terms of the surface potential, the resistance becomes high, the influence of the component of the electrostatic capacitance becomes large, and the surface potential can be lowered by the charge that can be stored in the pseudo capacitor component.

Note that, when the surface of the carbon black is coated with an insulating material such as a silane coupling agent, the carbon black cannot act as a pseudo capacitor, such that both the impedance and the surface potential are high.

Note that a plurality of types of carbon blacks may be used in combination as long as the impedance value and the surface potential are not affected.

The arithmetic mean value Rc of the equivalent circle diameters is more preferably 40.0 to 60.0 nm and still more preferably 45.0 to 55.0 nm. σc/Rc is more preferably 0.500 to 0.650 and still more preferably 0.550 to 0.650.

The arithmetic mean value Rc and the standard deviation σc of the equivalent circle diameters can be changed depending on, for example, a dispersion state in a mill or the like when a coating liquid for forming a resin layer is prepared. When the dispersion is weaker, Rc and σc tend to increase, and when the dispersion is strengthened, Rc and σc tend to decrease. Normally, since Rc converges, when the dispersion state exceeds a certain level, it is possible to lower σc while Rc is substantially constant, which makes it possible to reduce σc/Rc.

The arithmetic mean value d of the wall-to-wall distances is more preferably 90.0 to 120.0 nm and still more preferably 95.0 to 115.0 nm. σd/d is more preferably 0.500 to 0.600 and still more preferably 0.540 to 0.590.

The arithmetic mean value d and the standard deviation σd of the wall-to-wall distances can be changed depending on, for example, a dispersion state in a mill or the like when a coating liquid for forming a resin layer is prepared. When the dispersion is weaker, d tends to decrease and σd tends to increase, and when the dispersion is stronger, d tends to increase and σd tends to decrease. Therefore, when the dispersion is weak, σd/d tends to be large, and when the dispersion is strong, σd/d tends to be small.

### (Additive)

It is also one preferred mode to use an additive for further improving dispersibility of carbon black in a binder resin using polycarbonate urethane. Here, as the additive, for example, at least one compound selected from the group consisting of a compound having a structure represented by the following Structural Formula (5), a compound having a structure represented by the following Structural Formula (6), and a compound having a structure represented by the following Structural Formula (7) can be preferably used. One of the methods for incorporating the additive into the surface layer is a method for incorporating a dispersant in a coating liquid for forming a resin layer. Note that in the surface layer formed using a coating liquid for forming a resin layer containing at least one compound selected from the group consisting of a compound having a structure represented by Structural Formula (5) and a compound having a structure represented by Structural Formula (6), the compound may be incorporated at the end of the polymer chain of the polyurethane. Even in this case, the effect of improving the dispersibility of carbon black can be expected, but it is preferable that carbon black is present in the surface layer independently of polyurethane.

Among the compounds having the structures represented by Structural Formulas (5) to (7), the compound having the structure represented by Structural Formula (5) is more suitably used because the dispersibility of carbon black and the affinity with polycarbonate urethane are particularly preferred.

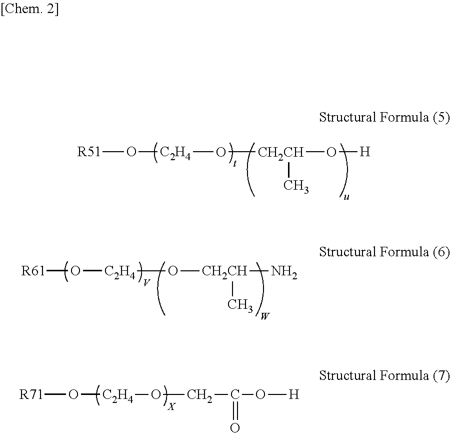

In Structural Formula (5), R51 represents a monovalent hydrocarbon group having 1 to 12 (preferably 3 to 12) carbon atoms. t and u are average numbers of added moles and each independently represent a number of 1 or more (preferably from 5 to 30, and more preferably from 10 to 25).

In Structural Formula (6), R61 represents a monovalent hydrocarbon group having 1 to 8 (preferably 1 to 4) carbon atoms. v and w are average numbers of added moles and each independently represent a number of 1 or more (preferably from 1 to 30, and more preferably from 5 to 30).

In Structural Formula (7), R71 represents a monovalent hydrocarbon group having 1 to 12 carbon atoms. x is an average number of added moles and represents a number of 1 or more (preferably 1 to 30, and more preferably 4 to 15).

Structural Formula (5) represents a polyoxyethylene polyoxypropylene alkyl ether, and is a polyether mono-ol having a structure obtained by block addition polymerization of ethylene oxide and propylene oxide. The hydroxyl group at the terminal of the polyether mono-ol interacts with functional groups on the surface of carbon black, which is a conductive filler, via hydrogen bonding, thereby acting as a dispersant for the carbon black. In addition, in order to enhance the effect of carbon black as a dispersant, the carbon black has a structure that is compatible with polycarbonate urethane.

Ethylene oxide is introduced into the structure to ensure uniform presence of the additive in the polycarbonate urethane. This is considered to be because the ethylene group in ethylene oxide is compatible with the hydrophobic hydrocarbon group in the polycarbonate urethane. In addition, propylene oxide is introduced into the structure in order to improve dispersibility of the conductive filler dispersed in the resin layer. This is considered to be due to the interaction between the side chain methyl group of propylene oxide and the conductive filler, which improves the dispersibility of the conductive filler.

R51, which is a monovalent hydrocarbon group having 1 to 12 carbon atoms, is introduced into the structure in order to make the additive uniformly present in the polycarbonate urethane. The monovalent hydrocarbon group is compatible with the hydrophobic hydrocarbon group in the polycarbonate urethane, and the additive can be uniformly present in the polycarbonate urethane. When the number of carbon atoms is 12 or less, steric hindrance with the polycarbonate urethane is unlikely to occur; thus, the additive is likely to be uniformly present.

Since the compound represented by Formula (5) has a mono-ol structure, the compound has lower reactivity than a diol, which makes it less likely to be incorporated during a urethanization reaction between the isocyanate and polyol; thus, the introduction of the ether structure into the polycarbonate urethane is minimized, thereby reducing a risk of a decrease in the resistivity of the polyurethane.

A polyoxyethylene polyoxypropylene alkyl ether can be obtained using commercially available products or by synthesis. The polyoxyethylene polyoxypropylene alkyl ether can be synthesized by performing step (B) after step (A). Note that step (B) may be performed on a commercially available product having a structure completed up to step (A).
Step (A): Reaction of alcohol with ethylene oxide
Step (B): Reaction of product obtained in step (A) with propylene oxide

In step (A), the reaction can proceed by adding ethylene oxide to an alcohol in the presence of a catalyst at 50 to 200° C., and more preferably at 100 to 160° C. Since ethylene oxide has a boiling point of 10.7° C. and is a gas at the above temperature, the reaction is preferably carried out in an environment pressurized in a sealed container. The pressure is preferably 0.1 MPa to 1.0 MPa. The reaction time is not particularly limited, but is preferably about 1 hour to 3 hours in order to reduce a content of unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of ease of reaction and reaction efficiency, sodium hydroxide and potassium hydroxide are particularly preferable. Examples of the acid catalyst include Brønsted acids such as sulfuric acid and phosphoric acid, and Lewis acids such as stannic chloride and boron trifluoride.

In the case of sodium hydroxide or potassium hydroxide, the amount of catalyst used is preferably 0.1 to 5 mol % based on 1 mol of the alcohol. Ethylene oxide reacts with water to produce ethylene glycol, such that moisture is prevented as much as possible, and a dehydration treatment may be performed before the reaction of step (A) as necessary.

Step (B) can be performed under the same conditions as in step (A). Since propylene oxide has a boiling point of 34.2° C. and is a gas at a reaction temperature of 50 to 200° C., it is preferable to perform the reaction in an environment pressurized in a sealed container. The catalyst used in step (A) may be used as it is or may be newly added. When newly added, the catalyst used in step (A) is preferable.

Structural Formula (6) is a polyether amine (monoamine) having a structure obtained by block addition polymerization of ethylene oxide and propylene oxide. The amino group at the terminal of the polyether amine interacts with the surface functional group of carbon black as a conductive filler by hydrogen bonding, and acts as a dispersant for carbon black. In addition, in order to enhance the effect as a dispersant, by introducing R61 which is a monovalent hydrocarbon group having 1 to 8 carbon atoms, a structure that is easily compatible with a hydrophobic functional group of polycarbonate urethane is obtained, and a structure that is compatible with the polycarbonate urethane is obtained.

A polyether monoamine can be obtained using a commercially available product or by synthesis. The polyether monoamine can be synthesized by performing step (D) after the following step (C).
Step (C): Oxidation reaction of compound of Structural Formula (5) which is secondary alcohol
Step (D): Reductive amination reaction of product obtained in step (C)

Step (C) is a reaction for producing a ketone by an oxidation reaction of a secondary alcohol. Ketone synthesis by oxidation of a secondary alcohol includes an oxidation reaction using a heavy metal salt such as chromic acid or manganese dioxide and a derivative thereof, and an oxidation reaction of a non-heavy metal salt using a hypohalous acid such as dimethyl sulfoxide (DMSO) or hypochlorous acid.

The synthesis may be performed using any method, but in view of environmental influence by heavy metals, an oxidation reaction using a hypohalous acid such as dimethyl sulfoxide (DMSO) or hypochlorous acid is preferable. Furthermore, dimethyl sulfoxide (DMSO) requires a low temperature of −60° C. because the reaction explosively proceeds at room temperature depending on an electrophilic activation reagent to be used, and thus, a method using a hypohalous acid is more preferable. Examples of the hypohalous acid include hypochlorites such as sodium hypochlorite and calcium hypochlorite (bleaching powder). These hypochlorites are reacted with a secondary alcohol in acetic acid to obtain a ketone.

When dimethyl sulfoxide (DMSO) is used, an electrophilic activation reagent is also required. By increasing the electrophilicity of sulfur in dimethyl sulfoxide (DMSO) with the electrophilic activation reagent, nucleophilic attack by the hydroxyl group of an alcohol. The nucleophilic attack generates a dimethyl alkoxy sulfonium salt, and the dimethyl alkoxy sulfonium salt is decomposed, thereby producing a ketone and dimethyl sulfide. Examples of the electrophilic activation reagent include dicyclohexylcarbodiimide (DCC), acetic anhydride, phosphorus pentoxide, a sulfur trisulfide-pyridine complex, trifluoroacetic anhydride, oxalyl chloride, and halogen.

Step (D) is a reductive amination reaction that converts a ketone to an amine. The reaction is divided into two stages. First, the carbonyl group reacts with the amine to produce an iminium cation. Subsequently, a hydride reducing agent performs a nucleophilic attack on the iminium cation to produce an amine. As the reducing agent, a borohydride reagent is preferably used. Examples of the borohydride reagent include sodium cyanoborohydride, sodium triacetoxyborohydride, and 2-picoline borane, and among them, sodium triacetoxyborohydride and 2-picoline-borane, which are less toxic, are preferable. In the reductive amination reaction using the borohydride reagent, it is difficult to produce an iminium cation due to steric hindrance when a bulky structure is involved. Therefore, R61 in Structural Formula (6) is preferably a monovalent hydrocarbon group having 1 to 8 carbon atoms.

Structural Formula (7) is polyoxyethylene alkyl ether acetate. The terminal carboxylic acid in Structural Formula (7) interacts with a surface functional group of carbon black as a conductive filler by hydrogen bonding, and acts as a dispersant for carbon black. In addition, in order to enhance the effect as a dispersant, by introducing R71 which is a monovalent hydrocarbon group having 1 to 12 carbon atoms, a structure that is easily compatible with a hydrophobic functional group of polycarbonate urethane is obtained, and a structure that is compatible with the polycarbonate urethane is obtained.

Polyoxyethylene alkyl ether acetate can be obtained using a commercially available product or by synthesis. The synthesis of polyoxyethylene alkyl ether acetate can be carried out by performing step (F) after step (E) described below. Note that step (F) may be performed on a commercially available product having a structure completed up to step (E).
Step (E): Reaction of alcohol with ethylene oxide
Step (F): Oxidation reaction of primary alcohol produced in step (E)

Step (E) is the same as step (A), and can be performed by the same method as in step (A).

The step (F) is a step of oxidizing a primary alcohol to produce a carboxylic acid. In the oxidation of a primary alcohol, a carboxylic acid is produced by further oxidation after an aldehyde is produced. Therefore, it is necessary to select a reaction method and conditions that do not stop at the aldehyde stage. Examples of the method for obtaining a carboxylic acid by oxidation of a primary alcohol include oxidation using an oxidizing agent and a catalytic dehydrogenation reaction using a catalyst. Examples of the oxidizing agent include permanganate, chromic acid, ruthenium tetroxide, and hypochlorite. Examples of the catalyst for the dehydrogenation reaction include palladium, platinum, iridium, rhodium, and manganese.

The compounds represented by Structural Formulas (5) to (7) have a function as a dispersant for carbon black, and are compounds having high affinity with polycarbonate urethane. Usually, a surfactant is used as a method for improving dispersibility and dispersion stability of carbon black. However, the compounds represented by Structural Formulas (5) to (7) are not generally used because the number of functional groups acting on the surface functional group of carbon black is small, and therefore, the surfactant action is weak. As a general dispersant for carbon black, a coupling agent and a nonionic surfactant are utilized.

As the coupling agent, a silane coupling agent, a titanate-based coupling agent, or an aluminum-based coupling agent is used, and as the nonionic surfactant, a polyester-based or polyether-based surfactant is used. However, when these dispersants are added to a level at which the dispersibility of carbon black can be sufficiently enhanced in polycarbonate urethane (mass ratio of 50 to 100% with respect to carbon black), the electrical conductivity of the carbon black or the binder resin is inhibited. On the other hand, when the amount added is set to a level at which the electrical conductivity of the carbon black or the binder resin is not inhibited (mass ratio of 10 to 40% with respect to the carbon black), the dispersibility of the carbon black cannot be obtained.

The amount of the compounds represented by Structural Formulas (5) to (7) is preferably 3.0 to 7.0 mass % based on the solid content in the coating liquid for forming a resin layer. The amount of the compounds represented by Structural Formulas (5) to (7) is more preferably 3.0 to 5.0 mass %. In addition, the total content is preferably 18.9 to 46.0 parts by mass with respect to 100 parts by mass of the carbon black in the coating liquid for forming a resin layer.

When the content of the additive in the coating liquid for forming a resin layer is within the above range, the dispersibility of carbon black in polyurethane is further improved, and a desired impedance value and surface potential can be more easily achieved.

The presence confirmation and quantitative evaluation of the additive in the resin layer can be analyzed by the following method. By cutting out the resin layer of the developing roller and using, for example, ¹H-NMR, ¹³C-NMR, XPS, or FT-IR on the cross-section, the carbonate structure of the binder resin, the ether structure, the amine structure, and the carboxylic acid structure of the additive can be detected in the resin layer, and ratios can be calculated from peak ratios or the like.

In addition, the cross section is immersed in an organic solvent such as 2-butanone (methyl ethyl ketone: MEK) overnight for extraction and analyzing both the extract and the extracted cross section using ¹H-NMR, ¹³C-NMR, XPS, and FT-IR, such that it is possible to determine the ratio of the additive incorporated into the resin during polymerization and the additive not incorporated in the resin.

Examples of the structure in which at least one of the compounds having the structures represented by Structural Formulas (5) and (6) is bonded to polyurethane (structure reacted during polymerization of polyurethane) include the following modes:
in the case of the structure represented by Structural Formula (5), in the polyurethane, a compound having the structure represented by Structural Formula (5) forms a urethane-modified structure; and
in the case of the structure represented by Structural Formula (6), in the polyurethane, a compound having the structure represented by Structural Formula (6) forms a urea-modified structure.

### [Coarse Particles]

The resin layer may contain coarse particles. The coarse particles may be, for example, spherical particles. A particle diameter of the coarse particle is, for example, preferably in the range of 1 μm to 150 μm, and more preferably in the range of 5 μm to 30 μm. Examples of the coarse particles include at least one spherical particle selected from the following particles:
urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. The coarse particles are preferably urethane resin particles.

The developing roller may have an elastic layer formed on the outer surface of the substrate. The developing roller has, for example, an elastic layer between the substrate and the resin layer. The elastic layer is not particularly limited, and a known elastic layer may be used as the elastic layer of the developing roller. Examples of the elastic layer include a cured product of an addition cure-type liquid silicone rubber mixture.

### (Production Method)

A method for forming the resin layer is not particularly limited, and examples thereof include a method by spraying with a coating material, dip coating, or roll coating. For example, a coating liquid for forming a resin layer is applied onto the substrate or the elastic layer formed on the outer surface of the substrate by a known method, and heated and dried to form a resin layer. The conditions for heating and drying are not particularly limited, and examples thereof include a method of drying under a condition of 120 to 200° C. A thickness of the resin layer is also not particularly limited, and is preferably 1 to 50 μm, and more preferably 5 to 20 μm.

### Method for Measuring Various Characteristics of Developing Roller

### <Impedance>

In the impedance measurement, the response of the developing roller is examined by applying an AC voltage and a DC voltage while varying the frequency. An AC voltage is applied, and a response with no phase shift and a response with a phase shift of π/2 with respect to the applied AC voltage are measured separately, the impedance of the response with no phase shift, which is defined as Z′ (the real part), and the impedance of the response with a phase shift, which is defined as Z″ (the imaginary part), are plotted on a complex plane, and a distance from the origin to the plotted point is calculated as an impedance value.

When the electrical characteristics of the developing roller are represented in a pseudo manner by an RC parallel circuit, the real part with no phase shift represents a resistive component, and the imaginary part with a phase shift represents a capacitive component. Note that the measurement conditions and the meanings of the measured values have been described in <Technical significance of requirement (1)> described above, and thus are omitted in this section.

A method for measuring impedance, a measuring apparatus, and measurement conditions will be described below.

### (Method for Measuring Impedance)

The impedance of the developing roller can be measured by the following methods (1) and (2):
(1) a method in which a thin film electrode is provided on a surface of a developing roller, and measurement is performed using two terminals of the electrode and the substrate; and
(2) a method in which a developing roller is pressed against a metal drum with a constant load, and measurement is performed with two terminals of the metal drum and the substrate.

Although the impedance can be measured by any method, the method (2) is affected by a nip width and a contact area between the developing roller and the metal drum, and thus, it is necessary to measure the impedance by the developing roller having the same hardness. Therefore, in the present disclosure, measurement is performed by the method (1). Hereinafter, the measurement method (1) will be described, and more specific conditions will be described below.

In the measurement of the impedance, in order to eliminate the influence of the contact resistance between the developing roller and the measurement electrode, it is preferable to deposit a low-resistance thin film on the surface of the developing roller, use the thin film as an electrode, and measure the impedance with two terminals using a conductive substrate as a ground electrode.

Examples of a method for forming the thin film include methods for forming a metal film such as metal vapor deposition, sputtering, application of a metal paste, and attachment of a metal tape. Among them, from the viewpoint of reducing the contact resistance with the developing roller, a method for forming a metal thin film such as platinum or palladium as an electrode by vapor deposition is preferable. In the present disclosure, vacuum platinum vapor deposition is employed.

When the metal thin film is formed on the surface of the developing roller, it is preferable to use a vacuum vapor deposition apparatus in which a mechanism capable of holding the developing roller is provided to the vacuum vapor deposition apparatus and a rotation mechanism is further provided to the developing roller having a cylindrical cross section in consideration of simplicity and uniformity of the thin film.

It is preferable that a metal thin film electrode having a width of about 10 mm in a longitudinal direction of the developing roller is formed, and a metal sheet wound around the metal thin film electrode in a direction intersecting the longitudinal direction without a gap is connected to the measurement electrode extending from the measuring apparatus to perform measurement. In the case of a cylindrical developing roller, it is preferable to use a metal sheet wound without a gap in a circumferential direction of the developing roller. As a result, the impedance measurement can be performed without being affected by the fluctuation of the size of the outer edge (the outer diameter in the cylindrical developing roller) in the cross section orthogonal to the longitudinal direction of the developing roller or the surface shape. As the metal sheet, an aluminum foil, a metal tape, or the like can be used.

### (Impedance Measurement Conditions)

The impedance measuring apparatus may be any device capable of measuring impedance in a frequency range of 1.0×10⁻¹ to 1.0×10⁵ Hz, such as an impedance analyzer, a network analyzer, or a spectrum analyzer. Among them, it is preferable to use an impedance analyzer for measurement from the viewpoint of the electrical resistance region of the developing roller.

The impedance measurement conditions will be described. The impedance in the frequency range of 1.0×10⁻¹ to 1.0×10⁵ Hz is measured using an impedance measuring apparatus. As the measurement environment, the temperature is 23° C. and the relative humidity is 50%. In consideration of measurement variations, it is preferable to measure at least a total of nine points including three longitudinal points and three rotational directions of the developing roller. The voltage application condition is obtained by superimposing an AC voltage of 50 V on a DC voltage of 50 V.

### <Surface Potential>

In an environment of a temperature of 23° C. and a relative humidity of 50%, a corona discharger having a grid portion with a width of 3.0 mm is disposed so that a distance between the grid portion and the outer surface of the developing roller is 1.0 mm, the direction of the width of the grid portion coincides with the axial direction of the developing roller, a voltage of 8 kV is applied to the grid portion, the corona discharger is relatively moved along the axial direction of the developing roller at a speed of 400 mm/sec to charge the outer surface of the developing roller, and the potential of the outer surface 0.06 seconds after the outer surface passes through the grid portion is measured to evaluate the easiness of excessive charging (charge-up) of the surface of the developing roller.

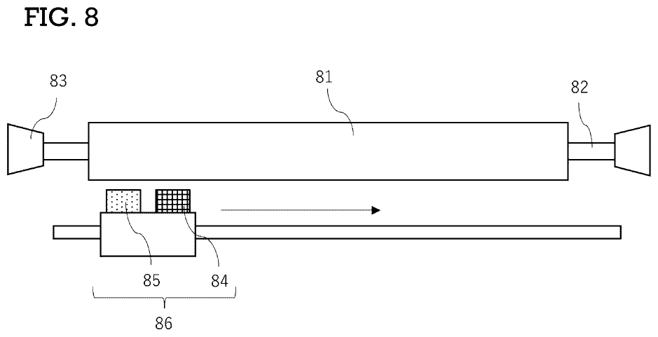

The surface potential of the developing roller can be measured by, for example, the device illustrated in FIG. 8. Both ends of a substrate 82 of a developing roller 81 are held by a chuck 83, and a measurement unit 86 in which a corona discharger 84 and a surface potential meter 85 are arranged in parallel with a 25 mm spacing is disposed to face a surface of the developing roller 81 at a distance of 1.0 mm. In a state where the developing roller 81 is stationary, a voltage of 8 kV is applied to a grid portion of the corona discharger 84, the measurement unit 86 is moved in an axial direction of the developing roller 81 at a speed of 400 mm/sec, and a surface potential is measured using the surface potential meter 85 at 0.06 seconds after passing the corona discharger 84.

The measurement conditions and the meanings of the measured values have been described in <Technical significance of requirement (2)> described above, and thus are omitted in this section.

### <Surface Shape of Developing Roller>

The method for measuring the surface shape of the developing roller is not particularly limited as long as the surface roughness can be measured. As will be described below, since the surface of the developing roller contains coarse particles, a measurement method having a resolution capable of measuring the surface shape formed by the coarse particles can be used.

To satisfy this condition, a confocal laser microscope capable of optically measuring the shape in a non-contact manner can be used to measure the surface shape of the developing roller. The axis of the substrate of the developing roller is disposed so as to be substantially orthogonal to the center line of an objective lens of a microscope, such that the surface shape in the vicinity of the apex of the outer peripheral surface of the developing roller can be measured. The maximum height roughness Rz of the roughness profile can be calculated by analyzing the obtained surface shape.

Hereinafter, the present disclosure will be described in more detail, but these descriptions are not intended to limit the present disclosure at all.

### [1. Preparation and Production of Raw Materials for Forming Resin Layer]

### <1-1. Preparation and Production Example of Raw Material Polyol>

Hereinafter, a synthesis example for obtaining a polyurethane resin layer will be described.

### [Measurement of Number Average Molecular Weight of Raw Material Polyol]

The apparatus and conditions used for measuring a number average molecular weight (Mn) in the present production example are as follows.
Measuring apparatus: HLC-8120GPC (Tosoh Corporation)
Column: TSKgel Super HZMM (Tosoh Corporation)×2 columns
Solvent: tetrahydrofuran (THF) (20 mmol/l triethylamine is added)
Temperature: 40° C.
Flow rate of THF: 0.6 ml/min

Note that the measurement sample was prepared as a 0.1 mass % solution in THF. Further, measurement was performed using a refractive index (RI) detector as a detector.

As a standard sample for preparing a calibration curve, a calibration curve was prepared using TSK standard polystyrene A-1000, A-2500, A-5000, F-1, F-2, F-4, F-10, F-20, F-40, F-80, and F-128 manufactured by Tosoh Corporation. Based on the calibration curve, the number average molecular weight was determined from the retention time of the obtained measurement sample.

### [Preparation of Raw Material Polyol]

Commercially available products A-1 to A-16, which are 16 types of raw material polyols shown in Table 1, were purchased. In addition, raw material polyols A-17 and A-18 were synthesized.

TABLE 1

| No. | Raw material polyol |
|---|---|
| A-1 | DURANOL T5652 Mn = 2000 (Asahi Kasei Chemicals Corporation) |
| A-2 | DURANOL G4672 Mn = 2000 (Asahi Kasei Chemicals Corporation) |
| A-3 | DURANOL G3452 Mn = 2000 (Asahi Kasei Chemicals Corporation) |
| A-4 | DURANOL G4692 Mn = 2000 (Asahi Kasei Chemicals Corporation) |
| A-5 | KURARAY POLYOL C2050 Mn = 2000 (Kuraray Co., Ltd.) |
| A-6 | KURARAY POLYOL C2090 Mn = 2000 (Kuraray Co., Ltd.) |
| A-7 | KURARAY POLYOL C3090 Mn = 3000 (Kuraray Co., Ltd.) |
| A-8 | KURARAY POLYOL C2015N Mn = 2000 (Kuraray Co., Ltd.) |
| A-9 | KURARAY POLYOL C2060N Mn = 2000 (Kuraray Co., Ltd.) |
| A-10 | NIPPOLLAN 982 Mn = 2000 (Tosoh Corporation) |
| A-11 | ETERNACOLL UH-200 Mn = 2000 (UBE Corporation) |
| A-12 | ETERNACOLL UH-300 Mn = 3000 (UBE Corporation) |
| A-13 | ETERNACOLL UC-100 Mn = 2000 (UBE Corporation) |
| A-14 | ETERNACOLL UM-90(1:1) Mn = 900 (UBE Corporation) |
| A-15 | ETERNACOLL UM-90(1:3) Mn = 900 (UBE Corporation) |
| A-16 | Oxymer M112 Mn = 1000 (Perstorp Japan Co., Ltd.) |

### [Synthesis of Raw Material Polyol A-17]

In a nitrogen atmosphere, 100.0 g of 1,3-propanediol, 49.4 g of adipic acid, and 69.5 g of ethylene carbonate were mixed and heated, and ethylene glycol and water generated from the reaction system were distilled off while the temperature was raised to 200° C. After ethylene glycol and water were distilled off, 15 ppm of titanium tetraisopropoxide was added, and a polycondensation reaction was further carried out under a reduced pressure of 266.7 Pa. The reaction solution was cooled to room temperature to obtain raw material polyol A-17. The number average molecular weight of the obtained raw material polyol A-17 was 2,030.

### [Synthesis of Raw Material Polyol A-18]

Raw material polyol A-18 was prepared in the same manner as in the case of the raw material polyol A-17, except that starting materials shown in Table 2 were used. The number average molecular weight of the raw material polyol A-18 was 2,040.

TABLE 2

| | | | | | Number |
|---|---|---|---|---|---|
| Raw | | Dicarboxylic | Ethylene | Ester group/ | average |
| material | Diol | acid | carbonate | carbonate group | molecular |
| polyol No. | (parts by mass) | (parts by mass) | parts by mass | (molar ratio) | weight |
| A-17 | 1,3-Propancdiol | Adipic acid | 69.5 | 3/7 | 2030 |
| | (100.0) | (49.4) | | | |
| A-18 | 1,6-Hexanediol | Sebacic acid | 19.2 | 7/3 | 2040 |
| | (100.0) | (102.8) | | | |

### <1-2. Preparation of Raw Material Isocyanates B-1 to B-6>

Raw material isocyanates shown in Table 3 were prepared.

TABLE 3

| No. | Raw material isocyanate |
|---|---|
| B-1 | Diphenylmethane diisocyanate (MDI) |
| | (trade name: MILLIONATE MT, Tosoh Corporation) |
| B-2 | Polymethylene polyphenyl polyisocyanate (Polymeric MDI) |
| | (trade name: MILLIONATE MR200, Tosoh Corporation) |
| B-3 | Tolylene diisocyanate (TDI) |
| | (trade name: CORONATE T-80, Tosoh Corporation) |
| B-4 | Tolylene diisocyanate (TDI), adduct of trimethylolpropane |
| | (trade name: CORONATE L, Tosoh Corporation) |
| B-5 | Hexamethylene diisocyanate |
| | (trade name: DURANATE 50M-HDI, Asahi Kasei Chemicals |
| | Corporation) |
| B-6 | Isocyanurate trimer of hexamethylene diisocyanate |
| | (trade name: DURANATE TPA-100, Asahi Kasei Chemicals |
| | Corporation) |

### <1-3. Production Example of Hydroxyl-Terminated Urethane Prepolymers C-1 to C-14>

### [Synthesis of Hydroxyl-Terminated Urethane Prepolymer C-1]

In a nitrogen atmosphere, materials shown in Table 4 were reacted by heating and stirring at a temperature of 90° C. for 3 hours. Thereafter, 2-butanone (MEK) was added to the obtained reaction product to prepare a hydroxyl-terminated urethane prepolymer C-1 as a solution having a solid content of 50 parts by mass.

TABLE 4

| | Parts |
|---|---|
| Material | by mass |
| Raw material polyol A-1 | 100 |
| (trade name: DURANOL T5652, Asahi Kasei | |
| Chemicals Corporation) | |
| Raw material isocyanate B-1 | 6.3 |
| (trade name: MILLIONATE MT, Tosoh Corporation) | |

### [Synthesis of Hydroxyl-Terminated Urethane Prepolymers C-2 to C-14]

Hydroxyl-terminated urethane prepolymers C-2 to C-14 were prepared in the same manner as in the case of synthesizing the hydroxyl-terminated urethane prepolymer C-1 using starting materials shown in Table 5.

The chemical structures of these hydroxyl-terminated urethane prepolymers C-1 to C-14 were specified using ¹H-NMR and ¹³C-NMR. Note that, in Table 5, m, n, o, p, q, r, and s in Structural Formulas (1), (2), (3), and (4) are the average numbers of added moles.

TABLE 5

| | Raw | | Raw | | | | | |
|---|---|---|---|---|---|---|---|---|
| Hydroxyl- | material | | material | | | | | |
| terminated | polyol | | isocyanate | | | | | |
| urethane | | Parts | | Parts | | | | |
| prepolymer | | by | | by | | | | |
| No. | No. | mass | No. | mass | Structure contained in molecule | | | |
| C-1 | A-1 | 100 | B-1 | 6.3 | (1) | R11 = (CH₂)₅ | R12 = (CH₂)₆ | m, n = 6.9 |
| C-2 | A-2 | 100 | B-1 | 5.7 | (1) | R11 = (CH₂)₄ | R12 = (CH₂)₆ | m = 10.7, n = 4.6 |
| C-3 | A-3 | 100 | B-1 | 6.3 | (1) | R11 = (CH₂)₃ | R12 = (CH₂)₄ | m, n = 8.8 |
| C-4 | A-4 | 100 | B-1 | 6.3 | (1) | R11 = (CH₂)₄ | R12 = (CH₂)₆ | m = 14.5, n = 1.6 |
| C-5 | A-5 | 100 | B-1 | 6.3 | (1) | R11 = (CH₂)₆ | R12 = (CH₂)₂—CHMe—(CH₂)₂ | m, n = 6.5 |
| C-6 | A-6 | 100 | B-1 | 6.3 | (1) | R11 = (CH₂)₆ | R12 = (CH₂)₂—CHMe—(CH₂)₂ | m = 1.3, n = 11.8 |
| C-7 | A-7 | 100 | B-1 | 4.2 | (1) | R11 = (CH₂)₆ | R12 = (CH₂)₂—CHMe—(CH₂)₂ | m = 2.0, n = 18.0 |
| C-8 | A-8 | 100 | B-1 | 6.3 | (1) | R11 = (CH₂)₉ | R12 = CH₂—CHMe—(CH₂)₅ | m = 6.5, n = 3.5 |
| C-9 | A-9 | 100 | B-1 | 6.3 | (1) | R11 = (CH₂)₉ | R12 = CH₂—CHMe—(CH₂)₅ | m = 3.5, n = 6.5 |
| C-10 | A-10 | 100 | B-5 | 4.3 | (2) | o = 9.1, p = 5.5 | | |
| C-11 | A-17 | 100 | B-1 | 6.3 | (3) | R31 = (CH₂)₃ | R32 = (CH₂)₄ | q = 12, r = 5.1 |
| C-12 | A-18 | 100 | B-1 | 6.3 | (3) | R31 = (CH₂)₆ | R32 = (CH₂)₈ | q = 2.7, r = 6.3 |
| C-13 | A-11 | 100 | B-1 | 6.3 | (4) | R41 = (CH₂)₅ | | s = 13.2 |
| C-14 | A-1 | 100 | B-3 | 4.8 | (1) | R11 = (CH₂)₅ | R12 = (CH₂)₆ | m, n = 6.9 |

Here, (1) to (4) means “Structural Formula (1)” to “Structural Formula (4)”.

Regarding the hydroxyl-terminated urethane prepolymers C-1 to C-9 and C-14 in which the structure represented by Structural Formula (1) was contained in the molecule, R13 in Structural Formula (1) was the same as R12.

In the table, notations such as m, n=6.9 or “x, y=A” indicate that the average number of added moles for each of x and y is A. The same applies to the following table.

### <1-4. Production Example of Isocyanate-Terminated Prepolymers D-1 to D-9>

### [Synthesis of Isocyanate-Terminated Prepolymer D-1]

In a nitrogen atmosphere, materials shown in Table 6 were reacted by heating and stirring at a temperature of 90° C. for 3 hours. Thereafter, 2-butanone (MEK) was added to the obtained reaction product to form a solution having a solid content of 50 parts by mass, thereby producing an isocyanate-terminated prepolymer D-1.

TABLE 6

| | Parts |
|---|---|
| Material | by mass |
| Raw material polyol A-10 | 100 |
| (trade name: NIPPOLLAN 982, Tosoh Corporation) | |
| Raw material isocyanate B-2 | 33.5 |
| (trade name: MILLIONATE MR200, Tosoh Corporation) | |

### [Synthesis of Isocyanate-Terminated Prepolymers D-2 to D-9]

Isocyanate-terminated prepolymers D-2 to D-9 were prepared in the same manner as in the case of synthesis of the isocyanate-terminated prepolymer D-1 using the types and amounts of starting materials shown in Table 7.

The chemical structures of these isocyanate-terminated prepolymers D-1 to D-9 were identified using ¹H-NMR and ¹³C-NMR. Note that, in Table 7, m, n, o, p, q, r, and s in Structural Formulas (1), (2), (3), and (4) are the average numbers of added moles.

TABLE 7

| | Raw | | Raw | | | | | |
|---|---|---|---|---|---|---|---|---|
| | material | | material | | | | | |
| Isocyanate- | polyol | | isocyanate | | | | | |
| terminated | | Parts | | Parts | | | | |
| prepolymer | | by | | by | | | | |
| No. | No. | mass | No. | mass | Structure contained in molecule | | | |
| D-1 | A-10 | 100 | B-2 | 33.5 | (2) | o = 9.1, p = 5.5 | | |
| D-2 | A-14 | 100 | B-6 | 78.4 | (1) | R11═(CH₂)₆ | $R 12 = {CH}_{2} - CH 〈 \begin{matrix}{( {CH}_{2} )}_{2} \\ {( {CH}_{2} )}_{2}\end{matrix} 〉 CH - {CH}_{2}$ | m, n = 2.7 |
| D-3 | A-15 | 100 | B-6 | 78.4 | (1) | R11═(CH₂)₆ | $R 12 = {CH}_{2} - CH 〈 \begin{matrix}{( {CH}_{2} )}_{2} \\ {( {CH}_{2} )}_{2}\end{matrix} 〉 CH - {CH}_{2}$ | m = 4.1, n = 1.4 |

| D-4 | A-13 | 100 | B-6 | 70.3 | (4) | $R 41 = {CH}_{2} - CH 〈 \begin{matrix}{( {CH}_{2} )}_{2} \\ {( {CH}_{2} )}_{2}\end{matrix} 〉 CH - {CH}_{2}$ | | s = 5.8 |
|---|---|---|---|---|---|---|---|---|
| D-5 | A-11 | 100 | B-2 | 33.5 | (4) | R41═(CH₂)₅ | | s = 13.2 |
| D-6 | A-12 | 100 | B-2 | 28.2 | (4) | R41═(CH₂)₆ | | s = 20.1 |
| D-7 | A-16 | 100 | B-6 | 70.3 | (4) | R41═CH₂—CEtBu—CH₂ | | s = 4.6 |
| D-8 | A-10 | 100 | B-4 | 102.2 | (2) | o = 9.1, p = 5.5 | | |
| D-9 | A-1 | 100 | B-2 | 33.5 | (1) | R11═(CH₂)₆ | R12═(CH₂)₅ | m:n = 1:1 |

Here, (1), (2), (4) means “Structural Formula (1)”, “Structural Formula (2)”, “Structural Formula (4)”

In the isocyanate-terminated prepolymers D-2 and D-3 in which the structure represented by Structural Formula (1) was contained in the molecule, R13 in Structural Formula (1) was the same as at least one selected from the group consisting of R11 and R12. In addition, in the isocyanate-terminated prepolymer D-9 in which the structure represented by Structural Formula (1) was contained in the molecule, R13 in Structural Formula (1) was the same as R12.

### [2. Preparation and Production of Additive Raw Materials for Resin Layer]

<2-1. Preparation and Production Example of Polyoxyethylene polyoxypropylene alkyl ethers E-1 to E-17>

### [Preparation of Polyoxyethylene Polyoxypropylene Alkyl Ether]

Additives E-1 to E-5 which are polyoxyethylene polyoxypropylene alkyl ethers shown in Table 8 were commercially available products. In addition, polyoxyethylene polyoxypropylene alkyl ethers E-6 and E-7 were synthesized.

### [Synthesis of Polyoxyethylene Polyoxypropylene Alkyl Ether E-6]

169.3 g of 1-octanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

The obtained ethylene oxide adduct was cooled to 130° C., and then 1,132.6 g of propylene oxide (15 mol relative to alcohol) was charged. After completion of the charging, the reaction was carried out at 130° C. for 5 hours to obtain a polyoxyethylene polyoxypropylene octyl ether adduct, which is a block polymer having an average number of added moles of 15 mol of ethylene oxide and 15 mol of propylene oxide.

The obtained polyoxyethylene polyoxypropylene octyl ether adduct was cooled to 80° C., and unreacted ethylene oxide and propylene oxide were removed at 2.5 kPa for 30 minutes. Next, 6.0 g of 90% lactic acid was charged into the autoclave, stirred at 80° C. for 30 minutes, and then extracted to obtain polyoxyethylene polyoxypropylene octyl ether E-6. The structure of R51 and the values of t and u in E-6 are shown in Table 8.

### [Synthesis of Polyoxyethylene Polyoxypropylene Alkyl Ether E-7]

550.0 g of polyoxyethylene methyl ether (trade name: Blaunon MP-550, manufactured by AOKI OIL INDUSTRIAL Co., Ltd., the average number of added moles of 12 mol of ethylene oxide relative to alcohol) and 3.0 g of potassium hydroxide were charged into an autoclave equipped with a stirrer, a temperature controller, and an automatic feed device, and subjected to dehydration at 110° C. and 1.2 kPa for 30 minutes. After completion of the dehydration, nitrogen purging was performed, the temperature was raised to 130° C., and then 871.2 g (12 mol relative to alcohol) of propylene oxide was charged. After completion of the charging, the reaction was carried out at 130° C. for 4 hours to obtain a polyoxyethylene polyoxypropylene methyl ether adduct, which is a block polymer having an average number of added moles of 12 mol of ethylene oxide and 12 mol of propylene oxide.

The obtained polyoxyethylene polyoxypropylene methyl ether adduct was cooled to 80° C., and unreacted propylene oxide was removed at 2.5 kPa for 30 minutes. Next, 6.0 g of 90% lactic acid was charged into the autoclave, stirred at 80° C. for 30 minutes, and then extracted to obtain polyoxyethylene polyoxypropylene methyl ether E-7. The structure of R51 and the values of t and u in E-7 are shown in Table 8.

TABLE 8

| No. | Material | Structure | | |
|---|---|---|---|---|
| E-1 | Polyoxyethylene polyoxypropylene butyl ether | (5) | R51 = C₄H₉ | t, u = 17 |
| | (trade name: UNILUBE 50MB-26, NOF corporation) | | | |
| E-2 | Polyoxyethylene polyoxypropylene butyl ether | (5) | R51 = C₄H₉ | t, u = 30 |
| | (trade name: UNILUBE 50MB-72, NOF corporation) | | | |
| E-3 | Polyoxyethylene polyoxypropylene butyl ether | (5) | R51 = C₄H₉ | t = 9, u = 10 |
| | (trade name: UNILUBE 50MB-11, NOF corporation) | | | |
| E-4 | Polyoxyethylene polyoxypropylene lauryl ether | (5) | R51 = C₁₂H₂₅ | t, u = 5 |
| | (trade name: NONION A-13PR, NOF corporation) | | | |
| E-5 | Polyoxyethylene polyoxypropylene lauryl ether | (5) | R51 = C₁₂H₂₅ | t, u = 25 |
| | (trade name: NONION A-25B, NOF corporation) | | | |
| E-6 | Polyoxyethylene polyoxypropylene octyl ether | (5) | R51 = C₈H₁₇ | t, u = 15 |
| E-7 | Polyoxyethylene polyoxypropylene methyl ether | (5) | R51 = CH₃ | t, u = 12 |

Here, (5) means Structural Formula (5).

### <2-2. Preparation and Production Example of Polyether Amine>

### [Preparation of Polyether Amine]

Commercially available products of E-8 and E-9, which are polyether amines as additives, shown in Table 9 were purchased. In addition, a polyether amine E-10 was synthesized.

### [Synthesis of Polyether Amine E-10]

A stirrer was attached to a three-neck flask, and 1,658 g of polyoxyethylene polyoxypropylene octyl ether and 460 ml of acetic acid were charged. 600 ml of a 2 mol/l aqueous sodium hypochlorite solution was added dropwise thereto over 1 hour. A reaction vessel was cooled in an ice bath so that the temperature was maintained in the range of 15 to 25° C. After completion of the dropwise addition, stirring was continued for 1 hour. Dichloromethane was added to the obtained solution, and the aqueous layer was extracted and post-treated and purified by a column to obtain a compound in which a secondary alcohol was converted into a ketone.

The mixture was cooled to 0° C. in an ice bath, 250 ml of a methanol-acetic acid mixed solution (volume ratio of 10:1) was added to 41.4 g of a compound in which the obtained secondary alcohol was converted into a ketone, and 2.7 g of 2-picoline-borane was added. The ice bath was removed, and the mixture was stirred overnight at room temperature in an open system. After concentration, the mixture was cooled to 0° C., 360 ml of a 35% aqueous hydrochloric acid solution was added, and the mixture was stirred at room temperature for 2 hours. An aqueous sodium hydroxide solution was added to make the mixture basic, and the aqueous layer was extracted with dichloromethane and post-treated and purified by a column to obtain a polyether amine E-10. The structure of R61 in E-10 and the values of v and ware shown in Table 9.

TABLE 9

| No. | Material | Structure | | |
|---|---|---|---|---|
| E-8 | Polyether amine | (6) | R61 = CH₃ | v = 6, |
| | (trade name: JEFFAMINE | | | w = 29 |
| | M-2005, Huntsman Corporation) | | | |
| E-9 | Polyether amine | (6) | R61 = CH₃ | v = 1, |
| | (trade name: JEFFAMINE | | | w = 9 |
| | M-600, Huntsman Corporation) | | | |
| E-10 | Polyether amine | (6) | R61 = C₈H₁₇ | v, w = 15 |

### <2-3. Preparation and Production Example of Polyoxyethylene Alkyl Ether Acetate>

### [Preparation of Polyoxyethylene Alkyl Ether Acetate]

Polyoxyethylene alkyl ether acetate E-11, which is used as an additive and is shown in Table 10, was purchased as a commercially available product. In addition, polyoxyethylene alkyl ether acetates E-12 and E-13 were synthesized.

### [Synthesis of Polyoxyethylene Alkyl Ether Acetate E-12]

55.0 g of polyoxyethylene methyl ether (trade name: Blaunon MP-550, manufactured by AOKI OIL INDUSTRIAL Co., Ltd., the average number of added moles of 12 mol relative to alcohol) and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-12. The structure of R71 in E-12 and the value of x are shown in Table 10.

### [Synthesis of Polyoxyethylene Alkyl Ether Acetate E-13]

169.3 g of 1-octanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

77.4 g of the obtained ethylene oxide adduct and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-13. The structure of R71 in E-13 and the value of x are shown in Table 10.

TABLE 10

| No | Material | Structure | | |
|---|---|---|---|---|
| E-11 | Polyoxyethylene lauryl ether acetate | (7) | R71 = C₁₂H₂₅ | x = 5 |
| | (trade name: TAIPOL SOFT ECA-490, | | | |
| | TAIKO OIL CHEM. Co., Ltd.) | | | |
| E-12 | Polyoxyethylene methyl ether acetate | (7) | R71 = CH₃ | x = 11 |
| E-13 | Polyoxyethylene octyl ether acetate | (7) | R71 = C₃H₁₇ | x = 14 |

Here, (7) means Structural Formula (7).

### [3. Production Example of Coating Liquids F-1 to F-44 for Forming Resin Layer]

### <3-1. Preparation of Coating Liquid F-1 for Forming Resin Layer>

The types and amounts of materials shown in Table 11 were added to a reaction vessel as materials for a coating liquid F-1 for forming a resin layer and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-1 for forming a resin layer.

TABLE 11

| | Parts |
|---|---|
| Material | by mass |
| Hydroxyl-terminated urethane prepolymer C-1 | 100 |
| Isocyanate-terminated urethane prepolymer D-5 | 54.7 |
| Additive E-1 | 7 |
| Carbon black | 35 |
| (trade name: MA8, Mitsubishi Chemical Corporation) | |
| Coarse particles | 23 |
| (trade name: ART PEARL C-400T, Negami Chemical | |
| Industrial Co., Ltd.) | |

### <3-2. Preparation of Coating Liquids F-2 to F-44 for Forming Resin Layer>

Coating liquids F-2 to F-44 for forming a resin layer were prepared by the following method. First, the hydroxyl-terminated urethane prepolymer, isocyanate-terminated prepolymer, additive, carbon black, and coarse particles described in Table 12 were mixed in the same manner as in the case of preparing the coating liquid F-1 for forming a resin layer. Thereafter, 2-butanone (MEK) was added to adjust the viscosity of the liquid to a range of 6 to 10 mPa·s, thereby producing coating liquids F-2 to F-44 for forming a resin layer.

### <3-3. Preparation of Coating Liquids F-54, F-56, and F-60 for Forming Resin Layer>

Coating liquids F-54, F-56, and F-60 for forming a resin layer were prepared in the same manner as in the coating liquid F-1 for forming a resin layer, except that the coarse particles were changed as shown in Table 12 in the production example of the coating liquid F-1 for forming a resin layer.

TABLE 12

| Coating | | |
|---|---|---|
| liquid for | | |
| forming | | Parts |
| resin layer No. | Coarse particles | by mass |
| F-1 | Coarse particles H-1 | 23 |
| | (trade name: ART PEARL C-400T, | |
| | Negami Chemical Industrial Co., Ltd.) | |
| F-54 | Coarse particles H-2 | 30 |
| | (trade name: ART PEARL C-300T, | |
| | Negami Chemical Industrial Co., Ltd.) | |
| F-56 | Coarse particles H-3 | 20 |
| | (trade name: ART PEARL C-200T, | |
| | Negami Chemical Industrial Co., Ltd.) | |
| F-60 | Coarse particles H-4 | 43 |
| | (trade name: ART PEARL C-600T, | |
| | Negami Chemical Industrial Co., Ltd.) | |

Here, “PBM” means “Parts by mass”.

TABLE 13-1

| | Hydroxyl- | | Isocyanate- | | | | | | |
|---|---|---|---|---|---|---|---|---|---|
| | terminated | | terminated | | | | | | |
| | urethane | | urethane | | | | Carbon | Coarse | |
| | prepolymer | | prepolymer | | Additive | | black | particles | |
| | No. | PBM | No. | PBM | No. | PBM | PBM | No. | PBM |
| F-1 | C-1 | 100 | D-5 | 54.7 | E-1 | 7 | 35 | H-1 | 23 |
| F-2 | C-3 | 100 | D-5 | 54.7 | E-1 | 7 | 35 | H-1 | 23 |
| F-3 | C-5 | 100 | D-5 | 54.7 | E-1 | 7 | 35 | H-1 | 23 |
| F-4 | C-7 | 100 | D-5 | 37.2 | E-1 | 6.4 | 32 | H-1 | 21 |
| F-5 | C-13 | 100 | D-3 | 54.7 | E-1 | 7 | 35 | H-1 | 23 |
| F-6 | C-1 | 100 | D-6 | 54.7 | E-1 | 7 | 35 | H-1 | 23 |
| F-7 | C-7 | 100 | D-4 | 37.2 | E-1 | 6.4 | 32 | H-1 | 21 |
| F-8 | C-9 | 100 | D-7 | 54.7 | E-1 | 7 | 35 | H-1 | 23 |
| F-9 | C-1 | 100 | D-1 | 54.7 | E-1 | 7 | 35 | H-1 | 23 |
| F-10 | C-2 | 100 | D-1 | 54.7 | E-1 | 7 | 35 | H-1 | 23 |
| F-11 | C-3 | 100 | D-1 | 54.7 | E-1 | 7 | 35 | H-1 | 23 |
| F-12 | C-4 | 100 | D-1 | 54.7 | E-1 | 7 | 35 | H-1 | 23 |
| F-13 | C-5 | 100 | D-1 | 54.7 | E-1 | 7 | 35 | H-1 | 23 |
| F-14 | C-6 | 100 | D-1 | 54.7 | E-1 | 7 | 35 | H-1 | 23 |
| F-15 | C-7 | 100 | D-1 | 37.2 | E-1 | 6.4 | 32 | H-1 | 21 |
| F-16 | C-8 | 100 | D-1 | 54.7 | E-1 | 7 | 35 | H-1 | 23 |
| F-17 | C-9 | 100 | D-1 | 54.7 | E-1 | 7 | 35 | H-1 | 23 |
| F-18 | C-10 | 100 | D-2 | 54.7 | E-1 | 7 | 35 | H-1 | 23 |
| F-19 | C-10 | 100 | D-3 | 54.7 | E-1 | 7 | 35 | H-1 | 23 |
| F-20 | C-11 | 100 | D-5 | 54.7 | E-1 | 7 | 35 | H-1 | 23 |
| F-21 | C-12 | 100 | D-5 | 54.7 | E-1 | 7 | 35 | H-1 | 23 |
| F-22 | C-13 | 100 | D-1 | 54.7 | E-1 | 7 | 35 | H-1 | 23 |
| F-23 | C-10 | 100 | D-4 | 54.7 | E-1 | 7 | 35 | H-1 | 23 |
| F-24 | C-10 | 100 | D-7 | 54.7 | E-1 | 7 | 35 | H-1 | 23 |

Here, “PBM” means “Parts by mass”.

TABLE 13-2

| | Hydroxyl- | | Isocyanate- | | | | | | |
|---|---|---|---|---|---|---|---|---|---|
| | terminated | | terminated | | | | | | |
| | urethane | | urethane | | | | Carbon | Coarse | |
| | prepolymer | | prepolymer | | Additive | | black | particles | |
| | No. | PBM | No. | PBM | No. | PBM | PBM | No. | PBM |
| F-25 | C-1 | 50 | D-5 | 54.7 | E-1 | 7 | 35 | H-1 | 23 |
| | C-10 | 50 | | | | | | | |
| F-26 | C-14 | 100 | D-1 | 54.7 | E-1 | 7 | 35 | H-1 | 23 |
| F-27 | C-1 | 100 | D-5 | 54.7 | E-1 | 6.6 | 35 | H-1 | 23 |
| F-28 | C-1 | 100 | D-5 | 54.7 | E-1 | 16.1 | 35 | H-1 | 23 |
| F-29 | C-1 | 100 | D-5 | 54.7 | E-2 | 7 | 35 | H-1 | 23 |
| F-30 | C-1 | 100 | D-5 | 54.7 | E-3 | 7 | 35 | H-1 | 23 |
| F-31 | C-1 | 100 | D-5 | 54.7 | E-4 | 7 | 35 | H-1 | 23 |
| F-32 | C-1 | 100 | D-5 | 54.7 | E-5 | 7 | 35 | H-1 | 23 |
| F-33 | C-1 | 100 | D-5 | 54.7 | E-6 | 7 | 35 | H-1 | 23 |
| F-34 | C-1 | 100 | D-5 | 54.7 | E-7 | 7 | 35 | H-1 | 23 |
| F-35 | C-1 | 100 | D-5 | 54.7 | E-8 | 7 | 35 | H-1 | 23 |
| F-36 | C-1 | 100 | D-5 | 54.7 | E-8 | 6.6 | 35 | H-1 | 23 |
| F-37 | C-1 | 100 | D-5 | 54.7 | E-8 | 16.1 | 35 | H-1 | 23 |
| F-38 | C-1 | 100 | D-5 | 54.7 | E-9 | 7 | 35 | H-1 | 23 |
| F-39 | C-1 | 100 | D-5 | 54.7 | E-10 | 7 | 35 | H-1 | 23 |
| F-40 | C-1 | 100 | D-5 | 54.7 | E-11 | 7 | 35 | H-1 | 23 |
| F-41 | C-1 | 100 | D-5 | 54.7 | E-11 | 6.6 | 35 | H-1 | 23 |
| F-42 | C-1 | 100 | D-5 | 54.7 | E-11 | 16.1 | 35 | H-1 | 23 |
| F-43 | C-1 | 100 | D-5 | 54.7 | E-12 | 7 | 35 | H-1 | 23 |
| F-44 | C-1 | 100 | D-5 | 54.7 | E-13 | 7 | 35 | H-1 | 23 |
| F-54 | C-1 | 100 | D-5 | 54.7 | E-1 | 7 | 35 | H-2 | 30 |
| F-56 | C-1 | 100 | D-5 | 54.7 | E-1 | 7 | 35 | H-3 | 20 |
| F-60 | C-1 | 100 | D-5 | 54.7 | E-1 | 7 | 35 | H-4 | 43 |

### <1. Production of Developing Roller>

In the present example, a developing roller in which an elastic roller provided with an elastic layer formed on an outer surface of a substrate is coated with a resin layer will be described, but the present disclosure is not limited to this configuration.

### [1-1. Preparation of Substrate]

As a substrate, a stainless steel (SUS304) core metal having a diameter of 6 mm was prepared by applying a primer (trade name: DY35-051, manufactured by Dow Toray Co., Ltd.) to a peripheral surface of the core metal and baking the primer.

### [1-2. Preparation of Elastic Layer]

The substrate was placed in a mold, and an addition-type silicone rubber composition obtained by mixing the materials shown in Tables 13-1 and 13-2 was injected into a cavity formed in the mold.

TABLE 14

| | Parts |
|---|---|
| Material | by mass |
| Liquid silicone rubber | 100 |
| (trade name: SE6724 A/B, Dow Toray Co., Ltd.) | |
| Carbon black | 16 |
| (trade name: TOKABLACK #4300, Tokai Carbon Co., Ltd.) | |
| Curing control agent | 0.01 |
| (trade name: 1-Ethenyl-1-cyclohexanol, Tokyo Chemical | |
| Industry Co., Ltd.) | |
| Platinum catalyst | 0.01 |
| (trade name: SIP6830.3, Gelest, Inc.) | |

Subsequently, the mold was heated to vulcanize and cure the silicone rubber at a temperature of 150° C. for 15 minutes, and the silicone rubber was demolded and then further heated at a temperature of 180° C. for 1 hour to complete the curing reaction, thereby obtaining an elastic roller in which an elastic layer having a diameter of 11.5 mm was provided on the outer periphery of the substrate.

### [1-3. Preparation of Resin Layer]

The elastic roller was held at its upper end with the longitudinal direction oriented vertically and was immersed (dipped) into the coating liquid F-1 for forming a resin layer, thereby coating the surface of the elastic roller with the coating liquid. The obtained coated product was air-dried at normal temperature for 30 minutes, and then dried in a hot air circulating dryer set at 160° C. for 1 hour. In this manner, a developing roller G-1 in which a resin layer having a thickness of 12 μm was formed on the elastic layer was obtained.

### <2. Measurement of Impedance>

The impedance was measured as follows. First, as a pretreatment, vacuum platinum vapor deposition was performed on the developing roller G-1 while rotating, thereby preparing a measurement electrode. For vapor deposition, a vacuum vapor deposition apparatus having a mechanism for holding and rotating a substrate portion of a roller as an object to be deposited in a circumferential direction was used, a roller rotational speed, a vapor deposition distance, and a vapor deposition time were controlled, and vapor deposition was performed so that a film thickness was 100 nm or more. At this time, an electrode having a width of 1.5 cm was produced using a masking tape. By forming the electrode with a film thickness of 100 nm or more, it is possible to minimize the effect of the surface roughness of the developing roller on the contact area between the measurement electrode and the developing roller.

Next, an aluminum sheet was wound around the electrode without any gap, and the aluminum sheet was connected to measurement electrodes of an impedance measuring apparatus (trade names: Solartron 1260 and Solartron 1296, Solartron) and a high-voltage system (trade names: 6792 and HVA-500, Toyo Corporation).

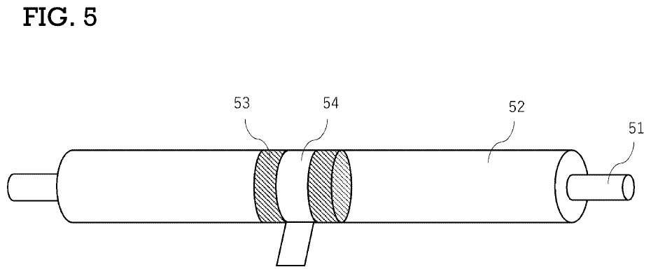

FIG. 5 is a schematic view of a state in which measurement electrodes are formed on the developing roller. In the drawing, reference numeral 51 denotes a conductive substrate, reference numeral 52 denotes a resin layer, reference numeral 53 denotes a platinum vapor-deposited layer, and reference numeral 54 denotes an aluminum sheet. Although the elastic layer is not illustrated in the drawing, the elastic layer is present between the substrate 51 and the resin layer 52.

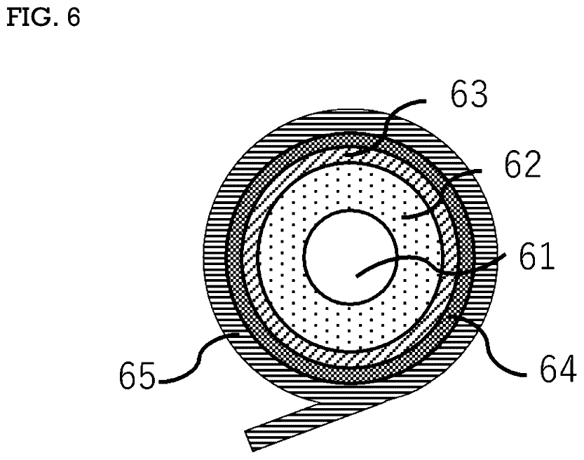

FIG. 6 is a cross-sectional view of a state in which measurement electrodes are formed on the developing roller. Reference numeral 61 denotes a conductive substrate, reference numeral 62 denotes an elastic layer, reference numeral 63 denotes a resin layer, reference numeral 64 denotes a platinum vapor-deposited layer, and reference numeral 65 denotes an aluminum sheet. Thus, it is important that the resin layer is sandwiched between the conductive substrate and the measurement electrode.

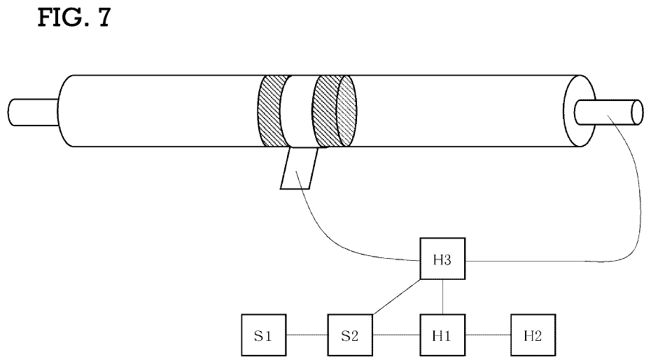

Then, the aluminum sheet was connected to measurement electrodes on a side of an impedance measuring apparatus (S1: Solartron 1260, manufactured by Solartron and S2: Solartron 1296, manufactured by Solartron) and a high-voltage system (H1: trade name: 6792, manufactured by TOYO Corporation, H2: trade name: HVA-500, manufactured by TOYO Corporation, and H3: reference box 6796, manufactured by Solartron). FIG. 7 is a schematic view of the measurement system. Impedance measurement was performed by using the conductive substrate and the aluminum sheet as two electrodes for measurement.

In the impedance measurement, a DC voltage of 50 V and an AC voltage of 50 V were applied in an environment of a temperature of 23° C. and a relative humidity of 50%, and an absolute value of the impedance was obtained at a frequency of 1.0×10⁻¹ to 1.0×10¹ Hz. Then, the minimum value of the impedance value at a frequency of 1.0×10⁰ to 1.0×10¹ Hz was confirmed. The impedance was measured at the center of the developing roller in the longitudinal direction.

### <3. Measurement of Surface Potential>

The surface potential of the developing roller was measured using a charge amount measuring apparatus (trade name: DRA-2000L, manufactured by QEA, Inc.). Specifically, in an environment of a temperature of 23° C. and a relative humidity of 50%, a grid portion of a corona discharger of the charge amount measuring apparatus was disposed so as to maintain a gap of 1.0 mm from the outer surface of the developing roller. The grid portion of the corona discharger of the apparatus has a width of 3.0 mm.

Next, a voltage of 8 kV was applied to the corona discharger, the corona discharger was relatively moved at a speed of 400 mm/sec along the axial direction of the developing roller to charge the surface of the conductive member, and a potential of the outer surface after 0.06 seconds from the passage of the grid portion was measured. The maximum value among all measurement values obtained at eight positions in the longitudinal direction at 450 intervals in the circumferential direction of the developing roller was adopted.

### <4. Measurement of Surface Shape>

The surface shape of the developing roller was measured using a confocal laser microscope (trade name: VK-X200, manufactured by Keyence Corporation). Specifically, the developing roller was disposed horizontally, and the position of the objective lens was adjusted so that the apex portion of the outer periphery of the developing roller having a substantially cylindrical shape was brought into focus. An objective lens with an NA of 0.95 and a magnification of 50× was used.

In the shape measurement mode “Expert Mode”, a laser was used as a light source at the time of measurement range adjustment, upper and lower limits of the measurement height range were set, and then the shape was measured by the following setting.
Light source: laser
Brightness adjustment: automatic
Measurement mode: surface shape
Measurement size: standard (1,024×768 pixels)
Measurement quality: high quality
Measurement pitch: 0.10 m
Real Peak Detection (RPD): enabled

After the measurement result including the shape information was saved in a file, the following operation was performed by the multi-file analysis application VK-X3000 Multi-File Analysis Software. A substantially cylindrical shape was converted into a planar unevenness shape by second-order surface correction using the surface shape correction in the image processing menu.

Next, in the multiple-line roughness measurement mode in the measurement menu,
a first measurement line was set near the center of a field of view,
a total of 21 measurement lines were set with 10 lines placed on each side of the central line at intervals of 45 lines,
the measurement line was set to be aligned in the circumferential direction,
the measurement type was set to roughness with terminal effect correction enabled and no cutoff applied, and
the mean value of the maximum height roughness Rz of the surface roughness was obtained from the total of 21 lines calculated by the application.

The shape measurement and analysis were performed on a total of nine points including three longitudinal points and three circumferential points of the developing roller, and the mean value of the measured values Rz was defined as Rz of the developing roller.

### <5. Calculation of Respective Physical Properties Such as Equivalent Circle Diameter and Wall-to-Wall Distance of Carbon Black Dispersed in Resin Layer>

The dispersion particle diameter and the wall-to-wall distance of carbon black dispersed in the resin layer were measured by the following methods.

First, a section (having a thickness of 0.5 to 1.0 mm) was cut out using a razor so that a cross section perpendicular to the longitudinal direction of the developing roller can be observed. When the adhesion between the substrate and the resin layer is strong and it is difficult to cut out the substrate with a razor blade, the entire substrate is cut out using a metal saw or the like, and then subjected to cross section processing with a focused ion beam (FIB) apparatus.

Next, the section is subjected to platinum vapor deposition, and an image of the resin layer is captured at 15,000× magnification using a scanning electron microscope (SEM) (trade name: JSM-7800F, manufactured by JEOL Ltd.) to obtain a cross-sectional image.

Furthermore, in order to quantify the cross-sectional image obtained by observation with the SEM, the cross-sectional image is converted to an 8-bit grayscale image using image processing software (trade name: Luzex AP, manufactured by Nireco Corporation) to obtain a 256-tone monochrome image. Next, black and white of the image are reversed so that the carbon black in the cross-sectional image becomes white, a threshold value for binarization is set on the luminance distribution of the image based on the Otsu's discriminant analysis algorithm, and then, a binarized image in which the carbon black becomes white and the binder resin portion becomes black is obtained.

Then, for the obtained binarized image, an equivalent circle diameter of the whitened carbon black portion and an adjacent wall-to-wall distance are calculated using image processing software (trade name: Luzex AP, manufactured by Nireco Corporation). The equivalent circle diameter and the adjacent wall-to-wall distance are calculated. In order to eliminate the uncertainty of the calculated value of the carbon black divided at the upper, lower, left, and right ends of the image, a region on the inner side of 0.075 μm in the actual image dimension (in cases where there are characters such as SEM measurement conditions, the region is set 0.075 μm inward from the start of the actual image) is set as the image region, and the equivalent circle diameter and the adjacent wall-to-wall distance for all the carbon blacks in the designated image region are calculated.

Then, the arithmetic mean value and the standard deviation are calculated for the distributions of the obtained equivalent circle diameters and the adjacent wall-to-wall distances. The number of images to be subjected to image analysis is not particularly limited even from one, but is set to at least three or more in order to eliminate the influence of a location difference in the longitudinal direction of the carbon black dispersed in the resin layer of the developing roller.

In addition, the number average diameter of primary particles of carbon black dispersed in the resin was measured with a transmission electron microscope (TEM). First, a thin-section sample was prepared. A known method can be used for preparing the thin section. For example, the sample can be thinned using an ion beam, a diamond knife, or the like. In the present disclosure, a 40 nm-thick thinned sample for observation was prepared using an ultramicrotome (trade name: ULTRACUT-S, manufactured by Leica Microsystems GmbH).

Then, using a transmission electron microscope (trade name: H-7100FA, manufactured by Hitachi High-Tech Corporation), a TEM image was acquired under measurement conditions of a TE mode and an acceleration voltage of 100 kV.

Then, using image analysis software (trade name: WinROOF, manufactured by MITANI CORPORATION), the equivalent circle diameters of 50 arbitrarily selected primary particles of carbon black in the TEM image were measured, and the number average value of the 50 primary particles was taken as the number average diameter of the primary particles.

### (Measurement of DBP Absorption of Carbon Black)

The DBP absorption of the carbon black was measured in accordance with Japanese Industrial Standard (JIS) K6217-4 using a carbon black powder.

### (Measurement of pH of Carbon Black)

The pH of the carbon black was measured in accordance with ASTM D1512 using a carbon black powder.

### 3. Image Evaluation

The developing roller G-1 was attached as the developing roller 31 of the process cartridge 20. The process cartridge was designated as P-1, and fogging evaluation and image stability evaluation were performed on the image forming apparatus.

### <3-1 Evaluation of Fogging>

In the fogging evaluation, the image forming apparatus was operated (printing operation) after being left to stand in an environment at a temperature of 30° C. and a relative humidity of 80% for 24 hours. In printing, horizontal lines were arranged at equal intervals in a conveyance direction so that a print coverage was 2%, and 5,000 sheets of A4 size paper were printed using a process cartridge in which 70 g of toner was filled in the developing container 32. Since the toner is consumed through the printing of 5,000 sheets, the amount of toner remaining in the container is small. A white image (so-called solid white image) without an image was output at each timing of an initial timing before printing of a horizontal line and a timing after printing of 5,000 sheets.

For the measurement of fogging, the reflectance (%) was measured using a reflection densitometer (Model TC-MOR-45, manufactured by Tokyo Denshoku Co., Ltd., green filter was used). In the fogging measurement, a sticky note or the like is affixed to a portion of the sheet to be printed, and a solid white image is output. The reflectance of the portion where the sticky note affixed to the output sheet was removed was set as the reference reflectance of the sheet itself, and fogging measurement was performed. Although the reflectance varies depending on the measurement portion, a difference between the measurement value at the portion having the minimum value and the measurement value at the portion to which the sticky note is affixed (reference reflectance) is measured as a fogging value. A smaller measured fogging value indicates a smaller amount of fogging, which is preferable.

Normally, toner is not transferred onto a transfer sheet on which a solid white image is formed. In a case where the charge amount of toner is insufficient or in a case where the toner is charged to a non-normal polarity, the toner moves onto the photosensitive member even at the time of forming a solid white image, and is further transferred onto a transfer sheet to increase the fogging value. The evaluation results of the initial stage and after printing are shown in Table 14-2.

Note that, in a high temperature and high humidity environment of a temperature of 30° C. and a relative humidity of 80%, since the amount of moisture in the environment tends to be large, the triboelectric charge of the toner tends to be small, and fogging tends to worsen. Therefore, the evaluation was performed in an environment of a temperature of 30° C. and a relative humidity of 80%.

### <3-2 Evaluation of Image Density Stability>

In the image density stability evaluation, the image forming apparatus was operated (printing operation) after being left to stand in an environment at a temperature of 23° C. and a relative humidity of 50% for 24 hours. As the printed image, one halftone image having a density of 25% was output, and subsequently, 48 solid white images and then one halftone image having the same density as that of the first image were continuously output in this order. The densities of the obtained halftone images of the first sheet and the 50th sheet were measured using a spectrodensitometer (eXact, manufactured by X-Rite, Inc.), and the density difference between the first sheet and the 50th sheet was obtained. Note that a smaller density difference indicates higher image density stability. The evaluation results are shown in Table 14-2.

### <3-3 Evaluation of Toner Shape Irregularity Ratio>

The evaluation of toner shape irregularity ratio was performed based on the aspect ratio of the toner. For the measurement of the aspect ratio, “FPIA-3000” (manufactured by Sysmex Corporation) which is a flow-type particle image analyzer was used. Measurement is performed under the measurement and analysis conditions during the calibration operation.

After adding an appropriate amount of alkylbenzene sulfonate, which is a surfactant, as a dispersant to 20 mL of ion-exchanged water, 0.02 g of a measurement sample was added, and dispersion treatment was performed for 2 minutes using a benchtop ultrasonic cleaner/disperser (trade name: VS-150, manufactured by VELVO-CLEAR) at an oscillation frequency of 50 kHz and an electric output of 150 W, thereby obtaining a dispersion for measurement. At this time, the dispersion is appropriately cooled so that the temperature of the dispersion is 10° C. to 40° C.

For the measurement, the flow-type particle image analyzer equipped with a standard objective lens (10×) is used, and a particle sheath “PSE-900A” (manufactured by Sysmex Corporation) is used as a sheath liquid. The dispersion prepared according to the above procedure is introduced into the flow-type particle image analyzer, 3,000 toner particles are measured in the total count mode in the HPF measurement mode, the binarization threshold value at the time of particle analysis is set to 85%, the analysis particle diameter is limited to an equivalent circle diameter of 1.98 μm to 19.92 μm, and the aspect ratio of the toner is obtained.

In the measurement, automatic focus adjustment is performed prior to the measurement using standard latex particles (for example, 5100A (trade name) manufactured by Duke Scientific is diluted with ion-exchanged water). Thereafter, it is preferable to perform focus adjustment every two hours from the start of measurement.

As the toner to be measured, the toner remaining in the developing container of the process cartridge after printing in the fogging evaluation was measured.

Note that an aspect ratio of 1.0 indicates a circular shape, and therefore represents a spherical toner. A smaller aspect ratio value indicates that the toner is further from a spherical shape, and the aspect ratio of the initial toner was 0.95. The results of the aspect ratio as the evaluation of the irregularity ratio are shown in Table 14-2.

### Examples 2 to 47

In Examples 2 to 47, developing rollers G-2 to G-44, G-54, G-56, and G-60 were each produced in the same manner as in Example 1, except that the coating liquid for forming a resin layer was changed to the coating liquids for forming a resin layer (F-2 to F-44, F-54, F-56, and F-60) shown in Table 14-1. Process cartridges P-2 to P-44, P-54, P-56, and P-60, in which the developing rollers G-2 to G-44, G-54, G-56, and G-60 prepared in the same manner as in Example 1 were mounted, were produced, and each measurement and evaluation were performed.

Physical properties and evaluation results are shown in Tables 15-1 to 15-4 and Tables 15-5 to 15-8. Tables 15-1 to 15-4 show the physical properties. The table is divided into four parts due to its large size. When these tables are combined into a single table, Table 15-1 corresponds to the upper left, Table 15-2 corresponds to the upper right, Table 15-3 corresponds to the lower left, and Table 15-4 corresponds to the lower right. In these tables, Me represents a methyl group, Et represents an ethyl group, and Bu represents a butyl group. Here, “Ex” means Example. (1) to (4) means “Formula (1)” to “Formula (4)”. “PC No.” means “Process cartridge No”. “DR No.” means “Developing roller No.”. “CL No.” means “Coating liquid for forming resin layer No.”.

TABLE 15-1

| | PC | DR | CL | Binder resin structure (structure (1)) | | | |
|---|---|---|---|---|---|---|---|
| Ex | No. | No. | No. | Structure (1) | | | |
| 1 | P-1 | G-1 | F-1 | (1) | R11-(CH₂)₅ | R12-(CH₂)₆ | m, n = 6.9 |
| 2 | P-2 | G-2 | F-2 | (1) | R11 = (CH₂)₃ | R12 = (CH₂)₄ | m, n = 8.8 |
| 3 | P-3 | G-3 | F-3 | (1) | R11 = (CH₂)₆ | R12 = (CH₂)₂—CHMe—(CH₂)₂ | m, n = 6.5 |
| 4 | P-4 | G-4 | F-4 | (1) | R11 = (CH₂)₆ | R12 = (CH₂)₂—CHMe—(CH₂)₂ | m = 2.0, n = 18.0 |
| 5 | P-5 | G-5 | F-5 | (4) | R41 = (CH₂)₆ | | s = 13.2 |
| 6 | P-6 | G-6 | F-6 | (1) | R11 = (CH₂)₅ | R12 = (CH₂)₆ | m, n = 6.9 |
| 7 | P-7 | G-7 | F-7 | (1) | R11-(CH₂)₆ | R12-(CH₂)₂ CHMe (CH₂)₂ | m = 2.0, n = 18.0 |
| 8 | P-8 | G-8 | F-8 | (1) | R11 = (CH₂)₉ | R12 = CH₂—CHMe—(CH₂)₆ | m = 3.5, n = 6.5 |
| 9 | P-9 | G-9 | F-9 | (1) | R11 = (CH₂)₅ | R12 = (CH₂)₆ | m, n-6.9 |
| 10 | P-10 | G-10 | F-10 | (1) | R11 = (CH₂)₄ | R12 = (CH₂)₆ | m-10.7, n-4.6 |
| 11 | P-11 | G-11 | F-11 | (1) | R11 = (CH₂)₃ | R12 = (CH₂)₄ | m, n-8.8 |
| 12 | P-12 | G-12 | F-12 | (1) | R11-(CH₂)₄ | R12-(CH₂)₆ | m = 14.5, n = 1.6 |
| 13 | P-13 | G-13 | F-13 | (1) | R11-(CH₂)₆ | R12-(CH₂)₂ CHMe (CH₂)₂ | m, n = 6.5 |
| 14 | P-14 | G-14 | F-14 | (1) | R11 = (CH₂)₆ | R12 = (CH₂)₂—CHMe—(CH₂)₂ | m = 1.3, n = 11.8 |
| 15 | P-15 | G-15 | F-15 | (1) | R11 = (CH₂)₆ | R12 = (CH₂)₂—CHMe—(CH₂)₂ | m = 2.0, n = 18.0 |
| 16 | P-16 | G-16 | F-16 | (1) | R11 = (CH₂)₉ | R12 = CH₂—CHMe—(CH₂)₆ | m = 6.5, n = 3.5 |
| 17 | P-17 | G-17 | F-17 | (1) | R11 = (CH₂)₉ | R12 = CH₂—CHMe—(CH₂)₆ | m-3.5, n-6.5 |
| 18 | P-18 | G-18 | F-18 | (2) | o = 9.1, p = 5.5 | | |
| 19 | P-19 | G-19 | F-19 | (2) | o = 9.1, p = 5.5 | | |
| 20 | P-20 | G-20 | F-20 | (3) | R31 = (CH₂)₃ | R32 = (CH₂)₄ | q = 12, r = 5.1 |
| 21 | P-21 | G-21 | F-21 | (3) | R31 = (CH₂)₆ | R32 = (CH₂)₈ | q = 2.7, r = 6.3 |

| | | | | | | |
|---|---|---|---|---|---|---|
| 22 | P-22 | G-22 | F-22 | (4) | R41 = (CH₂)₆ | s = 13.2 |

| | | | | | |
|---|---|---|---|---|---|
| 23 | P-23 | G-23 | F-23 | (2) | o = 9.1, p = 5.5 |
| 24 | P-24 | G-24 | F-24 | (2) | o = 9.1, p = 5.5 |

Here, “Ex” means Example. (1) to (5) means “Formula (1)” to “Formula (5)”.

TABLE 15-2

| | Binder resin structure (structure (2)) | | | | | | |
|---|---|---|---|---|---|---|---|
| Ex | Structure (2) | | | | Additive structure | | |
| 1 | (4) | R41═(CH₂)₆ | | s = 13.2 | (5) | R51═C₄H₉ | t, u = 17 |
| 2 | (4) | R41═(CH₂)₆ | | s = 13.2 | (5) | R51═C₄H₉ | t, u = 17 |
| 3 | (4) | R41═(CH₂)₆ | | s = 13.2 | (5) | R51═C₄H₉ | t, u = 17 |
| 4 | (4) | R41═(CH₂)₆ | | s = 13.2 | (5) | R51═C₄H₉ | t, u = 17 |
| 5 | (1) | R11═(CH₂)₆ | $R 12 \text{=C} {H}_{2} - CH 〈 \begin{matrix}{( {CH}_{2} )}_{2} \\ {( {CH}_{2} )}_{2}\end{matrix} 〉 CH - {CH}_{2}$ | m = 4.1, n = 1.4 | (5) | R51═C₄H₉ | t, u = 17 |
| 6 | (4) | R41═(CH₂)₆ | | s = 20.1 | (5) | R51═C₄H₉ | t, u = 17 |
| 7 | (4) | $R 41 = {CH}_{2} - CH 〈 \begin{matrix}{( {CH}_{2} )}_{2} \\ {( {CH}_{2} )}_{2}\end{matrix} 〉 CH - {CH}_{2}$ | | s = 5.8 | (5) | R51═C₄H₉ | t, u = 17 |
| 8 | (4) | R41═CH₂—CEtBu—CH₂ | | s = 4.6 | (5) | R51═C₄H₉ | t, u = 17 |
| 9 | (2) | o = 9.1, p = 5.5 | | | (5) | R51═C₄H₉ | t, u = 17 |
| 10 | (2) | o = 9.1, p = 5.5 | | | (5) | R51═C₄H₉ | t, u = 17 |
| 11 | (2) | o = 9.1, p = 5.5 | | | (5) | R51═C₄H₉ | t, u = 17 |
| 12 | (2) | o = 9.1, p = 5.5 | | | (5) | R51═C₄H₉ | t, u = 17 |
| 13 | (2) | o = 9.1, p = 5.5 | | | (5) | R51═C₄H₉ | t, u = 17 |
| 14 | (2) | o = 9.1, p = 5.5 | | | (5) | R51═C₄H₉ | t, u = 17 |
| 15 | (2) | o = 9.1, p = 5.5 | | | (5) | R51═C₄H₉ | t, u = 17 |
| 16 | (2) | o = 9.1, p = 5.5 | | | (5) | R51═C₄H₉ | t, u = 17 |
| 17 | (2) | o = 9.1, p = 5.5 | | | (5) | R51═C₄H₉ | t, u = 17 |
| 18 | (1) | R11═(CH₂)₆ | $R 12 = {CH}_{2} - CH 〈 \begin{matrix}{( {CH}_{2} )}_{2} \\ {( {CH}_{2} )}_{2}\end{matrix} 〉 CH - {CH}_{2}$ | m, n = 2.7 | (5) | R51═C₄H₉ | t, u = 17 |
| 19 | (1) | R11═(CH₂)₆ | $R 12 - {CH}_{2} - CH 〈 \begin{matrix}{( {CH}_{2} )}_{2} \\ {( {CH}_{2} )}_{2}\end{matrix} 〉 CH - {CH}_{2}$ | m = 4.1, n = 1.4 | (5) | R51═C₄H₉ | t, u = 17 |

| 20 | (4) | R41═(CH₂)₆ | s = 13.2 | (5) | R51═C₄H₉ | t, u = 17 |
|---|---|---|---|---|---|---|
| 21 | (4) | R41═(CH₂)₆ | s = 13.2 | (5) | R51═C₄H₉ | t, u = 17 |
| 22 | (2) | o = 9.1, p = 5.5 | | (5) | R51═C₄H₉ | t, u = 17 |
| 23 | (4) | $R 41 - {CH}_{2} - CH 〈 \begin{matrix}{( {CH}_{2} )}_{2} \\ {( {CH}_{2} )}_{2}\end{matrix} 〉 CH - {CH}_{2}$ | s = 5.8 | (5) | R51═C₄H₉ | t, u = 17 |
| 24 | (4) | R41═CH₂—CEtBu—CH₂ | s = 4.6 | (5) | R51═C₄H₉ | t, u = 17 |

Here, “Ex” means Example. (1) to (4) means “Formula (1)” to “Formula (4)”. “PC No.” means “Process cartridge No”. “DR No.” means “Developing roller No.”. “CL No.” means “Coating liquid for forming resin layer No.”.

TABLE 15-3

| | PC | DR | CL | Binder resin structure (structure (1)) | | | |
|---|---|---|---|---|---|---|---|
| Ex | No. | No. | No. | Structure (1) | | | |
| 25 | P-25 | G-25 | F-25 | (1) | R11 = (CH₂)₅ | R12 = (CH₂)₆ | m, n = 6.9 |
| | | | | (2) | o = 9.1, p = 5.5 | | |
| 26 | P-26 | G-26 | F-26 | (1) | R11 = (CH₂)₅ | R12 = (CH₂)₆ | m, n = 6.9 |
| 27 | P-27 | G-27 | F-27 | (1) | R11 = (CH₂)₅ | R12 = (CH₂)₆ | m, n = 6.9 |
| 28 | P-28 | G-28 | F-28 | (1) | R11 = (CH₂)₅ | R12 = (CH₂)₆ | m, n = 6.9 |
| 29 | P-29 | G-29 | F-29 | (1) | R11 = (CH₂)₅ | R12 = (CH₂)₆ | m, n = 6.9 |
| 30 | P-30 | G-30 | F-30 | (1) | R11 = (CH₂)₅ | R12 = (CH₂)₆ | m, n-6.9 |
| 31 | P-31 | G-31 | F-31 | (1) | R11 = (CH₂)₅ | R12 = (CH₂)₆ | m, n = 6.9 |
| 32 | P-32 | G-32 | F-32 | (1) | R11 = (CH₂)₅ | R12 = (CH₂)₆ | m, n = 6.9 |
| 33 | P-33 | G-33 | F-33 | (1) | R11 = (CH₂)₅ | R12 = (CH₂)₆ | m, n = 6.9 |
| 34 | P-34 | G-34 | F-34 | (1) | R11 = (CH₂)₅ | R12 = (CH₂)₆ | m, n = 6.9 |
| 35 | P-35 | G-35 | F-35 | (1) | R11-(CH₂)₅ | R12-(CH₂)₆ | m, n = 6.9 |
| 36 | P-36 | G-36 | F-36 | (1) | R11-(CH₂)₅ | R12-(CH₂)₆ | m, n = 6.9 |
| 37 | P-37 | G-37 | F-37 | (1) | R11 = (CH₂)₅ | R12 = (CH₂)₆ | m, n = 6.9 |
| 38 | P-38 | G-38 | F-38 | (1) | R11-(CH₂)₅ | R12-(CH₂)₆ | m, n = 6.9 |
| 39 | P-39 | G-39 | F-39 | (1) | R11-(CH₂)₅ | R12-(CH₂)₆ | m, n = 6.9 |
| 40 | P-40 | G-40 | F-40 | (1) | R11 = (CH₂)₅ | R12 = (CH₂)₆ | m, n = 6.9 |
| 41 | P-41 | G-41 | F-41 | (1) | R11 = (CH₂)₅ | R12 = (CH₂)₆ | m, n = 6.9 |
| 42 | P-42 | G-42 | F-42 | (1) | R11 = (CH₂)₅ | R12 = (CH₂)₆ | m, n = 6.9 |
| 43 | P-43 | G-43 | F-43 | (1) | R11 = (CH₂)₅ | R12 = (CH₂)₆ | m, n = 6.9 |
| 44 | P-44 | G-44 | F-44 | (1) | R11 = (CH₂)₅ | R12 = (CH₂)₆ | m, n = 6.9 |
| 45 | P-54 | G-54 | F-54 | (1) | R11 = (CH₂)₅ | R12 = (CH₂)₆ | m, n = 6.9 |
| 46 | P-56 | G-56 | F-56 | (1) | R11 = (CH₂)₅ | R12 = (CH₂)₆ | m, n = 6.9 |
| 47 | P-60 | G-60 | F-60 | (1) | R11 = (CH₂)₅ | R12 = (CH₂)₆ | m, n = 6.9 |

Here, “Ex” means Example. (2) to (7) means “Formula (2)” to “Formula (7)”.

TABLE 15-4

| | Binder resin structure (structure (2)) | | | | | |
|---|---|---|---|---|---|---|
| Ex | Structure (2) | | | Additive structure | | |
| 25 | (4) | R41 = (CH₂)₆ | s = 13.2 | (5) | R51 = C₄H₉ | t, u = 17 |
| 26 | (2) | o = 9.1, p = 5.5 | | (5) | R51 = C₄H₉ | t, u = 17 |
| 27 | (4) | R41 = (CH₂)₆ | s-13.2 | (5) | R51 = C₄H₉ | t, u-17 |
| 28 | (4) | R41-(CH₂)₆ | s-13.2 | (5) | R51 = C₄H₉ | t, u-17 |
| 29 | (4) | R41 = (CH₂)₆ | s = 13.2 | (5) | R51 = C₄H₉ | t, u = 30 |
| 30 | (4) | R41 = (CH₂)₆ | s = 13.2 | (5) | R51 = C₄H₉ | t = 9, u = 10 |
| 31 | (4) | R41 = (CH₂)₆ | s = 13.2 | (5) | R51 = C₁₂H₂₅ | t, u = 5 |
| 32 | (4) | R41 = (CH₂)₆ | s = 13.2 | (5) | R51 = C₁₂H₂₅ | t, u = 25 |
| 33 | (4) | R41 = (CH₂)₆ | s = 13.2 | (5) | R51 = C₈H₁₇ | t, u = 15 |
| 34 | (4) | R41 = (CH₂)₆ | s = 13.2 | (5) | R51 = CH₃ | t, u = 12 |
| 35 | (4) | R41 = (CH₂)₆ | s = 13.2 | (6) | R61 = CH₃ | v = 6, w = 29 |
| 36 | (4) | R41 = (CH₂)₆ | s = 13.2 | (6) | R61 = CH₃ | v = 6, w = 29 |
| 37 | (4) | R41 = (CH₂)₆ | s = 13.2 | (6) | R61 = CH₃ | v = 6, w = 29 |
| 38 | (4) | R41 = (CH₂)₆ | s = 13.2 | (6) | R61-CH₃ | v = 1, w = 9 |
| 39 | (4) | R41 = (CH₂)₆ | s = 13.2 | (6) | R61 = C₈H₁₇ | v, w = 15 |
| 40 | (4) | R41 = (CH₂)₆ | s = 13.2 | (7) | R71 = C₁₂H₂₅ | x = 5 |
| 41 | (4) | R41 = (CH₂)₆ | s = 13.2 | (7) | R71 = C₁₂H₂₅ | x = 5 |
| 42 | (4) | R41 = (CH₂)₆ | s = 13.2 | (7) | R71-C₁₂H₂₅ | x = 5 |
| 43 | (4) | R41 = (CH₂)₆ | s = 13.2 | (7) | R71 = CH₃ | x = 11 |
| 44 | (4) | R41 = (CH₂)₆ | s = 13.2 | (7) | R71 = C₈H₁₇ | x = 14 |
| 45 | (4) | R41 = (CH₂)₆ | s = 13.2 | (5) | R51 = C₄H₉ | t, u = 17 |
| 46 | (4) | R41 = (CH₂)₆ | s = 13.2 | (5) | R51 = C₄H₉ | t, u = 17 |
| 47 | (4) | R41 = (CH₂)₆ | s-13.2 | (5) | R51 = C₄H₉ | t, u-17 |

Tables 15-5 to 15-8 show the evaluation results. The table is divided into four parts due to its large size. When these tables are combined into a single table, Table 15-5 corresponds to the upper left, Table 15-6 corresponds to the upper right, Table 15-7 corresponds to the lower left, and Table 15-8 corresponds to the lower right. In these tables, X represents the total amount (mass %) of the compounds having the structures represented by Structural Formulas (5) to (7) based on the solid content in the coating liquid for forming a resin layer. Here, “PC No.” means “Process cartridge No.”. “DR No.” means “Developing roller No.”. “PPD” means “Primary particle diameter [nm]”. “DBP abs” means “DBP absorption [m/100 g]”. “MVSP” means “Maximum value of surface potential [IV]”. “MHR Rz” means “Maximum height roughness Rz [μm]”.

TABLE 15-5

| | | | Carbon black | | | | | | |
|---|---|---|---|---|---|---|---|---|---|
| | | | physical properties | | | | | | |
| | | | | DBP | | | Impedance | | |
| | | | | abs | | | [Ω] | | MHR |
| | PC | DR | PPD | [ml/ | | | @1.0 × | MVSP | Rz |
| Example | No. | No. | [nm] | 100 g] | pH | X | 10¹ Hz | [V] | [μm] |
| 1 | P-1 | G-1 | 24 | 51 | 2.5 | 3.2 | 9.12E+06 | 5.7 | 7 |
| 2 | P-2 | G-2 | 24 | 51 | 2.5 | 3.2 | 8.67E+06 | 12.5 | 7 |
| 3 | P-3 | G-3 | 24 | 51 | 2.5 | 3.2 | 2.32E+07 | 5.5 | 7 |
| 4 | P-4 | G-4 | 24 | 51 | 2.5 | 3.3 | 1.69E+07 | 6.2 | 7 |
| 5 | P-5 | G-5 | 24 | 51 | 2.5 | 3.2 | 7.41E+06 | 14.2 | 7 |
| 6 | P-6 | G-6 | 24 | 51 | 2.5 | 3.2 | 6.52E+06 | 8.1 | 7 |
| 7 | P-7 | G-7 | 24 | 51 | 2.5 | 3.3 | 1.52E+07 | 13.2 | 7 |
| 8 | P-8 | G-8 | 24 | 51 | 2.5 | 3.2 | 7.01E+06 | 10.5 | 7 |
| 9 | P-9 | G-9 | 24 | 51 | 2.5 | 3.2 | 2.79E+06 | 3.2 | 7 |
| 10 | P-10 | G-10 | 24 | 51 | 2.5 | 3.2 | 2.68E+06 | 2.8 | 7 |
| 11 | P-11 | G-11 | 24 | 51 | 2.5 | 3.2 | 1.52E+06 | 3.2 | 7 |
| 12 | P-12 | G-12 | 24 | 51 | 2.5 | 3.2 | 2.83E+06 | 4.5 | 7 |
| 13 | P-13 | G-13 | 24 | 51 | 2.5 | 3.2 | 3.82E+06 | 4.2 | 7 |
| 14 | P-14 | G-14 | 24 | 51 | 2.5 | 3.2 | 3.51E+06 | 3.6 | 7 |
| 15 | P-15 | G-15 | 24 | 51 | 2.5 | 3.3 | 3.39E+06 | 5.1 | 7 |
| 16 | P-16 | G-16 | 24 | 51 | 2.5 | 3.2 | 4.11E+06 | 4.7 | 7 |
| 17 | P-17 | G-17 | 24 | 51 | 2.5 | 3.2 | 4.22E+06 | 3.9 | 7 |
| 18 | P-18 | G-18 | 24 | 51 | 2.5 | 3.2 | 1.89E+06 | 2.6 | 7 |
| 19 | P-19 | G-19 | 24 | 51 | 2.5 | 3.2 | 1.57E+06 | 3.1 | 7 |
| 20 | P-20 | G-20 | 24 | 51 | 2.5 | 3.2 | 2.11E+06 | 3.5 | 7 |
| 21 | P-21 | G-21 | 24 | 51 | 2.5 | 3.2 | 1.98E+06 | 3.8 | 7 |
| 22 | P-22 | G-22 | 24 | 51 | 2.5 | 3.2 | 2.36E+06 | 3.2 | 7 |
| 23 | P-23 | G-23 | 24 | 51 | 2.5 | 3.2 | 2.25E+06 | 2.9 | 7 |
| 24 | P-24 | G-24 | 24 | 51 | 2.5 | 3.2 | 3.55E+06 | 3.6 | 7 |

Here, “Ex” means Example.

TABLE 15-6

| | Carbon black dispersion state | | | | | | | | | |
|---|---|---|---|---|---|---|---|---|---|---|
| | Equivalent circle diameter | | | | | | | | | |
| | of dispersed particles | | | Wall-to-wall distance | | | | Fogging | | |
| | Mean | Standard | | Mean | Standard | | Initial | evaluation | Image | |
| | value | deviation | | value | deviation | | fogging | after | density | Aspect |
| Ex | Rc [nm] | σc [nm] | σc/Rc | d [nm] | σd [nm] | σd/d | evaluation | print | stability | ratio |
| 1 | 55.2 | 33.1 | 0.600 | 111.6 | 64.1 | 0.574 | 0.2 | 1.5 | 0.04 | 0.92 |
| 2 | 55.9 | 32.9 | 0.589 | 108.9 | 62.1 | 0.570 | 0.3 | 2.8 | 0.03 | 0.92 |
| 3 | 49.2 | 27.3 | 0.555 | 98.2 | 54.8 | 0.558 | 0.2 | 1.6 | 0.01 | 0.93 |
| 4 | 51.7 | 29.6 | 0.573 | 97.9 | 55.2 | 0.564 | 0.1 | 1.5 | 0.02 | 0.92 |
| 5 | 52.1 | 31.1 | 0.597 | 102.3 | 57.2 | 0.559 | 0.2 | 2.9 | 0.03 | 0.91 |
| 6 | 53.3 | 30.8 | 0.578 | 103.5 | 57.8 | 0.558 | 0.2 | 1.6 | 0.04 | 0.92 |
| 7 | 51.3 | 31.2 | 0.608 | 101.5 | 58.2 | 0.573 | 0.3 | 2.7 | 0.02 | 0.92 |
| 8 | 50.9 | 30.1 | 0.591 | 101.8 | 57.9 | 0.569 | 0.3 | 2.4 | 0.03 | 0.92 |
| 9 | 54.3 | 31.8 | 0.586 | 100.7 | 56.9 | 0.565 | 0.2 | 1.3 | 0.08 | 0.92 |
| 10 | 53 | 32.1 | 0.606 | 102.3 | 57.6 | 0.563 | 0.2 | 1.1 | 0.07 | 0.91 |
| 11 | 59.2 | 38 | 0.642 | 103.8 | 57.2 | 0.551 | 0.3 | 1.2 | 0.09 | 0.92 |
| 12 | 57.1 | 34.9 | 0.611 | 104.3 | 58 | 0.556 | 0.2 | 1.4 | 0.06 | 0.92 |
| 13 | 53 | 32 | 0.604 | 105.6 | 57.9 | 0.548 | 0.1 | 1.4 | 0.05 | 0.92 |
| 14 | 55.1 | 32.2 | 0.584 | 106.5 | 60.2 | 0.565 | 0.1 | 1.3 | 0.06 | 0.92 |
| 15 | 54.2 | 32.2 | 0.594 | 106.1 | 59.9 | 0.565 | 0.2 | 1.6 | 0.07 | 0.92 |
| 16 | 51.4 | 30.1 | 0.586 | 105.8 | 60.2 | 0.569 | 0.2 | 1.5 | 0.05 | 0.92 |
| 17 | 52.2 | 32.4 | 0.621 | 103.5 | 60.2 | 0.582 | 0.1 | 1.2 | 0.05 | 0.92 |
| 18 | 58.1 | 34.1 | 0.587 | 106.8 | 61 | 0.571 | 0.1 | 1.0 | 0.07 | 0.93 |
| 19 | 57.1 | 35.2 | 0.616 | 107.6 | 61.2 | 0.569 | 0.2 | 1.1 | 0.07 | 0.92 |
| 20 | 58 | 34.7 | 0.598 | 106.5 | 60.9 | 0.572 | 0.2 | 1.3 | 0.08 | 0.92 |
| 21 | 59.1 | 34.9 | 0.591 | 104.9 | 61.1 | 0.582 | 0.1 | 1.2 | 0.08 | 0.92 |
| 22 | 58.2 | 35.3 | 0.607 | 105.8 | 60.9 | 0.576 | 0.2 | 1.3 | 0.08 | 0.92 |
| 23 | 56.1 | 35.2 | 0.627 | 106.8 | 60.9 | 0.570 | 0.2 | 1.0 | 0.07 | 0.92 |
| 24 | 57.3 | 35.4 | 0.618 | 103.5 | 58.8 | 0.568 | 0.2 | 1.4 | 0.06 | 0.92 |

Here, Ex means Example. “PC No.” means “Process cartridge No.”. “DR No.” means “Developing roller No.”. “PPD” means “Primary particle diameter [nm]”. “DBP abs” means “DBP absorption [ml/100 g]”. “MVSP” means “Maximum value of surface potential [IV]”. “MHR Rz” means “Maximum height roughness Rz [μm]”.

TABLE 15-7

| | | | Carbon black | | | | | | |
|---|---|---|---|---|---|---|---|---|---|
| | | | physical properties | | | | | | |
| | | | | DBP | | | | | |
| | | | | abs | | | Impedance | | MHR |
| | PC | DR | PPD | [ml/ | | | [Ω] | MVSP | Rz |
| Ex | No. | No. | [nm] | 100 g] | pH | X | @1.0 × 10¹ Hz | [V] | [μm] |
| 25 | P-25 | G-25 | 24 | 51 | 2.5 | 3.2 | 5.01E+06 | 4.5 | 7 |
| 26 | P-26 | G-26 | 24 | 51 | 2.5 | 3.2 | 3.11E+06 | 3.5 | 7 |
| 27 | P-27 | G-27 | 24 | 51 | 2.5 | 3.0 | 8.58E+06 | 4.5 | 7 |
| 28 | P-28 | G-28 | 24 | 51 | 2.5 | 7.0 | 6.55E+06 | 7.2 | 7 |
| 29 | P-29 | G-29 | 24 | 51 | 2.5 | 3.2 | 7.92E+06 | 6.8 | 7 |
| 30 | P-30 | G-30 | 24 | 51 | 2.5 | 3.2 | 7.71E+06 | 6.4 | 7 |
| 31 | P-31 | G-31 | 24 | 51 | 2.5 | 3.2 | 6.31E+06 | 5.9 | 7 |
| 32 | P-32 | G-32 | 24 | 51 | 2.5 | 3.2 | 5.47E+06 | 5.7 | 7 |
| 33 | P-33 | G-33 | 24 | 51 | 2.5 | 3.2 | 7.21E+06 | 6.9 | 7 |
| 34 | P-34 | G-34 | 24 | 51 | 2.5 | 3.2 | 6.74E+06 | 6.3 | 7 |
| 35 | P-35 | G-35 | 24 | 51 | 2.5 | 3.2 | 6.32E+06 | 5.1 | 7 |
| 36 | P-36 | G-36 | 24 | 51 | 2.5 | 3.0 | 5.89E+06 | 5.2 | 7 |
| 37 | P-37 | G-37 | 24 | 51 | 2.5 | 7.0 | 5.84E+06 | 4.9 | 7 |
| 38 | P-38 | G-38 | 24 | 51 | 2.5 | 3.2 | 5.10E+06 | 3.9 | 7 |
| 39 | P-39 | G-39 | 24 | 51 | 2.5 | 3.2 | 2.80E+06 | 4.8 | 7 |
| 40 | P-40 | G-40 | 24 | 51 | 2.5 | 3.2 | 2.25E+06 | 4.5 | 7 |
| 41 | P-41 | G-41 | 24 | 51 | 2.5 | 3.0 | 2.11E+06 | 3.8 | 7 |
| 42 | P-42 | G-42 | 24 | 51 | 2.5 | 7.0 | 2.37E+06 | 4.2 | 7 |
| 43 | P-43 | G-43 | 24 | 51 | 2.5 | 3.2 | 2.15E+06 | 3.8 | 7 |
| 44 | P-44 | G-44 | 24 | 51 | 2.5 | 3.2 | 2.27E+06 | 3.8 | 7 |
| 45 | P-54 | G-54 | 24 | 51 | 2.5 | 3.2 | 9.12E+06 | 5.7 | 10 |
| 46 | P-56 | G-56 | 24 | 51 | 2.5 | 3.2 | 9.12E+06 | 5.7 | 15 |
| 47 | P-60 | G-60 | 24 | 51 | 2.5 | 3.2 | 9.12E+06 | 5.7 | 5 |

Here, “Ex” means Example.

TABLE 15-8

| | Carbon black dispersion state | | | | | | | | | |
|---|---|---|---|---|---|---|---|---|---|---|
| | Equivalent circle diameter | | | | | | | | | |
| | of dispersed particles | | | Wall-to-wall distance | | | | Fogging | | |
| | Mean | Standard | | Mean | Standard | | Initial | evaluation | Image | |
| | value | deviation | | value | deviation | | fogging | after | density | Aspect |
| Ex | Rc [nm] | σc [nm] | σc/Rc | d [nm] | σd [nm] | σd/d | evaluation | print | stability | ratio |
| 25 | 54.3 | 34.1 | 0.628 | 102.7 | 58.1 | 0.566 | 0.3 | 1.6 | 0.04 | 0.92 |
| 26 | 53.1 | 33.3 | 0.627 | 100.2 | 57.6 | 0.575 | 0.1 | 1.0 | 0.07 | 0.93 |
| 27 | 57.4 | 34.5 | 0.601 | 99.8 | 56.6 | 0.567 | 0.1 | 1.2 | 0.03 | 0.92 |
| 28 | 56.1 | 34.2 | 0.610 | 101.2 | 57 | 0.563 | 0.2 | 2.1 | 0.04 | 0.91 |
| 29 | 57.2 | 34 | 0.594 | 103.5 | 58.1 | 0.561 | 0.2 | 1.7 | 0.03 | 0.92 |
| 30 | 57 | 34.9 | 0.612 | 98.7 | 56.7 | 0.574 | 0.2 | 1.6 | 0.04 | 0.92 |
| 31 | 56.2 | 34.5 | 0.614 | 101.7 | 57.1 | 0.561 | 0.3 | 1.6 | 0.03 | 0.92 |
| 32 | 55.2 | 34.2 | 0.620 | 102.4 | 58 | 0.566 | 0.2 | 1.4 | 0.03 | 0.92 |
| 33 | 56.7 | 33.8 | 0.596 | 100.8 | 57.4 | 0.569 | 0.3 | 1.8 | 0.04 | 0.92 |
| 34 | 57.2 | 35.1 | 0.614 | 100.7 | 56.9 | 0.565 | 0.2 | 1.6 | 0.04 | 0.92 |
| 35 | 55 | 32 | 0.582 | 102.3 | 57.4 | 0.561 | 0.2 | 1.4 | 0.03 | 0.92 |
| 36 | 55.1 | 33.1 | 0.601 | 103.8 | 56.9 | 0.548 | 0.1 | 1.3 | 0.04 | 0.92 |
| 37 | 56.1 | 33.8 | 0.602 | 104.6 | 57.3 | 0.548 | 0.1 | 1.3 | 0.05 | 0.92 |
| 38 | 55.7 | 33.5 | 0.601 | 105.7 | 61 | 0.577 | 0.2 | 1.3 | 0.04 | 0.92 |
| 39 | 58.2 | 35.2 | 0.605 | 114.6 | 67.4 | 0.588 | 0.2 | 1.5 | 0.07 | 0.92 |
| 40 | 59 | 37.9 | 0.642 | 130.3 | 77.6 | 0.596 | 0.3 | 1.6 | 0.07 | 0.92 |
| 41 | 58.2 | 37.1 | 0.637 | 135.6 | 78.9 | 0.582 | 0.2 | 1.2 | 0.08 | 0.92 |
| 42 | 58.3 | 37.2 | 0.638 | 137.8 | 78.2 | 0.567 | 0.1 | 1.4 | 0.07 | 0.92 |
| 43 | 58.9 | 37 | 0.628 | 143.5 | 83.2 | 0.580 | 0.2 | 1.1 | 0.08 | 0.93 |
| 44 | 57.9 | 37.2 | 0.642 | 127.5 | 74.1 | 0.581 | 0.3 | 1.3 | 0.08 | 0.92 |
| 45 | 55.2 | 33.1 | 0.600 | 111.6 | 64.1 | 0.574 | 0.2 | 2.3 | 0.04 | 0.92 |
| 46 | 55.2 | 33.1 | 0.600 | 111.6 | 64.1 | 0.574 | 0.2 | 2.8 | 0.04 | 0.91 |
| 47 | 55.2 | 33.1 | 0.600 | 111.6 | 64.1 | 0.574 | 0.2 | 1.0 | 0.04 | 0.93 |

The impedance value indicates the minimum value of the impedance value at a frequency of 1.0×10⁰ Hz to 1.0×10¹ Hz. Note that description such as “9.12E+06” indicates “9.12×10⁶”.

### Examples 48 to 50

In the examples so far, evaluation was performed by applying −300 V to the developing power supply E2, −400 V to the blade power supply E5, and −300 V to the supply roller power supply E6. In the evaluation in Examples 48 to 50, the developing power supply E2, the blade power supply E5, and the supply roller power supply E6 were changed, and the same evaluation as in Example 1 was performed. Table 16 shows the cartridge Nos. used in Example 1 and Examples 48 to 50, the power supply conditions at that time, and the evaluation results thereof.

TABLE 16

| | | | | Supply | | | | |
|---|---|---|---|---|---|---|---|---|
| | | Developing | Blade | roller | | Fogging | | |
| | Process | power | power | power | Initial | evaluation | Image | |
| | cartridge | supply | supply | supply | fogging | after | density | Aspect |
| Example | No. | E2 [−V] | E5 [−V] | E6 [−V] | evaluation | printing | stability | ratio |
| 1 | P-1 | 300 | 400 | 300 | 0.2 | 1.5 | 0.04 | 0.92 |
| 48 | P-1 | 300 | 400 | 400 | 0.3 | 1.2 | 0.03 | 0.93 |
| 49 | P-1 | 300 | 500 | 400 | 0.2 | 1.0 | 0.02 | 0.93 |
| 50 | P-1 | 300 | 400 | 500 | 0.5 | 2.0 | 0.05 | 0.92 |

### Comparative Example 1

The types and amounts of materials shown in Table 17 were added to a reaction vessel and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-45 for forming a resin layer. Except that the coating liquid F-1 for forming a resin layer was changed to the coating liquid F-45 for forming a resin layer, in the same manner as in Example 1, a developing roller G-45 was produced, mounted in the process cartridge P-45, and then evaluated. The evaluation results are shown in Tables 21-1 and 21-2.

TABLE 17

| | Parts |
|---|---|
| Material | by mass |
| Polytetramethylene glycol ether polyol | 25 |
| (trade name: PTG1000SN, Hodogaya Chemical Co., Ltd.) | |
| Polycarbonate polyol | 75 |
| (trade name: T5651, Asahi Kasei Chemicals Corporation) | |
| Isocyanate | 55.5 |
| (trade name: CORONATE HX, Tosoh Corporation) | |
| Carbon black | 30 |
| (trade name: MA8, Mitsubishi Chemical Corporation) | |
| Coarse particles | 20 |
| (trade name: ART PEARL C-400T, | |
| Negami Chemical Industrial Co., Ltd.) | |

### Comparative Examples 2 and 3

Except that the carbon black used in the coating liquid F-1 for forming a resin layer was changed to the materials shown in Table 18, in the same manner as in Example 1, coating liquids F-46 and F-47 for forming a resin layer and developing rollers G-46 and G-47 were produced, mounted in the process cartridges P-46 and P-47, respectively, and then evaluated. The evaluation results are shown in Tables 21-1 and 21-2. Here, “PPD” means “Primary particle diameter [nm]”. “DBP abs” means “DBP absorption [ml/100 g]”.

TABLE 18

| | | | Coating | | | | |
|---|---|---|---|---|---|---|---|
| | | | liquid for | | | | |
| | Process | Developing | forming | Carbon black material | | | |
| | cartridge | roller | resin layer | Material | PPD | DBP abs | |
| | No. | No. | No. | name | [nm] | [ml/100 g] | pH |
| Exam- | P-1 | G-1 | F-1 | MA8 | 24 | 51 | 2.5 |
| ple 1 | | | | (Mitsubishi | | | |
| | | | | Chemical | | | |
| | | | | Corporation) | | | |
| Compar- | P-46 | G-46 | F-46 | MA230 | 30 | 113 | 3 |
| ative | | | | (Mitsubishi | | | |
| Exam- | | | | Chemical | | | |
| ple 1 | | | | Corporation) | | | |
| Compar- | P-47 | G-47 | F-47 | MA14 | 40 | 73 | 3 |
| ative | | | | (Mitsubishi | | | |
| Exam | | | | Chemical | | | |
| ple 2 | | | | Corporation) | | | |

### Comparative Examples 4 to 6

Except that the additive used in the coating liquid F-1 for forming a resin layer was changed to the materials and parts by mass shown in Table 19, in the same manner as in Example 1, coating liquids F-48 to F-50 for forming a resin layer and developing rollers G-48 to G-50 were produced, mounted in the process cartridges P-48 to P-50, respectively, and then evaluated. The evaluation results are shown in Tables 21-1 and 21-2. Here, “Ex” means “Example” and “CE” means “Comparative Example”.

TABLE 19

| | | | Coating | | |
|---|---|---|---|---|---|
| | | | liquid for | | |
| | Process | | forming | Additive | |
| | cartridge | Developing | resin | | Parts |
| | No. | roller No. | layer No. | Material | by mass |
| Ex 1 | P-1 | G-1 | F-1 | E-1 | 7 |
| CE 4 | P-48 | G-48 | F-48 | E-1 | 5.25 |
| CE 5 | P-49 | G-49 | F-49 | Silane coupling agent | 14 |
| | | | | (trade name: A-187, | |
| | | | | Momentive Inc.) | |
| CE 6 | P-50 | G-50 | F-50 | Polymer-based dispersant | 24.5 |
| | | | | (trade name: Disper byk-185, | |
| | | | | BYK-Chemie GmbH) | |

### Comparative Example 7

Except that the additive used in the coating liquid F-1 for forming a resin layer was changed to E-14 shown in Table 20, in the same manner as in Example 1, a coating liquid F-51 for forming a resin layer and a developing roller G-51 were produced, mounted in the process cartridge P-51, and then evaluated. The evaluation results are shown in Tables 21-1 and 21-2.

### Comparative Example 8

### <Synthesis of Additive E-15>

An additive E-15, which is a polyether amine, was obtained by synthesizing polyoxyethylene polyoxypropylene decyl ether, oxidizing a secondary alcohol to form a ketone, and then performing reductive amination.

### (Synthesis of Polyoxyethylene Polyoxypropylene Decyl Ether)

205.8 g of 1-decanol (Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

The obtained ethylene oxide adduct was cooled to 130° C., and then 1,132.6 g of propylene oxide (15 mol relative to alcohol) was charged. After completion of the charging, the reaction was carried out at 130° C. for 5 hours to obtain a polyoxyethylene polyoxypropylene decyl ether adduct, which is a block polymer having an average number of added moles of 15 mol of ethylene oxide and 15 mol of propylene oxide.

The obtained polyoxyethylene polyoxypropylene octyldecyl adduct was cooled to 80° C., and unreacted ethylene oxide and propylene oxide were removed at 2.5 kPa for 30 minutes. Next, 6.0 g of 90% lactic acid was charged into the autoclave, stirred at 80° C. for 30 minutes, and then extracted to obtain polyoxyethylene polyoxypropylene decyl ether.

### (Synthesis of Polyether Amine E-15)

A stirrer was attached to a three-neck flask, and 1,688 g of polyoxyethylene polyoxypropylene decyl ether and 460 ml of acetic acid were charged. 600 ml of a 2 mol/l aqueous sodium hypochlorite solution was added dropwise thereto over 1 hour. The reaction vessel was cooled in an ice bath so that the temperature was in the range of 15 to 25° C. After completion of the dropwise addition, stirring was continued for 1 hour. Dichloromethane was added to the obtained solution, and the aqueous layer was extracted and post-treated and purified by a column to obtain a compound in which a secondary alcohol was converted into a ketone.

The mixture was cooled to 0° C. in an ice bath, 250 ml of a methanol-acetic acid mixed solution (volume ratio 10:1) was added to 41.4 g of a compound in which the obtained secondary alcohol was converted into a ketone, and 2.7 g of 2-picoline-borane was added. The ice bath was removed, and the mixture was stirred overnight at room temperature in an open system. After concentration, the mixture was cooled to 0° C., 360 ml of a 35% aqueous hydrochloric acid solution was added, and the mixture was stirred at room temperature for 2 hours. An aqueous sodium hydroxide solution was added to make the mixture basic, and the aqueous layer was extracted with dichloromethane and post-treated and purified by a column to obtain a polyether amine E-15. The structure of R61 in E-15 and the values of v and w are shown in Table 20.

### <Synthesis of Coating Liquid F-52 for Forming Resin Layer and Developing Roller G-52>

Except that the additive used in the coating liquid F-1 for forming a resin layer was changed to the additive E-15, in the same manner as in Example 1, a coating liquid F-52 for forming a resin layer and a developing roller G-52 were produced, mounted in the process cartridge P-52, and then evaluated. The evaluation results are shown in Tables 21-1 and 21-2.

### Comparative Example 9

### <Synthesis of Additive E-16>

315.2 g of 1-hexadecanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged.

The reaction was carried out at 150° C. for 1 hour to obtain an ethylene oxide adduct having an average number of added moles of 15 mol.

90.2 g of the obtained ethylene oxide adduct and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-16. The structure of R71 in E-16 and the value of x are shown in Table 20.

### <Synthesis of Coating Liquid F-53 for Forming Resin Layer and Developing Roller G-53>

Except that the additive used in the coating liquid F-1 for forming a resin layer was changed to the additive E-16, in the same manner as in Example 1, a coating liquid F-53 for forming a resin layer and a developing roller G-53 were produced, mounted in the process cartridge P-53, and then evaluated. The evaluation results are shown in Tables 21-1 and 21-2. Here, (5) to (7) means “Formula (7)” to “Formula (9)”.

TABLE 20

| No. | Material | Structure | | |
|---|---|---|---|---|
| E-14 | Polyoxyethylene | (5) | R51 = C₁₆H₃₃ | t = 20, |
| | polyoxypropylene cetyl | | | u = 8 |
| | ether (trade name: UNISAFE | | | |
| | 20P-8, NOF corporation) | | | |
| E-15 | Polyether amine | (6) | R61 = C₁₀H₂₁ | v, w = 15 |
| E-16 | Polyoxyethylene hexadecyl | (7) | R71 = C₁₆H₃₃ | x = 14 |
| | ether acetate | | | |

### Comparative Examples 10 to 12

Except that the coarse particles were changed as shown in Table 12 in Tables 21-1 and 21-2 for the coating liquids F-61 to F-63 for forming a resin layer, coating liquids F-61 to F-63 for forming a resin layer were produced in the same manner as in the coating liquid F-45 for forming a resin layer, developing rollers G-61 to G-63 and process cartridges P-61 to P-63 were produced, and evaluation was performed. The evaluation results are shown in Tables 21-1 and 21-2. Here, CE means “Comparative Example”. “PC No.” means “Process cartridge No.”. “DR No.” means “Developing roller No.”. “PPD” means “Primary particle diameter [nm]”. “DBP abs” means “DBP absorption [ml/100 g]”. “MVSP” means “Maximum value of surface potential [V]”. “MHR Rz” means “Maximum height roughness Rz [μm]”.

TABLE 21-1

| | | | Carbon black | | | | | | |
|---|---|---|---|---|---|---|---|---|---|
| | | | physical properties | | | | Impedance | | |
| | | | | DBP abs | | | [Ω] | | MHR |
| | PC | DR | PPD | [ml/ | | | @1.0 × | MVSP | Rz |
| CE | No. | No. | [nm] | 100 g] | pH | X | 10¹ Hz | [V] | [μm] |
| 1 | P-45 | G-45 | 24 | 51 | 25 | — | 3.96E+05 | 3.7 | 7 |
| 2 | P-46 | G-46 | 30 | 113 | 3 | — | 2.25E+04 | 2.4 | 7 |
| 3 | P-47 | G-47 | 40 | 73 | 3 | — | 1.59E+05 | 8.7 | 7 |
| 4 | P-48 | G-48 | 24 | 51 | 25 | 2.4 | 4.56E+05 | 3.5 | 7 |
| 5 | P-49 | G-49 | 24 | 51 | 25 | 6.2 | 2.00E+08 | 462.0 | 7 |
| 6 | P-50 | G-50 | 24 | 51 | 25 | 10.3 | 4.18E+05 | 4.6 | 7 |
| 7 | P-51 | G-51 | 24 | 51 | 25 | 3.2 | 1.56E+05 | 7.6 | 7 |
| 8 | P-52 | G-52 | 24 | 51 | 25 | 3.2 | 1.18E+05 | 6.8 | 7 |
| 9 | P-53 | G-53 | 24 | 51 | 25 | 3.2 | 8.92E+04 | 2.5 | 7 |
| 10 | P-61 | G-61 | 24 | 51 | 25 | — | 3.96E+05 | 3.7 | 10 |
| 11 | P-62 | G-62 | 24 | 51 | 25 | — | 3.96E+05 | 3.7 | 15 |
| 12 | P-63 | G-63 | 24 | 51 | 25 | — | 3.96E+05 | 3.7 | 5 |

Here, CE means “Comparative Example”.

TABLE 21-2

| | Carbon black dispersion state | | | | | | | | | |
|---|---|---|---|---|---|---|---|---|---|---|
| | Equivalent circle diameter | | | Wall-to-wall distance | | | | | | |
| | of dispersed particles | | | | Standard | | | Fogging | | |
| | Mean | Standard | | Mean | deviation | | Initial | evaluation | Image | |
| | value | deviation | | value | σd | | fogging | after | density | Aspect |
| CE | Rc | σc | σc/Rc | d | [nm] | σd/d | evaluation | print | stability | ratio |
| 1 | 92.9 | 60.7 | 0.653 | 146.8 | 95.6 | 0.651 | 0.4 | 3.8 | 0.16 | 0.89 |
| 2 | 88 | 56 | 0.636 | 130.1 | 79.5 | 0.611 | 0.4 | 3.9 | 0.21 | 0.89 |
| 3 | 104 | 79.7 | 0.766 | 205.8 | 130.7 | 0.635 | 0.4 | 5.0 | 0.19 | 0.88 |
| 4 | 86.8 | 57 | 0.657 | 129.8 | 80.1 | 0.617 | 0.5 | 3.9 | 0.18 | 0.89 |
| 5 | 57 | 34 | 0.596 | 112.7 | 63.8 | 0.566 | 1.1 | 11.7 | 0.27 | 0.87 |
| 6 | 87.8 | 55.5 | 0.632 | 130.7 | 79.5 | 0.608 | 0.4 | 4.2 | 0.18 | 0.89 |
| 7 | 89.1 | 57.6 | 0.646 | 148.2 | 98.7 | 0.666 | 0.5 | 4.3 | 0.16 | 0.89 |
| 8 | 92 | 61 | 0.663 | 145.7 | 97.6 | 0.670 | 0.5 | 4.8 | 0.19 | 0.88 |
| 9 | 96.1 | 65 | 0.676 | 152.3 | 100.2 | 0.658 | 0.6 | 5.6 | 0.22 | 0.87 |
| 10 | 92.9 | 60.7 | 0.653 | 146.8 | 95.6 | 0.651 | 0.4 | 4.3 | 0.16 | 0.87 |
| 11 | 92.9 | 60.7 | 0.653 | 146.8 | 95.6 | 0.651 | 0.4 | 5.0 | 0.16 | 0.85 |
| 12 | 92.9 | 60.7 | 0.653 | 146.8 | 95.6 | 0.651 | 0.4 | 3.4 | 0.16 | 0.90 |

In the table, X represents the total amount (mass %) of the compounds having the structures represented by Structural Formulas (5) to (7) based on the solid content in the coating liquid for forming a resin layer.

The impedance value indicates the minimum value of the impedance value at a frequency of 1.0×10⁰ Hz to 1.0×10¹ Hz.

### Comparative Examples 13 to 15

In Comparative Examples 13 to 15, the developing power supply E2, the blade power supply E5, and the supply roller power supply E6 were changed from those in Comparative Examples 1 to 12, and evaluation was performed. Table 22 shows the cartridge Nos. used in Comparative Example 1 and Comparative Examples 13 to 15, the power supply conditions at that time, and the evaluation results thereof.

TABLE 22

| | | | | Supply | | | | |
|---|---|---|---|---|---|---|---|---|
| | | Developing | Blade | roller | | Fogging | | |
| | Process | power | power | power | Initial | evaluation | Image | |
| Comparative | cartridge | supply | supply | supply | fogging | after | density | Aspect |
| Example | No. | E2 [−V] | E5 [−V] | E6 [−V] | evaluation | printing | stability | ratio |
| 1 | P-45 | 300 | 400 | 300 | 0.4 | 3.8 | 0.16 | 0.89 |
| 13 | P-45 | 300 | 400 | 400 | 0.4 | 3.7 | 0.17 | 0.88 |
| 14 | P-45 | 300 | 500 | 400 | 0.4 | 3.6 | 0.17 | 0.88 |
| 15 | P-45 | 300 | 400 | 500 | 0.4 | 3.5 | 0.18 | 0.88 |

Examples 1 to 47 show favorable results in the fogging evaluation, the image density stability evaluation, and the toner shape irregularity ratio evaluation.

The numerical values of the fogging evaluation results after printing are all 3.0 or less, indicating favorable results. The favorable fogging is considered to be due to sufficient triboelectric charging of the toner with desired impedance characteristics. In addition, the aspect ratio, which is an index of the toner shape irregularity ratio evaluation, is 0.90 or more, and the irregular-shaped toner ratio also shows excellent results. This is considered to be due to the structural formula of the developing roller, and in the developing roller having a desired structural formula, it is considered that since triboelectric charging can be performed even for an irregular-shaped toner that is not spherical but is less likely to be triboelectrically charged, toner consumption by development can be performed, and therefore, the sphericity (aspect ratio) of the toner remaining after printing is maintained at a high level.

In addition, in particular, it is preferable to use a polyurethane having only a polycarbonate structure and having a combination of Structural Formula (1) and Structural Formula (4). Since an ester structure is present in Structural Formula (2) and Structural Formula (3), and the ester structure is more electrically conductive than the polycarbonate structure, it is considered that the combination of Structural Formula (1) and Structural Formula (4) having only the polycarbonate structure shows favorable results.

Furthermore, Example 47 shows favorable results in fogging and aspect ratio. This is considered to be because the Rz of the developing roller is smaller than the average particle diameter of the toner, thereby enabling more effective rubbing of the toner.

In addition, in Examples 48 and 49 in which the output of the power supply voltage was changed, favorable results are shown in the fogging evaluation, the image density stability evaluation, and the toner shape irregularity ratio evaluation as in Examples 1 to 47.

In Example 48, with respect to the developing roller voltage, which is the output of the developing power supply E2, a supply roller voltage, which is the output of the supply roller power supply E6, is applied at a voltage of the same polarity as the toner but with a greater absolute value (the potential difference of the supply roller is set). This is considered to be because, when the toner is supplied from the supply roller to the developing roller, the triboelectric charge can be applied more than when the same voltage as that of the developing roller is applied. The effect of the triboelectric charging is due to the desired impedance characteristics, and the toner charged by triboelectric charging from the supply roller passes through the developing blade and easily contributes to development because adhesion to the developing roller acts. As a result, the non-spherical toner also easily contributes to development, and thus, it is considered that the fogging and the aspect ratio after printing showed favorable results.

In Example 49, favorable results were obtained in the fogging evaluation after printing. This is considered to be because the developing blade voltage, which is the output of the blade power supply E5, was set to have a greater absolute value compared to Example 48 with respect to the developing roller voltage. It is considered that by increasing the absolute value of the blade voltage, the triboelectric charge imparting property was further enhanced, and by setting the impedance to a desired impedance, charge leakage (decrease in triboelectric charge) from the toner was suppressed, resulting in further suppression of fogging.

In Example 50, although the same process cartridge as in Examples 1 and Examples 48 and 49 was used, the results of the initial fogging evaluation and the post-printing fogging evaluation were somewhat inferior. This is considered to be because the absolute value of the supply roller voltage is greater than that of the blade voltage. This is considered to be because the amount of charge imparted to the toner supplied from the supply roller to the developing roller becomes large (so-called toner charge-up). The toner on the developing roller, which is charged up at the supply roller portion, is more likely to exhibit uneven triboelectric charging (broader triboelectric charge distribution) when it is further charged upon contact with the developing blade, thereby increasing the proportion of toner with insufficient charge. As a result, it is considered that fogging is likely to occur.

On the other hand, in Comparative Examples 1 to 15, favorable results were not obtained in the fogging evaluation after printing, the image density uniformity evaluation, and the toner shape irregularity ratio evaluation.

The results of the respective comparative examples are considered to be due to the following causes.

In Comparative Example 1, a polyether diol and a polycarbonate diol are used, and both an ether structure and a polycarbonate structure are incorporated in a polyurethane structure. As a result, it is considered that electrical characteristics due to the polycarbonate structure are inhibited by the ether structure, and a desired impedance value cannot be obtained. Therefore, it is considered that favorable results were not obtained.

In Comparative Examples 2 and 3, desired impedance values were also not obtained, and favorable results were not obtained. It is considered that the reason why the impedance value was decreased is that carbon black having a greater number average diameter of primary particles and a greater DBP absorption was used, the structure of the carbon black after milling dispersion was increased, the dispersion particle diameter was increased, and the wall-to-wall distance was also increased.

In Comparative Example 4, a desired impedance value was also not obtained, and favorable results were not obtained. It is considered that the impedance value decreased because the amount of additive was small, the dispersibility of the conductive filler became insufficient, and a conductive path formed by the conductive filler was formed in the surface layer.

In Comparative Example 5, the surface potential was too high, and therefore, favorable results were not obtained in the fogging evaluation and the image density stability evaluation. It is considered that this result occurred because the carbon black was coated with an insulating silane coupling agent, which caused an increase in surface potential.

In Comparative Example 6, the impedance decreased, and the results of the fogging evaluation and the image density stability evaluation became poor. It is considered that the reason for the decrease in impedance is that although a polymer dispersant suitable for dispersing carbon black was used, the dispersibility of the carbon black in the resin was not improved, and furthermore, since a large amount of dispersant was added, the electrical characteristics of the resin were affected.

In Comparative Examples 7 to 9, the impedance decreased, and the results of the fogging evaluation and the image density stability evaluation became poor. It is considered that the reason for the decrease in impedance is that the carbon chains R51, R61, and R71 of Structural Formulas (5), (6), and (7), which were used in Comparative Examples 7 to 9, exceeded the desired ranges, resulting in reduced dispersibility of the carbon black and a decrease in impedance.

In Comparative Examples 10 and 11, since the maximum height roughness Rz of the surface of the developing roller was greater than the toner average particle diameter, the results were worse than those in Comparative Example 1. This is considered to be because the triboelectric charging performance of the toner between the developing roller and the developing blade was reduced.

In Comparative Example 12, since the roughness was small, the fogging and toner shape irregularity ratio showed favorable results compared to Comparative Example 1; however, since a desired impedance was not be obtained, the image density stability was worse than in the examples.

In Comparative Examples 13 to 15, the developing roller voltage and the supply roller voltage were set to greater absolute values compared to Comparative Example 1, but the fogging evaluation after printing and the aspect ratio evaluation results were not favorable. This is considered to be because the impedance of the developing roller was not within the desired range, and therefore, triboelectric charging was not performed effectively.

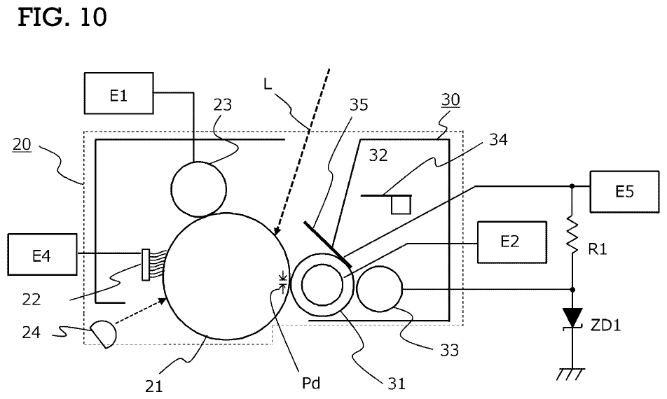

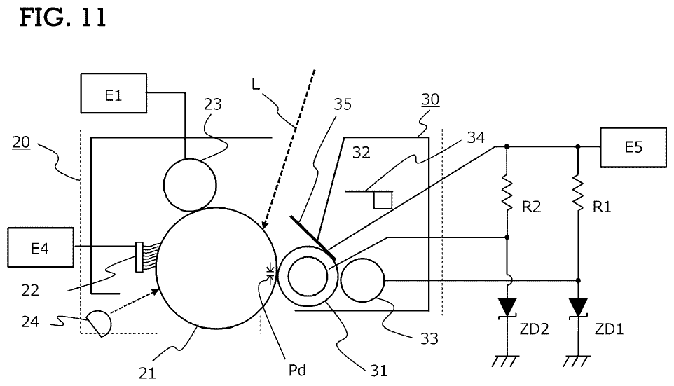

Note that, in order to set the absolute value of the supply roller voltage smaller than that of the blade voltage as in Examples 1 to 47 and Example 49, as illustrated in FIG. 2, it is generally controlled in a configuration in which voltages are applied to the developing roller, the developing blade, and the supply roller, respectively. However, a configuration as illustrated in FIG. 10 or FIG. 11 may also be used.

In the circuit configuration of FIG. 10, −300 V is applied to the developing roller 31 by the developing power supply E2. For example, −400 to −600 V can be variably applied to the blade power supply E5. A Zener diode ZD1 and a resistor R1 are connected to the supply roller 33. When an element with a Zener voltage of 400 V is connected, a voltage of −400 V is applied to the supply roller even when a variable voltage is supplied to the blade power supply E5. The resistor R1 is several to several tens of MΩ.

In addition, in the circuit configuration of FIG. 11, −400 to −600 V are variably applied to the blade power supply E5. Similarly to FIG. 10, a Zener diode ZD1 and a resistor R1 are connected to the supply roller 33 from the blade power supply E5, and a voltage of −400 V is applied. Furthermore, a Zener diode ZD2 and a resistor R2 are connected to the developing roller 31 from the blade power supply E5. When the Zener voltage of Zener diode ZD2 is 300 V, even if a variable voltage is supplied to the blade power supply E5, a voltage of −400 V is applied to the supply roller and a voltage of −300 V is applied to the developing roller. Note that the resistor R2, like the resistor R1, is also a resistive element having a resistance of several to several tens of MΩ.

Hereinafter, preferred examples of the present disclosure will be exemplarily described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

In the present disclosure, the description “XX or more and YY or less” or “XX to YY” representing a numerical range means a numerical range including a lower limit and an upper limit which are endpoints, unless otherwise specified. When the numerical ranges are listed in stages, the upper limit and the lower limit of each numerical range can be combined as appropriate. In addition, in the present disclosure, the description such as “at least one selected from the group consisting of XX, YY and ZZ” means any of XX, YY, ZZ, a combination of XX and YY, a combination of XX and ZZ, a combination of YY and ZZ, or a combination of XX and YY and ZZ.

The present inventors consider details of solving the problem by the methods described above as follows.

First, the present inventors presumed the following reason why it was not possible to sufficiently prevent a decrease in the photosensitive drum potential in the developing region when the developing roller according to Japanese Patent Laid-Open No. 2017-191316 was mounted in the process cartridge.

In the developing roller according to Japanese Patent Laid-Open No. 2017-191316, a specific structure having a polycarbonate structure is introduced into polyurethane in order to increase the resistance of the surface layer. On the other hand, while the hardness of the surface layer is increased due to the introduction of the specific structure having the polycarbonate structure, a specific structure having an oxyalkylene structure is introduced.

The present inventors presumed that the oxyalkylene structure caused charge leakage from the photosensitive drum. That is, it was considered that the oxyalkylene structure promotes the movement of charge in the polyurethane. Therefore, the present inventors have considered a combination of a developing roller in which a surface layer is formed using a polyurethane having only a polycarbonate structure (hereinafter, referred to as polycarbonate urethane), obtained by removing the specific structure having the oxyalkylene structure from the polyurethane of Japanese Patent Laid-Open No. 2017-191316, with a developing blade to which a high voltage is applied.

As a result, although the charge leakage from the photosensitive drum to the developing roller can be prevented, the electrical resistance of the surface layer becomes too high, such that the surface of the developing roller is excessively charged at the time of continuous printing, the potential difference between the photosensitive drum and the developing roller becomes small, and a new problem arises in that a part of the toner is unintentionally deposited on a non-exposed area, which is a so-called ground fogging phenomenon.

Therefore, the present inventors have studied removal of excess charge from an excessively charged developing roller. For example, as a result of examining inclusion of a conductive filler in the surface layer, the present inventors have found a new issue that it is difficult to sufficiently disperse the conductive filler in polycarbonate urethane that does not have an oxyalkylene structure. When the dispersibility of the conductive filler is insufficient, a conductive path formed by the conductive filler in the surface layer may cause charge leakage, or conversely, the expected effect of removing excess charge by the conductive filler may be insufficient.

That is, the present inventors have recognized that it is necessary to develop a novel surface layer capable of removing excess charge while maintaining a high electrical resistance of the surface layer in order to solve the contradictory problems such as prevention of charge leakage from the photosensitive drum in the surface layer containing polycarbonate urethane and suppression of ground fogging caused by overcharge of the surface layer of the developing roller at a high level. Based on such recognition, the present inventors have further studied.

As a result, the present inventors have recognized that, for a developing roller including a substrate having a conductive outer surface and a resin layer containing a polyurethane having a polycarbonate structure, the resin layer being provided on the outer surface of the substrate, it is effective to satisfy the following three requirements in order to solve the above two conflicting problems at a high level.

### Requirement (1)

A metal film is directly provided on an outer surface of a developer carrying member, and in an environment of a temperature of 23° C. and a relative humidity of 50%, a DC voltage of 50 V is applied between the outer surface of the substrate and the metal film, while an AC voltage having an amplitude of 50 V is applied with a frequency varied in a range of 1.0×10⁻¹ to 1.0×10⁵ Hz. At this time, the impedance at the frequency of 1.0×10⁰ to 1.0×10¹ Hz is 1.00×10⁶Ω or more.

### Requirement (2)

In an environment of a temperature of 23° C. and a relative humidity of 50%, a corona discharger having a grid portion having a width of 3.0 mm is disposed so that a distance between the grid portion and the outer surface of the developer carrying member is 1.0 mm, and a direction of the width of the grid coincides with an axial direction of the developer carrying member. Then, a voltage of 8 kV is applied to the grid portion, the corona discharger is relatively moved at a speed of 400 mm/sec along the axial direction of the developer carrying member to charge the outer surface of the developer carrying member, and a potential of the outer surface after 0.06 seconds from the passage of the grid is measured. The maximum value of the potential at this time is less than 20.0 V.

### Requirement (3)

In the surface shape of the outer surface of the developer carrying member, the maximum height roughness Rz of the roughness profile is greater than the volume average particle diameter of the developer.

Hereinafter, the requirements (1) to (3) will be described in detail.

### <Technical Significance of Requirement (1)>

In the requirement (1), a numerical value of the impedance of the developer carrying member is defined. The impedance is a physical property value indicating charge leakage from the image carrying member to the developer carrying member.

In considering charge leakage, it is necessary to take into account not only the resistance component of the developer carrying member, but also the influence of the capacitance component. This is considered to be because when the electrical characteristics of the developer carrying member are represented in a pseudo manner by an RC parallel circuit, charge is sufficiently stored in a capacitor component, and a transient state until reaching a steady state in which the resistance component is dominant greatly affects charge leakage.

The voltage application condition for impedance measurement is obtained by superimposing an AC voltage of 50 V on a DC voltage of 50 V. That is, a sine wave having a minimum value and a maximum value of the applied voltage of 0 V and 100 V (Vpp 100 V), respectively, is applied.

The impedance exhibits bias dependence and has a property that the impedance decreases as the bias increases. In the conventional impedance measurement of the developer carrying member, the condition that the voltage application condition is the AC voltage of 1 V is generally used, but under the application condition of the AC voltage of 1 V, the voltage application condition is clearly smaller than the potential difference (generally several hundred V) at the developing region where the image carrying member and the developer carrying member are brought into contact with each other in the actual electrophotographic image forming apparatus. Therefore, since there is a case where the behavior in the developing region in the electrophotographic image forming apparatus cannot be simulated, Vpp 100 V closer to the actual potential difference in the developing region is adopted.

In the present disclosure, the impedance at the frequency of 1.0×10⁰ to 1.0×10¹ Hz is specified, and a low frequency range of the frequency of 1.0×10⁰ to 1.0×10¹ Hz is a region where the transient state is completed and a steady state in which the resistance component is dominant is reached. That is, the influence of both the electrostatic capacitance component and the resistance component is reflected, and the region is suitable for grasping the charge leakage property from the image carrying member to the developer carrying member. When the impedance at the frequency of 1.0×10⁰ to 1.0×10¹ Hz is 1.00×10⁶Ω or more, the charge leakage is low, the charge leakage from the image carrying member to the developer carrying member is suppressed in the developing region, and a decrease in the potential of the image carrying member can be prevented. As a result, image density unevenness and ground fogging can be suppressed, and excellent image stability can be obtained.

The impedance at the frequency of 1.0×10⁰ to 1.0×10¹ Hz is preferably 1.40×10⁶Ω or more. The impedance value is preferably as high as possible. Although an upper limit of the impedance value is not particularly limited, the upper limit may be, for example, 5.00×10⁷Ω or less.

In addition, the minimum value of the impedance at the frequency of 1.0×10⁰ to 1.0×10¹ Hz is preferably 1.40×10⁶Ω or more, more preferably 2.00×10⁶Ω or more, particularly preferably 3.00×10⁶Ω or more, and still more preferably 5.00×10⁶Ω or more. A preferred range of the impedance is 1.00×10⁶Ω or more and 5.00×10⁷Ω or less, preferably 1.40×10⁶Ω or more and 5.00×10⁷Ω or less, more preferably 2.00×10⁶Ω or more and 5.00×10⁷Ω or less, particularly preferably 3.00×10⁶Ω or more and 5.00×10⁷Ω or less, and still more preferably 5.00×10⁶Ω or more and 5.00×10⁷Ω or less.

### <Technical Significance of Requirement (2)>

In the requirement (2), the surface potential of the developer carrying member is defined. The surface potential of the developer carrying member indicates a residual charge on the surface of the developer carrying member, and is a physical property value indicating a degree of excessive charging (charge-up) of the surface of the developer carrying member. When the continuous printing operation is continued, a developer carrying member having a high degree of excessive charging may cause charge transfer from the image carrying member to the developer carrying member, resulting in a decrease in the potential of the image carrying member, while the surface potential of the developer carrying member gradually increases, and as a result, the potential difference (back contrast) between the image carrying member and the developer carrying member decreases, which may cause unintended toner adhesion to the non-exposed area (ground fogging).

At this time, since the charge tends to remain on the surface of the developer carrying member, it becomes difficult to appropriately remove the toner charge to the developer carrying member, the potential formed by the toner layer on the surface of the developer carrying member increases, the actual back contrast further decreases, and the ground fogging is more likely to occur.

In the present disclosure, when a voltage of 8 kV is applied to the grid portion and the corona discharger is relatively moved at a speed of 400 mm/sec along the axial direction of the developer carrying member, the potential of the outer surface of the developer carrying member is checked 0.06 seconds after the outer surface passes through the grid portion of the corona discharger. When the maximum value of the potential of the outer surface is less than 20.0 V, it is possible to suppress the occurrence of ground fogging caused by overcharge of the surface of the developer carrying member even when printing is continuously performed. Note that a time of 0.06 seconds after passing through the grid portion of the corona discharger simulates the time for one rotation of the developer carrying member.

The maximum value of the potential of the outer surface is preferably 15.0 V or less, and more preferably 10.0 V or less. The maximum value of the potential of the outer surface is preferably as low as possible. A lower limit of the maximum value is not particularly limited.

As a preferred range of the maximum value of the potential of the outer surface, for example, 0 V or more and less than 20.0 V, particularly, 0 V or more and 15.0 V or less, and further, 0 V or more and 10.0 V or less are preferable.

### <Technical Significance of Requirement (3)>

In the requirement (3), the surface shape of the developer carrying member is defined. In the roughness profile of the outer surface of the developer carrying member, the definition that the maximum height roughness Rz is greater than the volume average particle diameter of the toner represents a state in which at least a part of the outer surface of the developer carrying member protrudes from the toner layer in the developing region.

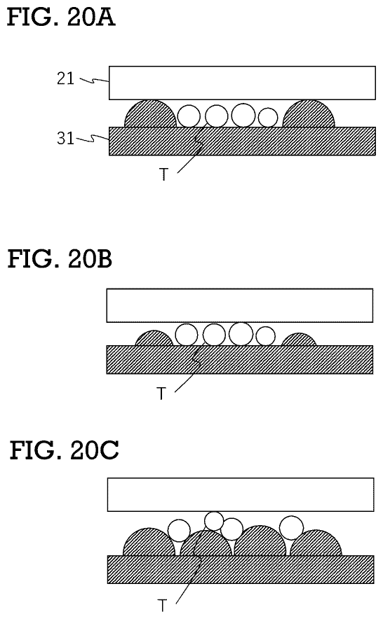

FIGS. 20A to 20C are schematic views illustrating an interposed state of the image carrying member, the developer carrying member, and the toner T in the developing region of a contact development method. In the developing region, the image carrying member and the developer carrying member are in direct contact with each other at a convex portion of the developer carrying member, and are in contact with each other via the toner. When the charge imparted from the image carrying member to the toner in the developing region becomes excessive, the decrease in the potential of the image carrying member may become large even when the requirements (1) and (2) are satisfied. As an example, such a phenomenon is likely to occur in a case where the toner in the developing region is not saturated and charged, and charge transfer from the image carrying member to the toner easily occurs at a contact portion between the image carrying member and the toner. This is more remarkable when the back contrast, which is the difference between the potential of the image carrying member and the applied voltage to the developer carrying member, is large, or when the difference in surface speed between the developer carrying member and the image carrying member is large.

Therefore, in order to prevent a decrease in potential of the surface of the image carrying member, as illustrated in FIG. 20A, it is necessary that the apex of the convex portion of the surface irregularity of the developer carrying member protrudes from the toner layer in the developing region. At this time, the protruding portion of the surface of the developer carrying member from the toner layer is brought into contact with the surface of the photosensitive drum, and the contact load is supported. As a result, contact between the toner and the image carrying member is not excessive, and therefore, excessive charge transfer from the image carrying member to the toner layer is suppressed.

On the other hand, as illustrated in FIG. 20B, in a case where the apex of the convex portion of the surface irregularity of the developer carrying member does not protrude from the toner layer in the developing region, the charge transfer from the image carrying member to the toner layer increases, and the surface potential of the image carrying member may decrease largely.

By satisfying the requirements (1) to (3), it is possible to solve the contradictory problems such as prevention of charge leakage from the image carrying member to the developer carrying member and suppression of excessive charging of the outer surface of the developer carrying member at a high level. As a result, image density unevenness and fogging can be suppressed, and excellent image stability can be obtained.

There are no particular limitations on the methods for satisfying the requirements (1) and (2). Specifically, as will be described below, examples thereof include methods for improving the dispersibility of the conductive filler by using the following resin layer materials, conductive filler materials, and additives. In addition, there are no particular limitations on the methods for satisfying the requirement (3). Specifically, as will be described below, appropriate mixing of coarse particles into the resin layer of the developer carrying member can be employed.

### Example 1

### 1. Image Forming Apparatus

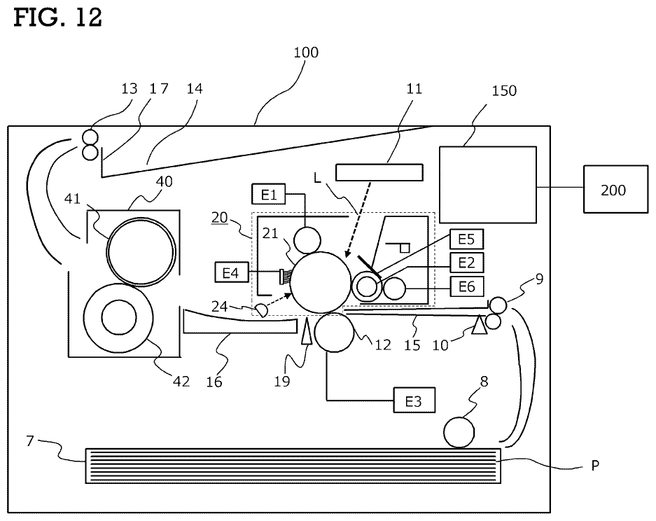

FIG. 12 is a schematic view of an image forming apparatus 100 of the present example. The image forming apparatus 100 of the present example is an electrophotographic laser printer, and can form an image on a recording material P (transfer material) according to image information input from an external device 200 such as a personal computer. Examples of the recording material P include various sheet materials of different materials, for example, paper such as plain paper or cardboard, a plastic film such as a sheet for an overhead projector, a sheet having a special shape such as an envelope and index paper, and cloth. First, the configuration of the image forming apparatus 100 of the present example will be described.

The image forming apparatus 100 includes a scanner unit 11, an electrophotographic process cartridge 20, and an image forming unit including a transfer roller 12 that transfers a toner image (developer image) formed on a photosensitive drum 21 in the process cartridge 20 to a recording material P. The image forming apparatus 100 also includes a recording material feeding unit that conveys the recording material P to the transfer unit together with the operation of the image forming unit, a fixing device 40 that fixes the toner image formed on the recording material in the transfer unit onto the recording material, and a control unit 150 that controls the operation of the image forming apparatus.

When an image forming command is input to the image forming apparatus 100, an image forming process by the image forming unit is started on the basis of image information input from an external device 200 such as a personal computer connected to the image forming apparatus 100.

The control unit 150 is a controller that integrally controls the operation of the image forming apparatus 100. The control unit 150 executes a predetermined image forming sequence by controlling transmission and reception of various electrical information signals, drive timing, and the like. Each unit of the image forming apparatus 100 is connected to the control unit 150. For example, in relation to the present example, a charging power supply E1, a developing power supply E2, a transfer power supply E3, a brush power supply E4, a blade power supply E5, a supply roller power supply E6, a scanner unit 11 (exposure unit), a power supply of a fixing device, a drive motor, and the like are connected to the control unit 150.

### Image Forming Unit

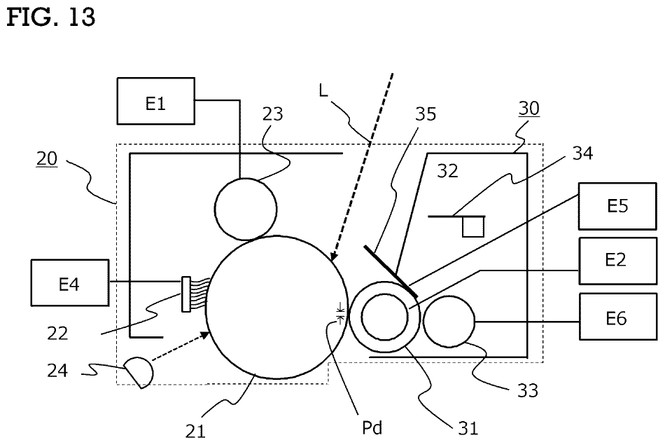

As illustrated in FIG. 13, the process cartridge 20 includes a developing device 30. The developing device 30 includes a developing roller 31 serving as a developer carrying member that carries a developer, a developing container 32 that serves as a frame of the developing device 30, a supply roller 33 that can supply a developer to the developing roller 31, a stirring member 34 that stirs toner in the developing container 32, and a developing blade 35 that uniformizes a toner layer on the developing roller 31. The developing roller 31, the supply roller 33, and the stirring member 34 are rotatably supported by the developing container 32. In addition, the developing roller 31 is disposed in an opening of the developing container 32 so as to face the photosensitive drum 21 serving as an image carrying member. The supply roller 33 is rotatably brought into contact with the developing roller 31, and the toner as the developer stored in the developing container 32 is applied to a surface of the developing roller 31 by the supply roller 33.

The stirring member 34 as a stirrer is provided inside the developing container 32. The stirring member 34 is driven to rotate, thereby stirring the toner in the developing container 32 and feeding the toner toward the developing roller 31 and the supply roller 33. In addition, the stirring member 34 has a role of circulating the toner not used for development but peeled off from the developing roller 31 in the developing container and evening the toner in the developing container.

In addition, the developing blade 35 formed of a stainless steel plate that regulates the amount of toner carried on the developing roller 31 is disposed in the opening of the developing container 32 in which the developing roller 31 is disposed.

The developer supplied to the surface of the developing roller 31 passes through a portion facing the developing blade 35 with the rotation of the developing roller 31, such that the developer is uniformly thinned and has a charge amount suitable for image formation.

The developing device 30 of the present example uses a contact development method as a developing method. That is, the toner layer carried on the developing roller 31 is brought into contact with the photosensitive drum 21 in developing region (developing area Pd) where the photosensitive drum 21 and the developing roller 31 face each other. A developing voltage is applied to the developing roller 31 by a developing power supply E2 as a developing voltage application unit. A blade voltage is applied to the developing blade 35 by the blade power supply E5 which serves as a developing blade voltage application unit. In addition, a supply voltage is applied to the supply roller 33 by the supply roller power supply E6 which serves as a supply voltage application unit. As a result, the charge amount of the developer and the thickness of the developer layer can be controlled to a state suitable for image formation. A common supply source can be used for these voltage application units as necessary.

The toner carried on the developing roller 31 is transferred from the developing roller 31 to a surface of the photosensitive drum 21 in accordance with the potential distribution on the surface of the photosensitive drum 21, such that the electrostatic latent image is developed into a toner image. In the present example, −300 V is applied to the developing power supply E2, and the surface of the developing roller 31 is at −300 V. −400 V is applied to the blade power supply E5, and −300 V is applied to the supply roller power supply E6. In addition, a reversal development method is adopted in which a drum surface potential is uniformly charged to −500 V by a charging unit to be described below, the drum surface potential is attenuated through exposure by a scanner unit to be described below in the printing unit, and then, negatively charged toner adheres to an exposed area.

A back contrast Vback, which is the absolute value of the potential difference between the surface of the photosensitive drum 21 of a non-exposed area Vd and the developing roller 31 before passing through the developing area, is 200 V.

In the present example, the surface of the photosensitive drum 21 rotates at a speed of 150 mm/sec, and a difference between the surface speed of the developing roller 31 and the surface speed of the photosensitive drum 21 (hereinafter, referred to as a development peripheral speed difference) is 40%. That is, the developing roller 31 rotates at 150×1.4=210 mm/sec. As a result, the photosensitive drum 21 and the developing roller 31 are brought into contact with each other with a speed difference of 60 mm/sec.

In addition, in the present example, toner having a volume average particle diameter of 6.5 μm and a normal charge polarity that is negative is used. As the toner, for example, a polymerized toner generated by a polymerization method is employed. The toner does not contain a magnetic component, and is a so-called non-magnetic single-component developer in which the toner is mainly carried on the developing roller 31 by an intermolecular force or electrostatic force (image force). The volume average particle diameter of the toner can be measured by, for example, the Coulter method.

In the present example, although a non-magnetic single-component developer is used as an example, a single-component developer containing a magnetic component may be used.

The photosensitive drum 21 is a photosensitive member formed into a cylindrical shape. The photosensitive drum 21 as an image carrying member is rotationally driven at a predetermined process speed in a predetermined direction (clockwise direction in FIGS. 12 and 13) by a motor (not illustrated).

A paper dust collection brush 22 and a charging roller 23 are in contact with the photosensitive drum 21 with a predetermined pressing force. An arbitrary charging roller voltage is applied to the charging roller 23 from the charging power supply E1 to uniformly charge the surface of the photosensitive drum 21 to a predetermined potential. In the present example, the drum surface potential is charged to −500 V by the charging roller 23. In addition, by equalizing the drum surface potential after the transfer using a pre-exposure device 24 in advance, the drum surface potential can be made more uniform when the photosensitive drum is charged by the charging roller 23.

An arbitrary brush voltage is applied to the paper dust collection brush 22 from the brush power supply E4, and paper fibers and paper dust detached from the recording material P and attached to the photosensitive drum are collected. As a result, it is possible to prevent paper fibers and paper dust from interfering with the charging of the photosensitive drum when passing through the charging unit.

The scanner unit 11 as an exposure unit scans and exposes the surface of the photosensitive drum 21 by irradiating the photosensitive drum 21 with a laser beam L corresponding to image information input from an external device using a polygon mirror. By this exposure, an electrostatic latent image corresponding to image information is formed on the surface of the photosensitive drum 21. Note that the scanner unit 11 is not limited to a laser scanner device, and for example, an LED exposure device having an LED array in which a plurality of LEDs are arranged along a longitudinal direction of the photosensitive drum 21 may be adopted. In the present example, a drum surface potential in a solid black portion attenuates to a potential of −50 V in the exposed area V1 due to laser exposure by the scanner unit 11.

### Recovery of Transfer Residual Toner

In the present example, a so-called cleaner-less configuration is adopted in which transfer residual toner remaining on the photosensitive drum 21 without being transferred to the recording material P is recovered to the developing device 30 and reused. The transfer residual toner is reused in the following steps. The transfer residual toner includes a mixture of toner charged with a positive polarity, which is opposite to the normal polarity in the present example, and toner charged with a negative polarity but lacking a sufficient amount of charge.

By charging these toners to the normal polarity again when passing through the paper dust collection brush 22 and before reaching the contact portion between the charging roller 23 and the photosensitive drum 21, the transfer residual toner is not attached to the charging roller 23 and is along conveyed with the rotation of the photosensitive drum 21. As a result, the charging roller 23 can maintain excellent chargeability.

The transfer residual toner adhering to the surface of the photosensitive drum 21 that has passed through the contact portion with the paper dust collection brush 22 and the contact portion with the charging roller 23 reaches the developing region Pd with the rotation of the photosensitive drum 21. Here, the behavior of the transfer residual toner that has reached the developing region will be described separately for the exposed area and the non-exposed area of the photosensitive drum 21. In the non-exposed area of the photosensitive drum 21, that is, a dark potential portion Vd, the surface potential of the photosensitive drum 21 is greater on the negative polarity side than the developing voltage applied to the developing roller 31. Therefore, the transfer residual toner having a sufficient negative charge moves to the developing roller 31 by Coulomb force due to the electric field and is recovered into the developing container 32. Here, the dark potential portion Vd of the photosensitive drum 21 is not limited to the non-exposed area, and weak exposure may be performed when the surface potential of the photosensitive drum 21 is greater on the negative polarity side than the developing voltage applied to the developing roller 31. An appropriate Vback can be set by weak exposure.

The toner recovered in the developing container 32 is stirred with and dispersed in the toner in the developing container 32 by the stirring member 34, and is carried by the developing roller 31 to be used again in the developing process.

On the other hand, in an exposed area V1 of the photosensitive drum 21, since the surface potential of the photosensitive drum 21 is smaller on the negative polarity side than the developing voltage applied to the developing roller 31, the transfer residual toner remains on the surface of the photosensitive drum 21 without being transferred from the photosensitive drum 21 to the developing roller 31 in the developing region. The transfer residual toner remaining on the surface of the photosensitive drum 21 is carried on the photosensitive drum 21 together with other toner transferred from the developing roller 31 to the exposed area, moves to the transfer unit, and is transferred to the recording material P in the transfer unit.

Note that, in the present example, although the technique is disclosed by taking the cleaner-less configuration as an example, the present disclosure is not limited thereto, and a configuration in which a cleaning member of a photosensitive drum is further provided may be used.

### Recording Material Feeding Unit

In parallel with the image forming process described above, the recording material P stored in a paper tray 7 serving as a recording material storage unit is fed in synchronization with the transfer timing of the toner image. Describing the conveying process of the recording material P, first, a paper feed roller 8 feeds the recording material P stored in the paper tray 7. Next, the recording material P is fed to a pair of conveying rollers 9 by the paper feed roller 8, and abuts against the nip of the pair of conveying rollers 9 to correct skew. Then, the pair of conveying rollers 9 is driven in synchronization with the transfer timing of the toner image on the basis of the detection result of the leading end in the conveyance direction of the recording material P by a top sensor 10 as the recording material detector, and conveys the recording material P toward a transfer nip formed by the transfer roller 12 and the photosensitive drum 21 along a conveyance guide 15.

An electric field in a direction in which regularly-charged toner moves from the photosensitive drum to the transfer roller at the transfer nip is formed on the transfer roller 12 by the transfer power supply E3. When the recording material P is conveyed to the transfer nip in synchronization with the image forming timing, the toner image formed on the photosensitive drum 21 is transferred to the recording material P.

The excess charge on the surface of the recording material P to which the toner image is transferred is removed by a discharging needle 19. The recording material P that has passed through the discharging needle 19 is conveyed along a transfer-to-fixing transport guide 16 as a guide member.

### Fixing Unit

The recording material P conveyed along the transfer-to-fixing transport guide 16 is conveyed to the fixing device 40. The fixing device 40 includes a fixing film 41, a fixing heater such as a ceramic heater that heats the fixing film 41, a thermistor that measures a temperature of the fixing heater, and a pressure roller 42 that comes into pressure contact with the fixing film 41. When the recording material P passes between the fixing film 41 and the pressure roller 42, the toner on the recording material P is heated and pressurized and fixed to the recording material P.

The recording material P that has passed through the fixing device 40 is discharged to the outside of the image forming apparatus 100 by a discharge roller pair 13, and is stacked on a discharge tray 14. The discharge tray 14 is inclined upward toward the downstream side in the discharge direction of the recording material, and the recording material discharged to the discharge tray 14 slides down the discharge tray 14, such that a trailing end is aligned by a regulation surface 17.

Note that, in the present example, although the process cartridge 20 detachably attached to a main body of the image forming apparatus is used, the present disclosure is not limited thereto, and it is sufficient that a predetermined image forming process can be performed. For example, the process cartridge may be a developing cartridge to which the developing device 30 is detachable, a drum cartridge to which the drum unit is detachable, or a toner cartridge for externally supplying toner to the developing device 30, may have a configuration without a detachable cartridge.

In addition, in the present example, although the technique using a monochrome printer as an example is disclosed, the present disclosure can also be applied to a full-color printer including process cartridges for a plurality of colors and forming a full-color image on the recording material P.

### 2. Developing Roller

The developing roller 31 as a developer carrying member will be described below with reference to the drawings.

A developing roller according to at least one aspect of the present disclosure includes a conductive substrate and at least one resin layer provided on an outer peripheral surface of the substrate.

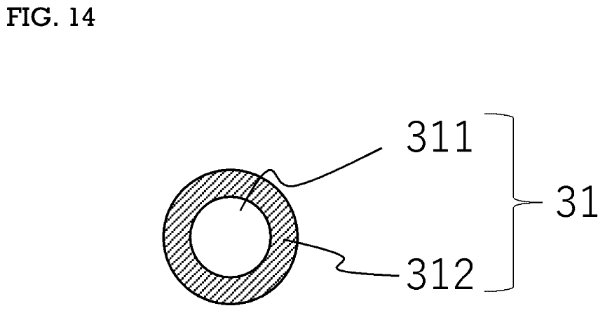

An example of the developing roller is illustrated in FIG. 14. In the developing roller 31 illustrated in the drawing, a resin layer 312 is laminated on an outer peripheral surface of a columnar or hollow cylindrical substrate 311. Note that the configuration of the layer of the developing roller is not limited to the form illustrated in the above drawing.

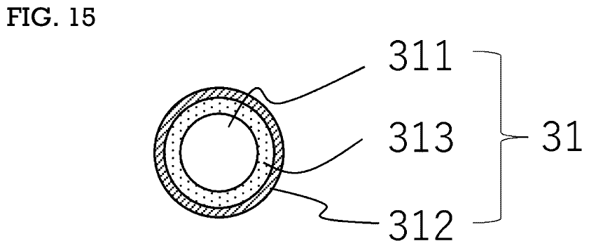

As another form of the developing roller, as illustrated in FIG. 15, an elastic layer 313 may be provided between the substrate 311 and the resin layer 312 provided on the outer peripheral surface thereof.

### [Substrate]

The substrate has a conductive outer surface, and functions as a support member of the developing roller and, in some cases, as an electrode. As a specific example of the substrate, a solid columnar shape or a hollow cylindrical shape is preferable.

The material constituting the substrate can be appropriately selected from materials known in the field of conductive members for electrophotography and materials that can be used as the developing roller. Examples thereof include metals represented by aluminum and stainless steel, carbon steel alloys, conductive synthetic resins, and metals or alloys such as iron and copper alloys.

Furthermore, the material constituting the substrate may be subjected to an oxidation treatment or a plating treatment with chromium, nickel, or the like. As the type of plating, either electroplating or electroless plating can be used. From the viewpoint of dimensional stability, electroless plating is preferable. Examples of the electroless plating used here include nickel plating, copper plating, gold plating, and various other alloy plating. A plating thickness is preferably 0.05 μm or more, and the plating thickness is preferably 0.1 to 30 μm in consideration of a balance between work efficiency and rust prevention capability.

A primer may be applied to the surface of the substrate in order to improve adhesiveness between the substrate and the resin layer. As the primer, a known primer can be selected and used according to the rubber material for forming the conductive layer, the material of the support, and the like. Examples of the material of the primer include a thermosetting resin and a thermoplastic resin, and specifically, materials such as a phenolic resin, polyurethane, an acrylic resin, a polyester resin, a polyether resin, and an epoxy resin can be used.

### [Resin Layer]

The developing roller has a resin layer provided on the outer surface of the substrate. For example, the resin layer is present on the outer surface of the developing roller. The resin layer may contain a binder resin. As the binder resin of the resin layer in the developing roller, a polyurethane having a polycarbonate structure is preferably used in order to suppress charge leakage from the photosensitive drum to the developing roller. That is, the resin layer contains a polyurethane having a polycarbonate structure. Furthermore, in order to sufficiently maintain abrasion resistance of the resin layer while suppressing charge leakage from the photosensitive drum to the developing roller, it is more preferable to use a polyurethane having a structure described below as the binder resin of the resin layer.

It is preferable that the resin layer contains a polyurethane having a polycarbonate structure, and the polyurethane satisfies at least two of the following (A), (B), and (C). All of the following (A), (B), and (C) may be satisfied:
(A) the polyurethane has a structure represented by the following Structural Formula (1) in a molecule;
(B) the polyurethane has, in a molecule, either or both of a structure represented by the following Structural Formula (2) and a structure represented by the following Structural Formula (3);
(C) the polyurethane has a structure represented by the following Structural Formula (4) in a molecule.

That is, the polyurethane preferably satisfies at least one of the following conditions.
The polyurethane has at least a structure represented by Structural Formula (1) and a structure represented by Structural Formula (2).
The polyurethane has at least a structure represented by Structural Formula (1) and a structure represented by Structural Formula (3).
The polyurethane has at least a structure represented by Structural Formula (1) and a structure represented by Structural Formula (4).
The polyurethane has at least a structure represented by Structural Formula (2) and a structure represented by Structural Formula (4).
The polyurethane has at least a structure represented by Structural Formula (3) and a structure represented by Structural Formula (4).

In particular, the polyurethane more preferably has at least the structure represented by Structural Formula (1) and the structure represented by Structural Formula (4) in the molecule from the viewpoint of excellent fogging suppression and image density stability.

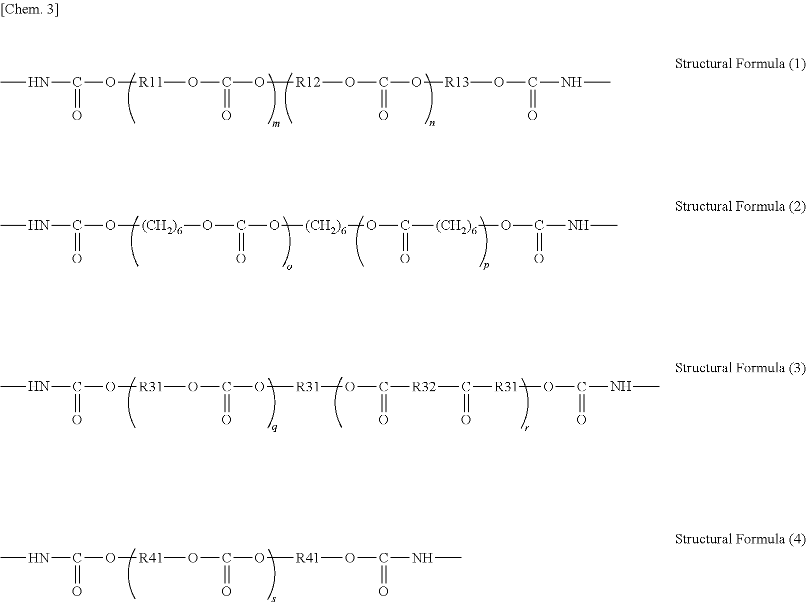

In Structural Formula (1), R11, R12, and R13 each represent a divalent hydrocarbon group having 3 to 9 carbon atoms. However, R11 and R12 are different from each other, and R13 is the same as at least one selected from the group consisting of R11 and R12. m and n are average numbers of added moles and each independently represent a number of 1.0 or more (preferably from 1.0 to 20.0, and more preferably from 2.0 to 12.0).

In Structural Formula (2), o and p are average numbers of added moles and each independently represent a number of 1.0 or more (preferably 1.0 to 15.0, and more preferably 4.0 to 10.0).

In Structural Formula (3), R31 and R32 each independently represent a divalent hydrocarbon group having 3 to 8 carbon atoms. q and r are average numbers of added moles and each independently represent a number of 1.0 or more (preferably from 1.0 to 20.0, and more preferably from 2.0 to 14.0).

In Structural Formula (4), R41 represents a divalent hydrocarbon group having 6 to 9 (preferably 5 to 8) carbon atoms. s is an average number of added moles and represents a number of 1.0 or more (preferably 1.0 to 22.0, and more preferably 4.0 to 18.0).

The structure represented by Structural Formula (1) is a structure obtained by reacting an isocyanate with a copolymerized polycarbonate polyol in which crystallinity is suppressed by linking two carbonate groups via two different hydrocarbon groups. Since the crystallinity is suppressed, the cohesive energy in the soft segment is low, and flexibility and a high volume resistivity can be imparted to the resin layer.

By using the structure of Structural Formula (1) in combination with the structures (2) to (4) described above for the resin layer, the adhesiveness of the resin layer can be reduced. Therefore, adhesion of toner, powder, or the like to the surface of the resin layer can be suppressed, an increase in the electrical resistance value of the surface of the resin layer due to contamination is suppressed, and uniform charging of the toner is easily performed.

In Structural Formula (1), R11 and R12 are each independently a divalent hydrocarbon group having 3 to 9 carbon atoms. R11 and R12 are different from each other, and R13 is the same as at least one selected from the group consisting of R11 and R12.

When the number of carbon atoms in R11 and R12 is 3 or more, in the polyurethane having a polycarbonate structure, the amount of carbonate groups which are polar functional groups and have strong cohesive energy is not excessively increased, and it becomes easier to maintain the resin layer in a flexible state and with a high electrical resistance.

In addition, when the number of carbon atoms in R11 and R12 is 9 or less, the amount of carbonate groups in the polyurethane is not excessively reduced, and the strength of the polymer can be maintained. In addition, since R11 and R12 have different structures, crystallinity of the polymer can be suppressed, and flexibility can be imparted to the resin layer. m and n each independently represent a number of 1.0 or more. The hydrocarbon groups represented by R11, R12, and R13 may have a branched structure or a cyclic structure.

The structures represented by Structural Formula (2) and Structural Formula (3) are structures obtained by reacting an isocyanate with a copolymerized polyol in which a polycarbonate structure and a polyester structure are copolymerized. The crystallinity of the polymer is suppressed by copolymerizing the polycarbonate structure and the polyester structure, and the soft segment is moderately reinforced by introducing an ester group having stronger cohesive energy than the carbonate group, such that abrasion resistance can be imparted to the resin layer.

When the resin layer is formed using a polymer in which the structure represented by Structural Formula (2) and/or Structural Formula (3) is combined with the structure of Formula (1) or (4) described above, a sufficient volume resistivity can be imparted to the resin layer while having an ester group having polarity, and charge leakage from the photosensitive drum to the developing roller is more easily suppressed.

In Structural Formula (2), o and p each independently represent a number of 1.0 or more.

In Structural Formula (3), R31 and R32 each independently represent a divalent hydrocarbon group having 3 to 8 carbon atoms, and q and r each independently represent a number of 1.0 or more. When the number of carbon atoms in each of R31 and R32 is 3 or more, the amount of the carbonate group and the ester group which are polar functional groups and have strong cohesive energy in the polyurethane is not excessively increased, and the flexibility of the resin layer can be maintained. In addition, when the number of carbon atoms in R31 and R32 are 8 or less, the amount of carbonate groups and ester groups in the polyurethane is not excessively reduced, and abrasion resistance can be imparted to the resin layer.

The structure represented by Structural Formula (4) is a structure obtained by reacting an isocyanate with a highly crystalline polycarbonate polyol in which two carbonate groups are linked via a single hydrocarbon group.

Since this structure has high crystallinity and is easily aligned in the soft segment, abrasion resistance and a high volume resistivity can be imparted to the resin layer. By forming the resin layer using a polymer in which the structure represented by Structural Formula (4) is combined with the structures of Formulas (1) to (3) described above, the hardness of the resin layer does not become excessively high and can be appropriately controlled with ease.

In Structural Formula (4), R41 represents a divalent hydrocarbon group having 6 to 9 carbon atoms, and s represents a number of 1.0 or more. When the number of carbon atoms in R41 is 6 or more, crystallinity is easily exhibited, and abrasion resistance and a high volume resistivity can be imparted to the resin layer. When the number of carbon numbers in R41 is 9 or less, excessive crystallinity can be suppressed, and therefore, by further incorporating at least one of the structures represented by Structural Formulas (1), (2), and (3) in the polymer, an increase in hardness of the resin layer can be suppressed.

The resin layer preferably contains a polymer having a urethane bond, that is, a polyurethane having a polycarbonate structure as a binder resin, and the polymer preferably satisfies at least two selected from the group consisting of (A), (B), and (C) described above. As a result, the resin layer becomes flexible and is less likely to wear.

The structure of the polymer contained in the resin layer of the developing roller can be confirmed by, for example, analysis by pyrolysis GC/MS, FT-IR, or NMR.

The polyurethane having a polycarbonate structure can be produced using (A) a polyol compound (A) and (B) a polyisocyanate compound (B). Usually, the following methods (1) and (2) are used for the synthesis of polyurethane:
(1) a one-shot method of mixing and reacting a polyol component and a polyisocyanate component; and
(2) a method of reacting an isocyanate-terminated prepolymer obtained by reacting a portion of the polyol with an isocyanate, with a chain extender such as a low-molecular-weight diol or a low-molecular-weight triol.

In the present disclosure, the polyurethane may be synthesized by any of the methods described above, but a method of thermally curing a hydroxyl-terminated prepolymer obtained by reacting a raw material polyol with isocyanate and an isocyanate-terminated prepolymer obtained by reacting a raw material polyol with isocyanate is more preferable.

The polyurethane having a polycarbonate structure is preferably a reaction product of a mixture containing a hydroxyl-terminated prepolymer and an isocyanate-terminated prepolymer. The mixture can be used as a coating liquid for forming a resin layer. The polyurethane having a polycarbonate structure is more preferably a reaction product of a mixture containing a hydroxyl-terminated prepolymer and an isocyanate-terminated prepolymer, and a conductive filler and an additive.

When there are a large number of hydroxyl groups or isocyanate groups, or when there are a large number of urea bonds, allophanate bonds, isocyanurate bonds, and the like, a large number of polar functional groups are present in the polyurethane, which increases the water absorbency of the polymer, lowers the volume resistivity of the resin layer, and may cause charge leakage from the photosensitive drum to the developing roller. On the other hand, by thermally curing the hydroxyl-terminated prepolymer and the isocyanate-terminated prepolymer, it is possible to obtain a polyurethane having low contents of unreacted polyol and polar functional groups without excessively using isocyanate.

### (A) Polyol Compound

The polyol is selected from known polycarbonate polyols and polyester polycarbonate copolymerized polyols.

Examples of the polycarbonate polyol include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester polycarbonate copolymerized polyol include the following: copolymers obtained by polycondensing the polycarbonate polyols with lactones such as ε-caprolactone, or copolymers with polyesters obtained by polycondensing diols such as 1,4-butanediol, 1,5-pentanediol, 1,6-hexanediol, 3-methylpentanediol, or neopentyl glycol, and dicarboxylic acids such as adipic acid or sebacic acid.

### (B) Polyisocyanate Compound

The polyisocyanate is selected from commonly used known polyisocyanates, and examples thereof include the following polyisocyanates: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, aromatic isocyanates such as toluene diisocyanate (TDI), diphenylmethane diisocyanate (MDI), polymeric diphenylmethane polyisocyanate, and polymeric MDI are more preferably used. Other polyisocyanates can also be used as long as they do not affect an impedance value and a surface potential.

A ratio of the number of isocyanate groups to the number of hydroxyl groups (hereinafter, also referred to as “ratio of NCO/OH”) is preferably 1.0 to 2.0. When the ratio of NCO/OH is 1.0 to 2.0, a crosslinking reaction proceeds, and bleeding of unreacted components and low-molecular-weight polyurethane, so-called “bleed” is suppressed. The ratio of NCO/OH is more preferably 1.0 to 1.6. When the ratio of NCO/OH is 1.0 to 1.6, bleed is suppressed, and the hardness of the polymer can be suppressed.

A content of the polyurethane in the resin layer is not particularly limited, but is preferably 50 to 95 mass %, more preferably 60 to 80 mass %, and still more preferably 65 to 75 mass %.

### (Conductive Filler)

The resin layer preferably contains a conductive filler in order to obtain electrical conductivity. As the conductive filler in the resin layer, it is more preferable to use an electron conductive agent. The electron conductive agent is a conductive particle exhibiting electronic conductivity, and preferably has a surface functional group capable of interacting with a functional group present in an additive to be described below.

Examples of the electron conductive agent exhibiting these properties include at least one selected from the group consisting of carbon black such as furnace black, thermal black, acetylene black, and Ketjen Black, metal oxide-based conductive particles such as titanium oxide having a surface treated with an acidic functional group, and metal-based conductive particles such as aluminum and iron having a surface treated with an acidic functional group.

Among them, at least one selected from the group consisting of carbon blacks having high stability of surface functional groups is preferably used. The conductive filler preferably contains carbon black. Furthermore, in order to obtain a desired impedance value and surface potential, carbon black having a number average diameter of primary particles capable of achieving higher dispersion in the resin layer of 30 nm or less, a DBP absorption of 90 ml/100 g or less, and a pH of 4.0 or less is particularly preferably used.

When the number average diameter of primary particles of carbon black is 30 nm or less, an aggregate (primary aggregate), which is a minimum unit in which carbon black can be dispersed, becomes small, and a structure (size of connection of particles) also becomes small, such that a conductive path is hardly formed. Therefore, a sufficiently high impedance is easily obtained. Note that a primary particle diameter of carbon black can be calculated by a transmission electron microscope (TEM). The number average diameter is preferably as low as possible, and a lower limit of the number average diameter is not particularly limited. For example, the number average diameter of primary particles of carbon black is more preferably 5 to 30 nm or 20 to 28 nm.

When the DBP absorption of the carbon black is 90 ml/100 g or less, the structure of the carbon black becomes small, and a conductive path is hardly formed, such that a sufficiently high impedance is easily obtained. The DBP absorption is preferably as low as possible, and a lower limit of the DBP absorption is not particularly limited. For example, the DBP absorption of carbon black is more preferably 30 to 90 ml/100 g or 40 to 60 ml/100 g.

When the pH of the carbon black is 4.0 or less, an effect of dispersion stability is obtained by repulsion of the surface functional group of the carbon black, and aggregation of the carbon black hardly occurs, such that sufficiently high impedance is easily obtained. The pH of the carbon black is preferably as low as possible, and a lower limit of the pH is not particularly limited. For example, the pH of the carbon black is more preferably 2.0 to 4.0 or 2.2 to 2.8.

However, even when the number average diameter, DBP absorption, and pH of the primary particles of carbon black are within the above ranges, when polycarbonate urethane is used as a binder resin, the carbon black cannot be sufficiently dispersed, and a desired impedance may not be obtained. The reason why the carbon black having the desired material properties cannot be dispersed when polycarbonate urethane is used as a binder resin is not clearly known, but is presumed as follows.

Hydroxyl groups, which are surface functional groups of carbon black, are likely to interact with terminal hydroxyl groups of polycarbonate diol. On the other hand, a structure in which a carbonate bond and a hydrocarbon group are bonded, which is present between two hydroxyl groups of polycarbonate diol, is hydrophobic due to the presence of the hydrocarbon group, and hardly interacts with carbon black. Since hydrophobic groups and hydrophilic groups tend to be structurally more stable when located near other hydrophobic groups and near other hydrophilic groups, respectively, hydrophilic carbon black tends to be located in the vicinity of other hydrophilic carbon black. As a result, it is considered that the carbon black is easily aggregated and hardly dispersed.

In order to sufficiently disperse carbon black in which the number average diameter of primary particles, the DBP absorption, and the pH are in the above numerical ranges using polycarbonate urethane as a binder resin, it is more preferable to add an additive described below.

A content of the carbon black is preferably 30 parts by mass or less with respect to 100 parts by mass of the polyurethane forming the resin layer although it is desirable to add the carbon black so as to have a desired volume resistivity. The content of the carbon black is more preferably 10 to 30 parts by mass and still more preferably 15 to 25 parts by mass.

When the content is 30 parts by mass or less, the distance between the carbon blacks in the coating liquid is appropriately maintained, the collision probability due to Brownian motion or the like of the carbon black is reduced, and the carbon black is less likely to aggregate. Therefore, carbon black is easily dispersed, and dispersion stability is also improved. As a result, carbon black is well dispersed in the resin layer formed by forming the coating liquid.

In order to achieve the specific impedance and surface potential, it is preferable to control the dispersion of carbon black. As a dispersion particle diameter of the carbon black, an arithmetic mean value Rc of equivalent circle diameters of the carbon black in the resin layer is preferably 60.0 nm or less. When the standard deviation of the equivalent circle diameter is defined as σc [nm], σc/Rc is more preferably 0.000 to 0.650.

In addition, as the distance between the carbon blacks, when an arithmetic mean value d of wall-to-wall distances of the carbon black in the resin layer is 80.0 to 150.0 nm and the standard deviation of the distances between the wall surfaces is defined as σd [nm], σd/d is more preferably 0.000 to 0.600.

The reason why the high impedance and the low surface potential are more easily compatible when the equivalent circle diameter and the wall-to-wall distance are in the above numerical ranges is estimated as follows.

When the dispersion particle diameter is large, there is a place where the wall-to-wall distance is short, and a conductive path is easily formed, such that the impedance and the surface potential are low. On the other hand, when the dispersion particle diameter is reduced, the wall-to-wall distance becomes uniform, it is difficult to form a conductive path, the resistance increases, and the capacitance also decreases, such that the impedance increases. In terms of the surface potential, the resistance becomes high, the influence of the component of the electrostatic capacitance becomes large, and the surface potential can be lowered by the charge that can be stored in the pseudo capacitor component.

Note that, when the surface of the carbon black is coated with an insulating material such as a silane coupling agent, the carbon black cannot act as a pseudo capacitor, such that both the impedance and the surface potential are high.

Note that a plurality of types of carbon blacks may be used in combination as long as the impedance value and the surface potential are not affected.

The arithmetic mean value Rc of the equivalent circle diameters is more preferably 40.0 to 60.0 nm and still more preferably 45.0 to 55.0 nm. σc/Rc is more preferably 0.500 to 0.650 and still more preferably 0.550 to 0.650.

The arithmetic mean value Rc and the standard deviation σc of the equivalent circle diameters can be changed depending on, for example, a dispersion state in a mill or the like when a coating liquid for forming a resin layer is prepared. When the dispersion is weaker, Rc and σc tend to increase, and when the dispersion is strengthened, Rc and σc tend to decrease. Normally, since Rc converges, when the dispersion state exceeds a certain level, it is possible to lower σc while Rc is substantially constant, which makes it possible to reduce σc/Rc.

The arithmetic mean value d of the wall-to-wall distances is more preferably 90.0 to 120.0 nm and still more preferably 95.0 to 115.0 nm. σd/d is more preferably 0.500 to 0.600 and still more preferably 0.540 to 0.590.

The arithmetic mean value d and the standard deviation σd of the wall-to-wall distances can be changed depending on, for example, a dispersion state in a mill or the like when a coating liquid for forming a resin layer is prepared. When the dispersion is weaker, d tends to decrease and σd tends to increase, and when the dispersion is stronger, d tends to increase and σd tends to decrease. Therefore, when the dispersion is weak, σd/d tends to be large, and when the dispersion is strong, σd/d tends to be small.

### (Additive)

It is also a preferred mode to use an additive for further improving dispersibility of carbon black in a binder resin using polycarbonate urethane. Here, as the additive, for example, at least one compound selected from the group consisting of a compound having a structure represented by the following Structural Formula (5), a compound having a structure represented by the following Structural Formula (6), and a compound having a structure represented by the following Structural Formula (7) can be preferably used. One of the methods for incorporating the additive into the surface layer is a method for incorporating a dispersant in a coating liquid for forming a resin layer. Note that in the surface layer formed using a coating liquid for forming a resin layer containing at least one compound selected from the group consisting of a compound having a structure represented by Structural Formula (5) and a compound having a structure represented by Structural Formula (6), the compound may be incorporated at the end of the polymer chain of the polyurethane. Even in this case, the effect of improving the dispersibility of carbon black can be expected, but it is preferable that carbon black is present in the surface layer independently of polyurethane.

Among the compounds having the structures represented by Structural Formulas (5) to (7), the compound having the structure represented by Structural Formula (5) is more suitably used because the dispersibility of carbon black and the affinity with polycarbonate urethane are particularly preferred.

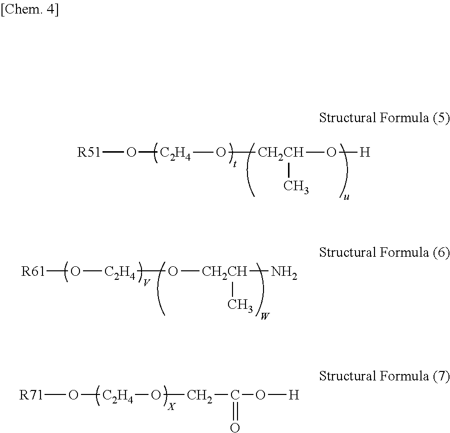

In Structural Formula (5), R51 represents a monovalent hydrocarbon group having 1 to 12 (preferably 3 to 12) carbon atoms. t and u are average numbers of added moles and each independently represent a number of 1 or more (preferably from 5 to 30, and more preferably from 10 to 25).

In Structural Formula (6), R61 represents a monovalent hydrocarbon group having 1 to 8 (preferably 1 to 4) carbon atoms. v and w are average numbers of added moles and each independently represent a number of 1 or more (preferably from 1 to 30, and more preferably from 5 to 30).

In Structural Formula (7), R71 represents a monovalent hydrocarbon group having 1 to 12 carbon atoms. x is an average number of added moles and represents a number of 1 or more (preferably 1 to 30, and more preferably 4 to 15).

Structural Formula (5) represents a polyoxyethylene polyoxypropylene alkyl ether, and is a polyether mono-ol having a structure obtained by block addition polymerization of ethylene oxide and propylene oxide. The hydroxyl group at the terminal of the polyether mono-ol interacts with functional groups on the surface of carbon black, which is a conductive filler, via hydrogen bonding, thereby acting as a dispersant for the carbon black. In addition, in order to enhance the effect of carbon black as a dispersant, the carbon black has a structure that is compatible with polycarbonate urethane.

Ethylene oxide is introduced into the structure to ensure uniform presence of the additive in the polycarbonate urethane. This is considered to be because the ethylene group in ethylene oxide is compatible with the hydrophobic hydrocarbon group in the polycarbonate urethane. In addition, propylene oxide is introduced into the structure in order to improve dispersibility of the conductive filler dispersed in the resin layer. This is considered to be due to the interaction between the side chain methyl group of propylene oxide and the conductive filler, which improves the dispersibility of the conductive filler.

R51, which is a monovalent hydrocarbon group having 1 to 12 carbon atoms, is introduced into the structure in order to make the additive uniformly present in the polycarbonate urethane. The monovalent hydrocarbon group is compatible with the hydrophobic hydrocarbon group in the polycarbonate urethane, and the additive can be uniformly present in the polycarbonate urethane. Because the number of carbon atoms is 12 or less, steric hindrance with the polycarbonate urethane is less likely to occur, and the additive tends to be uniformly present.

Since the compound represented by Formula (5) has a monool structure, the compound has lower reactivity than a diol, which makes it less likely to be incorporated during a urethanization reaction between the isocyanate and polyol; thus, the introduction of the ether structure into the polycarbonate urethane is minimized, thereby reducing a risk of a decrease in the resistivity of the polyurethane.

A polyoxyethylene polyoxypropylene alkyl ether can be obtained using commercially available products or by synthesis. The polyoxyethylene polyoxypropylene alkyl ether can be synthesized by performing step (B) after step (A). Note that step (B) may be performed on a commercially available product having a structure completed up to step (A).
Step (A): Reaction of alcohol with ethylene oxide
Step (B): Reaction of product obtained in step (A) with propylene oxide

In step (A), the reaction can proceed by adding ethylene oxide to an alcohol in the presence of a catalyst at 50 to 200° C., and more preferably at 100 to 160° C. Since ethylene oxide has a boiling point of 10.7° C. and is a gas at the above temperature, the reaction is preferably carried out in an environment pressurized in a sealed container. The pressure is preferably 0.1 MPa to 1.0 MPa. The reaction time is not particularly limited, but is preferably about 1 hour to 3 hours in order to reduce a content of unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of ease of reaction and reaction efficiency, sodium hydroxide and potassium hydroxide are particularly preferable. Examples of the acid catalyst include Brønsted acids such as sulfuric acid and phosphoric acid, and Lewis acids such as stannic chloride and boron trifluoride.

In the case of sodium hydroxide or potassium hydroxide, the amount of catalyst used is preferably 0.1 to 5 mol % based on 1 mol of the alcohol. Ethylene oxide reacts with water to produce ethylene glycol, such that moisture is prevented as much as possible, and a dehydration treatment may be performed before the reaction of step (A) as necessary.

Step (B) can be performed under the same conditions as in step (A). Since propylene oxide has a boiling point of 34.2° C. and is a gas at a reaction temperature of 50 to 200° C., it is preferable to perform the reaction in an environment pressurized in a sealed container. The catalyst used in step (A) may be used as it is or may be newly added. When newly added, the catalyst used in step (A) is preferable.

Structural Formula (6) is a polyether amine (monoamine) having a structure obtained by block addition polymerization of ethylene oxide and propylene oxide. The amino group at the terminal of the polyether amine interacts with the surface functional group of carbon black as a conductive filler by hydrogen bonding, and acts as a dispersant for carbon black. In addition, in order to enhance the effect as a dispersant, by introducing R61 which is a monovalent hydrocarbon group having 1 to 8 carbon atoms, a structure that is easily compatible with a hydrophobic functional group of polycarbonate urethane is obtained, and a structure that is also compatible with polycarbonate urethane is obtained.

A polyether monoamine can be obtained using a commercially available product or by synthesis. The polyether monoamine can be synthesized by performing step (D) after the following step (C).
Step (C): Oxidation reaction of compound of Structural Formula (5) which is secondary alcohol
Step (D): Reductive amination reaction of product obtained in step (C)

Step (C) is a reaction for producing a ketone by an oxidation reaction of a secondary alcohol. Ketone synthesis by oxidation of a secondary alcohol includes an oxidation reaction using a heavy metal salt such as chromic acid or manganese dioxide and a derivative thereof, and an oxidation reaction of a non-heavy metal salt using a hypohalous acid such as dimethyl sulfoxide (DMSO) or hypochlorous acid.

The synthesis may be performed using any method, but in view of environmental influence by heavy metals, an oxidation reaction using a hypohalous acid such as dimethyl sulfoxide (DMSO) or hypochlorous acid is preferable. Furthermore, dimethyl sulfoxide (DMSO) requires a low temperature of −60° C. because the reaction explosively proceeds at room temperature depending on an electrophilic activation reagent to be used, and thus, a method using a hypohalous acid is more preferable. Examples of the hypohalous acid include hypochlorites such as sodium hypochlorite and calcium hypochlorite (bleaching powder). These hypochlorites are reacted with a secondary alcohol in acetic acid to obtain a ketone.

When dimethyl sulfoxide (DMSO) is used, an electrophilic activation reagent is also required. By increasing the electrophilicity of sulfur in dimethyl sulfoxide (DMSO) with the electrophilic activation reagent, nucleophilic attack by the hydroxyl group of an alcohol. The nucleophilic attack generates a dimethyl alkoxy sulfonium salt, and the dimethyl alkoxy sulfonium salt is decomposed, thereby producing a ketone and dimethyl sulfide. Examples of the electrophilic activation reagent include dicyclohexylcarbodiimide (DCC), acetic anhydride, phosphorus pentoxide, a sulfur trisulfide-pyridine complex, trifluoroacetic anhydride, oxalyl chloride, and halogen.

Step (D) is a reductive amination reaction that converts a ketone to an amine. The reaction is divided into two stages. First, the carbonyl group reacts with the amine to produce an iminium cation. Subsequently, a hydride reducing agent performs a nucleophilic attack on the iminium cation to produce an amine. As the reducing agent, a borohydride reagent is preferably used. Examples of the borohydride reagent include sodium cyanoborohydride, sodium triacetoxyborohydride, and 2-picoline borane, and among them, sodium triacetoxyborohydride and 2-picoline-borane, which are less toxic, are preferable. In the reductive amination reaction using the borohydride reagent, it is difficult to produce an iminium cation due to steric hindrance when a bulky structure is involved. Therefore, R61 in Structural Formula (6) is preferably a monovalent hydrocarbon group having 1 to 8 carbon atoms.

Structural Formula (7) is polyoxyethylene alkyl ether acetate. The terminal carboxylic acid in Structural Formula (7) interacts with a surface functional group of carbon black as a conductive filler by hydrogen bonding, and acts as a dispersant for carbon black. In addition, in order to enhance the effect as a dispersant, by introducing R71 which is a monovalent hydrocarbon group having 1 to 12 carbon atoms, a structure that is easily compatible with a hydrophobic functional group of polycarbonate urethane is obtained, and a structure that is also compatible with polycarbonate urethane is obtained.

Polyoxyethylene alkyl ether acetate can be obtained using a commercially available product or by synthesis. The synthesis of polyoxyethylene alkyl ether acetate can be carried out by performing step (F) after step (E) described below. Note that step (F) may be performed on a commercially available product having a structure completed up to step (E).
Step (E): Reaction of alcohol with ethylene oxide
Step (F): Oxidation reaction of primary alcohol produced in step (E)

Step (E) is the same as step (A), and can be performed by the same method as in step (A).

The step (F) is a step of oxidizing a primary alcohol to produce a carboxylic acid. In the oxidation of a primary alcohol, a carboxylic acid is produced by further oxidation after an aldehyde is produced. Therefore, it is necessary to select a reaction method and conditions that do not stop at the aldehyde stage. Examples of the method for obtaining a carboxylic acid by oxidation of a primary alcohol include oxidation using an oxidizing agent and a catalytic dehydrogenation reaction using a catalyst. Examples of the oxidizing agent include permanganate, chromic acid, ruthenium tetroxide, and hypochlorite. Examples of the catalyst for the dehydrogenation reaction include palladium, platinum, iridium, rhodium, and manganese.

The compounds represented by Structural Formulas (5) to (7) have a function as a dispersant for carbon black, and are compounds having high affinity with polycarbonate urethane. Usually, a surfactant is used as a method for improving dispersibility and dispersion stability of carbon black. However, the compounds represented by Structural Formulas (5) to (7) are not generally used because the number of functional groups acting on the surface functional group of carbon black is small, and therefore, the surfactant action is weak. As a general dispersant for carbon black, a coupling agent and a nonionic surfactant are utilized.

As the coupling agent, a silane coupling agent, a titanate-based coupling agent, or an aluminum-based coupling agent is used, and as the nonionic surfactant, a polyester-based or polyether-based surfactant is used. However, when these dispersants are added to a level at which the dispersibility of carbon black can be sufficiently enhanced in polycarbonate urethane (mass ratio of 50 to 100% with respect to carbon black), the electrical conductivity of the carbon black or the binder resin is inhibited. On the other hand, when the amount added is set to a level at which the electrical conductivity of the carbon black or the binder resin is not inhibited (mass ratio of 10 to 40% with respect to the carbon black), the dispersibility of the carbon black cannot be obtained.

The amount of the compounds represented by Structural Formulas (5) to (7) is preferably 3.0 to 7.0 mass % based on the solid content in the coating liquid for forming a resin layer. The amount of the compounds represented by Structural Formulas (5) to (7) is more preferably 3.0 to 5.0 mass %. In addition, the total content is preferably 18.9 to 46.0 parts by mass with respect to 100 parts by mass of the carbon black in the coating liquid for forming a resin layer.

When the content of the additive in the coating liquid for forming a resin layer is within the above range, the dispersibility of carbon black in polyurethane is further improved, and a desired impedance value and surface potential can be more easily achieved.

The presence confirmation and quantitative evaluation of the additive in the resin layer can be analyzed by the following method. By cutting out the resin layer of the developing roller and using, for example, ¹H-NMR, ¹³C-NMR, XPS, or FT-IR on the cross-section, the carbonate structure of the binder resin, the ether structure, the amine structure, and the carboxylic acid structure of the additive can be detected in the resin layer, and ratios can be calculated from peak ratios or the like.

In addition, the cross section is immersed in an organic solvent such as 2-butanone (methyl ethyl ketone: MEK) overnight for extraction and analyzing both the extract and the extracted cross section using ¹H-NMR, ¹³C-NMR, XPS, and FT-IR, such that it is possible to determine the ratio of the additive incorporated into the resin during polymerization and the additive not incorporated in the resin.

Examples of the structure in which at least one of the compounds having the structures represented by Structural Formulas (5) and (6) is bonded to polyurethane (structure reacted during polymerization of polyurethane) include the following modes:
in the case of the structure represented by Structural Formula (5), in the polyurethane, a compound having the structure represented by Structural Formula (5) forms a urethane-modified structure; and
in the case of the structure represented by Structural Formula (6), in the polyurethane, a compound having the structure represented by Structural Formula (6) forms a urea-modified structure.

### [Coarse Particles]

The resin layer may contain coarse particles. The coarse particles may be, for example, spherical particles. A particle diameter of the coarse particle is, for example, preferably in the range of 1 μm to 150 μm, and more preferably in the range of 5 μm to 30 μm. Examples of the coarse particles include at least one spherical particle selected from the following particles:
urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. The coarse particles are preferably urethane resin particles.

The developing roller may have an elastic layer formed on the outer surface of the substrate. The developing roller has, for example, an elastic layer between the substrate and the resin layer. The elastic layer is not particularly limited, and a known elastic layer may be used as the elastic layer of the developing roller. Examples of the elastic layer include a cured product of an addition cure-type liquid silicone rubber mixture.

### (Production Method)

A method for forming the resin layer is not particularly limited, and examples thereof include a method by spraying with a coating material, dip coating, or roll coating. For example, a coating liquid for forming a resin layer is applied onto the substrate or the elastic layer formed on the outer surface of the substrate by a known method, and heated and dried to form a resin layer. The conditions for heating and drying are not particularly limited, and examples thereof include a method of drying under a condition of 120 to 200° C. A thickness of the resin layer is also not particularly limited, and is preferably 1 to 50 μm, and more preferably 5 to 20 μm.

### Method of Measuring Various Characteristics of Developing Roller

### <Impedance>

In the impedance measurement, the response of the developing roller is examined by applying an AC voltage and a DC voltage while varying the frequency. An AC voltage is applied, and a response with no phase shift and a response with a phase shift of π/2 with respect to the applied AC voltage are measured separately, the impedance of the response with no phase shift, which is defined as Z′ (the real part), and the impedance of the response with a phase shift, which is defined as Z″ (the imaginary part), are plotted on a complex plane, and a distance from the origin to the plotted point is calculated as an impedance value.

When the electrical characteristics of the developing roller are represented in a pseudo manner by an RC parallel circuit, the real part with no phase shift represents a resistive component, and the imaginary part with a phase shift represents a capacitive component. Note that the measurement conditions and the meanings of the measured values have been described in <Technical significance of requirement (1)> described above, and thus are omitted in this section.

A method for measuring impedance, a measuring apparatus, and measurement conditions will be described below.

### (Method for Measuring Impedance)

The impedance of the developing roller can be measured by the following methods (1) and (2):
(1) a method in which a thin film electrode is provided on a surface of a developing roller, and measurement is performed using two terminals of the electrode and the substrate; and
(2) a method in which a developing roller is pressed against a metal drum with a constant load, and measurement is performed with two terminals of the metal drum and the substrate.

Although the impedance can be measured by any method, the method (2) is affected by a nip width and a contact area between the developing roller and the metal drum, and thus, it is necessary to measure the impedance by the developing roller having the same hardness. Therefore, in the present disclosure, measurement is performed by the method (1). Hereinafter, the measurement method (1) will be described, and more specific conditions will be described below.

In the measurement of the impedance, in order to eliminate the influence of the contact resistance between the developing roller and the measurement electrode, it is preferable to deposit a low-resistance thin film on the surface of the developing roller, use the thin film as an electrode, and measure the impedance with two terminals using a conductive substrate as a ground electrode.

Examples of a method for forming the thin film include methods for forming a metal film such as metal vapor deposition, sputtering, application of a metal paste, and attachment of a metal tape. Among them, from the viewpoint of reducing the contact resistance with the developing roller, a method for forming a metal thin film such as platinum or palladium as an electrode by vapor deposition is preferable. In the present disclosure, vacuum platinum vapor deposition is employed.

When the metal thin film is formed on the surface of the developing roller, it is preferable to use a vacuum vapor deposition apparatus in which a mechanism capable of holding the developing roller is provided to the vacuum vapor deposition apparatus and a rotation mechanism is further provided to the developing roller having a cylindrical cross section in consideration of simplicity and uniformity of the thin film.

It is preferable that a metal thin film electrode having a width of about 10 mm in a longitudinal direction of the developing roller is formed, and a metal sheet wound around the metal thin film electrode in a direction intersecting the longitudinal direction without a gap is connected to the measurement electrode extending from the measuring apparatus to perform measurement. In the case of a cylindrical developing roller, it is preferable to use a metal sheet wound without a gap in a circumferential direction of the developing roller. As a result, the impedance measurement can be performed without being affected by the fluctuation of the size of the outer edge (the outer diameter in the cylindrical developing roller) in the cross section orthogonal to the longitudinal direction of the developing roller or the surface shape. As the metal sheet, an aluminum foil, a metal tape, or the like can be used.

### (Impedance Measurement Conditions)

The impedance measuring apparatus may be any device capable of measuring impedance in a frequency range of 1.0×10⁻¹ to 1.0×10⁵ Hz, such as an impedance analyzer, a network analyzer, or a spectrum analyzer. Among them, it is preferable to use an impedance analyzer for measurement from the viewpoint of the electrical resistance region of the developing roller.

The impedance measurement conditions will be described. The impedance in the frequency range of 1.0×10⁻¹ to 1.0×10⁵ Hz is measured using an impedance measuring apparatus. As the measurement environment, the temperature is 23° C. and the relative humidity is 50%. In consideration of measurement variations, it is preferable to measure at least a total of nine points including three longitudinal points and three rotational directions of the developing roller. The voltage application condition is obtained by superimposing an AC voltage of 50 V on a DC voltage of 50 V.

### <Surface Potential>

In an environment of a temperature of 23° C. and a relative humidity of 50%, a corona discharger having a grid portion with a width of 3.0 mm is disposed so that a distance between the grid portion and the outer surface of the developing roller is 1.0 mm, the direction of the width of the grid portion coincides with the axial direction of the developing roller, a voltage of 8 kV is applied to the grid portion, the corona discharger is relatively moved along the axial direction of the developing roller at a speed of 400 mm/sec to charge the outer surface of the developing roller, and the potential of the outer surface 0.06 seconds after the outer surface passes through the grid portion is measured to evaluate the easiness of excessive charging (charge-up) of the surface of the developing roller.

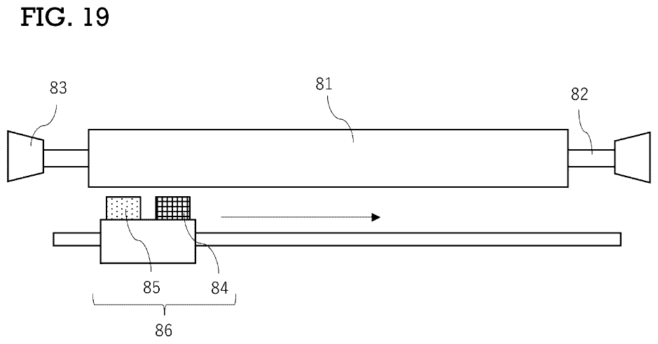

The surface potential of the developing roller can be measured by, for example, the device illustrated in FIG. 19. Both ends of a substrate 82 of a developing roller 81 are held by a chuck 83, and a measurement unit 86 in which a corona discharger 84 and a surface potential meter 85 are arranged in parallel with a 25 mm spacing is disposed to face a surface of the developing roller 81 at a distance of 1.0 mm. In a state where the developing roller 81 is stationary, a voltage of 8 kV is applied to a grid portion of the corona discharger 84, the measurement unit 86 is moved in an axial direction of the developing roller 81 at a speed of 400 mm/sec, and a surface potential is measured using the surface potential meter 85 at 0.06 seconds after passing the corona discharger 84.

The measurement conditions and the meanings of the measured values have been described in <Technical significance of requirement (2)> described above, and thus are omitted in this section.

### <Surface Shape of Developing Roller>

The method for measuring the surface shape of the developing roller is not particularly limited as long as the surface roughness can be measured. As will be described below, a measurement method having a resolution capable of measuring the surface shape formed by the coarse particles contained on the surface of the developing roller can be used. In order to calculate the mean length of elements Rsm of the surface roughness profile, the measurement distance is preferably 200 μm or more.

To satisfy this condition, a confocal laser microscope capable of optically measuring the shape in a non-contact manner can be used to measure the surface shape of the developing roller. The surface shape in the vicinity of the apex of the outer peripheral surface of the developing roller can be measured by substantially arranging a line obtained by extending the objective lens center line of the microscope so as to pass through the axis line of the substrate of the developing roller and to be orthogonal to the axis line. The maximum height roughness Rz of the roughness profile and the mean length of roughness elements Rsm can be calculated by analyzing the obtained surface shape.

The meanings of the measured values have been described in <Technical significance of requirement (3)> described above, and thus are omitted in this section.

Hereinafter, the present disclosure will be described in more detail, but these descriptions are not intended to limit the present disclosure at all.

### [1. Preparation and Production of Raw Materials for Forming Resin Layer]

### <1-1. Preparation and Production Example of Raw Material Polyol>

Hereinafter, a synthesis example for obtaining a polyurethane resin layer will be described.

### [Measurement of Number Average Molecular Weight of Raw Material Polyol]

The apparatus and conditions used for measuring a number average molecular weight (Mn) in the present production example are as follows.
Measuring apparatus: HLC-8120GPC (Tosoh Corporation)
Column: TSKgel Super HZMM (Tosoh Corporation)×2 columns
Solvent: tetrahydrofuran (THF) (20 mmol/l triethylamine is added)
Temperature: 40° C.
Flow rate of THF: 0.6 ml/min

Note that the measurement sample was prepared as a 0.1 mass % solution in THF. Further, measurement was performed using a refractive index (RI) detector as a detector.

As a standard sample for preparing a calibration curve, a calibration curve was prepared using TSK standard polystyrene A-1000, A-2500, A-5000, F-1, F-2, F-4, F-10, F-20, F-40, F-80, and F-128 manufactured by Tosoh Corporation. Based on the calibration curve, the number average molecular weight was determined from the retention time of the obtained measurement sample.

### [Preparation of Raw Material Polyol]

Commercially available products A-1 to A-16, which are 16 types of raw material polyols shown in Table 23, were purchased. In addition, raw material polyols A-17 and A-18 were synthesized.

TABLE 23

| No. | Raw material polyol |
|---|---|
| A-1 | DURANOL T5652 Mn = 2000 (Asahi Kasei |
| | Chemicals Corporation) |
| A-2 | DURANOL G4672 Mn = 2000 (Asahi Kasei |
| | Chemicals Corporation) |
| A-3 | DURANOL G3452 Mn = 2000 (Asahi Kasei |
| | Chemicals Corporation) |
| A-4 | DURANOL G4692 Mn = 2000 (Asahi Kasei |
| | Chemicals Corporation) |
| A-5 | KURARAY POLYOL C2050 Mn = 2000 (Kuraray Co., Ltd.) |
| A-6 | KURARAY POLYOL C2090 Mn = 2000 (Kuraray Co., Ltd.) |
| A-7 | KURARAY POLYOL C3090 Mn = 3000 (Kuraray Co., Ltd.) |
| A-8 | KURARAY POLYOL C2015N Mn = 2000 (Kuraray Co., Ltd.) |
| A-9 | KURARAY POLYOL C2060N Mn = 2000 (Kuraray Co., Ltd.) |
| A-10 | NIPPOLLAN 982 Mn = 2000 (Tosoh Corporation) |
| A-11 | ETERNACOLL UH-200 Mn = 2000 (UBE Corporation) |
| A-12 | ETERNACOLL UH-300 Mn = 3000 (UBE Corporation) |
| A-13 | ETERNACOLL UC-100 Mn = 2000 (UBE Corporation) |
| A-14 | ETERNACOLL UM-90(1:1) Mn = 900 (UBE Corporation) |
| A-15 | ETERNACOLL UM-90(1:3) Mn = 900 (UBE Corporation) |
| A-16 | Oxymer M112 Mn = 1000 (Perstorp Japan Co., Ltd.) |

### [Synthesis of Raw Material Polyol A-17]

In a nitrogen atmosphere, 100.0 g of 1,3-propanediol, 49.4 g of adipic acid, and 69.5 g of ethylene carbonate were mixed and heated, and ethylene glycol and water generated from the reaction system were distilled off while the temperature was raised to 200° C. After ethylene glycol and water were distilled off, 15 ppm of titanium tetraisopropoxide was added, and a polycondensation reaction was further carried out under a reduced pressure of 266.7 Pa. The reaction solution was cooled to room temperature to obtain raw material polyol A-17. The number average molecular weight of the obtained raw material polyol A-17 was 2,030.

### [Synthesis of Raw Material Polyol A-18]

Raw material polyol A-18 was prepared in the same manner as in the case of the raw material polyol A-17, except that starting materials shown in Table 24 were used. The number average molecular weight of the raw material polyol A-18 was 2,040.

TABLE 24

| | | Dicarboxylic | Ethylene | Ester | Number |
|---|---|---|---|---|---|
| Raw | | acid | carbonate | group/carbonate | average |
| material | Diol | (parts | (parts | group (molar | molecular |
| polyol No. | (parts by mass) | by mass) | by mass) | ratio) | weight |
| A-17 | 1,3-Propanediol | Adipic acid | 69.5 | 3/7 | 2030 |
| | (100.0) | (49.4) | | | |
| A-18 | 1,6-Hexanediol | Sebacic acid | 19.2 | 7/3 | 2040 |
| | (100.0) | (102.8) | | | |

### <1-2. Preparation of Raw Material Isocyanates B-1 to B-6>

Raw material isocyanates shown in Table 25 were prepared.

TABLE 25

| No. | Raw material isocyanate |
|---|---|
| B-1 | Diphenylmethane diisocyanate (MDI) |
| | (trade name: MILLIONATE MT, Tosoh Corporation) |
| B-2 | Polymethylene polyphenyl polyisocyanate (Polymeric MDI) |
| | (trade name: MILLIONATE MR200, Tosoh Corporation) |
| B-3 | Tolylene diisocyanate (TDI) |
| | (trade name: CORONATE T-80, Tosoh Corporation) |
| B-4 | Tolylene diisocyanate (TDI), adduct of trimethylolpropane |
| | (trade name: CORONATE L, Tosoh Corporation) |
| B-5 | Hexamethylene diisocyanate |
| | (trade name: DURANATE 50M-HDI, Asahi Kasei |
| | Chemicals Corporation) |
| B-6 | Isocyanurate trimer of hexamethylene diisocyanate |
| | (trade name: DURANATE TPA-100, Asahi Kasei |
| | Chemicals Corporation) |

### <1-3. Production Example of Hydroxyl-Terminated Urethane Prepolymers C-1 to C-14>

### [Synthesis of Hydroxyl-Terminated Urethane Prepolymer C-1]

In a nitrogen atmosphere, materials shown in Table 26 were reacted by heating and stirring at a temperature of 90° C. for 3 hours. Thereafter, 2-butanone (MEK) was added to the obtained reaction product to prepare a hydroxyl-terminated urethane prepolymer C-1 as a solution having a solid content of 50 parts by mass.

TABLE 26

| | Parts |
|---|---|
| Material | by mass |
| Raw material polyol A-1 | 100 |
| (trade name: DURANOL T5652, Asahi Kasei | |
| Chemicals Corporation) | |
| Raw material isocyanate B-1 | 6.3 |
| (trade name: MILLIONATE MT, Tosoh Corporation) | |

### [Synthesis of Hydroxyl-Terminated Urethane Prepolymers C-2 to C-14]

Hydroxyl-terminated urethane prepolymers C-2 to C-14 were prepared in the same manner as in the case of synthesizing the hydroxyl-terminated urethane prepolymer C-1 using starting materials shown in Table 27.

The chemical structures of these hydroxyl-terminated urethane prepolymers C-1 to C-14 were specified using ¹H-NMR and ¹³C-NMR. Note that, in Table 27, m, n, o, p, q, r, and s in Structural Formulas (1), (2), (3), and (4) are the average numbers of added moles. Here, (1) to (4) means “Structural Formula (1)” to “Structural Formula (4)”. PBM means “Parts by mass”.

TABLE 27

| Hydroxyl- | | | | | | | | |
|---|---|---|---|---|---|---|---|---|
| terminated | Raw | | Raw | | | | | |
| urethane | material | | material | | | | | |
| prepolymer | polyol | | isocyanate | | | | | |
| No. | No. | PBM | No. | PBM | Structure contained in molecule | | | |
| C-1 | A-1 | 100 | B-1 | 6.3 | (1) | R11 = (CH₂)₅ | R12 = (CH₂)₆ | m, n = 6.9 |
| C-2 | A-2 | 100 | B-1 | 5.7 | (1) | R11 = (CH₂)₄ | R12 = (CH₂)₆ | m = 10.7, n = 4.6 |
| C-3 | A-3 | 100 | B-1 | 6.3 | (1) | R11 = (CH₂)₃ | R12 = (CH₂)₄ | m, n = 8.8 |
| C-4 | A-4 | 100 | B-1 | 6.3 | (1) | R11 = (CH₂)₄ | R12 = (CH₂)₆ | m = 14.5, n = 1.6 |
| C-5 | A-5 | 100 | B-1 | 6.3 | (1) | R11 = (CH₂)₆ | R12 = (CH₂)₂—CHMe—(CH₂)₂ | m, n = 6.5 |
| C-6 | A-6 | 100 | B-1 | 6.3 | (1) | R11 = (CH₂)₆ | R12 = (CH₂)₂—CHMe—(CH₂)₂ | m = 1.3, n = 11.8 |
| C-7 | A-7 | 100 | B-1 | 4.2 | (1) | R11 = (CH₂)₆ | R12 = (CH₂)₂—CHMe—(CH₂)₂ | m = 2.0, n = 18.0 |
| C-8 | A-8 | 100 | B-1 | 6.3 | (1) | R11 = (CH₂)₉ | R12 = CH₂—CHMe—(CH₂)₃ | m = 6.5, n = 3.5 |
| C-9 | A-9 | 100 | B-1 | 6.3 | (1) | R11 = (CH₂)₉ | R12 = CH₂—CHMe—(CH₂)₅ | m = 3.5, n = 6.5 |
| C-10 | A-10 | 100 | B-5 | 4.3 | (2) | o = 9.1, p = 5.5 | | |
| C-11 | A-17 | 100 | B-1 | 6.3 | (3) | R31 = (CH₂)₃ | R32 = (CH₂)₄ | q = 12, r = 5.1 |
| C-12 | A-18 | 100 | B-1 | 6.3 | (3) | R31 = (CH₂)₆ | R32 = (CH₂)₈ | q = 2.7, r = 6.3 |
| C-13 | A-11 | 100 | B-1 | 6.3 | (4) | R41 = (CH₂)₆ | | s = 13.2 |
| C-14 | A-1 | 100 | B-3 | 4.8 | (1) | R11 = (CH₂)₅ | R12 = (CH₂)₆ | m, n = 6.9 |

Regarding the hydroxyl-terminated urethane prepolymers C-1 to C-9 and C-14 in which the structure represented by Structural Formula (1) was contained in the molecule, R13 in Structural Formula (1) was the same as R12.

In the table, notations such as m, n=6.9 or “x, y=A” indicate that the average number of added moles for each of x and y is A. The same applies to the following table.

### <1-4. Production Example of Isocyanate-Terminated Prepolymers D-1 to D-9>

### [Synthesis of Isocyanate-Terminated Prepolymer D-1]

In a nitrogen atmosphere, materials shown in Table 28 were reacted by heating and stirring at a temperature of 90° C. for 3 hours. Thereafter, 2-butanone (MEK) was added to the obtained reaction product to form a solution having a solid content of 50 parts by mass, thereby producing an isocyanate-terminated prepolymer D-1.

TABLE 28

| | Parts |
|---|---|
| Material | by mass |
| Raw material polyol A-10 | 100 |
| (trade name: NIPPOLLAN 982, Tosoh Corporation) | |
| Raw material isocyanate B-2 | 33.5 |
| (trade name: MILLIONATE MR200, Tosoh Corporation) | |

### [Synthesis of Isocyanate-Terminated Prepolymers D-2 to D-9]

Isocyanate-terminated prepolymers D-2 to D-9 were prepared in the same manner as in the case of synthesis of the isocyanate-terminated prepolymer D-1 using the types and amounts of starting materials shown in Table 29.

The chemical structures of these isocyanate-terminated prepolymers D-1 to D-9 were identified using ¹H-NMR and ¹³C-NMR. Note that, in Table 29, m, n, o, p, q, r, and s in Structural Formulas (1), (2), (3), and (4) are the average numbers of added moles. Here, PBM means “Parts by mass”. (1) to (4) means “Structural Formula (1)”

TABLE 29

| Isocyanate- | Raw | | Raw | | | | | |
|---|---|---|---|---|---|---|---|---|
| terminated | material | | material | | | | | |
| prepolymer | polyol | | isocyanate | | | | | |
| No. | No. | PBM | No. | PBM | Structure contained in molecule | | | |
| D-1 | A-10 | 100 | B-2 | 33.5 | (2) | o = 9.1, p = 5.5 | | |
| D-2 | A-14 | 100 | B-6 | 78.4 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m, n = 2.7 |
| D-3 | A-15 | 100 | B-6 | 78.4 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m = 4.1, n = 1.4 |
| D-4 | A-13 | 100 | B-6 | 70.3 | (4) | $R 41 = {CH}_{2} - CH < \begin{matrix}{( {CH}_{2} )}_{2} \\ {( {CH}_{2} )}_{2}\end{matrix} > CH - {CH}_{2}$ | | s = 5.8 |
| D-5 | A-11 | 100 | B-2 | 33.5 | (4) | R41 = (CH₂)₆ | | s = 13.2 |
| D-6 | A-12 | 100 | B-2 | 28.2 | (4) | R41 = (CH₂)₆ | | s = 20.1 |
| D-7 | A-16 | 100 | B-6 | 70.3 | (4) | R41 = CH₂—CEtBu—CH₂ | | s = 4.6 |
| D-8 | A-10 | 100 | B-4 | 102.2 | (2) | o = 9.1, p = 5.5 | | |
| D-9 | A-1 | 100 | B-2 | 33.5 | (1) | R11 = (CH₂)₆ | R12 = (CH₂)₆ | m:n = 1:1 |

In the isocyanate-terminated prepolymers D-2 and D-3 in which the structure represented by Structural Formula (1) was contained in the molecule, R13 in Structural Formula (1) was the same as at least one selected from the group consisting of R11 and R12. In addition, in the isocyanate-terminated prepolymer D-9 in which the structure represented by Structural Formula (1) was contained in the molecule, R13 in Structural Formula (1) was the same as R12.

### [2. Preparation and Production of Additive Raw Materials for Resin Layer]

### <2-1. Preparation and Production Example of Polyoxyethylene Polyoxypropylene Alkyl Ethers E-1 to E-7>

### [Preparation of Polyoxyethylene Polyoxypropylene Alkyl Ether]

Additives E-1 to E-5 which are polyoxyethylene polyoxypropylene alkyl ethers shown in Table 30 were commercially available products. In addition, polyoxyethylene polyoxypropylene alkyl ethers E-6 and E-7 were synthesized.

### [Synthesis of Polyoxyethylene Polyoxypropylene Alkyl Ether E-6]

169.3 g of 1-octanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

The obtained ethylene oxide adduct was cooled to 130° C., and then 1,132.6 g of propylene oxide (15 mol relative to alcohol) was charged. After completion of the charging, the reaction was carried out at 130° C. for 5 hours to obtain a polyoxyethylene polyoxypropylene octyl ether adduct, which is a block polymer having an average number of added moles of 15 mol of ethylene oxide and 15 mol of propylene oxide.

The obtained polyoxyethylene polyoxypropylene octyl ether adduct was cooled to 80° C., and unreacted ethylene oxide and propylene oxide were removed at 2.5 kPa for 30 minutes. Next, 6.0 g of 90% lactic acid was charged into the autoclave, stirred at 80° C. for 30 minutes, and then extracted to obtain polyoxyethylene polyoxypropylene octyl ether E-6. The structure of R51 and the values of t and u in E-6 are shown in Table 30.

### [Synthesis of Polyoxyethylene Polyoxypropylene Alkyl Ether E-7]

550.0 g of polyoxyethylene methyl ether (trade name: Blaunon MP-550, manufactured by AOKI OIL INDUSTRIAL Co., Ltd., the average number of added moles of 12 mol of ethylene oxide relative to alcohol) and 3.0 g of potassium hydroxide were charged into an autoclave equipped with a stirrer, a temperature controller, and an automatic feed device, and subjected to dehydration at 110° C. and 1.2 kPa for 30 minutes. After completion of the dehydration, nitrogen purging was performed, the temperature was raised to 130° C., and then 871.2 g (12 mol relative to alcohol) of propylene oxide was charged. After completion of the charging, the reaction was carried out at 130° C. for 4 hours to obtain a polyoxyethylene polyoxypropylene methyl ether adduct, which is a block polymer having an average number of added moles of 12 mol of ethylene oxide and 12 mol of propylene oxide.

The obtained polyoxyethylene polyoxypropylene methyl ether adduct was cooled to 80° C., and unreacted propylene oxide was removed at 2.5 kPa for 30 minutes. Next, 6.0 g of 90% lactic acid was charged into the autoclave, stirred at 80° C. for 30 minutes, and then extracted to obtain polyoxyethylene polyoxypropylene methyl ether E-7. The structure of R51 and the values of t and u in E-7 are shown in Table 30. Here, (5) means “Structural Formula (5)”.

TABLE 30

| No. | Material | Structure | | |
|---|---|---|---|---|
| E-1 | Polyoxyethylene polyoxypropylene butyl ether | (5) | R51 = C₄H₉ | t, u = 17 |
| | (trade name: UNILUBE 50MB-26, NOF corporation) | | | |
| E-2 | Polyoxyethylene polyoxypropylene butyl ether | (5) | R51 = C₄H₉ | t, u = 30 |
| | (trade name: UNILUBE 50MB-72, NOF corporation) | | | |
| E-3 | Polyoxyethylene polyoxypropylene butyl ether | (5) | R51 = C₄H₉ | t = 9, u = 10 |
| | (trade name: UNILUBE 50MB-11, NOF corporation) | | | |
| E-4 | Polyoxyethylene polyoxypropylene lauryl ether | (5) | R51 = C₁₂H₂₅ | t, u = 5 |
| | (trade name: NONION A-13PR, NOF corporation) | | | |
| E-5 | Polyoxyethylene polyoxypropylene lauryl ether | (5) | R51 = C₁₂H₂₅ | t, u = 25 |
| | (trade name: NONION A-25B, NOF corporation) | | | |
| E-6 | Polyoxyethylene polyoxypropylene octyl ether | (5) | R51 = C₈H₁₇ | t, u = 15 |
| E-7 | Polyoxyethylene polyoxypropylene methyl ether | (5) | R51 = CH₃ | t, u = 12 |

### <2-2. Preparation and Production Example of Polyether Amine>

### [Preparation of Polyether Amine]

Commercially available products of E-8 and E-9, which are polyether amines as additives, shown in Table 31 were purchased. In addition, a polyether amine E-10 was synthesized.

### [Synthesis of Polyether Amine E-10]

A stirrer was attached to a three-neck flask, and 1,658 g of polyoxyethylene polyoxypropylene octyl ether and 460 ml of acetic acid were charged. 600 ml of a 2 mol/l aqueous sodium hypochlorite solution was added dropwise thereto over 1 hour. A reaction vessel was cooled in an ice bath so that the temperature was maintained in the range of 15 to 25° C. After completion of the dropwise addition, stirring was continued for 1 hour. Dichloromethane was added to the obtained solution, and the aqueous layer was extracted and post-treated and purified by a column to obtain a compound in which a secondary alcohol was converted into a ketone.

The mixture was cooled to 0° C. in an ice bath, 250 ml of a methanol-acetic acid mixed solution (volume ratio of 10:1) was added to 41.4 g of a compound in which the obtained secondary alcohol was converted into a ketone, and 2.7 g of 2-picoline-borane was added. The ice bath was removed, and the mixture was stirred overnight at room temperature in an open system. After concentration, the mixture was cooled to 0° C., 360 ml of a 35% aqueous hydrochloric acid solution was added, and the mixture was stirred at room temperature for 2 hours. An aqueous sodium hydroxide solution was added to make the mixture basic, and the aqueous layer was extracted with dichloromethane and post-treated and purified by a column to obtain a polyether amine E-10. The structure of R61 in E-10 and the values of v and w are shown in Table 31. Here, (6) means “Structural Formula (6)”.

TABLE 31

| No. | Material | Structure | | |
|---|---|---|---|---|
| E-8 | Polyether amine | (6) | R61 = CH₃ | v = 6, |
| | (trade name: JEFFAMINE | | | w = 29 |
| | M-2005, Huntsman Corporation) | | | |
| E-9 | Polyether amine | (6) | R61 = CH₃ | v = 1, |
| | (trade name: JEFFAMINE | | | w = 9 |
| | M-600, Huntsman Corporation) | | | |
| E-10 | Polyether amine | (6) | R61 = C₈H₁₇ | v, w = 15 |

### <2-3. Preparation and Production Example of Polyoxyethylene Alkyl Ether Acetate>

### [Preparation of Polyoxyethylene Alkyl Ether Acetate]

Polyoxyethylene alkyl ether acetate E-11, which is used as an additive and is shown in Table 32, was purchased as a commercially available product. In addition, polyoxyethylene alkyl ether acetates E-12 and E-13 were synthesized.

### [Synthesis of Polyoxyethylene Alkyl Ether Acetate E-12]

55.0 g of polyoxyethylene methyl ether (trade name: Blaunon MP-550, manufactured by AOKI OIL INDUSTRIAL Co., Ltd., the average number of added moles of 12 mol relative to alcohol) and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-12. The structure of R71 in E-12 and the value of x are shown in Table 32.

### [Synthesis of Polyoxyethylene Alkyl Ether Acetate E-13]

169.3 g of 1-octanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

77.4 g of the obtained ethylene oxide adduct and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-13. The structure of R71 in E-13 and the value of x are shown in Table 32. Here, (7) means “Structural Formula (7)”.

TABLE 32

| No. | Material | Structure | | |
|---|---|---|---|---|
| E-11 | Polyoxyethylene lauryl ether | (7) | R71 = C₁₂H₂₅ | x = 5 |
| | acetate (trade name: TAIPOL | | | |
| | SOFT ECA-490, TAIKO OIL | | | |
| | CHEM. Co., Ltd.) | | | |
| E-12 | Polyoxyethylene methyl | (7) | R71 = CH₃ | x = 11 |
| | ether acetate | | | |
| E-13 | Polyoxyethylene octyl | (7) | R71 = C₈H₁₇ | x = 14 |
| | ether acetate | | | |

### [3. Production Example of Coating Liquids F-1 to F-44 and F-54 to F-58 for Forming Resin Layer]

### <3-1. Preparation of Coating Liquid F-1 for Forming Resin Layer>

The types and amounts of materials shown in Table 33 were added to a reaction vessel as materials for a coating liquid F-1 for forming a resin layer and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-1 for forming a resin layer.

TABLE 33

| | Parts |
|---|---|
| Material | by mass |
| Hydroxyl-terminated urethane prepolymer C-1 | 100 |
| Isocyanate-terminated urethane prepolymer D-5 | 54.7 |
| Additive E-1 | 7 |
| Carbon black | 35 |
| (trade name: MA8, Mitsubishi Chemical Corporation) | |
| Coarse particles | 23 |
| (trade name: ART PEARL C-400T, | |
| Negami Chemical Industrial Co., Ltd.) | |

### <3-2. Preparation of Coating Liquids F-2 to F-44 for Forming Resin Layer>

Coating liquids F-2 to F-44 for forming a resin layer were prepared by the following method. First, the hydroxyl-terminated urethane prepolymer, isocyanate-terminated prepolymer, additive, carbon black, and coarse particles described in Tables 35-1 and 35-2 were mixed in the same manner as in the case of preparing the coating liquid F-1 for forming a resin layer. Thereafter, 2-butanone (MEK) was added to adjust the viscosity of the liquid to a range of 6 to 10 mPa·s, thereby producing coating liquids F-2 to F-44 for forming a resin layer.

### <3-3. Preparation of Coating Liquids F-54 to F-58 for Forming Resin Layer>

Coating liquids F-54 to F-58 for forming a resin layer were prepared in the same manner as in the coating liquid F-1 for forming a resin layer, except that the coarse particles were changed as shown in Table 34 in the production example of the coating liquid F-1 for forming a resin layer. Here, “Coating liquid No.” means “Coating liquid for forming resin layer No.”.

TABLE 34

| Coating | | |
|---|---|---|
| liquid | | Parts |
| No. | Coarse particles | by mass |
| F-1 | Coarse particles H-1 | 23 |
| | (trade name: ART PEARL C-400T, | |
| | Negami Chemical Industrial Co., Ltd.) | |
| F-54 | Coarse particles H-2 | 30 |
| | (trade name: ART PEARL C-300T, | |
| | Negami Chemical Industrial Co., Ltd.) | |
| F-55 | Coarse particles H-2 | 43 |
| | (trade name: ART PEARL C-300T, | |
| | Negami Chemical Industrial Co., Ltd.) | |
| F-56 | Coarse particles H-3 | 20 |
| | (trade name: ART PEARL C-200T, | |
| | Negami Chemical Industrial Co., Ltd.) | |
| F-57 | Coarse particles H-2 | 48 |
| | (trade name: ART PEARL C-300T, | |
| | Negami Chemical Industrial Co., Ltd.) | |
| F-58 | Coarse particles H-2 | 18 |
| | (trade name: ART PEARL C-300T, | |
| | Negami Chemical Industrial Co., Ltd.) | |

Here, PBM means “Parts by mass”. [Table 35-1]

TABLE 35-1

| | Hydroxyl- | | Isocyanate- | | | | | | |
|---|---|---|---|---|---|---|---|---|---|
| | terminated urethane | | terminated urethane | | | | Carbon | | |
| | prepolymer | | prepolymer | | Additive | | black | Coarse particles | |
| | No. | PBP | No. | PBP | No. | PBP | PBP | No. | PBP |
| F-1 | C-1 | 100 | D-5 | 54.7 | E-1 | 7 | 35 | H-1 | 23 |
| F-2 | C-3 | 100 | D-5 | 54.7 | E-1 | 7 | 35 | H-1 | 23 |
| F-3 | C-5 | 100 | D-5 | 54.7 | E-1 | 7 | 35 | H-1 | 23 |
| F-4 | C-7 | 100 | D-5 | 37.2 | E-1 | 6.4 | 32 | H-1 | 21 |
| F-5 | C-13 | 100 | D-3 | 54.7 | E-1 | 7 | 35 | H-1 | 23 |
| F-6 | C-1 | 100 | D-6 | 54.7 | E-1 | 7 | 35 | H-1 | 23 |
| F-7 | C-7 | 100 | D-4 | 37.2 | E-1 | 6.4 | 32 | H-1 | 21 |
| F-8 | C-9 | 100 | D-7 | 54.7 | E-1 | 7 | 35 | H-1 | 23 |
| F-9 | C-1 | 100 | D-1 | 54.7 | E-1 | 7 | 35 | H-1 | 23 |
| F-10 | C-2 | 100 | D-1 | 54.7 | E-1 | 7 | 35 | H-1 | 23 |
| F-11 | C-3 | 100 | D-1 | 54.7 | E-1 | 7 | 35 | H-1 | 23 |
| F-12 | C-4 | 100 | D-1 | 54.7 | E-1 | 7 | 35 | H-1 | 23 |
| F-13 | C-5 | 100 | D-1 | 54.7 | E-1 | 7 | 35 | H-1 | 23 |
| F-14 | C-6 | 100 | D-1 | 54.7 | E-1 | 7 | 35 | H-1 | 23 |
| F-15 | C-7 | 100 | D-1 | 37.2 | E-1 | 6.4 | 32 | H-1 | 21 |
| F-16 | C-8 | 100 | D-1 | 54.7 | E-1 | 7 | 35 | H-1 | 23 |
| F-17 | C-9 | 100 | D-1 | 54.7 | E-1 | 7 | 35 | H-1 | 23 |
| F-18 | C-10 | 100 | D-2 | 54.7 | E-1 | 7 | 35 | H-1 | 23 |
| F-19 | C-10 | 100 | D-3 | 54.7 | E-1 | 7 | 35 | H-1 | 23 |
| F-20 | C-11 | 100 | D-5 | 54.7 | E-1 | 7 | 35 | H-1 | 23 |
| F-21 | C-12 | 100 | D-5 | 54.7 | E-1 | 7 | 35 | H-1 | 23 |
| F-22 | C-13 | 100 | D-1 | 54.7 | E-1 | 7 | 35 | H-1 | 23 |
| F-23 | C-10 | 100 | D-4 | 54.7 | E-1 | 7 | 35 | H-1 | 23 |
| F-24 | C-10 | 100 | D-7 | 54.7 | E-1 | 7 | 35 | H-1 | 23 |
| F-25 | C-1 | 50 | D-5 | 54.7 | E-1 | 7 | 35 | H-1 | 23 |
| | C-10 | 50 | | | | | | | |

Here, PBM means “Parts by mass”.

TABLE 35-2

| | Hydroxyl- | | Isocyanate- | | | | | | |
|---|---|---|---|---|---|---|---|---|---|
| | terminated urethane | | terminated urethane | | | | Carbon | | |
| | prepolymer | | prepolymer | | Additive | | black | Coarse particles | |
| | No. | PBM | No. | PBM | No. | PBM | PBM | No. | PBM |
| F-26 | C-14 | 100 | D-1 | 54.7 | E-1 | 7 | 35 | H-1 | 23 |
| F-27 | C-1 | 100 | D-5 | 54.7 | E-1 | 6.6 | 35 | H-1 | 23 |
| F-28 | C-1 | 100 | D-5 | 54.7 | E-1 | 16.1 | 35 | H-1 | 23 |
| F-29 | C-1 | 100 | D-5 | 54.7 | E-2 | 7 | 35 | H-1 | 23 |
| F-30 | C-1 | 100 | D-5 | 54.7 | E-3 | 7 | 35 | H-1 | 23 |
| F-31 | C-1 | 100 | D-5 | 54.7 | E-4 | 7 | 35 | H-1 | 23 |
| F-32 | C-1 | 100 | D-5 | 54.7 | E-5 | 7 | 35 | H-1 | 23 |
| F-33 | C-1 | 100 | D-5 | 54.7 | E-6 | 7 | 35 | H-1 | 23 |
| F-34 | C-1 | 100 | D-5 | 54.7 | E-7 | 7 | 35 | H-1 | 23 |
| F-35 | C-1 | 100 | D-5 | 54.7 | E-8 | 7 | 35 | H-1 | 23 |
| F-36 | C-1 | 100 | D-5 | 54.7 | E-8 | 6.6 | 35 | H-1 | 23 |
| F-37 | C-1 | 100 | D-5 | 54.7 | E-8 | 16.1 | 35 | H-1 | 23 |
| F-38 | C-1 | 100 | D-5 | 54.7 | E-9 | 7 | 35 | H-1 | 23 |
| F-39 | C-1 | 100 | D-5 | 54.7 | E-10 | 7 | 35 | H-1 | 23 |
| F-40 | C-1 | 100 | D-5 | 54.7 | E-11 | 7 | 35 | H-1 | 23 |
| F-41 | C-1 | 100 | D-5 | 54.7 | E-11 | 6.6 | 35 | H-1 | 23 |
| F-42 | C-1 | 100 | D-5 | 54.7 | E-11 | 16.1 | 35 | H-1 | 23 |
| F-43 | C-1 | 100 | D-5 | 54.7 | E-12 | 7 | 35 | H-1 | 23 |
| F-44 | C-1 | 100 | D-5 | 54.7 | E-13 | 7 | 35 | H-1 | 23 |
| F-54 | C-1 | 100 | D-5 | 54.7 | E-1 | 7 | 35 | H-2 | 30 |
| F-55 | C-1 | 100 | D-5 | 54.7 | E-1 | 7 | 35 | H-2 | 43 |
| F-56 | C-1 | 100 | D-5 | 54.7 | E-1 | 7 | 35 | H-3 | 20 |
| F-57 | C-1 | 100 | D-5 | 54.7 | E-1 | 7 | 35 | H-2 | 48 |
| F-58 | C-1 | 100 | D-5 | 54.7 | E-1 | 7 | 35 | H-2 | 18 |

### <1. Production of Developing Roller>

In the present example, a developing roller in which an elastic roller provided with an elastic layer formed on an outer surface of a substrate is coated with a resin layer will be described, but the present disclosure is not limited to this configuration.

### [1-1. Preparation of Substrate]

As a substrate, a stainless steel (SUS304) core metal having a diameter of 6 mm was prepared by applying a primer (trade name: DY35-051, manufactured by Dow Toray Co., Ltd.) to a peripheral surface of the core metal and baking the primer.

### [1-2. Preparation of Elastic Layer]

The substrate was placed in a mold, and an addition-type silicone rubber composition obtained by mixing the materials shown in Table 36 was injected into a cavity formed in the mold.

TABLE 36

| | Parts |
|---|---|
| Material | by mass |
| Liquid silicone rubber | 100 |
| (trade name: SE6724 A/B, Dow Toray Co., Ltd.) | |
| Carbon black | 16 |
| (trade name: TOKABLACK #4300, Tokai Carbon Co., Ltd.) | |
| Curing control agent | 0.01 |
| (trade name: 1-Ethenyl-1-cyclohexanol, | |
| Tokyo Chemical Industry Co., Ltd.) | |
| Platinum catalyst | 0.01 |
| (trade name: SIP6830.3, Gelest, Inc.) | |

Subsequently, the mold was heated to vulcanize and cure the silicone rubber at a temperature of 150° C. for 15 minutes, and the silicone rubber was demolded and then further heated at a temperature of 180° C. for 1 hour to complete the curing reaction, thereby obtaining an elastic roller in which an elastic layer having a diameter of 11.5 mm was provided on the outer periphery of the substrate.

### [1-3. Preparation of Resin Layer]

The elastic roller was held at its upper end with the longitudinal direction oriented vertically and was immersed (dipped) into the coating liquid F-1 for forming a resin layer, thereby coating the surface of the elastic roller with the coating liquid. The obtained coated product was air-dried at normal temperature for 30 minutes, and then dried in a hot air circulating dryer set at 160° C. for 1 hour. In this manner, a developing roller G-1 in which a resin layer having a thickness of 12 μm was formed on the elastic layer was obtained.

### <2. Measurement of Impedance>

The impedance was measured as follows.

First, as a pretreatment, vacuum platinum vapor deposition was performed on the developing roller G-1 while rotating, thereby preparing a measurement electrode. For vapor deposition, a vacuum vapor deposition apparatus having a mechanism for holding and rotating a substrate portion of a roller as an object to be deposited in a circumferential direction was used, a roller rotational speed, a vapor deposition distance, and a vapor deposition time were controlled, and vapor deposition was performed so that a film thickness was 100 nm or more. At this time, an electrode having a width of 1.5 cm was produced using a masking tape. By forming the electrode with a film thickness of 100 nm or more, it is possible to minimize the effect of the surface roughness of the developing roller on the contact area between the measurement electrode and the developing roller.

Next, an aluminum sheet was wound around the electrode without any gap, and the aluminum sheet was connected to measurement electrodes of an impedance measuring apparatus (trade names: Solartron 1260 and Solartron 1296, manufactured by Solartron) and a high-voltage system (trade names: 6792 and HVA-500, manufactured by Toyo Corporation).

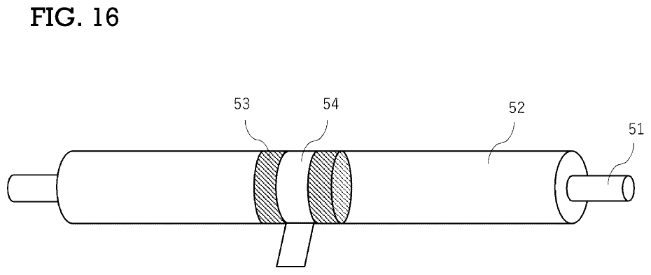

FIG. 16 is a schematic view of a state in which measurement electrodes are formed on the developing roller. In the drawing, reference numeral 51 denotes a conductive substrate, reference numeral 52 denotes a resin layer, reference numeral 53 denotes a platinum vapor-deposited layer, and reference numeral 54 denotes an aluminum sheet. Although the elastic layer is not illustrated in the drawing, the elastic layer is present between the substrate 51 and the resin layer 52.

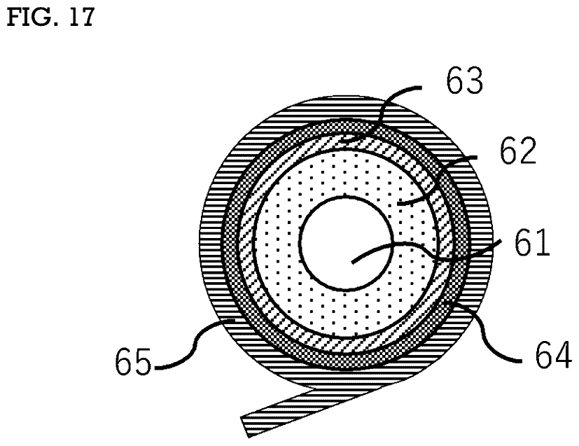

FIG. 17 is a cross-sectional view of a state in which measurement electrodes are formed on the developing roller. Reference numeral 61 denotes a conductive substrate, reference numeral 62 denotes an elastic layer, reference numeral 63 denotes a resin layer, reference numeral 64 denotes a platinum vapor-deposited layer, and reference numeral 65 denotes an aluminum sheet. Thus, it is important that the resin layer is sandwiched between the conductive substrate and the measurement electrode.

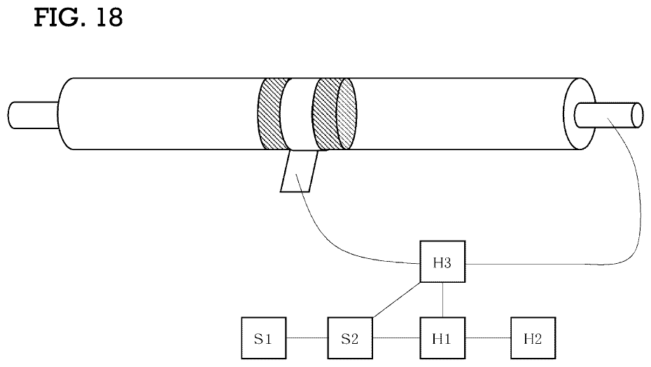

Then, the aluminum sheet was connected to measurement electrodes on a side of an impedance measuring apparatus (S1: Solartron 1260, manufactured by Solartron and S2: Solartron 1296, manufactured by Solartron) and a high-voltage system (H1: trade name: 6792, manufactured by TOYO Corporation, H2: trade name: HVA-500, manufactured by TOYO Corporation, and H3: reference box 6796, manufactured by Solartron). FIG. 18 is a schematic view of the measurement system. Impedance measurement was performed by using the conductive substrate and the aluminum sheet as two electrodes for measurement.

In the impedance measurement, a DC voltage of 50 V and an AC voltage of 50 V were applied in an environment of a temperature of 23° C. and a relative humidity of 50%, and an absolute value of the impedance was obtained at a frequency of 1.0×10⁻¹ to 1.0×10⁵ Hz. Then, the minimum value of the impedance value at a frequency of 1.0×10⁰ to 1.0×10¹ Hz was confirmed. The impedance was measured at the center of the developing roller in the longitudinal direction.

### <3. Measurement of Surface Potential>

The surface potential of the developing roller was measured using a charge amount measuring apparatus (trade name: DRA-2000L, manufactured by QEA, Inc.). Specifically, in an environment of a temperature of 23° C. and a relative humidity of 50%, a grid portion of a corona discharger of the charge amount measuring apparatus was disposed so as to maintain a gap of 1.0 mm from the outer surface of the developing roller. The grid portion of the corona discharger of the apparatus has a width of 3.0 mm.

Next, a voltage of 8 kV was applied to the corona discharger, the corona discharger was relatively moved at a speed of 400 mm/sec along the axial direction of the developing roller to charge the surface of the conductive member, and a potential of the outer surface after 0.06 seconds from the passage of the grid portion was measured. The maximum value among all measurement values obtained at eight positions in the longitudinal direction at 450 intervals in the circumferential direction of the developing roller was adopted.

### <4. Measurement of Surface Shape>

The surface shape of the developing roller was measured using a confocal laser microscope (trade name: VK-X200, manufactured by Keyence Corporation). Specifically, the developing roller was disposed horizontally, and the position of the objective lens was adjusted so that the apex portion of the outer periphery of the developing roller having a substantially cylindrical shape was brought into focus. An objective lens with an NA of 0.95 and a magnification of 50× was used. The observation field of view is 284×213 km.

In the shape measurement mode “Expert Mode”, a laser was used as a light source at the time of measurement range adjustment, upper and lower limits of the measurement height range were set, and then the shape was measured by the following setting.
Light source: laser
Brightness adjustment: automatic
Measurement mode: surface shape
Measurement size: standard (1,024×768 pixels)
Measurement quality: high quality Measurement pitch: 0.10 km
Real Peak Detection (RPD): enabled

The measurement result including the shape information was saved in a file. Next, the following operation was performed by the multi-file analysis application VK-X3000 Multi-File Analysis Software. A substantially cylindrical shape was converted into a planar unevenness shape by second-order surface correction using the surface shape correction in the image processing menu.

Next, in the multiple-line roughness measurement mode in the measurement menu,
a first measurement line was set near the center of a field of view,
a total of 21 measurement lines were set with 10 lines placed on each side of the central line at intervals of 45 lines,
the measurement line was set to be aligned in the circumferential direction,
the measurement type was set to roughness with terminal effect correction enabled and no cutoff applied, and
the mean value of the maximum height roughness Rz of the surface roughness and the mean value of the mean length of roughness elements Rsm were obtained from the total of 21 lines calculated by the application.

The shape measurement and analysis were performed on a total of nine points including three longitudinal points and three circumferential points of the developing roller, and the mean values of the measured values Rz and Rsm were defined as Rz and Rsm of the developing roller, respectively.

### <5. Calculation of Respective Physical Properties Such as Equivalent Circle Diameter and Wall-to-Wall Distance of Carbon Black Dispersed in Resin Layer>

The dispersion particle diameter and the wall-to-wall distance of carbon black dispersed in the resin layer were measured by the following methods.

First, a section (having a thickness of 0.5 to 1.0 mm) was cut out using a razor so that a cross section perpendicular to the longitudinal direction of the developing roller can be observed. When the adhesion between the substrate and the resin layer is strong and it is difficult to cut out the substrate with a razor blade, the entire substrate is cut out using a metal saw or the like, and then subjected to cross section processing with a focused ion beam (FIB) apparatus.

Next, the section is subjected to platinum vapor deposition, and an image of the resin layer is captured at 15,000× magnification using a scanning electron microscope (SEM) (trade name: JSM-7800F, manufactured by JEOL Ltd.) to obtain a cross-sectional image.

Furthermore, in order to quantify the cross-sectional image obtained by observation with the SEM, the cross-sectional image is converted to an 8-bit grayscale image using image processing software (trade name: Luzex AP, manufactured by Nireco Corporation) to obtain a 256-tone monochrome image. Next, black and white of the image are reversed so that the carbon black in the cross-sectional image becomes white, a threshold value for binarization is set on the luminance distribution of the image based on the Otsu's discriminant analysis algorithm, and then, a binarized image in which the carbon black becomes white and the binder resin portion becomes black is obtained.

Then, for the obtained binarized image, an equivalent circle diameter of the whitened carbon black portion and an adjacent wall-to-wall distance are calculated using image processing software (trade name: Luzex AP, manufactured by Nireco Corporation). The equivalent circle diameter and the adjacent wall-to-wall distance are calculated. In order to eliminate the uncertainty of the calculated value of the carbon black divided at the upper, lower, left, and right ends of the image, a region on the inner side of 0.075 μm in the actual image dimension (in cases where there are characters such as SEM measurement conditions, the region is set 0.075 μm inward from the start of the actual image) is set as the image region, and the equivalent circle diameter and the adjacent wall-to-wall distance for all the carbon blacks in the designated image region are calculated.

Then, the arithmetic mean value and the standard deviation are calculated for the distributions of the obtained equivalent circle diameters and the adjacent wall-to-wall distances. The number of images to be subjected to image analysis is not particularly limited even from one, but is set to at least three or more in order to eliminate the influence of a location difference in the longitudinal direction of the carbon black dispersed in the resin layer of the developing roller.

In addition, the number average diameter of primary particles of carbon black dispersed in the resin was measured with a transmission electron microscope (TEM). First, a thin-section sample was prepared. A known method can be used for preparing the thin section. For example, the sample can be thinned using an ion beam, a diamond knife, or the like. In the present disclosure, a 40 nm-thick thinned sample for observation was prepared using an ultramicrotome (trade name: ULTRACUT-S, manufactured by Leica Microsystems GmbH).

Then, using a transmission electron microscope (trade name: H-7100FA, manufactured by Hitachi High-Tech Corporation), a TEM image was acquired under measurement conditions of a TE mode and an acceleration voltage of 100 kV.

Then, using image analysis software (trade name: WinROOF, manufactured by MITANI CORPORATION), the equivalent circle diameters of 50 arbitrarily selected primary particles of carbon black in the TEM image were measured, and the number average value of the 50 primary particles was taken as the number average diameter of the primary particles.

### (Measurement of DBP Absorption of Carbon Black)

The DBP absorption of the carbon black was measured in accordance with Japanese Industrial Standard (JIS) K6217-4 using a carbon black powder.

### (Measurement of pH of Carbon Black)

The pH of the carbon black was measured in accordance with ASTM D1512 using a carbon black powder. The physical property measurement results are shown in Tables 37-1 to 37-4.

### 3. Image Evaluation

The process cartridge in which the developing roller G-1 was mounted as the developing roller 31 of the process cartridge 20 was denoted by P-1, inserted into the image forming apparatus 100, and then left to stand for 24 hours in an environment of a temperature of 15° C. and a relative humidity of 10%, and 100 sheets of completely white images were printed on A4 size recording paper (GF-C081, manufactured by Canon Inc.). Thereafter, horizontal lines were arranged at equal intervals in the conveyance direction so as to achieve a print coverage of 2%, and continuous printing of 5,000 sheets was performed.

### <3-1 Image Density Unevenness>

The process cartridge P-1 after the printing was performed was left to stand for 24 hours in an environment of a temperature of 23° C. and a relative humidity of 50%, and then a halftone image with a density of 25% with respect to solid black was output by the image forming apparatus to determine image density unevenness.

The potential of the photosensitive drum is more likely to decrease when the contact width of the developing region is large. When the contact width fluctuates due to deflection of the developing roller or the photosensitive drum, it appears as periodic image density unevenness in a direction perpendicular to the conveyance direction of the recording material.

In addition, when the peripheral speed difference between the developing roller and the photosensitive drum is large, the distance at which charge can leak from the photosensitive drum in the developing region becomes longer, such that density unevenness is easily visible.

In the present example, a visual evaluation was performed, in which periodic image density unevenness in a direction perpendicular to the conveyance direction of the recording material was rated as:
“⊚” when it was almost invisible,
“∘” when it was practically acceptable, and
“x” when it was clearly noticeable.

### <3-2 Ground Fogging>

In <5 Image evaluation>, the 100th sheet of recording material printed with a completely white image was visually observed to confirm whether or not there was ground fogging in which a part of the toner was unintentionally transferred to the white background portion and formed an image. Since the ground fogging is likely to occur at the end, the image evaluation was performed with particular attention to the end. As a result, a case in which no ground fogging was observed at the end was rated as “∘”, and a case in which ground fogging occurred was rated as “x”.

The evaluation results are shown in Tables 37-5 to 37-8.

### Examples 2 to 49

In Examples 2 to 49, except that the coating liquid for forming a resin layer was changed to the coating liquids for forming a resin layer (F-2 to F-44 and F-54 to F-58) shown in Tables 37-1 to 37-4, developing rollers G-2 to G-44 and G-54 to G-58 were produced in the same manner as in Example 1, process cartridges P-2 to P-44 and P-54 to P-58 were produced in the same manner as in Example 1, and then, each measurement and evaluation were performed.

Tables 37-1 to 37-4 show the physical properties. The table is divided into four parts due to its large size. When these tables are combined into a single table, Table 37-1 corresponds to the upper left, Table 37-2 corresponds to the upper right, Table 37-3 corresponds to the lower left, and Table 37-4 corresponds to the lower right. Note that Tables 37-2 and 37-4 also show a column for “Examples”. In these tables, Me represents a methyl group, Et represents an ethyl group, and Bu represents a butyl group.

Tables 37-5 to 37-8 show the evaluation results. The table is divided into four parts due to its large size. When these tables are combined into a single table, Table 37-5 corresponds to the upper left, Table 37-6 corresponds to the upper right, Table 37-7 corresponds to the lower left, and Table 37-8 corresponds to the lower right. Note that Tables 37-6 and 37-8 also show a column for “Examples”. In these tables, X represents the total amount (mass %) of the compounds having the structures represented by Structural Formulas (5) to (7) based on the solid content in the coating liquid for forming a resin layer. Here, Ex means Example. “PC No.” means “Process cartridge No.”. “DR No.” means “Developing roller No.”. “CL No.” means “Coating liquid for forming resin layer No.”. (1) to (4) means “Formula (1)” to “Formula (4)”.

TABLE 37-1

| | PC | DR | CL | Binder resin structure (structure (1)) | | | |
|---|---|---|---|---|---|---|---|
| Ex | No. | No. | No. | Structure (1) | | | |
| 1 | P-1 | G-1 | F-1 | (1) | R11 = (CH₂)₅ | R12 = (CH₂)₆ | m, n = 6.9 |
| 2 | P-2 | G-2 | F-2 | (1) | R11 = (CH₂)₃ | R12 = (CH₂)₄ | m, n = 8.8 |
| 3 | P-3 | G-3 | F-3 | (1) | R11 = (CH₂)₆ | R12 = (CH₂)₂—CHMe—(CH₂)₂ | m, n = 6.5 |
| 4 | P-4 | G-4 | F-4 | (1) | R11 = (CH₂)₆ | R12 = (CH₂)₂—CHMe—(CH₂)₂ | m = 2.0, n = 18.0 |
| 5 | P-5 | G-5 | F-5 | (4) | R41 = (CH₂)₆ | | s = 13.2 |
| 6 | P-6 | G-6 | F-6 | (1) | R11 = (CH₂)₅ | R12 = (CH₂)₆ | m, n = 6.9 |
| 7 | P-7 | G-7 | F-7 | (1) | R11 = (CH₂)₆ | R12 = (CH₂)₂—CHMe—(CH₂)₂ | m = 2.0, n = 18.0 |
| 8 | P-8 | G-8 | F-8 | (1) | R11 = (CH₂)₉ | R12 = CH₂—CHMe—(CH₂)₆ | m = 3.5, n = 6.5 |
| 9 | P-9 | G-9 | F-9 | (1) | R11 = (CH₂)₅ | R12 = (CH₂)₆ | m, n = 6.9 |
| 10 | P-10 | G-10 | F-10 | (1) | R11 = (CH₂)₄ | R12 = (CH₂)₆ | m = 10.7, n = 4.6 |
| 11 | P-11 | G-11 | F-11 | (1) | R11 = (CH₂)₃ | R12 = (CH₂)₄ | m, n = 8.8 |
| 12 | P-12 | G-12 | F-12 | (1) | R11 = (CH₂)₄ | R12 = (CH₂)₆ | m = 14.5, n = 1.6 |
| 13 | P-13 | G-13 | F-13 | (1) | R11 = (CH₂)₆ | R12 = (CH₂)₂—CHMe—(CH₂)₂ | m, n = 6.5 |
| 14 | P-14 | G-14 | F-14 | (1) | R11 = (CH₂)₆ | R12 = (CH₂)₂—CHMe—(CH₂)₂ | m = 1.3, n = 11.8 |
| 15 | P-15 | G-15 | F-15 | (1) | R11 = (CH₂)₆ | R12 = (CH₃)₂—CHMe—(CH₂)₂ | m = 2.0, n = 18.0 |
| 16 | P-16 | G-16 | F-16 | (1) | R11 = (CH₂)₉ | R12 = CH₂—CHMe—(CH₂)₆ | m = 6.5, n = 3.5 |
| 17 | P-17 | G-17 | F-17 | (1) | R11 = (CH₂)₉ | R12 = CH₂—CHMe—(CH₂)₆ | m = 3.5, n = 6.5 |
| 18 | P-18 | G-18 | F-18 | (2) | o = 9.1, p = 5.5 | | |
| 19 | P-19 | G-19 | F-19 | (2) | o = 9.1, p = 5.5 | | |
| 20 | P-20 | G-20 | F-20 | (3) | R31 = (CH₂)₃ | R32 = (CH₂)₄ | q = 12, r = 5.1 |
| 21 | P-21 | G-21 | F-21 | (3) | R31 = (CH₂)₆ | R32 = (CH₂)₈ | q = 2.7, r = 6.3 |

| | | | | | | |
|---|---|---|---|---|---|---|
| 22 | P-22 | G-22 | F-22 | (4) | R41 = (CH₂)₆ | s = 13.2 |

| | | | | | |
|---|---|---|---|---|---|
| 23 | P-23 | G-23 | F-23 | (2) | o = 9.1, p = 5.5 |
| 24 | P-24 | G-24 | F-24 | (2) | o = 9.1, p = 5.5 |

Here, Ex means Example. (1) to (5) means “Formula (1)” to “Formula (5)”.

TABLE 37-2

| | Binder resin structure (structure (2)) | | | | | | |
|---|---|---|---|---|---|---|---|
| Ex | Structure (2) | | | | Additive structure | | |
| 1 | (4) | R41 = (CH₂)₆ | | s = 13.2 | (5) | R51 = C₄H₉ | t, u = 17 |
| 2 | (4) | R41 = (CH₂)₆ | | s = 13.2 | (5) | R51 = C₄H₉ | t, u = 17 |
| 3 | (4) | R41 = (CH₂)₆ | | s = 13.2 | (5) | R51 = C₄H₉ | t, u = 17 |
| 1 | (4) | R41 = (CH₂)₆ | | s = 13.2 | (5) | R51 = C₄H₉ | t, u = 17 |
| 5 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m = 4.1, n = 1.4 | (5) | R51 = C₄H₉ | t, u = 17 |
| 6 | (4) | R41 = (CH₂)₆ | | s = 20.1 | (5) | R51 = C₄H₉ | t, u = 17 |
| 7 | (4) | $R 41 = {CH}_{2} - CH < \begin{matrix}{( {CH}_{2} )}_{2} \\ {( {CH}_{2} )}_{2}\end{matrix} > CH - {CH}_{2}$ | | s = 5.8 | (5) | R51 = C₄H₉ | t, u = 17 |
| 8 | (4) | R41 = CH₂—CEtBu—CH₂ | | s = 4.6 | (5) | R51 = C₄H₉ | t, u = 17 |
| 9 | (2) | o = 9.1, p = 5.5 | | | (5) | R51 = C₄H₉ | t, u = 17 |
| 10 | (2) | o = 9.1, p = 5.5 | | | (5) | R51 = C₄H₉ | t, u = 17 |
| 11 | (2) | o = 9.1, p = 5.5 | | | (5) | R51 = C₄H₉ | t, u = 17 |
| 12 | (2) | o = 9.1, p = 5.5 | | | (5) | R51 = C₄H₉ | t, u = 17 |
| 13 | (2) | o = 9.1, p = 5.5 | | | (5) | R51 = C₄H₉ | t, u = 17 |
| 14 | (2) | o = 9.1, p = 5.5 | | | (5) | R51 = C₄H₉ | t, u = 17 |
| 15 | (2) | o = 9.1, p = 5.5 | | | (5) | R51 = C₄H₉ | t, u = 17 |
| 16 | (2) | o = 9.1, p = 5.5 | | | (5) | R51 = C₄H₉ | t, u = 17 |
| 17 | (2) | o = 9.1, p = 5.5 | | | (5) | R51 = C₄H₉ | t, u = 17 |
| 18 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m, n = 2.7 | (5) | R51 = C₄H₉ | t, u = 17 |
| 19 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m = 4.1, n = 1.4 | (5) | R51 = C₄H₉ | t, u = 17 |

| 20 | (4) | R41 = (CH₂)₆ | s = 13.2 | (5) | R51 = C₄H₉ | t, u = 17 |
|---|---|---|---|---|---|---|
| 21 | (4) | R41 = (CH₂)₆ | s = 13.2 | (5) | R51 = C₄H₉ | t, u = 17 |
| 22 | (2) | o = 9.1, p = 5.5 | | (5) | R51 = C₄H₉ | t, u = 17 |
| 23 | (4) | $R 41 = {CH}_{2} - CH < \begin{matrix}{( {CH}_{2} )}_{2} \\ {( {CH}_{2} )}_{2}\end{matrix} > CH - {CH}_{2}$ | s = 5.8 | (5) | R51 = C₄H₉ | t, u = 17 |
| 24 | (4) | R41 = CH₂—CEtBu—CH₂ | s = 4.6 | (5) | R51 = C₄H₉ | t, u = 17 |

Here, Ex means Example. “PC No.” means “Process cartridge No.”. “DR No.” means “Developing roller No.”. “CL No.” means “Coating liquid for forming resin layer No.”. (1) to (2) means “Formula (1)” to “Formula (2)”.

TABLE 37-3

| | PC | DR | CL | Binder resin structure (structure (1)) | | | |
|---|---|---|---|---|---|---|---|
| Ex | No. | No. | No. | Structure (1) | | | |
| 25 | P-25 | G-25 | F-25 | (1) | R11 = (CH₂)₅ | R12 = (CH₂)₆ | m, n = 6.9 |
| | | | | (2) | o = 9.1, p = 5.5 | | |
| 26 | P-26 | G-26 | F-26 | (1) | R11 = (CH₂)₅ | R12 = (CH₂)₆ | m, n = 6.9 |
| 27 | P-27 | G-27 | F-27 | (1) | R11 = (CH₂)₅ | R12 = (CH₂)₆ | m, n = 6.9 |
| 28 | P-28 | G-28 | F-28 | (1) | R11 = (CH₂)₅ | R12 = (CH₂)₆ | m, n = 6.9 |
| 29 | P-29 | G-29 | F-29 | (1) | R11 = (CH₂)₅ | R12 = (CH₂)₆ | m, n = 6.9 |
| 30 | P-30 | G-30 | F-30 | (1) | R11 = (CH₂)₅ | R12 = (CH₂)₆ | m, n = 6.9 |
| 31 | P-31 | G-31 | F-31 | (1) | R11 = (CH₂)₅ | R12 = (CH₂)₆ | m, n = 6.9 |
| 32 | P-32 | G-32 | F-32 | (1) | R11 = (CH₂)₅ | R12 = (CH₂)₆ | m, n = 6.9 |
| 33 | P-33 | G-33 | F-33 | (1) | R11 = (CH₂)₅ | R12 = (CH₂)₆ | m, n = 6.9 |
| 34 | P-34 | G-34 | F-34 | (1) | R11 = (CH₂)₅ | R12 = (CH₂)₆ | m, n = 6.9 |
| 35 | P-35 | G-35 | F-35 | (1) | R11 = (CH₂)₅ | R12 = (CH₂)₆ | m, n = 6.9 |
| 36 | P-36 | G-36 | F-36 | (1) | R11 = (CH₂)₅ | R12 = (CH₂)₆ | m, n = 6.9 |
| 37 | P-37 | G-37 | F-37 | (1) | R11 = (CH₂)₅ | R12 = (CH₂)₆ | m, n = 6.9 |
| 38 | P-38 | G-38 | F-38 | (1) | R11 = (CH₂)₅ | R12 = (CH₂)₆ | m, n = 6.9 |
| 39 | P-39 | G-39 | F-39 | (1) | R11 = (CH₂)₅ | R12 = (CH₂)₆ | m, n = 6.9 |
| 40 | P-40 | G-40 | F-40 | (1) | R11 = (CH₂)₅ | R12 = (CH₂)₆ | m, n = 6.9 |
| 41 | P-41 | G-41 | F-41 | (1) | R11 = (CH₂)₅ | R12 = (CH₂)₆ | m, n = 6.9 |
| 42 | P-42 | G-42 | F-42 | (1) | R11 = (CH₂)₅ | R12 = (CH₂)₆ | m, n = 6.9 |
| 43 | P-43 | G-43 | F-43 | (1) | R11 = (CH₂)₅ | R12 = (CH₂)₆ | m, n = 6.9 |
| 44 | P-44 | G-44 | F-44 | (1) | R11 = (CH₂)₅ | R12 = (CH₂)₆ | m, n = 6.9 |
| 45 | P-54 | G-54 | F-54 | (1) | R11 = (CH₂)₅ | R12 = (CH₂)₆ | m, n = 6.9 |
| 46 | P-55 | G-55 | F-55 | (1) | R11 = (CH₂)₅ | R12 = (CH₂)₆ | m, n = 6.9 |
| 47 | P-56 | G-56 | F-56 | (1) | R11 = (CH₂)₅ | R12 = (CH₂)₆ | m, n = 6.9 |
| 48 | P-57 | G-57 | F-57 | (1) | R11 = (CH₂)₅ | R12 = (CH₂)₆ | m, n = 6.9 |
| 49 | P-58 | G-58 | F-58 | (1) | R11 = (CH₂)₅ | R12 = (CH₂)₆ | m, n = 6.9 |

Here, Ex means Example. (1) to (7) means “Formula (1)” to “Formula (7)”.

TABLE 37-4

| | | Binder resin structure (structure (2)) | | | | |
|---|---|---|---|---|---|---|
| Ex | | Structure (2) | | Additive structure | | |
| 25 | (4) | R41 = (CH₂)₆ | s = 13.2 | (5) | R51 = C₄H₉ | t, u = 17 |
| 26 | (2) | o = 9.1, p = 5.5 | | (5) | R51 = C₄H₉ | t, u = 17 |
| 27 | (4) | R41 = (CH₂)₆ | s = 13.2 | (5) | R51 = C₄H₉ | t, u = 17 |
| 28 | (4) | R41 = (CH₂)₆ | s = 13.2 | (5) | R51 = C₄H₉ | t, u = 17 |
| 29 | (4) | R41 = (CH₂)₆ | s = 13.2 | (5) | R51 = C₄H₉ | t, u = 30 |
| 30 | (4) | R41 = (CH₂)₆ | s = 13.2 | (5) | R51 = C₄H₉ | t = 9, u = 10 |
| 31 | (4) | R41 = (CH₂)₆ | s = 13.2 | (5) | R51 = C₁₂H₂₅ | t, u = 5 |
| 32 | (4) | R41 = (CH₂)₆ | s = 13.2 | (5) | R51 = C₁₂H₂₅ | t, u = 25 |
| 33 | (4) | R41 = (CH₂)₆ | s = 13.2 | (5) | R51 = C₈H₁₇ | t, u = 15 |
| 34 | (4) | R41 = (CH₂)₆ | s = 13.2 | (5) | R51 = CH₃ | t, u = 12 |
| 35 | (4) | R41 = (CH₂)₆ | s = 13.2 | (6) | R61 = CH₃ | v = 6, w = 29 |
| 36 | (4) | R41 = (CH₂)₆ | s = 13.2 | (6) | R61 = CH₃ | v = 6, w = 29 |
| 37 | (4) | R41 = (CH₂)₆ | s = 13.2 | (6) | R61 = CH₃ | v = 6, w = 29 |
| 38 | (4) | R41 = (CH₂)₆ | s = 13.2 | (6) | R61 = CH₃ | v = 1, w = 9 |
| 39 | (4) | R41 = (CH₂)₆ | s = 13.2 | (6) | R61 = C₈H₁₇ | v, w = 15 |
| 40 | (4) | R41 = (CH₂)₆ | s = 13.2 | (7) | R71 = C₁₂H₂₅ | x = 5 |
| 41 | (4) | R41 = (CH₂)₆ | s = 13.2 | (7) | R71 = C₁₂H₂₅ | x = 5 |
| 42 | (4) | R41 = (CH₂)₆ | s = 13.2 | (7) | R71 = C₁₂H₂₅ | x = 5 |
| 43 | (4) | R41 = (CH₂)₆ | s = 13.2 | (7) | R71 = CH₃ | x = 11 |
| 44 | (4) | R41 = (CH₂)₆ | s = 13.2 | (7) | R71 = C₈H₁₇ | x = 14 |
| 45 | (4) | R41 = (CH₂)₆ | s = 13.2 | (5) | R51 = C₄H₉ | t, u = 17 |
| 46 | (4) | R41 = (CH₂)₆ | s = 13.2 | (5) | R51 = C₄H₉ | t, u = 17 |
| 47 | (4) | R41 = (CH₂)₆ | s = 13.2 | (5) | R51 = C₄H₉ | t, u = 17 |
| 48 | (4) | R41 = (CH₂)₆ | s = 13.2 | (5) | R51 = C₄H₉ | t, u = 17 |
| 49 | (4) | R41 = (CH₂)₆ | s = 13.2 | (5) | R51 = C₄H₉ | t, u = 17 |

Here, Ex means Example. “PC No.” means “Process cartridge No.”. “DR No.” means “Developing roller No.”. PPB means “Primary particle diameter [nm]”. “DBP abs” means “DBP absorption [ml/100 g]”. MVSP means “Maximum value of surface potential [IV]”. “MHR Rz” means “Maximum height roughness Rz [μm]”. “MLRE Rsm” means “Mean length of roughness elements Rsm [μm]”.

TABLE 37-5

| | | | Carbon black | | | | Impedance | | | |
|---|---|---|---|---|---|---|---|---|---|---|
| | | | physical properties | | | | [Ω] | | MHR | MLRE |
| | PC | DR | PPB | DBP abs | | | @1.0 × | MVSP | Rz | Rsm |
| Ex | No. | No. | [nm] | [ml/100 g] | pH | X | 10¹ Hz | [V] | [μm] | [μm] |
| 1 | P-1 | G-1 | 24 | 51 | 2.5 | 3.2 | 9.12E+06 | 5.7 | 7 | 60 |
| 2 | P-2 | G-2 | 24 | 51 | 2.5 | 3.2 | 8.67E+06 | 12.5 | 7 | 60 |
| 3 | P-3 | G-3 | 24 | 51 | 2.5 | 3.2 | 2.32E+07 | 5.5 | 7 | 60 |
| 4 | P-4 | G-4 | 24 | 51 | 2.5 | 3.2 | 1.69E+07 | 6.2 | 7 | 70 |
| 5 | P-5 | G-5 | 24 | 51 | 2.5 | 3.2 | 7.41E+06 | 14.2 | 7 | 60 |
| 6 | P-6 | G-6 | 24 | 51 | 2.5 | 3.2 | 6.52E+06 | 8.1 | 7 | 60 |
| 7 | P-7 | G-7 | 24 | 51 | 2.5 | 3.2 | 1.52E+07 | 13.2 | 7 | 60 |
| 8 | P-8 | G-8 | 24 | 51 | 2.5 | 3.2 | 7.01E+06 | 10.5 | 7 | 60 |
| 9 | P-9 | G-9 | 24 | 51 | 2.5 | 3.2 | 2.79E+06 | 3.2 | 7 | 60 |
| 10 | P-10 | G-10 | 24 | 51 | 2.5 | 3.2 | 2.68E+06 | 2.8 | 7 | 60 |
| 11 | P-11 | G-11 | 24 | 51 | 2.5 | 3.2 | 1.52E+06 | 3.2 | 7 | 60 |
| 12 | P-12 | G-12 | 24 | 51 | 2.5 | 3.2 | 2.83E+06 | 4.5 | 7 | 60 |
| 13 | P-13 | G-13 | 24 | 51 | 2.5 | 3.2 | 3.82E+06 | 4.2 | 7 | 60 |
| 14 | P-14 | G-14 | 24 | 51 | 2.5 | 3.2 | 3.51E+06 | 3.6 | 7 | 60 |
| 15 | P-15 | G-15 | 24 | 51 | 2.5 | 3.2 | 3.39E+06 | 5.1 | 7 | 70 |
| 16 | P-16 | G-16 | 24 | 51 | 2.5 | 3.2 | 4.11E+06 | 4.7 | 7 | 60 |
| 17 | P-17 | G-17 | 24 | 51 | 2.5 | 3.2 | 4.22E+06 | 3.9 | 7 | 60 |
| 18 | P-18 | G-18 | 24 | 51 | 2.5 | 3.2 | 1.89E+06 | 2.6 | 7 | 60 |
| 19 | P-19 | G-19 | 24 | 51 | 2.5 | 3.2 | 1.57E+06 | 3.1 | 7 | 60 |
| 20 | P-20 | G-20 | 24 | 51 | 2.5 | 3.2 | 2.11E+06 | 3.5 | 7 | 60 |
| 21 | P-21 | G-21 | 24 | 51 | 2.5 | 3.2 | 1.98E+06 | 3.8 | 7 | 60 |
| 22 | P-22 | G-22 | 24 | 51 | 2.5 | 3.2 | 2.36E+06 | 3.2 | 7 | 60 |
| 23 | P-23 | G-23 | 24 | 51 | 2.5 | 3.2 | 2.25E+06 | 2.9 | 7 | 60 |
| 24 | P-24 | G-24 | 24 | 51 | 2.5 | 3.2 | 3.55E+06 | 3.6 | 7 | 60 |

Here, Ex means Example.

TABLE 37-6

| | Carbon black dispersion state | | | | | | | |
|---|---|---|---|---|---|---|---|---|
| | Equivalent circle diameter | | | | | | | |
| | of dispersed particles | | | Wall-to-wall distance | | | | |
| | Mean | Standard | | Mean | Standard | | | Ground |
| | value | deviation | | value | deviation | | Density | fogging |
| Ex | Rc [nm] | σc [nm] | σc/Rc | d [nm] | σd [nm] | σd/d | unevenness | evaluation |
| 1 | 55.2 | 33.1 | 0.600 | 111.6 | 64.1 | 0.574 | ⊚ | ◯ |
| 2 | 55.9 | 32.9 | 0.589 | 108.9 | 62.1 | 0.570 | ◯ | ◯ |
| 3 | 49.2 | 27.3 | 0.555 | 98.2 | 54.8 | 0.558 | ⊚ | ◯ |
| 4 | 51.7 | 29.6 | 0.573 | 97.9 | 55.2 | 0.564 | ⊚ | ◯ |
| 5 | 52.1 | 31.1 | 0.597 | 102.3 | 57.2 | 0.559 | ◯ | ◯ |
| 6 | 53.3 | 30.8 | 0.578 | 103.5 | 57.8 | 0.558 | ⊚ | ◯ |
| 7 | 51.3 | 31.2 | 0.608 | 101.5 | 58.2 | 0.573 | ◯ | ◯ |
| 8 | 50.9 | 30.1 | 0.591 | 101.8 | 57.9 | 0.569 | ◯ | ◯ |
| 9 | 54.3 | 31.8 | 0.586 | 100.7 | 56.9 | 0.565 | ◯ | ◯ |
| 10 | 53 | 32.1 | 0.606 | 102.3 | 57.6 | 0.563 | ◯ | ◯ |
| 11 | 59.2 | 38 | 0.642 | 103.8 | 57.2 | 0.551 | ◯ | ◯ |
| 12 | 57.1 | 34.9 | 0.611 | 104.3 | 58 | 0.556 | ◯ | ◯ |
| 13 | 53 | 32 | 0.604 | 105.6 | 57.9 | 0.548 | ◯ | ◯ |
| 14 | 55.1 | 32.2 | 0.584 | 106.5 | 60.2 | 0.565 | ◯ | ◯ |
| 15 | 54.2 | 32.2 | 0.594 | 106.1 | 59.9 | 0.565 | ◯ | ◯ |
| 16 | 51.4 | 30.1 | 0.586 | 105.8 | 60.2 | 0.569 | ◯ | ◯ |
| 17 | 52.2 | 32.4 | 0.621 | 103.5 | 60.2 | 0.582 | ◯ | ◯ |
| 18 | 58.1 | 34.1 | 0.587 | 106.8 | 61 | 0.571 | ◯ | ◯ |
| 19 | 57.1 | 35.2 | 0.616 | 107.6 | 61.2 | 0.569 | ◯ | ◯ |
| 20 | 58 | 34.7 | 0.598 | 106.5 | 60.9 | 0.572 | ◯ | ◯ |
| 21 | 59.1 | 34.9 | 0.591 | 104.9 | 61.1 | 0.582 | ◯ | ◯ |
| 22 | 58.2 | 35.3 | 0.607 | 105.8 | 60.9 | 0.576 | ◯ | ◯ |
| 23 | 56.1 | 35.2 | 0.627 | 106.8 | 60.9 | 0.570 | ◯ | ◯ |
| 24 | 57.3 | 35.4 | 0.618 | 103.5 | 58.8 | 0.568 | ◯ | ◯ |

Here, Ex means Example. “PC No.” means “Process cartridge No.”. “DR No.” means “Developing roller No.”. PPB means “Primary particle diameter [nm]”. “DBP abs” means “DBP absorption [ml/100 g]”. MVSP means “Maximum value of surface potential [IV]”. “MHR Rz” means “Maximum height roughness Rz [μm]”. “MLRE Rsm” means “Mean length of roughness elements Rsm [μm]”.

TABLE 37-7

| | | | Carbon black | | | | | | | |
|---|---|---|---|---|---|---|---|---|---|---|
| | | | physical properties | | | | Impedance | | MHR | MLRE |
| | | | | DBP abs | | | [Ω] @1.0 × | MVSP | Rz | Rsm |
| Ex | PC No. | DR No. | PPB [nm] | [ml/100 g] | pH | X | 10¹ Hz | [V] | [μm] | [μm] |
| 25 | P-25 | G-25 | 24 | 51 | 2.5 | 3.2 | 5.01E+06 | 4.5 | 7 | 60 |
| 26 | P-26 | G-26 | 24 | 51 | 2.5 | 3.2 | 3.11E+06 | 3.5 | 7 | 60 |
| 27 | P-27 | G-27 | 24 | 51 | 2.5 | 3.0 | 8.58E+06 | 4.5 | 7 | 60 |
| 28 | P-28 | G-28 | 24 | 51 | 2.5 | 7.0 | 6.55E+06 | 7.2 | 7 | 60 |
| 29 | P-29 | G-29 | 24 | 51 | 2.5 | 3.2 | 7.92E+06 | 6.8 | 7 | 60 |
| 30 | P-30 | G-30 | 24 | 51 | 2.5 | 3.2 | 7.71E+06 | 6.4 | 7 | 60 |
| 31 | P-31 | G-31 | 24 | 51 | 2.5 | 3.2 | 6.31E+06 | 5.9 | 7 | 60 |
| 32 | P-32 | G-32 | 24 | 51 | 2.5 | 3.2 | 5.47E+06 | 5.7 | 7 | 60 |
| 33 | P-33 | G-33 | 24 | 51 | 2.5 | 3.2 | 7.21E+06 | 6.9 | 7 | 60 |
| 34 | P-34 | G-34 | 24 | 51 | 2.5 | 3.2 | 6.74E+06 | 6.3 | 7 | 60 |
| 35 | P-35 | G-35 | 24 | 51 | 2.5 | 3.2 | 6.32E+06 | 5.1 | 7 | 60 |
| 36 | P-36 | G-36 | 24 | 51 | 2.5 | 3.0 | 5.89E+06 | 5.2 | 7 | 60 |
| 37 | P-37 | G-37 | 24 | 51 | 2.5 | 7.0 | 5.84E+06 | 4.9 | 7 | 60 |
| 38 | P-38 | G-38 | 24 | 51 | 2.5 | 3.2 | 5.10E+06 | 3.9 | 7 | 60 |
| 39 | P-39 | G-39 | 24 | 51 | 2.5 | 3.2 | 2.80E+06 | 4.8 | 7 | 60 |
| 40 | P-40 | G-40 | 24 | 51 | 2.5 | 3.2 | 2.25E+06 | 4.5 | 7 | 60 |
| 41 | P-41 | G-41 | 24 | 51 | 2.5 | 3.0 | 2.11E+06 | 3.8 | 7 | 60 |
| 42 | P-42 | G-42 | 24 | 51 | 2.5 | 7.0 | 2.37E+06 | 4.2 | 7 | 60 |
| 43 | P-43 | G-43 | 24 | 51 | 2.5 | 3.2 | 2.15E+06 | 3.8 | 7 | 60 |
| 44 | P-44 | G-44 | 24 | 51 | 2.5 | 3.2 | 2.27E+06 | 3.8 | 7 | 60 |
| 45 | P-54 | G-54 | 24 | 51 | 2.5 | 3.2 | 9.12E+06 | 5.7 | 10 | 90 |
| 46 | P-55 | G-55 | 24 | 51 | 2.5 | 3.2 | 9.12E+06 | 5.7 | 10 | 50 |
| 47 | P-56 | G-56 | 24 | 51 | 2.5 | 3.2 | 9.12E+06 | 5.7 | 15 | 90 |
| 48 | P-57 | G-57 | 24 | 51 | 2.5 | 3.2 | 9.12E+06 | 5.7 | 10 | 30 |
| 49 | P-58 | G-58 | 24 | 51 | 2.5 | 3.2 | 9.12E+06 | 5.7 | 10 | 130 |

Here, Ex means Example.

TABLE 37-8

| | Carbon black dispersion state | | | | | | | |
|---|---|---|---|---|---|---|---|---|
| | Equivalent circle diameter | | | | | | | |
| | of dispersed particles | | | Wall-to-wall distance | | | | |
| | Mean | Standard | | Mean | Standard | | | Ground |
| | value | deviation | | value | deviation | | Density | fogging |
| Ex | Rc [nm] | σc [nm] | σc/Rc | d [nm] | σd [nm] | σd/d | unevenness | evaluation |
| 25 | 54.3 | 34.1 | 0.628 | 102.7 | 58.1 | 0.566 | ⊚ | ◯ |
| 26 | 53.1 | 33.3 | 0.627 | 100.2 | 57.6 | 0.575 | ◯ | ◯ |
| 27 | 57.4 | 34.5 | 0.601 | 99.8 | 56.6 | 0.567 | ⊚ | ◯ |
| 28 | 56.1 | 34.2 | 0.610 | 101.2 | 57 | 0.563 | ⊚ | ◯ |
| 29 | 57.2 | 34 | 0.594 | 103.5 | 58.1 | 0.561 | ⊚ | ◯ |
| 30 | 57 | 34.9 | 0.612 | 98.7 | 56.7 | 0.574 | ⊚ | ◯ |
| 31 | 56.2 | 34.5 | 0.614 | 101.7 | 57.1 | 0.561 | ⊚ | ◯ |
| 32 | 55.2 | 34.2 | 0.620 | 102.4 | 58 | 0.566 | ⊚ | ◯ |
| 33 | 56.7 | 33.8 | 0.596 | 100.8 | 57.4 | 0.569 | ⊚ | ◯ |
| 34 | 57.2 | 35.1 | 0.614 | 100.7 | 56.9 | 0.565 | ⊚ | ◯ |
| 35 | 55 | 32 | 0.582 | 102.3 | 57.4 | 0.561 | ⊚ | ◯ |
| 36 | 55.1 | 33.1 | 0.601 | 103.8 | 56.9 | 0.548 | ⊚ | ◯ |
| 37 | 56.1 | 33.8 | 0.602 | 104.6 | 57.3 | 0.548 | ⊚ | ◯ |
| 38 | 55.7 | 33.5 | 0.601 | 105.7 | 61 | 0.577 | ⊚ | ◯ |
| 39 | 58.2 | 35.2 | 0.605 | 114.6 | 67.4 | 0.588 | ⊚ | ◯ |
| 40 | 59 | 37.9 | 0.642 | 130.3 | 77.6 | 0.596 | ⊚ | ◯ |
| 41 | 58.2 | 37.1 | 0.637 | 135.6 | 78.9 | 0.582 | ⊚ | ◯ |
| 42 | 58.3 | 37.2 | 0.638 | 137.8 | 78.2 | 0.567 | ⊚ | ◯ |
| 43 | 58.9 | 37 | 0.628 | 143.5 | 83.2 | 0.580 | ⊚ | ◯ |
| 44 | 57.9 | 37.2 | 0.642 | 127.5 | 74.1 | 0.581 | ⊚ | ◯ |
| 45 | 55.2 | 33.1 | 0.600 | 111.6 | 64.1 | 0.574 | ⊚ | ◯ |
| 46 | 55.2 | 33.1 | 0.600 | 111.6 | 64.1 | 0.574 | ⊚ | ◯ |
| 47 | 55.2 | 33.1 | 0.600 | 111.6 | 64.1 | 0.574 | ⊚ | ◯ |
| 48 | 55.2 | 33.1 | 0.600 | 111.6 | 64.1 | 0.574 | ◯ | ◯ |
| 49 | 55.2 | 33.1 | 0.600 | 111.6 | 64.1 | 0.574 | ◯ | ◯ |

The impedance value indicates the minimum value of the impedance value at a frequency of 1.0×10⁰ Hz to 1.0×10¹ Hz. Note that description such as “9.12E+06” indicates “9.12×10⁶” ˜.

### Comparative Example 1

The types and amounts of materials shown in Table 38 were added to a reaction vessel and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-45 for forming a resin layer. Except that the coating liquid F-1 for forming a resin layer was changed to the coating liquid F-45 for forming a resin layer, in the same manner as in Example 1, a developing roller G-45 and a process cartridge P-45 were produced and then evaluated. The evaluation results are shown in Table 43.

TABLE 38

| | Parts |
|---|---|
| Material | by mass |
| Polytetramethylene glycol ether polyol | 25 |
| (trade name: PTG1000SN, Hodogaya Chemical Co., Ltd.) | |
| Polycarbonate polyol | 75 |
| (trade name: T5651, Asahi Kasei Chemicals Corporation) | |
| Isocyanate | 55.5 |
| (trade name: CORONATE HX, Tosoh Corporation) | |
| Carbon black | 30 |
| (trade name: MA8, Mitsubishi Chemical Corporation) | |
| Coarse particles | 20 |
| (trade name: ART PEARL C-400T, | |
| Negami Chemical Industrial Co., Ltd.) | |

### Comparative Examples 2 and 3

Except that the carbon black used in the coating liquid F-1 for forming a resin layer was changed to the materials shown in Table 39, in the same manner as in Example 1, coating liquids F-46 and F-47 for forming a resin layer and developing rollers G-46 and G-47 were produced, process cartridges P-46 and P-47 were produced, and evaluation was performed. The evaluation results are shown in Table 43. Here, Ex means Example and CE means “Comparative Example”. “PC No.” means “Process cartridge No.”. “DR No.” means “Developing roller No.”. “CL No.” means “Coating liquid for forming resin layer No.”. PPD means “Primary particle diameter [nm]”. “DBP abs” means “DBP absorption [ml/100 g]”. MA8, MA230 and MA14 are manufactured by Mitsubishi Chemical Corporation.

TABLE 39

| | | | | Carbon black material | | | |
|---|---|---|---|---|---|---|---|
| | | | | Material | PPD | DBP abs | |
| | PC No. | DR No. | CL No. | name | [nm] | [ml/100 g] | pH |
| Ex 1 | P-1 | G-1 | F-1 | MA8 | 24 | 51 | 2.5 |
| CE 2 | P-46 | G-46 | F-46 | MA230 | 30 | 113 | 3 |
| CE 3 | P-47 | G-47 | F-47 | MA14 | 40 | 73 | 3 |

### Comparative Examples 4 to 6

Except that the additive used in the coating liquid F-1 for forming a resin layer was changed to the materials and parts by mass shown in Table 40, in the same manner as in Example 1, coating liquids F-48 to F-50 for forming a resin layer and developing rollers G-48 to G-50 were produced, process cartridges P-48 to P-50 were produced, and evaluation was performed. The evaluation results are shown in Table 43. Here, Ex means Example and CE means “Comparative Example”. “PC No.” means “Process cartridge No.”. “DR No.” means “Developing roller No.”. “CL No.” means “Coating liquid for forming resin layer No.”.

TABLE 40

| | | | | Additive | |
|---|---|---|---|---|---|
| | PC | DR | CL | | Parts |
| | No. | No. | No. | Material | by mass |
| Ex 1 | P-1 | G-1 | F-1 | E-1 | 7 |
| CE 4 | P-48 | G-48 | F-48 | E-1 | 5.25 |
| CE 5 | P-49 | G-49 | F-49 | Silane coupling agent | 14 |
| | | | | (trade name: A-187, | |
| | | | | Momentive Inc.) | |
| CE 6 | P-50 | G-50 | F-50 | Polymer-based dispersant | 24.5 |
| | | | | (trade name: Disper byk-185, | |
| | | | | BYK-Chemie GmbH) | |

### Comparative Example 7

Except that the additive used in the coating liquid F-1 for forming a resin layer was changed to E-14 shown in Table 41, in the same manner as in Example 1, a coating liquid F-51 for forming a resin layer and a developing roller G-51 were produced, a process cartridge P-51 was produced, and evaluation was performed. The evaluation results are shown in Table 43.

### Comparative Example 8

### <Synthesis of Additive E-15>

An additive E-15, which is a polyether amine, was obtained by synthesizing polyoxyethylene polyoxypropylene decyl ether, oxidizing a secondary alcohol to form a ketone, and then performing reductive amination.

### (Synthesis of Polyoxyethylene Polyoxypropylene Decyl Ether)

205.8 g of 1-decanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

The obtained ethylene oxide adduct was cooled to 130° C., and then 1,132.6 g of propylene oxide (15 mol relative to alcohol) was charged. After completion of the charging, the reaction was carried out at 130° C. for 5 hours to obtain a polyoxyethylene polyoxypropylene decyl ether adduct, which is a block polymer having an average number of added moles of 15 mol of ethylene oxide and 15 mol of propylene oxide.

The obtained polyoxyethylene polyoxypropylene octyldecyl adduct was cooled to 80° C., and unreacted ethylene oxide and propylene oxide were removed at 2.5 kPa for 30 minutes. Next, 6.0 g of 90% lactic acid was charged into the autoclave, stirred at 80° C. for 30 minutes, and then extracted to obtain polyoxyethylene polyoxypropylene decyl ether.

### (Synthesis of Polyether Amine E-15)

A stirrer was attached to a three-neck flask, and 1,688 g of polyoxyethylene polyoxypropylene decyl ether and 460 ml of acetic acid were charged. 600 ml of a 2 mol/l aqueous sodium hypochlorite solution was added dropwise thereto over 1 hour. The reaction vessel was cooled in an ice bath so that the temperature was in the range of 15 to 25° C. After completion of the dropwise addition, stirring was continued for 1 hour. Dichloromethane was added to the obtained solution, and the aqueous layer was extracted and post-treated and purified by a column to obtain a compound in which a secondary alcohol was converted into a ketone.

The mixture was cooled to 0° C. in an ice bath, 250 ml of a methanol-acetic acid mixed solution (volume ratio 10:1) was added to 41.4 g of a compound in which the obtained secondary alcohol was converted into a ketone, and 2.7 g of 2-picoline-borane was added. The ice bath was removed, and the mixture was stirred overnight at room temperature in an open system. After concentration, the mixture was cooled to 0° C., 360 ml of a 35% aqueous hydrochloric acid solution was added, and the mixture was stirred at room temperature for 2 hours. An aqueous sodium hydroxide solution was added to make the mixture basic, and the aqueous layer was extracted with dichloromethane and post-treated and purified by a column to obtain a polyether amine E-15. The structure of R61 in E-15 and the values of v and w are shown in Table 41.

### <Synthesis of Coating Liquid F-52 for Forming Resin Layer and Developing Roller G-52>

Except that the additive used in the coating liquid F-1 for forming a resin layer was changed to the additive E-15, in the same manner as in Example 1, a coating liquid F-52 for forming a resin layer and a developing roller G-52 were produced, a process cartridge P-52 was produced, and evaluation was performed. The evaluation results are shown in Table 43.

### Comparative Example 9

### <Synthesis of Additive E-16>

315.2 g of 1-hexadecanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged.

The reaction was carried out at 150° C. for 1 hour to obtain an ethylene oxide adduct having an average number of added moles of 15 mol.

90.2 g of the obtained ethylene oxide adduct and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-16. The structure of R71 in E-16 and the value of x are shown in Table 41.

### <Synthesis of Coating Liquid F-53 for Forming Resin Layer and Developing Roller G-53>

Except that the additive used in the coating liquid F-1 for forming a resin layer was changed to the additive E-16, in the same manner as in Example 1, a coating liquid F-53 for forming a resin layer and a developing roller G-53 were produced, a process cartridge P-53 was produced, and evaluation was performed. The evaluation results are shown in Table 43. Here, (5) to (7) means “Formula (5)” to “Formula (7)”.

TABLE 41

| No. | Material | Structure | | |
|---|---|---|---|---|
| E-14 | Polyoxyethylene polyoxypropylene | (5) | R51 = C₁₆H₃₃ | t = 20, |
| | cetyl ether (trade name: UNISAFE | | | u = 8 |
| | 20P-8, NOF corporation) | | | |
| E-15 | Polyether amine | (6) | R61 = C₁₀H₂₁ | v, |
| | | | | w = 15 |
| E-16 | Polyoxyethylene hexadecyl ether | (7) | R71 = C₁₆H₃₃ | x = 14 |
| | acetate | | | |

### Comparative Examples 10 and 11

### <Preparation of Coating Liquids F-59 and F-60 for Forming Resin Layer>

Except that the coarse particles were changed as shown in Table 42 in Table 33 for the coating liquids F-59 and F-60 for forming a resin layer, coating liquids F-59 and F-60 for forming a resin layer were produced in the same manner as in the coating liquid F-1 for forming a resin layer, developing rollers G-59 and G-60 and process cartridges P-59 and P-60 were produced, and evaluation was performed. The evaluation results are shown in Tables 43-1 and 43-2.

TABLE 42

| Coating liquid | | |
|---|---|---|
| for forming | | Parts |
| resin layer No. | Coarse particles | by mass |
| F-1 | Coarse particles H-1 (trade name: | 23 |
| | ART PEARL C-400T, Negami | |
| | Chemical Industrial Co., Ltd.) | |
| F-59 | Coarse particles H-4 (trade name: | 20 |
| | ART PEARL C-600T, Negami | |
| | Chemical Industrial Co., Ltd.) | |
| F-60 | Coarse particles H-4 (trade name: | 43 |
| | ART PEARL C-600T, Negami | |
| | Chemical Industrial Co., Ltd.) | |

Here, CE means “Comparative Example”. “PC No.” means “Process cartridge No.”. “DR No.” means “Developing roller No.”. PPD means “Primary particle diameter [nm]”. “DBP abs” means “DBP absorption [ml/100 g]”. MVSP means “Maximum value of surface potential [V]”. “MHR Rz” means “Maximum height roughness Rz [μm]”. “MLRE Rsm” means “Mean length of roughness elements Rsm [μm]”.

TABLE 43-1

| | | | Carbon black | | | | | | | |
|---|---|---|---|---|---|---|---|---|---|---|
| | | | physical properties | | | | Impedance | | | MLRE |
| | | | PPD | DBP abs | | | [Ω] @1.0 × | MVSP | MHR | Rsm |
| CE | PC No. | DR No. | [nm] | [ml/100 g] | pH | X | 10¹ Hz | [V] | Rz[μm] | [μm] |
| 1 | P-45 | G-45 | 24 | 51 | 25 | — | 3.96E+05 | 3.7 | 7 | 75 |
| 2 | P-46 | G-46 | 30 | 113 | 3 | — | 2.25E+04 | 2.4 | 7 | 60 |
| 3 | P-47 | G-47 | 40 | 73 | 3 | — | 1.59E+05 | 8.7 | 7 | 60 |
| 4 | P-48 | G-48 | 24 | 51 | 25 | 2.4 | 4.56E+05 | 3.5 | 7 | 60 |
| 5 | P-49 | G-49 | 24 | 51 | 25 | 6.2 | 2.00E+08 | 462.0 | 7 | 60 |
| 6 | P-50 | G-50 | 24 | 51 | 25 | 10.3 | 4.18E+05 | 4.6 | 7 | 60 |
| 7 | P-51 | G-51 | 24 | 51 | 25 | 3.2 | 1.56E+05 | 7.6 | 7 | 60 |
| 8 | P-52 | G-52 | 24 | 51 | 25 | 3.2 | 1.18E+05 | 6.8 | 7 | 60 |
| 9 | P-53 | G-53 | 24 | 51 | 25 | 3.2 | 8.92E+04 | 2.5 | 7 | 60 |
| 10 | P-59 | G-59 | 24 | 51 | 2.5 | 3.2 | 9.12E+06 | 5.7 | 5 | 200 |
| 11 | P-60 | G-60 | 24 | 51 | 2.5 | 3.2 | 9.12E+06 | 5.7 | 5 | 90 |

Here, CE means “Comparative Example”.

TABLE 43-2

| | Carbon black dispersion state | | | | | | | |
|---|---|---|---|---|---|---|---|---|
| | Equivalent circle diameter | | | | | | | |
| | of dispersed particles | | | Wall-to-wall distance | | | | |
| | Mean | Standard | | Mean | Standard | | | Ground |
| | value | deviation | | value | deviation | | Density | fogging |
| CE | Rc | σc | σc/Rc | d | σd | σd/d | unevenness | evaluation |
| 1 | 92.9 | 60.7 | 0.653 | 146.8 | 95.6 | 0.651 | X | ◯ |
| 2 | 88 | 56 | 0.636 | 130.1 | 79.5 | 0.611 | X | ◯ |
| 3 | 104 | 79.7 | 0.766 | 205.8 | 130.7 | 0.635 | X | ◯ |
| 4 | 86.8 | 57 | 0.657 | 129.8 | 80.1 | 0.617 | X | ◯ |
| 5 | 57 | 34 | 0.596 | 112.7 | 63.8 | 0.566 | X | X |
| 6 | 87.8 | 55.5 | 0.632 | 130.7 | 79.5 | 0.608 | X | ◯ |
| 7 | 89.1 | 57.6 | 0.646 | 148.2 | 98.7 | 0.666 | X | ◯ |
| 8 | 92 | 61 | 0.663 | 145.7 | 97.6 | 0.670 | X | ◯ |
| 9 | 96.1 | 65 | 0.676 | 152.3 | 100.2 | 0.658 | X | ◯ |
| 10 | 55.2 | 33.1 | 0.600 | 111.6 | 64.1 | 0.574 | X | ◯ |
| 11 | 55.2 | 33.1 | 0.600 | 111.6 | 64.1 | 0.574 | X | ◯ |

In the table, X represents the total amount (mass %) of the compounds having the structures represented by Structural Formulas (5) to (7) based on the solid content in the coating liquid for forming a resin layer.

The impedance value indicates the minimum value of the impedance value at a frequency of 1.0×10⁰ Hz to 1.0×10¹ Hz.

Examples 1 to 49 show favorable results in the image density unevenness and the ground fogging evaluation. In particular, it is preferable to use a polyurethane having only a polycarbonate structure and having a combination of Structural Formula (1) and Structural Formula (4) in order to achieve a suitable impedance and surface potential range of the developing roller. Since an ester structure is present in Structural Formula (2) and Structural Formula (3), and the ester structure is more electrically conductive than the polycarbonate structure, it is considered that the combination of Structural Formula (1) and Structural Formula (4) having only the polycarbonate structure shows favorable results.

Furthermore, in Examples 1 to 49, in the developing region, the surface of the developing roller is within a shape range that allows it to protrude from the toner layer, thereby suppressing image density unevenness. In addition, when the mean length of roughness elements Rsm of the roughness profile is within an appropriate range, the image density unevenness can be more preferably suppressed. Rsm can be considered as a parameter having a strong correlation with the distance between the protrusions due to the coarse particles in the developing roller containing the coarse particles on the surface of the resin layer. Therefore, when Rsm is in an appropriate range, since the surface of the developing roller protrudes from the toner layer at an appropriate density, the contact between the photosensitive drum and the toner layer does not become excessive, the decrease in the potential of the surface of the photosensitive drum can be more effectively suppressed, and the effect of suppressing the image density unevenness is sufficiently obtained.

As illustrated in FIG. 20C, when the coarse particles are densely packed and Rsm is 40 μm or less, since there is a portion where the toner layer is formed on the top of the surface irregularities of the developing roller, charge transfer from the photosensitive drum to the toner layer may occur in the developing region depending on the charge state of the toner. In addition, when Rsm is 120 μm or more, the ratio of the area where the photosensitive drum and the developing roller are in contact with each other in the developing region is small, and the contact area between the photosensitive drum and the toner layer is large. Therefore, it is considered that the influence of charge transfer from the photosensitive drum to the toner layer may occur depending on the charge state of the toner.

On the other hand, in Comparative Examples 1 to 11, favorable results were not obtained in the image density unevenness and the ground fogging.

In Comparative Example 1, a polyether diol and a polycarbonate diol are used, and both an ether structure and a polycarbonate structure are incorporated in a polyurethane structure. As a result, it is considered that electrical characteristics due to the polycarbonate structure are inhibited by the ether structure, and a desired impedance value cannot be obtained. Therefore, it is considered that favorable results were not obtained.

In Comparative Examples 2 and 3, desired impedance values were also not obtained, and favorable results were not obtained. It is considered that the reason why the impedance value was decreased is that carbon black having a greater number average diameter of primary particles and a greater DBP absorption was used, the structure of the carbon black after milling dispersion was increased, the dispersion particle diameter was increased, and the wall-to-wall distance was also increased.

In Comparative Example 4, a desired impedance value was also not obtained, and favorable results were not obtained. It is considered that the impedance value decreased because the amount of additive was small, the dispersibility of the conductive filler became insufficient, and a conductive path formed by the conductive filler was formed in the surface layer.

In Comparative Example 5, since the surface potential was too high, favorable results of image density unevenness and ground fogging were not obtained. In particular, the ground fogging evaluation was conspicuous. It is considered that this result occurred because the carbon black was coated with an insulating silane coupling agent, which caused an increase in surface potential.

In Comparative Example 6, the impedance was low, and favorable results were not obtained. It is considered that the reason for the decrease in impedance is that although a polymer dispersant suitable for dispersing carbon black was used, the dispersibility of the carbon black in the resin was not improved, and furthermore, since a large amount of dispersant was added, the electrical characteristics of the resin were affected.

In Comparative Examples 7 to 9 as well, the impedance was low, and favorable results were not obtained in the image density unevenness and fogging evaluation. It is considered that the reason for the decrease in impedance is that the carbon chains R51, R61, and R71 of Structural Formulas (5), (6), and (7), which were used in Comparative Examples 7 to 9, exceeded the desired ranges, resulting in reduced dispersibility of the carbon black and a decrease in impedance.

In Comparative Example 10, favorable results were not obtained in the image density unevenness. It is considered that since the maximum height roughness Rz of the surface of the developing roller is greater than the toner average particle diameter, the surface of the developing roller does not protrude from the toner layer in the developing region, the contact between the photosensitive drum and the toner layer becomes dominant, and the charge transfer from the photosensitive drum to the toner layer increases. In addition, it is considered that the mean length of roughness elements Rsm of the roughness profile is large, the contact between the photosensitive drum and the toner layer becomes dominant in the developing region, and the charge transfer from the photosensitive drum to the toner layer increases.

In Comparative Example 11 as well, it is considered that the maximum height roughness of the surface of the developing roller was small, the surface layer of the developing roller did not sufficiently protrude, charge was excessively imparted from the photosensitive drum to the toner layer in the developing region, the drum surface potential was lowered, and favorable results were not obtained in terms of image density unevenness.

Hereinafter, preferred examples of the present disclosure will be exemplarily described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

In the present disclosure, the description “XX or more and YY or less” or “XX to YY” representing a numerical range means a numerical range including a lower limit and an upper limit which are endpoints, unless otherwise specified. When the numerical ranges are listed in stages, the upper limit and the lower limit of each numerical range can be combined as appropriate. In addition, in the present disclosure, the description such as “at least one selected from the group consisting of XX, YY and ZZ” means any of XX, YY, ZZ, a combination of XX and YY, a combination of XX and ZZ, a combination of YY and ZZ, or a combination of XX and YY and ZZ.

The present inventors consider details of solving the problem by the methods described above as follows.

First, as a countermeasure against the fogging described above, the present inventors have considered a combination of a developing roller in which a surface layer is formed using a polyurethane having only a polycarbonate structure (hereinafter, referred to as polycarbonate urethane) with a developing blade to which a high voltage is applied.

As a result, although the charge leakage from the toner to the developing roller can be prevented, a new problem that the excessively charged toner adhered to the surface of the developing roller occurred due to the excessively high electrical resistance of the surface layer.

Therefore, the present inventors have studied removal of excess charge from an excessively charged toner. For example, as a result of examining inclusion of a conductive filler in the surface layer, the present inventors have found a new issue that it is difficult to sufficiently disperse the conductive filler in polycarbonate urethane. When the dispersibility of the conductive filler is insufficient, a conductive path formed by the conductive filler in the surface layer may cause charge leakage, or conversely, the expected effect of removing excess charge by the conductive filler may be insufficient.

That is, the present inventors have recognized that it is necessary to develop a novel surface layer capable of removing excess charge while maintaining a high electrical resistance of the surface layer in order to solve the contradictory problems such as prevention of charge leakage from the toner in the surface layer containing polycarbonate urethane and removal of excess charge from excessively charged toner at a high level. Based on such recognition, the present inventors have further studied.

As a result, the present inventors have recognized that, for an electrophotographic roller including a substrate having a conductive outer surface and a resin layer containing a polyurethane having a polycarbonate structure (hereinafter, also referred to as a “developing roller”), the resin layer being provided on the outer surface of the substrate, it is effective to satisfy the following two requirements in order to solve the above two conflicting problems at a high level.

### Requirement (1)

A metal film is directly provided on an outer surface of an electrophotographic roller, and in an environment of a temperature of 23° C. and a relative humidity of 50%, a DC voltage of 50 V is applied between the outer surface of the substrate and the metal film, while an AC voltage having an amplitude of 50 V is applied with a frequency varied in a range of 1.0×10⁻¹ to 1.0×10⁵ Hz. At this time, the impedance at the frequency of 1.0×10¹ to 1.0×10¹ Hz is 1.00×10⁶Ω or more.

### Requirement (2)

In an environment of a temperature of 23° C. and a relative humidity of 50%, a corona discharger having a grid portion having a width of 3.0 mm is disposed so that a distance between the grid portion and the outer surface of the electrophotographic roller is 1.0 mm, and a direction of the width of the grid coincides with an axial direction of the electrophotographic roller. Then, a voltage of 8 kV is applied to the grid portion, the corona discharger is relatively moved at a speed of 400 mm/sec along the axial direction of the electrophotographic roller to charge the outer surface of the electrophotographic roller, and a potential of the outer surface after 0.06 seconds from the passage of the grid is measured. The maximum value of the potential at this time is less than 20.0 V.

Hereinafter, the requirements (1) and (2) will be described in detail.

### <Technical Significance of Requirement (1)>

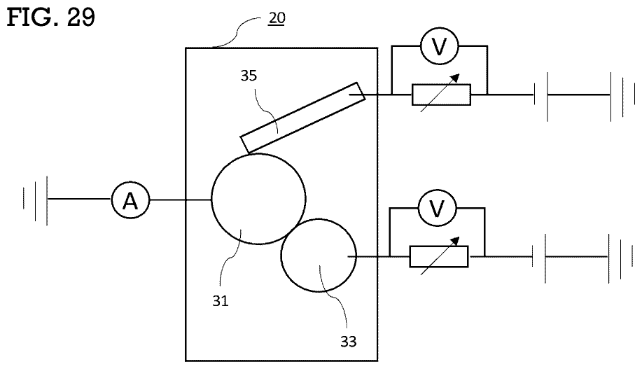

In the requirement (1), a numerical value of the impedance of the electrophotographic roller is defined. The impedance is a physical property value indicating charge leakage from the toner to the electrophotographic roller. The present inventors measured a current value (leakage current value) flowing through the electrophotographic roller when a blade bias is applied to the developing blade according to the circuit diagram illustrated in FIG. 29. As a result, it was found that the current value has a higher correlation with the impedance value of the electrophotographic roller than the electrical resistance value of the electrophotographic roller.

That is, the charge leakage indicates that it is necessary to consider the influence of not only a resistance component of the electrophotographic roller but also an electrostatic capacitance component. This is considered to be because when the electrical characteristics of the electrophotographic roller are represented in a pseudo manner by an RC parallel circuit, charge is sufficiently stored in a capacitor component, and a transient state until reaching a steady state in which the resistance component is dominant greatly affects charge leakage.

The voltage application condition for impedance measurement is obtained by superimposing an AC voltage of 50 V on a DC voltage of 50 V. That is, a sine wave having a minimum value and a maximum value of the applied voltage of 0 V and 100 V (Vpp 100 V), respectively, is applied. The value of Vpp 100 V is a value assumed to be the maximum divided voltage applied to the electrophotographic roller when a voltage is applied so that a voltage difference of 300 V is applied between the electrophotographic roller and the developing blade in an electrophotographic image forming apparatus.

The impedance shows bias dependency, and has a property that the impedance decreases as the bias increases, but it is known that the degree of decrease varies depending on the electrophotographic roller. In the conventional impedance measurement of the electrophotographic roller, the condition that the voltage application condition is the AC voltage of 1 V is generally used, but under the application condition of the AC voltage of 1 V, the voltage is clearly smaller than the voltage (generally several hundred V) applied between the electrophotographic roller and the developing blade in the actual electrophotographic image forming apparatus. Therefore, in many cases, the behavior of the electrophotographic roller in the electrophotographic image forming apparatus cannot be accurately simulated, and such conditions are often unsuitable for impedance measurement.

Therefore, in the present disclosure, a voltage application condition simulating a high blade bias applied to an actual electrophotographic image forming apparatus is adopted. In addition, a sine wave having a minimum value of the applied voltage of 0 V simulates a rectangular wave generally used for blade bias application of an actual electrophotographic image forming apparatus.

In the present disclosure, the impedance at the frequency of 1.0×10⁰ to 1.0×10¹ Hz is specified, and a low frequency range of the frequency of 1.0×10⁰ to 1.0×10¹ Hz is a region where the transient state is completed and a steady state in which the resistance component is dominant is reached. That is, the influence of both the electrostatic capacitance component and the resistance component is reflected, and the region is suitable for grasping the charge leakage property from the toner to the electrophotographic roller. When the impedance at the frequency of 1.0×10⁰ to 1.0×10¹ Hz is 1.00×10⁶Ω or more, the charge leakage is low, charge leakage from the toner to the electrophotographic roller is suppressed under a high blade bias, and a decrease in the charge amount of toner can be prevented. As a result, fogging can be suppressed, and excellent image density stability can be obtained.

In addition, when talc paper or the like is used as the medium, charge can be applied to the filler collected in the developing container via the photosensitive drum in the process of passing between the electrophotographic roller and the developing blade, such that the filler that cannot be transferred due to a low charge amount can be transferred. Therefore, the amount accumulated in the developing container can be suppressed. As a result, even when talc paper or the like is used as the medium, the toner charging failure can be suppressed, such that fogging can be suppressed, and excellent image density stability can be obtained.

The impedance at the frequency of 1.0×10⁰ to 1.0×10¹ Hz is preferably 1.40×10⁶Ω or more. The impedance value is preferably as high as possible. Although an upper limit of the impedance value is not particularly limited, the upper limit may be, for example, 5.00×10⁷Ω or less.

In addition, the minimum value of the impedance at the frequency of 1.0×10⁰ to 1.0×10¹ Hz is preferably 1.40×10⁶Ω or more, more preferably 2.00×10⁶Ω or more, particularly preferably 3.00×10⁶Ω or more, and still more preferably 5.00×10⁶Ω or more. A preferred range of the impedance is 1.00×10⁶Ω or more and 5.00×10⁷Ω or less, preferably 1.40×10⁶Ω or more and 5.00×10⁷Ω or less, more preferably 2.00×10⁶Ω or more and 5.00×10⁷Ω or less, particularly preferably 3.00×10⁶Ω or more and 5.00×10⁷Ω or less, and still more preferably 5.00×10⁶Ω or more and 5.00×10⁷Ω or less.

### <Technical Significance of Requirement (2)>

In the requirement (2), the surface potential of the electrophotographic roller is defined. The surface potential of the electrophotographic roller indicates a residual charge on the surface of the electrophotographic roller, and is a physical property value indicating a degree of excessive charging (charge-up) of the toner. When the surface potential is high, the charge of the excessively charged toner cannot be appropriately controlled, and a decrease in image density or fogging may occur.

Two factors are considered as causes of the decrease in image density. The first factor is that excessively charged toner becomes electrically adhered to the surface of the electrophotographic roller, making it impossible to charge the toner subsequently conveyed to the same location. The second factor is that, after the toner is removed from the surface of the electrophotographic roller, a residual charge remains on the surface of the electrophotographic roller, making it impossible to charge the toner subsequently conveyed to the same location.

In the present disclosure, when a voltage of 8 kV is applied to the grid portion and the corona discharger is relatively moved at a speed of 400 mm/sec along the axial direction of the electrophotographic roller, the potential of the outer surface of the electrophotographic roller is checked 0.06 seconds after the outer surface passes through the grid portion of the corona discharger. When the maximum value of the potential of the outer surface is less than 20.0 V, it is possible to suppress the occurrence of image defects due to excessive charging of the toner even in an electrophotographic image forming apparatus with a high process speed in which the time until the toner charged by the developing blade is conveyed to the photosensitive member is shorter. Note that a time of 0.06 seconds after passing through the grid portion of the corona discharger simulates a high-process-speed model.

The maximum value of the potential of the outer surface is preferably 15.0 V or less, and more preferably 10.0 V or less. The maximum value of the potential of the outer surface is preferably as low as possible. A lower limit of the maximum value is not particularly limited.

As a preferred range of the maximum value of the potential of the outer surface, for example, 0 V or more and less than 20.0 V, particularly, 0 V or more and 15.0 V or less, and further, 0 V or more and 10.0 V or less are preferable.

By satisfying the requirements (1) and (2), it is possible to solve, at a high level, the conflicting problems such as prevention of charge leakage from the toner to the electrophotographic roller and removal of excess charge from excessively charged toner. In addition, even when talc paper or the like is used as the medium, accumulation of the filler in the developing container can be suppressed. As a result, even when talc paper or the like is used as the medium, fogging can be suppressed, and excellent image density stability can be obtained.

There are no particular limitations on the methods for satisfying the requirements (1) and (2). Specifically, as will be described below, examples thereof include methods for improving the dispersibility of the conductive filler by using the following resin layer materials, conductive filler materials, and additives.

Hereinafter, preferred examples of the present disclosure will be exemplarily described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

### Example 1

### 1. Image Forming Apparatus

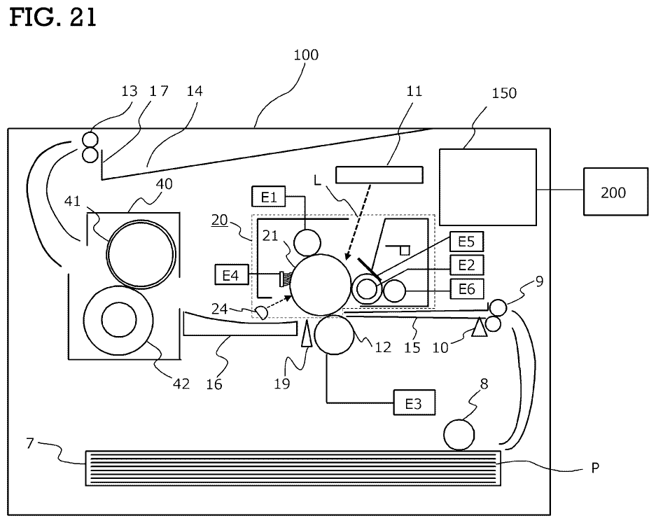

FIG. 21 is a schematic view of an image forming apparatus 100 of the present example. The image forming apparatus 100 of the present example is an electrophotographic laser printer, and can form an image on a recording material P (transfer material) according to image information input from an external device 200 such as a personal computer. Examples of the recording material P include various sheet materials of different materials, for example, paper such as plain paper, cardboard, or talc paper, a plastic film such as a sheet for an overhead projector, a sheet having a special shape such as an envelope and index paper, and cloth. First, the configuration of the image forming apparatus 100 of the present example will be described.

The image forming apparatus 100 includes a scanner unit 11, an electrophotographic process cartridge 20, and an image forming unit including a transfer roller 12 that transfers a toner image formed on a photosensitive drum 21 in the process cartridge 20 to a recording material P. The image forming apparatus 100 also includes a recording material feeding unit that conveys the recording material P to the transfer unit together with the operation of the image forming unit, a fixing device 40 that fixes the toner image formed on the recording material P in the transfer unit onto the recording material P, and a control unit 150 that controls the operation of the image forming apparatus.

When an image forming command is input to the image forming apparatus 100, an image forming process by the image forming unit is started on the basis of image information input from an external device 200 such as a personal computer connected to the image forming apparatus 100.

The control unit 150 is a controller that integrally controls the operation of the image forming apparatus 100. The control unit 150 executes a predetermined image forming sequence by controlling transmission and reception of various electrical information signals, drive timing, and the like. Each unit of the image forming apparatus 100 is connected to the control unit 150. For example, in relation to the present example, a charging power supply E1, a developing power supply E2, a transfer power supply E3, a brush power supply E4, a blade power supply E5, a supply roller power supply E6, a scanner unit 11 (exposure unit), a power supply of a fixing device, a drive motor, and the like are connected to the control unit 150.

### Image Forming Unit

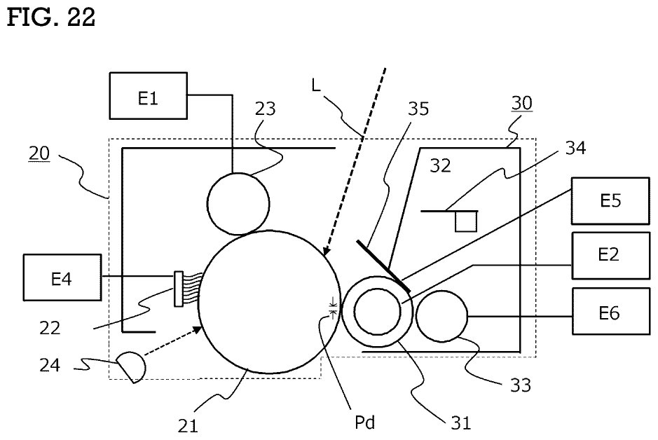

As illustrated in FIG. 22, the process cartridge 20 includes a developing device 30. The developing device 30 includes a developing roller 31 serving as a developer carrying member that carries a developer, a developing container 32 that serves as a frame of the developing device 30, a supply roller 33 that can supply a developer to the developing roller 31, a stirring member 34 that stirs toner in the developing container 32, and a developing blade 35 that uniformizes a toner layer on the developing roller 31. The developing roller 31, the supply roller 33, and the stirring member 34 are rotatably supported by the developing container 32. In addition, the developing roller 31 is disposed in an opening of the developing container 32 so as to face the photosensitive drum 21 serving as an image carrying member. The supply roller 33 is rotatably brought into contact with the developing roller 31, and the toner as the developer stored in the developing container 32 is applied to a surface of the developing roller 31 by the supply roller 33.

The stirring member 34 as a stirrer is provided inside the developing container 32. The stirring member 34 is driven to rotate, thereby stirring the toner in the developing container 32 and feeding the toner toward the developing roller 31 and the supply roller 33. In addition, the stirring member 34 has a role of circulating the toner not used for development but peeled off from the developing roller 31 in the developing container and evening the toner in the developing container.

In addition, the developing blade 35 formed of a stainless steel plate that regulates the amount of toner carried on the developing roller 31 is disposed in the opening of the developing container 32 in which the developing roller 31 is disposed.

The developer supplied to the surface of the developing roller 31 passes through a portion facing the developing blade 35 with the rotation of the developing roller 31, such that the developer is uniformly thinned and has a charge amount suitable for image formation. At this time, by making the width in the longitudinal direction of the toner carried on the developing roller 31 longer than the width of the recording material in a direction perpendicular to the conveyance direction of the recording material, the filler transferred from the recording material to the photosensitive drum 21 can be reliably collected into the developing container 32, and electric charge can also be applied to the filler when being carried on the developing roller 31 again, such that a larger amount of filler can be discharged from the developing device 30. When the filler transferred from the recording material to the photosensitive drum 21 cannot be collected in the developing container 32, contamination of the photosensitive drum 21 progresses, and contamination unevenness of the photosensitive drum 21 occurs. In this case, it has been confirmed that the contact unevenness between the developing roller 31 and the photosensitive drum 21 occurs, resulting in deterioration of the quality of a uniform image.

The developing device 30 of the present example uses a contact development method as a developing method. That is, the toner layer carried on the developing roller 31 is brought into contact with the photosensitive drum 21 in developing region (developing area Pd) where the photosensitive drum 21 and the developing roller 31 face each other. A developing voltage is applied to the developing roller 31 by a developing power supply E2 as a developing voltage application unit. A blade voltage is applied to the developing blade 35 by the blade power supply E5 which serves as a developing blade voltage application unit. In addition, a supply voltage is applied to the supply roller 33 by the supply roller power supply E6 which serves as a supply voltage application unit. As a result, the charge amount of the developer can be controlled to a state suitable for image formation. A common supply source can be used for these voltage application units as necessary.

The toner carried on the developing roller 31 is transferred from the developing roller 31 to a surface of the photosensitive drum 21 in accordance with the potential distribution on the surface of the photosensitive drum 21, such that the electrostatic latent image is developed into a toner image. In the present example, the surface of the developing roller 31 is set to −300 V by the developing power supply E2. −600 V is applied to the blade power supply E5, and −300 V is applied to the supply roller power supply E6. In addition, a reversal development method is adopted in which a drum surface potential is uniformly charged to −500 V by a charging unit to be described below, the drum surface potential is attenuated through exposure by a scanner unit to be described below in the printing unit, and then, negatively charged toner adheres to an exposed area.

A back contrast Vback, which is the absolute value of the potential difference between the surface of the photosensitive drum 21 of a non-exposed area Vd and the developing roller 31 before passing through the developing area, is 200 V.

In the present example, the surface of the photosensitive drum 21 rotates at a speed of 150 mm/sec, and a difference between the surface speed of the developing roller 31 and the surface speed of the photosensitive drum 21 (hereinafter, referred to as a development peripheral speed difference) is 40%. That is, the developing roller 31 rotates at 150×1.4=210 mm/sec. As a result, the photosensitive drum 21 and the developing roller 31 are brought into contact with each other with a speed difference of 60 mm/sec.

In addition, in the present example, toner having a volume average particle diameter of 7 μm and a normal charge polarity that is negative is used. As the toner, for example, a polymerized toner generated by a polymerization method is employed. The toner does not contain a magnetic component, and is a so-called non-magnetic single-component developer in which the toner is mainly carried on the developing roller 31 by an intermolecular force or electrostatic force (image force).

In the present example, although a non-magnetic single-component developer is used as an example, a single-component developer containing a magnetic component may be used.

The photosensitive drum 21 is a photosensitive member formed into a cylindrical shape. The photosensitive drum 21 as an image carrying member is rotationally driven at a predetermined process speed in a predetermined direction (clockwise direction in FIGS. 21 and 22) by a motor (not illustrated).

A paper dust collection brush 22 and a charging roller 23 are in contact with the photosensitive drum 21 with a predetermined pressing force. An arbitrary charging roller voltage is applied to the charging roller 23 from the charging power supply E1 to uniformly charge the surface of the photosensitive drum 21 to a predetermined potential. In the present example, the drum surface potential is charged to −500 V by the charging roller 23. In addition, by equalizing the drum surface potential after the transfer using a pre-exposure device 24 in advance, the drum surface potential can be made more uniform when the photosensitive drum is charged by the charging roller 23.

An arbitrary brush voltage is applied to the paper dust collection brush 22 from the brush power supply E4, and paper fibers and paper dust detached from the recording material P and attached to the photosensitive drum are collected. As a result, it is possible to prevent paper fibers and paper dust from interfering with the charging of the photosensitive drum when passing through the charging unit.

The scanner unit 11 as an exposure unit scans and exposes the surface of the photosensitive drum 21 by irradiating the photosensitive drum 21 with a laser beam L corresponding to image information input from an external device using a polygon mirror. By this exposure, an electrostatic latent image corresponding to image information is formed on the surface of the photosensitive drum 21. Note that the scanner unit 11 is not limited to a laser scanner device, and for example, an LED exposure device having an LED array in which a plurality of LEDs are arranged along a longitudinal direction of the photosensitive drum 21 may be adopted. In the present example, a drum surface potential (potential in the exposed area V1) in a solid black portion attenuates to −50 V due to laser exposure by the scanner unit 11.

### Recovery of Transfer Residual Toner

In the present example, a so-called cleaner-less configuration is adopted in which transfer residual toner remaining on the photosensitive drum 21 without being transferred to the recording material P is recovered to the developing device 30 and reused. The transfer residual toner is reused in the following steps. The transfer residual toner includes a mixture of toner charged with a positive polarity, which is opposite to the normal polarity in the present example, and toner charged with a negative polarity but lacking a sufficient amount of charge.

By charging these toners to the normal polarity again when passing through the paper dust collection brush 22 and before reaching the contact portion between the charging roller 23 and the photosensitive drum 21, the transfer residual toner is not attached to the charging roller 23 and is along conveyed with the rotation of the photosensitive drum 21. As a result, the charging roller 23 can maintain excellent chargeability.

The transfer residual toner adhering to the surface of the photosensitive drum 21 that has passed through the contact portion with the paper dust collection brush 22 and the contact portion with the charging roller 23 reaches the developing region Pd with the rotation of the photosensitive drum 21. Here, the behavior of the transfer residual toner that has reached the developing region will be described separately for the exposed area and the non-exposed area of the photosensitive drum 21. In the non-exposed area of the photosensitive drum 21, that is, a dark potential portion Vd, the surface potential of the photosensitive drum 21 is greater on the negative polarity side than the developing voltage applied to the developing roller 31. Therefore, the transfer residual toner having a sufficient negative charge moves to the developing roller 31 by Coulomb force due to the electric field and is recovered into the developing container 32. Here, the dark potential portion Vd of the photosensitive drum 21 is not limited to the non-exposed area, and weak exposure may be performed in order to adjust to appropriate Vback when the surface potential of the photosensitive drum 21 is greater on the negative polarity side than the developing voltage applied to the developing roller 31.

The toner recovered in the developing container 32 is stirred with and dispersed in the toner in the developing container 32 by the stirring member 34, and is carried by the developing roller 31 to be used again in the developing process.

On the other hand, in an exposed area V1 of the photosensitive drum 21, since the surface potential of the photosensitive drum 21 is smaller on the negative polarity side than the developing voltage applied to the developing roller 31, the transfer residual toner remains on the surface of the photosensitive drum 21 without being transferred from the photosensitive drum 21 to the developing roller 31 in the developing region. The transfer residual toner remaining on the surface of the photosensitive drum 21 is carried on the photosensitive drum 21 together with other toner transferred from the developing roller 31 to the exposed area, moves to the transfer unit, and is transferred to the recording material P in the transfer unit.

### Recording Material Feeding Unit

In parallel with the image forming process described above, the recording material P stored in a paper tray 7 serving as a recording material storage unit is fed in synchronization with the transfer timing of the toner image. Describing the conveying process of the recording material P, first, a paper feed roller 8 feeds the recording material P stored in the paper tray 7. Next, the recording material P is fed to a pair of conveying rollers 9 by the paper feed roller 8, and abuts against the nip of the pair of conveying rollers 9 to correct skew. Then, the pair of conveying rollers 9 is driven in synchronization with the transfer timing of the toner image on the basis of the detection result of the leading end in the conveyance direction of the recording material P by a top sensor 10 as the recording material detector, and conveys the recording material P toward a transfer nip formed by the transfer roller 12 and the photosensitive drum 21 along a conveyance guide 15.

An electric field in a direction in which regularly-charged toner moves from the photosensitive drum to the transfer roller at the transfer nip is formed on the transfer roller 12 by the transfer power supply E3. When the recording material P is conveyed to the transfer nip in synchronization with the image forming timing, the toner image formed on the photosensitive drum 21 is transferred to the recording material P.

The excess charge on the surface of the recording material P to which the toner image is transferred is removed by a discharging needle 19. The recording material P that has passed through the discharging needle 19 is conveyed to the fixing device 40 along a transfer-to-fixing transport guide 16 as a guide member.

### Fixing Unit

The recording material P conveyed along the transfer-to-fixing transport guide 16 is conveyed to the fixing device 40. The fixing device 40 includes a fixing film 41, a fixing heater such as a ceramic heater that heats the fixing film 41, a thermistor that measures a temperature of the fixing heater, and a pressure roller 42 that comes into pressure contact with the fixing film 41. When the recording material P passes between the fixing film 41 and the pressure roller 42, the toner on the recording material P is heated and pressurized and fixed to the recording material P.

The recording material P that has passed through the fixing device 40 is discharged to the outside of the image forming apparatus 100 by a discharge roller pair 13, and is stacked on a discharge tray 14. The discharge tray 14 is inclined upward toward the downstream side in the discharge direction of the recording material, and the recording material discharged to the discharge tray 14 slides down the discharge tray 14, such that a trailing end is aligned by a regulation surface 17.

Note that, in the present example, although the process cartridge 20 detachably attached to a main body of the image forming apparatus is used, the present disclosure is not limited thereto, and it is sufficient that a predetermined image forming process can be performed. For example, the process cartridge may be a developing cartridge to which the developing device 30 is detachable, a drum cartridge to which the drum unit is detachable, or a toner cartridge for externally supplying toner to the developing device 30, may have a configuration without a detachable cartridge.

### 2. Developing Roller

The developing roller 31 as a developer carrying member will be described below with reference to the drawings. A developing roller according to at least one aspect of the present disclosure includes a conductive substrate and at least one resin layer provided on an outer peripheral surface of the substrate.

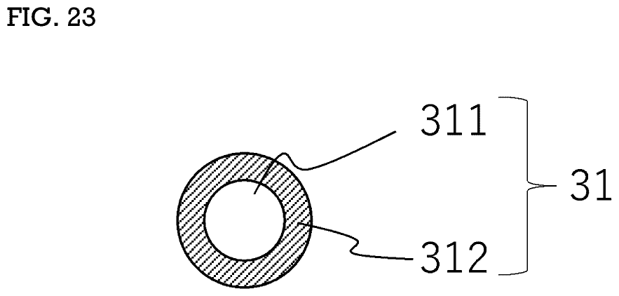

An example of the developing roller is illustrated in FIG. 23. In the developing roller 31 illustrated in the drawing, a resin layer 312 is laminated on an outer peripheral surface of a columnar or hollow cylindrical substrate 311.

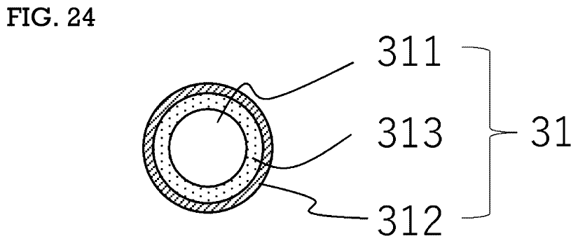

Note that the configuration of the layer of the developing roller is not limited to the form illustrated in the above drawing. As another form of the developing roller, as illustrated in FIG. 24, an elastic layer 313 may be provided between the substrate 311 and the resin layer 312 provided on the outer peripheral surface thereof.

### [Substrate]

The substrate has a conductive outer surface, and functions as a support member of the developing roller and, in some cases, as an electrode. As a specific example of the substrate, a solid columnar shape or a hollow cylindrical shape is preferable.

The material constituting the substrate can be appropriately selected from materials known in the field of conductive members for electrophotography and materials that can be used as the developer carrying member. Examples thereof include metals represented by aluminum and stainless steel, carbon steel alloys, conductive synthetic resins, and metals or alloys such as iron and copper alloys.

Furthermore, the material constituting the substrate may be subjected to an oxidation treatment or a plating treatment with chromium, nickel, or the like. As the type of plating, either electroplating or electroless plating can be used. From the viewpoint of dimensional stability, electroless plating is preferable. Examples of the electroless plating used here include nickel plating, copper plating, gold plating, and various other alloy plating. A plating thickness is preferably 0.05 μm or more, and the plating thickness is preferably 0.1 to 30 μm in consideration of a balance between work efficiency and rust prevention capability.

A primer may be applied to the surface of the substrate in order to improve adhesiveness between the substrate and the resin layer. As the primer, a known primer can be selected and used according to the rubber material for forming the conductive layer, the material of the support, and the like. Examples of the material of the primer include a thermosetting resin and a thermoplastic resin, and specifically, materials such as a phenolic resin, polyurethane, an acrylic resin, a polyester resin, a polyether resin, and an epoxy resin can be used.

### [Resin Layer]

The developing roller has a resin layer provided on the outer surface of the substrate. For example, the resin layer is present on the outer surface of the developer carrying member. The resin layer may contain a binder resin. As the binder resin of the resin layer in the developing roller, a polyurethane having a polycarbonate structure is preferably used in order to suppress charge leakage from the toner to the developing roller. That is, the resin layer contains a polyurethane having a polycarbonate structure. Furthermore, in order to sufficiently maintain a light load on the toner and abrasion resistance of the resin layer while suppressing charge leakage from the toner to the developing roller, it is more preferable to use a polyurethane having a structure described below as the binder resin of the resin layer.

It is preferable that the resin layer contains a polyurethane having a polycarbonate structure, and the polyurethane satisfies at least two of the following (A), (B), and (C). All of the following (A), (B), and (C) may be satisfied:
(A) the polyurethane has a structure represented by the following Structural Formula (1) in a molecule;
(B) the polyurethane has, in a molecule, either or both of a structure represented by the following Structural Formula (2) and a structure represented by the following Structural Formula (3);
(C) the polyurethane has a structure represented by the following Structural Formula (4) in a molecule.

That is, the polyurethane preferably satisfies at least one of the following conditions.
The polyurethane has at least a structure represented by Structural Formula (1) and a structure represented by Structural Formula (2).
The polyurethane has at least a structure represented by Structural Formula (1) and a structure represented by Structural Formula (3).
The polyurethane has at least a structure represented by Structural Formula (1) and a structure represented by Structural Formula (4).
The polyurethane has at least a structure represented by Structural Formula (2) and a structure represented by Structural Formula (4).
The polyurethane has at least a structure represented by Structural Formula (3) and a structure represented by Structural Formula (4).

In particular, the polyurethane more preferably has at least the structure represented by Structural Formula (1) and the structure represented by Structural Formula (4) in the molecule from the viewpoint of excellent fogging suppression and image density stability.

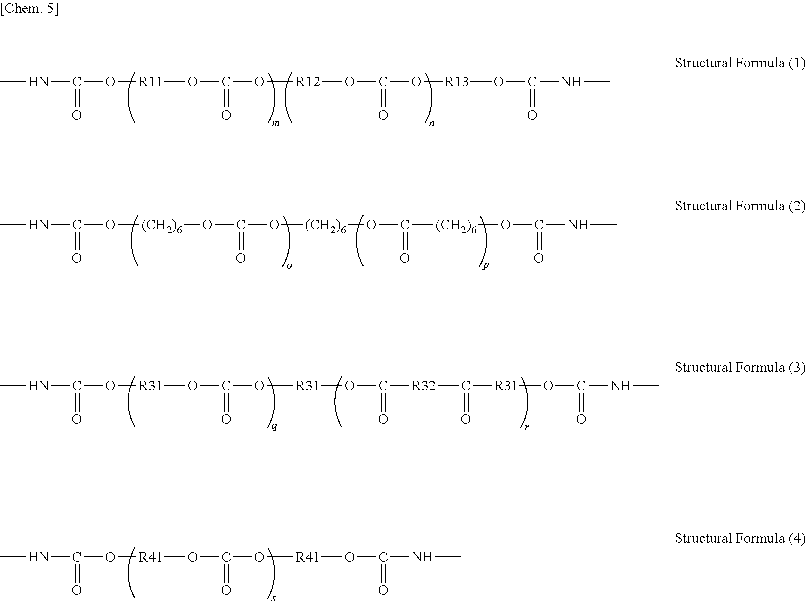

In Structural Formula (1), R11, R12, and R13 each represent a divalent hydrocarbon group having 3 to 9 carbon atoms. However, R11 and R12 are different from each other, and R13 is the same as at least one selected from the group consisting of R11 and R12. m and n are average numbers of added moles and each independently represent a number of 1.0 or more (preferably from 1.0 to 20.0, and more preferably from 2.0 to 12.0).

In Structural Formula (2), o and p are average numbers of added moles and each independently represent a number of 1.0 or more (preferably 1.0 to 15.0, and more preferably 4.0 to 10.0).

In Structural Formula (3), R31 and R32 each independently represent a divalent hydrocarbon group having 3 to 8 carbon atoms. q and r are average numbers of added moles and each independently represent a number of 1.0 or more (preferably from 1.0 to 20.0, and more preferably from 2.0 to 14.0).

In Structural Formula (4), R41 represents a divalent hydrocarbon group having 6 to 9 (preferably 5 to 8) carbon atoms. s is an average number of added moles and represents a number of 1.0 or more (preferably 1.0 to 22.0, and more preferably 4.0 to 18.0).

The structure represented by Structural Formula (1) is a structure obtained by reacting an isocyanate with a copolymerized polycarbonate polyol in which crystallinity is suppressed by linking two carbonate groups via two different hydrocarbon groups. Since the crystallinity is suppressed, the cohesive energy in the soft segment is low, and flexibility and a high volume resistivity can be imparted to the resin layer.

By using the structure of Structural Formula (1) in combination with the structures (2) to (4) described above for the resin layer, the adhesiveness of the resin layer can be reduced. Therefore, adhesion of toner, powder, or the like to the surface of the resin layer can be suppressed, an increase in the electrical resistance value of the surface of the resin layer due to contamination is suppressed, and uniform charging of the toner is easily performed.

In Structural Formula (1), R11 and R12 are each independently a divalent hydrocarbon group having 3 to 9 carbon atoms. R11 and R12 are different from each other, and R13 is the same as at least one selected from the group consisting of R11 and R12.

When the number of carbon atoms in R11 and R12 is 3 or more, in the polyurethane having a polycarbonate structure, the amount of carbonate groups which are polar functional groups and have strong cohesive energy is not excessively increased, and it becomes easier to maintain the resin layer in a flexible state and with a high electrical resistance.

In addition, when the number of carbon atoms in R11 and R12 is 9 or less, the amount of carbonate groups in the polyurethane is not excessively reduced, and the strength of the polymer can be maintained. In addition, since R11 and R12 have different structures, crystallinity of the polymer can be suppressed, and flexibility can be imparted to the resin layer. m and n each independently represent a number of 1.0 or more. The hydrocarbon groups represented by R11, R12, and R13 may have a branched structure or a cyclic structure.

The structures represented by Structural Formula (2) and Structural Formula (3) are structures obtained by reacting an isocyanate with a copolymerized polyol in which a polycarbonate structure and a polyester structure are copolymerized. The crystallinity of the polymer is suppressed by copolymerizing the polycarbonate structure and the polyester structure, and the soft segment is moderately reinforced by introducing an ester group having stronger cohesive energy than the carbonate group, such that abrasion resistance can be imparted to the resin layer.

When the resin layer is formed using a polymer in which the structure represented by Structural Formula (2) and/or Structural Formula (3) is combined with the structure of Formula (1) or (4) described above, a sufficient volume resistivity can be imparted to the resin layer while having an ester group having polarity, and charge leakage from the toner to the developing roller is more easily suppressed.

In Structural Formula (2), o and p each independently represent a number of 1.0 or more.

In Structural Formula (3), R31 and R32 each independently represent a divalent hydrocarbon group having 3 to 8 carbon atoms, and q and r each independently represent a number of 1.0 or more. When the number of carbon atoms in each of R31 and R32 is 3 or more, the amount of the carbonate group and the ester group which are polar functional groups and have strong cohesive energy in the polyurethane is not excessively increased, and the flexibility of the resin layer can be maintained. In addition, when the number of carbon atoms in R31 and R32 are 8 or less, the amount of carbonate groups and ester groups in the polyurethane is not excessively reduced, and abrasion resistance can be imparted to the resin layer.

The structure represented by Structural Formula (4) is a structure obtained by reacting an isocyanate with a highly crystalline polycarbonate polyol in which two carbonate groups are linked via a single hydrocarbon group.

Since this structure has high crystallinity and is easily aligned in the soft segment, abrasion resistance and a high volume resistivity can be imparted to the resin layer. By forming the resin layer using a polymer in which the structure represented by Structural Formula (4) is combined with the structures of Formulas (1) to (3) described above, the hardness of the resin layer does not become excessively high and can be appropriately controlled with ease.

In Structural Formula (4), R41 represents a divalent hydrocarbon group having 6 to 9 carbon atoms, and s represents a number of 1.0 or more. When the number of carbon atoms in R41 is 6 or more, crystallinity is easily exhibited, and abrasion resistance and a high volume resistivity can be imparted to the resin layer. When the number of carbon numbers in R41 is 9 or less, excessive crystallinity can be suppressed, and therefore, by further incorporating at least one of the structures represented by Structural Formulas (1), (2), and (3) in the polymer, an increase in hardness of the resin layer can be suppressed.

The resin layer preferably contains a polymer having a urethane bond, that is, a polyurethane having a polycarbonate structure as a binder resin, and the polymer preferably satisfies at least two selected from the group consisting of (A), (B), and (C) described above. As a result, the resin layer becomes flexible and is less likely to wear.

The structure of the polymer contained in the resin layer of the developing roller can be confirmed by, for example, analysis by pyrolysis GC/MS, FT-IR, or NMR.

The polyurethane having a polycarbonate structure can be produced using (A) a polyol compound (A) and (B) a polyisocyanate compound (B). Usually, the following methods (1) and (2) are used for the synthesis of polyurethane:
(1) a one-shot method of mixing and reacting a polyol component and a polyisocyanate component; and
(2) a method of reacting an isocyanate-terminated prepolymer obtained by reacting a portion of the polyol with an isocyanate, with a chain extender such as a low-molecular-weight diol or a low-molecular-weight triol.

In the present disclosure, the polyurethane may be synthesized by any of the methods described above, but a method of thermally curing a hydroxyl-terminated prepolymer obtained by reacting a raw material polyol with isocyanate and an isocyanate-terminated prepolymer obtained by reacting a raw material polyol with isocyanate is more preferable.

The polyurethane having a polycarbonate structure is preferably a reaction product of a mixture containing a hydroxyl-terminated prepolymer and an isocyanate-terminated prepolymer. The mixture can be used as a coating liquid for forming a resin layer. The polyurethane having a polycarbonate structure is more preferably a reaction product of a mixture containing a hydroxyl-terminated prepolymer and an isocyanate-terminated prepolymer, and a conductive filler and an additive.

When hydroxyl groups, isocyanate groups, or a large number of urea bonds, allophanate bonds, isocyanurate bonds, and the like are present, since a large number of polar functional groups are present in the polyurethane; thus, the water absorption of the polymer increases, and the volume resistivity of the resin layer decreases, and there is a risk of causing charge leakage from the toner to the developing roller. On the other hand, by thermally curing the hydroxyl-terminated prepolymer and the isocyanate-terminated prepolymer, it is possible to obtain a polyurethane having low contents of unreacted polyol and polar functional groups without excessively using isocyanate.

### (A) Polyol Compound

The polyol is selected from known polycarbonate polyols and polyester polycarbonate copolymerized polyols.

Examples of the polycarbonate polyol include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester polycarbonate copolymerized polyol include the following: copolymers obtained by polycondensing the polycarbonate polyols with lactones such as F-caprolactone, or copolymers with polyesters obtained by polycondensing diols such as 1,4-butanediol, 1,5-pentanediol, 1,6-hexanediol, 3-methylpentanediol, or neopentyl glycol, and dicarboxylic acids such as adipic acid or sebacic acid.

### (B) Polyisocyanate Compound

The polyisocyanate is selected from commonly used known polyisocyanates, and examples thereof include the following polyisocyanates: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, aromatic isocyanates such as toluene diisocyanate (TDI), diphenylmethane diisocyanate (MDI), polymeric diphenylmethane polyisocyanate, and polymeric MDI are more preferably used. Other polyisocyanates can also be used as long as they do not affect an impedance value and a surface potential.

A ratio of the number of isocyanate groups to the number of hydroxyl groups (hereinafter, also referred to as “ratio of NCO/OH”) is preferably 1.0 to 2.0. When the ratio of NCO/OH is 1.0 to 2.0, a crosslinking reaction proceeds, and bleeding of unreacted components and low-molecular-weight polyurethane, so-called “bleed” is suppressed. The ratio of NCO/OH is more preferably 1.0 to 1.6. When the ratio of NCO/OH is 1.0 to 1.6, bleed is suppressed, and the hardness of the polymer can be suppressed.

A content of the polyurethane in the resin layer is not particularly limited, but is preferably 50 to 95 mass %, more preferably 60 to 80 mass %, and still more preferably 65 to 75 mass %.

### (Conductive Filler)

The resin layer preferably contains a conductive filler in order to obtain electrical conductivity. As the conductive filler in the resin layer, it is more preferable to use an electron conductive agent. The electron conductive agent is a conductive particle exhibiting electronic conductivity, and preferably has a surface functional group capable of interacting with a functional group present in an additive to be described below.

Examples of the electron conductive agent exhibiting these properties include at least one selected from the group consisting of carbon black such as furnace black, thermal black, acetylene black, and Ketjen Black, metal oxide-based conductive particles such as titanium oxide having a surface treated with an acidic functional group, and metal-based conductive particles such as aluminum and iron having a surface treated with an acidic functional group.

Among them, at least one selected from the group consisting of carbon blacks having high stability of surface functional groups is preferably used. The conductive filler preferably contains carbon black. Furthermore, in order to obtain a desired impedance value and surface potential, carbon black having a number average diameter of primary particles capable of achieving higher dispersion in the resin layer of 30 nm or less, a DBP absorption of 90 ml/100 g or less, and a pH of 4.0 or less is particularly preferably used.

When the number average diameter of primary particles of carbon black is 30 nm or less, an aggregate (primary aggregate), which is a minimum unit in which carbon black can be dispersed, becomes small, and a structure (size of connection of particles) also becomes small, such that a conductive path is hardly formed. Therefore, a sufficiently high impedance is easily obtained. Note that a primary particle diameter of carbon black can be calculated by a transmission electron microscope (TEM). The number average diameter is preferably as low as possible, and a lower limit of the number average diameter is not particularly limited. For example, the number average diameter of primary particles of carbon black is more preferably 5 to 30 nm or 20 to 28 nm.

When the DBP absorption of the carbon black is 90 ml/100 g or less, the structure of the carbon black becomes small, and a conductive path is hardly formed, such that a sufficiently high impedance is easily obtained. The DBP absorption is preferably as low as possible, and a lower limit of the DBP absorption is not particularly limited. For example, the DBP absorption of carbon black is more preferably 30 to 90 ml/100 g or 40 to 60 ml/100 g.

When the pH of the carbon black is 4.0 or less, an effect of dispersion stability is obtained by repulsion of the surface functional group of the carbon black, and aggregation of the carbon black hardly occurs, such that sufficiently high impedance is easily obtained. The pH of the carbon black is preferably as low as possible, and a lower limit of the pH is not particularly limited. For example, the pH of the carbon black is more preferably 2.0 to 4.0 or 2.2 to 2.8.

However, even when the number average diameter, DBP absorption, and pH of the primary particles of carbon black are within the above ranges, when polycarbonate urethane is used as a binder resin, the carbon black cannot be sufficiently dispersed, and a desired impedance may not be obtained. The reason why the carbon black having the desired material properties cannot be dispersed when polycarbonate urethane is used as a binder resin is not clearly known, but is presumed as follows.

Hydroxyl groups, which are surface functional groups of carbon black, are likely to interact with terminal hydroxyl groups of polycarbonate diol. On the other hand, a structure in which a carbonate bond and a hydrocarbon group are bonded, which is present between two hydroxyl groups of polycarbonate diol, is hydrophobic due to the presence of the hydrocarbon group, and hardly interacts with carbon black. Since hydrophobic groups and hydrophilic groups tend to be structurally more stable when located near other hydrophobic groups and near other hydrophilic groups, respectively, hydrophilic carbon black tends to be located in the vicinity of other hydrophilic carbon black. As a result, it is considered that the carbon black is easily aggregated and hardly dispersed.

In order to sufficiently disperse carbon black in which the number average diameter of primary particles, the DBP absorption, and the pH are in the above numerical ranges using polycarbonate urethane as a binder resin, it is more preferable to add an additive described below.

A content of the carbon black is preferably 30 parts by mass or less with respect to 100 parts by mass of the polyurethane forming the resin layer although it is desirable to add the carbon black so as to have a desired volume resistivity. The content of the carbon black is more preferably 10 to 30 parts by mass and still more preferably 15 to 25 parts by mass.

When the content is 30 parts by mass or less, the distance between the carbon blacks in the coating liquid is appropriately maintained, the collision probability due to Brownian motion or the like of the carbon black is reduced, and the carbon black is less likely to aggregate. Therefore, carbon black is easily dispersed, and dispersion stability is also improved. As a result, carbon black is well dispersed in the resin layer formed by forming the coating liquid.

In order to achieve the specific impedance and surface potential, it is preferable to control the dispersion of carbon black. As a dispersion particle diameter of the carbon black, an arithmetic mean value Rc of equivalent circle diameters of the carbon black in the resin layer is preferably 60.0 nm or less.

When the standard deviation of the equivalent circle diameter is defined as ac [nm], σc/Rc is more preferably 0.000 to 0.650.

In addition, as the distance between the carbon blacks, when an arithmetic mean value d of wall-to-wall distances of the carbon black in the resin layer is 80.0 to 150.0 nm and the standard deviation of the distances between the wall surfaces is defined as σd [nm], σd/d is more preferably 0.000 to 0.600.

The reason why the high impedance and the low surface potential are more easily compatible when the equivalent circle diameter and the wall-to-wall distance are in the above numerical ranges is estimated as follows.

When the dispersion particle diameter is large, there is a place where the wall-to-wall distance is short, and a conductive path is easily formed, such that the impedance and the surface potential are low. On the other hand, when the dispersion particle diameter is reduced, the wall-to-wall distance becomes uniform, it is difficult to form a conductive path, the resistance increases, and the capacitance also decreases, such that the impedance increases. In terms of the surface potential, the resistance becomes high, the influence of the component of the electrostatic capacitance becomes large, and the surface potential can be lowered by the charge that can be stored in the pseudo capacitor component.

Note that, when the surface of the carbon black is coated with an insulating material such as a silane coupling agent, the carbon black cannot act as a pseudo capacitor, such that both the impedance and the surface potential are high.

Note that a plurality of types of carbon blacks may be used in combination as long as the impedance value and the surface potential are not affected.

The arithmetic mean value Rc of the equivalent circle diameters is more preferably 40.0 to 60.0 nm and still more preferably 45.0 to 55.0 nm. σc/Rc is more preferably 0.500 to 0.650 and still more preferably 0.550 to 0.650.

The arithmetic mean value Rc and the standard deviation σc of the equivalent circle diameters can be changed depending on, for example, a dispersion state in a mill or the like when a coating liquid for forming a resin layer is prepared. When the dispersion is weaker, Rc and σc tend to increase, and when the dispersion is strengthened, Rc and σc tend to decrease. Normally, since Rc converges, when the dispersion state exceeds a certain level, it is possible to lower σc while Rc is substantially constant, which makes it possible to reduce σc/Rc.

The arithmetic mean value d of the wall-to-wall distances is more preferably 90.0 to 120.0 nm and still more preferably 95.0 to 115.0 nm. σd/d is more preferably 0.500 to 0.600 and still more preferably 0.540 to 0.590.

The arithmetic mean value d and the standard deviation σd of the wall-to-wall distances can be changed depending on, for example, a dispersion state in a mill or the like when a coating liquid for forming a resin layer is prepared. When the dispersion is weaker, d tends to decrease and σd tends to increase, and when the dispersion is stronger, d tends to increase and σd tends to decrease. Therefore, when the dispersion is weak, σd/d tends to be large, and when the dispersion is strong, σd/d tends to be small.

### (Additive)

It is also one preferred mode to use an additive for further improving dispersibility of carbon black in a binder resin using polycarbonate urethane. Here, as the additive, for example, at least one compound selected from the group consisting of a compound having a structure represented by the following Structural Formula (5), a compound having a structure represented by the following Structural Formula (6), and a compound having a structure represented by the following Structural Formula (7) can be preferably used. One of the methods for incorporating the additive into the surface layer is a method for incorporating a dispersant in a coating liquid for forming a resin layer. Note that in the surface layer formed using a coating liquid for forming a resin layer containing at least one compound selected from the group consisting of a compound having a structure represented by Structural Formula (5) and a compound having a structure represented by Structural Formula (6), the compound may be incorporated at the end of the polymer chain of the polyurethane. Even in this case, the effect of improving the dispersibility of carbon black can be expected, but it is preferable that carbon black is present in the surface layer independently of polyurethane.

Among the compounds having the structures represented by Structural Formulas (5) to (7), the compound having the structure represented by Structural Formula (5) is more suitably used because the dispersibility of carbon black and the affinity with polycarbonate urethane are particularly preferred.

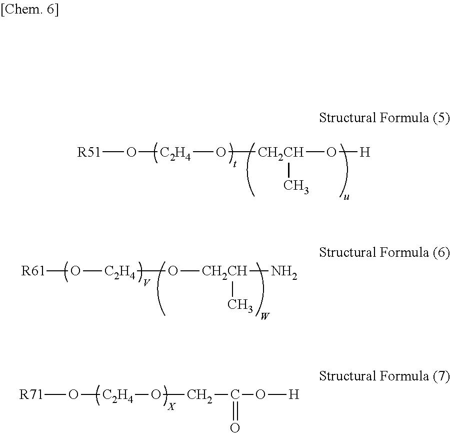

In Structural Formula (5), R51 represents a monovalent hydrocarbon group having 1 to 12 (preferably 3 to 12) carbon atoms. t and u are average numbers of added moles and each independently represent a number of 1 or more (preferably from 5 to 30, and more preferably from 10 to 25).

In Structural Formula (6), R61 represents a monovalent hydrocarbon group having 1 to 8 (preferably 1 to 4) carbon atoms. v and w are average numbers of added moles and each independently represent a number of 1 or more (preferably from 1 to 30, and more preferably from 5 to 30).

In Structural Formula (7), R71 represents a monovalent hydrocarbon group having 1 to 12 carbon atoms. x is an average number of added moles and represents a number of 1 or more (preferably 1 to 30, and more preferably 4 to 15).

Structural Formula (5) represents a polyoxyethylene polyoxypropylene alkyl ether, and is a polyether mono-ol having a structure obtained by block addition polymerization of ethylene oxide and propylene oxide. The hydroxyl group at the terminal of the polyether mono-ol interacts with functional groups on the surface of carbon black, which is a conductive filler, via hydrogen bonding, thereby acting as a dispersant for the carbon black. In addition, in order to enhance the effect of carbon black as a dispersant, the carbon black has a structure that is compatible with polycarbonate urethane.

Ethylene oxide is introduced into the structure to ensure uniform presence of the additive in the polycarbonate urethane. This is considered to be because the ethylene group in ethylene oxide is compatible with the hydrophobic hydrocarbon group in the polycarbonate urethane. In addition, propylene oxide is introduced into the structure in order to improve dispersibility of the conductive filler dispersed in the resin layer. This is considered to be due to the interaction between the side chain methyl group of propylene oxide and the conductive filler, which improves the dispersibility of the conductive filler.

R51, which is a monovalent hydrocarbon group having 1 to 12 carbon atoms, is introduced into the structure in order to make the additive uniformly present in the polycarbonate urethane. The monovalent hydrocarbon group is compatible with the hydrophobic hydrocarbon group in the polycarbonate urethane, and the additive can be uniformly present in the polycarbonate urethane. When the number of carbon atoms is 12 or less, steric hindrance with the polycarbonate urethane is unlikely to occur; thus, the additive is likely to be uniformly present.

Since the compound represented by Formula (5) has a mono-ol structure, the compound has lower reactivity than a diol, which makes it less likely to be incorporated during a urethanization reaction between the isocyanate and polyol; thus, the introduction of the ether structure into the polycarbonate urethane is minimized, thereby reducing a risk of a decrease in the resistivity of the polyurethane.

A polyoxyethylene polyoxypropylene alkyl ether can be obtained using commercially available products or by synthesis. The polyoxyethylene polyoxypropylene alkyl ether can be synthesized by performing step (B) after step (A). Note that step (B) may be performed on a commercially available product having a structure completed up to step (A).
Step (A): Reaction of alcohol with ethylene oxide
Step (B): Reaction of product obtained in step (A) with propylene oxide

In step (A), the reaction can proceed by adding ethylene oxide to an alcohol in the presence of a catalyst at 50 to 200° C., and more preferably at 100 to 160° C. Since ethylene oxide has a boiling point of 10.7° C. and is a gas at the above temperature, the reaction is preferably carried out in an environment pressurized in a sealed container. The pressure is preferably 0.1 MPa to 1.0 MPa. The reaction time is not particularly limited, but is preferably about 1 hour to 3 hours in order to reduce a content of unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of ease of reaction and reaction efficiency, sodium hydroxide and potassium hydroxide are particularly preferable. Examples of the acid catalyst include Brønsted acids such as sulfuric acid and phosphoric acid, and Lewis acids such as stannic chloride and boron trifluoride.

In the case of sodium hydroxide or potassium hydroxide, the amount of catalyst used is preferably 0.1 to 5 mol % based on 1 mol of the alcohol. Ethylene oxide reacts with water to produce ethylene glycol, such that moisture is prevented as much as possible, and a dehydration treatment may be performed before the reaction of step (A) as necessary.

Step (B) can be performed under the same conditions as in step (A). Since propylene oxide has a boiling point of 34.2° C. and is a gas at a reaction temperature of 50 to 200° C., it is preferable to perform the reaction in an environment pressurized in a sealed container. The catalyst used in step (A) may be used as it is or may be newly added. When newly added, the catalyst used in step (A) is preferable.

Structural Formula (6) is a polyether amine (monoamine) having a structure obtained by block addition polymerization of ethylene oxide and propylene oxide. The amino group at the terminal of the polyether amine interacts with the surface functional group of carbon black as a conductive filler by hydrogen bonding, and acts as a dispersant for carbon black. In addition, in order to enhance the effect as a dispersant, by introducing R61 which is a monovalent hydrocarbon group having 1 to 8 carbon atoms, a structure that is easily compatible with a hydrophobic functional group of polycarbonate urethane is obtained, and a structure that is compatible with the polycarbonate urethane is obtained.

A polyether monoamine can be obtained using a commercially available product or by synthesis. The polyether monoamine can be synthesized by performing step (D) after the following step (C).
Step (C): Oxidation reaction of compound of Structural Formula (5) which is secondary alcohol
Step (D): Reductive amination reaction of product obtained in step (C)

Step (C) is a reaction for producing a ketone by an oxidation reaction of a secondary alcohol. Ketone synthesis by oxidation of a secondary alcohol includes an oxidation reaction using a heavy metal salt such as chromic acid or manganese dioxide and a derivative thereof, and an oxidation reaction of a non-heavy metal salt using a hypohalous acid such as dimethyl sulfoxide (DMSO) or hypochlorous acid.

The synthesis may be performed using any method, but in view of environmental influence by heavy metals, an oxidation reaction using a hypohalous acid such as dimethyl sulfoxide (DMSO) or hypochlorous acid is preferable. Furthermore, dimethyl sulfoxide (DMSO) requires a low temperature of −60° C. because the reaction explosively proceeds at room temperature depending on an electrophilic activation reagent to be used, and thus, a method using a hypohalous acid is more preferable. Examples of the hypohalous acid include hypochlorites such as sodium hypochlorite and calcium hypochlorite (bleaching powder). These hypochlorites are reacted with a secondary alcohol in acetic acid to obtain a ketone.

When dimethyl sulfoxide (DMSO) is used, an electrophilic activation reagent is also required. By increasing the electrophilicity of sulfur in dimethyl sulfoxide (DMSO) with the electrophilic activation reagent, nucleophilic attack by the hydroxyl group of an alcohol. The nucleophilic attack generates a dimethyl alkoxy sulfonium salt, and the dimethyl alkoxy sulfonium salt is decomposed, thereby producing a ketone and dimethyl sulfide. Examples of the electrophilic activation reagent include dicyclohexylcarbodiimide (DCC), acetic anhydride, phosphorus pentoxide, a sulfur trisulfide-pyridine complex, trifluoroacetic anhydride, oxalyl chloride, and halogen.

Step (D) is a reductive amination reaction that converts a ketone to an amine. The reaction is divided into two stages. First, the carbonyl group reacts with the amine to produce an iminium cation. Subsequently, a hydride reducing agent performs a nucleophilic attack on the iminium cation to produce an amine. As the reducing agent, a borohydride reagent is preferably used. Examples of the borohydride reagent include sodium cyanoborohydride, sodium triacetoxyborohydride, and 2-picoline borane, and among them, sodium triacetoxyborohydride and 2-picoline-borane, which are less toxic, are preferable. In the reductive amination reaction using the borohydride reagent, it is difficult to produce an iminium cation due to steric hindrance when a bulky structure is involved. Therefore, R61 in Structural Formula (6) is preferably a monovalent hydrocarbon group having 1 to 8 carbon atoms.

Structural Formula (7) is polyoxyethylene alkyl ether acetate. The terminal carboxylic acid in Structural Formula (7) interacts with a surface functional group of carbon black as a conductive filler by hydrogen bonding, and acts as a dispersant for carbon black. In addition, in order to enhance the effect as a dispersant, by introducing R71 which is a monovalent hydrocarbon group having 1 to 12 carbon atoms, a structure that is easily compatible with a hydrophobic functional group of polycarbonate urethane is obtained, and a structure that is compatible with the polycarbonate urethane is obtained.

Polyoxyethylene alkyl ether acetate can be obtained using a commercially available product or by synthesis. The synthesis of polyoxyethylene alkyl ether acetate can be carried out by performing step (F) after step (E) described below. Note that step (F) may be performed on a commercially available product having a structure completed up to step (E).
Step (E): Reaction of alcohol with ethylene oxide
Step (F): Oxidation reaction of primary alcohol produced in step (E)

Step (E) is the same as step (A), and can be performed by the same method as in step (A).

The step (F) is a step of oxidizing a primary alcohol to produce a carboxylic acid. In the oxidation of a primary alcohol, a carboxylic acid is produced by further oxidation after an aldehyde is produced. Therefore, it is necessary to select a reaction method and conditions that do not stop at the aldehyde stage. Examples of the method for obtaining a carboxylic acid by oxidation of a primary alcohol include oxidation using an oxidizing agent and a catalytic dehydrogenation reaction using a catalyst. Examples of the oxidizing agent include permanganate, chromic acid, ruthenium tetroxide, and hypochlorite. Examples of the catalyst for the dehydrogenation reaction include palladium, platinum, iridium, rhodium, and manganese.

The compounds represented by Structural Formulas (5) to (7) have a function as a dispersant for carbon black, and are compounds having high affinity with polycarbonate urethane. Usually, a surfactant is used as a method for improving dispersibility and dispersion stability of carbon black. However, the compounds represented by Structural Formulas (5) to (7) are not generally used because the number of functional groups acting on the surface functional group of carbon black is small, and therefore, the surfactant action is weak. As a general dispersant for carbon black, a coupling agent and a nonionic surfactant are utilized.

As the coupling agent, a silane coupling agent, a titanate-based coupling agent, or an aluminum-based coupling agent is used, and as the nonionic surfactant, a polyester-based or polyether-based surfactant is used. However, when these dispersants are added to a level at which the dispersibility of carbon black can be sufficiently enhanced in polycarbonate urethane (mass ratio of 50 to 100% with respect to carbon black), the electrical conductivity of the carbon black or the binder resin is inhibited. On the other hand, when the amount added is set to a level at which the electrical conductivity of the carbon black or the binder resin is not inhibited (mass ratio of 10 to 40% with respect to the carbon black), the dispersibility of the carbon black cannot be obtained.

The amount of the compounds represented by Structural Formulas (5) to (7) is preferably 3.0 to 7.0 mass % based on the solid content in the coating liquid for forming a resin layer. The amount of the compounds represented by Structural Formulas (5) to (7) is more preferably 3.0 to 5.0 mass %. In addition, the total content is preferably 18.9 to 46.0 parts by mass with respect to 100 parts by mass of the carbon black in the coating liquid for forming a resin layer.

When the content of the additive in the coating liquid for forming a resin layer is within the above range, the dispersibility of carbon black in polyurethane is further improved, and a desired impedance value and surface potential can be more easily achieved.

The presence confirmation and quantitative evaluation of the additive in the resin layer can be analyzed by the following method. By cutting out the resin layer of the developing roller and using, for example, ¹H-NMR, ¹³C-NMR, XPS, or FT-IR on the cross-section, the carbonate structure of the binder resin, the ether structure, the amine structure, and the carboxylic acid structure of the additive can be detected in the resin layer, and ratios can be calculated from peak ratios or the like.

In addition, the cross section is immersed in an organic solvent such as 2-butanone (methyl ethyl ketone: MEK) overnight for extraction and analyzing both the extract and the extracted cross section using ¹H-NMR, ¹³C-NMR, XPS, and FT-IR, such that it is possible to determine the ratio of the additive incorporated into the resin during polymerization and the additive not incorporated in the resin.

Examples of the structure in which at least one of the compounds having the structures represented by Structural Formulas (5) and (6) is bonded to polyurethane (structure reacted during polymerization of polyurethane) include the following modes:
in the case of the structure represented by Structural Formula (5), in the polyurethane, a compound having the structure represented by Structural Formula (5) forms a urethane-modified structure; and
in the case of the structure represented by Structural Formula (6), in the polyurethane, a compound having the structure represented by Structural Formula (6) forms a urea-modified structure.

### [Coarse Particles]

The resin layer may contain coarse particles. The coarse particles may be, for example, spherical particles. A particle diameter of the coarse particle is, for example, preferably in the range of 1 μm to 150 μm, and more preferably in the range of 5 μm to 30 μm. Examples of the coarse particles include at least one spherical particle selected from the following particles:
urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. The coarse particles are preferably urethane resin particles.

The developing roller may have an elastic layer formed on the outer surface of the substrate. The developing roller has, for example, an elastic layer between the substrate and the resin layer. The elastic layer is not particularly limited, and a known elastic layer may be used as the elastic layer of the developer carrying member. Examples of the elastic layer include a cured product of an addition cure-type liquid silicone rubber mixture.

### (Production Method)

A method for forming the resin layer is not particularly limited, and examples thereof include a method by spraying with a coating material, dip coating, or roll coating. For example, a coating liquid for forming a resin layer is applied onto the substrate or the elastic layer formed on the outer surface of the substrate by a known method, and heated and dried to form a resin layer. The conditions for heating and drying are not particularly limited, and examples thereof include a method of drying under a condition of 120 to 200° C. A thickness of the resin layer is also not particularly limited, and is preferably 1 to 50 μm, and more preferably 5 to 20 μm.

### (Method of Measuring Various Characteristics of Developer Carrying Member)

### <Impedance>

In the impedance measurement, the response of the developing roller is examined by applying an AC voltage and a DC voltage while varying the frequency. An AC voltage is applied, and a response with no phase shift and a response with a phase shift of π/2 with respect to the applied AC voltage are measured separately, the impedance of the response with no phase shift, which is defined as Z′ (the real part), and the impedance of the response with a phase shift, which is defined as Z″ (the imaginary part), are plotted on a complex plane, and a distance from the origin to the plotted point is calculated as an impedance value.

When the electrical characteristics of the developing roller are represented in a pseudo manner by an RC parallel circuit, the real part with no phase shift represents a resistive component, and the imaginary part with a phase shift represents a capacitive component. Note that the measurement conditions and the meanings of the measured values have been described in <Technical significance of requirement (1)> described above, and thus are omitted in this section.

A method for measuring impedance, a measuring apparatus, and measurement conditions will be described below.

### (Method for Measuring Impedance)

The impedance of the developing roller can be measured by the following methods (1) and (2):
(1) a method in which a thin film electrode is provided on a surface of a developing roller, and measurement is performed using two terminals of the electrode and the substrate; and
(2) a method in which a developing roller is pressed against a metal drum with a constant load, and measurement is performed with two terminals of the metal drum and the substrate.

Although the impedance can be measured by any method, the method (2) is affected by a nip width and a contact area between the developing roller and the metal drum, and thus, it is necessary to measure the impedance by the developing roller having the same hardness. Therefore, in the present disclosure, measurement is performed by the method (1). Hereinafter, the measurement method (1) will be described, and more specific conditions will be described below.

In the measurement of the impedance, in order to eliminate the influence of the contact resistance between the developing roller and the measurement electrode, it is preferable to deposit a low-resistance thin film on the surface of the developing roller, use the thin film as an electrode, and measure the impedance with two terminals using a conductive substrate as a ground electrode.

Examples of a method for forming the thin film include methods for forming a metal film such as metal vapor deposition, sputtering, application of a metal paste, and attachment of a metal tape. Among them, from the viewpoint of reducing the contact resistance with the developer carrying member, a method for forming a metal thin film such as platinum or palladium as an electrode by vapor deposition is preferable. In the present disclosure, vacuum platinum vapor deposition is employed.

When the metal thin film is formed on the surface of the developing roller, it is preferable to use a vacuum vapor deposition apparatus in which a mechanism capable of holding the developing roller is provided to the vacuum vapor deposition apparatus and a rotation mechanism is further provided to the developing roller having a cylindrical cross section in consideration of simplicity and uniformity of the thin film.

It is preferable that a metal thin film electrode having a width of about 10 mm in a longitudinal direction of the developing roller is formed, and a metal sheet wound around the metal thin film electrode in a direction intersecting the longitudinal direction without a gap is connected to the measurement electrode extending from the measuring apparatus to perform measurement. In the case of a cylindrical developing roller, it is preferable to use a metal sheet wound without a gap in a circumferential direction of the developing roller. As a result, the impedance measurement can be performed without being affected by the fluctuation of the size of the outer edge (the outer diameter in the cylindrical developing roller) in the cross section orthogonal to the longitudinal direction of the developing roller or the surface shape. As the metal sheet, an aluminum foil, a metal tape, or the like can be used.

### (Impedance Measuring Apparatus and Measurement Conditions)

The impedance measuring apparatus may be any device capable of measuring impedance in a frequency range of 1.0×10⁻¹ to 1.0×10⁵ Hz, such as an impedance analyzer, a network analyzer, or a spectrum analyzer. Among them, it is preferable to use an impedance analyzer for measurement from the viewpoint of the electrical resistance region of the developing roller.

The impedance measurement conditions will be described. The impedance in the frequency range of 1.0×10⁻¹ to 1.0×10⁵ Hz is measured using an impedance measuring apparatus. As the measurement environment, the temperature is 23° C. and the relative humidity is 50%. In consideration of measurement variations, it is preferable to measure at least a total of nine points including three longitudinal points and three rotational directions of the developer carrying member. The voltage application condition is obtained by superimposing an AC voltage of 50 V on a DC voltage of 50 V.

### <Surface Potential>

In an environment of a temperature of 23° C. and a relative humidity of 50%, a corona discharger having a grid portion with a width of 3.0 mm is disposed so that a distance between the grid portion and the outer surface of the developing roller is 1.0 mm, the direction of the width of the grid portion coincides with the axial direction of the developing roller, a voltage of 8 kV is applied to the grid portion, the corona discharger is relatively moved along the axial direction of the developing roller at a speed of 400 mm/sec to charge the outer surface of the developing roller, and the potential of the outer surface 0.06 seconds after the outer surface passes through the grid portion is measured to evaluate the easiness of excessive charging (charge-up) of the surface of the developing roller.

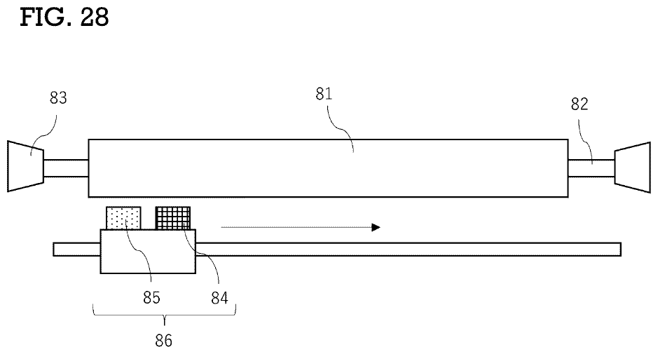

The surface potential of the developing roller can be measured by, for example, the apparatus illustrated in FIG. 28. Both ends of a substrate 82 of a developing roller 81 are held by a chuck 83, and a measurement unit 86 in which a corona discharger 84 and a surface potential meter 85 are arranged in parallel with a 25 mm spacing is disposed to face a surface of the developing roller 81 at a distance of 1.0 mm. In a state where the developing roller 81 is stationary, a voltage of 8 kV is applied to a grid portion of the corona discharger 84, the measurement unit 86 is moved in an axial direction of the developing roller 81 at a speed of 400 mm/sec, and a surface potential is measured using the surface potential meter 85 at 0.06 seconds after passing the corona discharger 84.

The measurement conditions and the meanings of the measured values have been described in <Technical significance of requirement (2)> described above, and thus are omitted in this section.

### <Surface Shape of Developing Roller>

The method for measuring the surface shape of the developing roller is not particularly limited as long as the surface roughness can be measured. As will be described below, a measurement method having a resolution capable of measuring the surface shape formed by the coarse particles contained on the surface of the developing roller can be used. In order to calculate the maximum height roughness Rz, the measurement distance is preferably 200 μm or more.

To satisfy this condition, a confocal laser microscope capable of optically measuring the shape in a non-contact manner can be used to measure the surface shape of the developing roller. The surface shape in the vicinity of the apex of the outer peripheral surface of the developing roller can be measured by substantially arranging a line obtained by extending the objective lens center line of the microscope so as to pass through the axis line of the substrate of the developing roller and to be orthogonal to the axis line. The maximum height roughness Rz of the roughness profile can be calculated by analyzing the obtained surface shape.

According to the present disclosure, the amount of filler discharged from the developing device by transfer can be increased by imparting charge between the electrophotographic roller and the developing blade to the filler collected in the developing container via the photosensitive drum. As a result, the occurrence of fogging can be suppressed. Since the size of the filler contained in the paper is not constant, the filler having a large size is physically difficult to pass through the developing blade and is likely to remain in the developing device. When the maximum height roughness Rz of the outermost surface of the electrophotographic roller is a certain level or more, the amount of filler that can pass between the electrophotographic roller and the developing blade increases, such that the amount of the filler discharged from the developing device increases, which is preferable. Specifically, the surface height Rz of the electrophotographic roller is preferably 7.0 μm or more.

Hereinafter, the present disclosure will be described in more detail, but these descriptions are not intended to limit the present disclosure at all.

### [1. Preparation and Production of Raw Materials for Forming Resin Layer]

### <1-1. Preparation and Production Example of Raw Material Polyol>

Hereinafter, a synthesis example for obtaining a polyurethane resin layer will be described.

### [Measurement of Number Average Molecular Weight of Raw Material Polyol]

The apparatus and conditions used for measuring a number average molecular weight (Mn) in the present production example are as follows.
Measuring apparatus: HLC-8120GPC (Tosoh Corporation)
Column: TSKgel Super HZMM (Tosoh Corporation)×2 columns
Solvent: tetrahydrofuran (THF) (20 mmol/l triethylamine is added)
Temperature: 40° C.
Flow rate of THF: 0.6 ml/min

Note that the measurement sample was prepared as a 0.1 mass % solution in THF. Further, measurement was performed using a refractive index (RI) detector as a detector.

As a standard sample for preparing a calibration curve, a calibration curve was prepared using TSK standard polystyrene A-1000, A-2500, A-5000, F-1, F-2, F-4, F-10, F-20, F-40, F-80, and F-128 Tosoh Corporation. Based on the calibration curve, the number average molecular weight was determined from the retention time of the obtained measurement sample.

### [Preparation of Raw Material Polyol]

Commercially available products A-1 to A-16, which are 16 types of raw material polyols shown in Table 44, were purchased. In addition, raw material polyols A-17 and A-18 were synthesized.

TABLE 44

| No. | Raw material polyol |
|---|---|
| A-1 | DURANOL T5652 Mn = 2000 (Asahi Kasei Chemicals |
| | Corporation) |
| A-2 | DURANOL G4672 Mn = 2000 (Asahi Kasei Chemicals |
| | Corporation) |
| A-3 | DURANOL G3452 Mn = 2000 (Asahi Kasei Chemicals |
| | Corporation) |
| A-4 | DURANOL G4692 Mn = 2000 (Asahi Kasei Chemicals |
| | Corporation) |
| A-5 | KURARAY POLYOL C2050 Mn = 2000 (Kuraray Co., Ltd.) |
| A-6 | KURARAY POLYOL C2090 Mn = 2000 (Kuraray Co., Ltd.) |
| A-7 | KURARAY POLYOL C3090 Mn = 3000 (Kuraray Co., Ltd.) |
| A-8 | KURARAY POLYOL C2015N Mn = 2000 (Kuraray Co., Ltd.) |
| A-9 | KURARAY POLYOL C2060N Mn = 2000 (Kuraray Co., Ltd.) |
| A-10 | NIPPOLLAN 982 Mn = 2000 (Tosoh Corporation) |
| A-11 | ETERNACOLL UH-200 Mn = 2000 (UBE Corporation) |
| A-12 | ETERNACOLL UH-300 Mn = 3000 (UBE Corporation) |
| A-13 | ETERNACOLL UC-100 Mn = 2000 (UBE Corporation) |
| A-14 | ETERNACOLL UM-90(1:1) Mn = 900 (UBE Corporation) |
| A-15 | ETERNACOLL UM-90(1:3) Mn = 900 (UBE Corporation) |
| A-16 | Oxymer M112 Mn = 1000 (Perstorp Japan Co., Ltd.) |

### [Synthesis of Raw Material Polyol A-17]

In a nitrogen atmosphere, 100.0 g of 1,3-propanediol, 49.4 g of adipic acid, and 69.5 g of ethylene carbonate were mixed and heated, and ethylene glycol and water generated from the reaction system were distilled off while the temperature was raised to 200° C. After ethylene glycol and water were distilled off, 15 ppm of titanium tetraisopropoxide was added, and a polycondensation reaction was further carried out under a reduced pressure of 266.7 Pa. The reaction solution was cooled to room temperature to obtain raw material polyol A-17. The number average molecular weight of the obtained raw material polyol A-17 was 2,030.

### [Synthesis of Raw Material Polyol A-18]

Raw material polyol A-18 was prepared in the same manner as in the case of the raw material polyol A-17, except that starting materials shown in Table 45 were used. The number average molecular weight of the raw material polyol A-18 was 2,040.

TABLE 45

| | | | Ethylene | Ester group/ | Number |
|---|---|---|---|---|---|
| Raw | | Dicarboxylic | carbonate | carbonate | average |
| material | Diol (parts | acid (parts | (parts | group | molecular |
| polyol No. | by mass) | by mass) | by mass) | (molar ratio) | weight |
| A-17 | 1,3-Propanediol | Adipic acid | 69.5 | 3/7 | 2030 |
| | (100.0) | (49.4) | | | |
| A-18 | 1,6-Hexanediol | Sebacic acid | 19.2 | 7/3 | 2040 |
| | (100.0) | (102.8) | | | |

### <1-2. Preparation of Raw Material Isocyanates B-1 to B-6>

Raw material isocyanates shown in Table 46 were prepared.

TABLE 46

| No. | Raw material isocyanate |
|---|---|
| B-1 | Diphenylmethane diisocyanate (MDI) |
| | (trade name: MILLIONATE MT, Tosoh Corporation) |
| B-2 | Polymethylene polyphenyl polyisocyanate (Polymeric MDI) |
| | (trade name: MILLIONATE MR200, Tosoh Corporation) |
| B-3 | Tolylene diisocyanate (TDI) |
| | (trade name: CORONATE T-80, Tosoh Corporation) |
| B-4 | Tolylene diisocyanate (TDI), adduct of trimethylolpropane |
| | (trade name: CORONATE L, Tosoh Corporation) |
| B-5 | Hexamethylene diisocyanate (trade name: |
| | DURANATE 50M-HDI, Asahi Kasei Chemicals Corporation) |
| B-6 | Isocyanurate trimer of hexamethylene diisocyanate (trade name: |
| | DURANATE TPA-100, Asahi Kasei Chemicals Corporation) |

### <1-3. Production Example of Hydroxyl-Terminated Urethane Prepolymers C-1 to C-14>

### [Synthesis of Hydroxyl-Terminated Urethane Prepolymer C-1]

In a nitrogen atmosphere, materials shown in Table 47 were reacted by heating and stirring at a temperature of 90° C. for 3 hours. Thereafter, 2-butanone (MEK) was added to the obtained reaction product to prepare a hydroxyl-terminated urethane prepolymer C-1 as a solution having a solid content of 50 parts by mass.

TABLE 47

| Material | Parts by mass |
|---|---|
| Raw material polyol A-1 (trade name: | 100 |
| DURANOL T5652, Asahi Kasci Chemicals Corporation) | |
| Raw material isocyanate B-1 | 6.3 |
| (trade name: MILLIONATE MT, Tosoh Corporation) | |

### [Synthesis of Hydroxyl-Terminated Urethane Prepolymers C-2 to C-14]

Hydroxyl-terminated urethane prepolymers C-2 to C-14 were prepared in the same manner as in the case of synthesizing the hydroxyl-terminated urethane prepolymer C-1 using starting materials shown in Table 48.

The chemical structures of these hydroxyl-terminated urethane prepolymers C-1 to C-14 were specified using ¹H-NMR and ¹³C-NMR. Note that, in Table 48, m, n, o, p, q, r, and s in Structural Formulas (1), (2), (3), and (4) are the average numbers of added moles. Here, PBM means “Parts by mass”. (1) to (4) means “Structural Formula (1)” to “Structural Formula (4)”.

TABLE 48

| Hydroxyl- | | | | | | | | |
|---|---|---|---|---|---|---|---|---|
| terminated | | | | | | | | |
| urethane | Raw material | | Raw material | | | | | |
| prepolymer | polyol | | isocyanate | | | | | |
| No. | No. | PBM | No. | PBM | Structure contained in molecule | | | |
| C-1 | A-1 | 100 | B-1 | 6.3 | (1) | R11 = (CH₂)₅ | R12 = (CH₂)₆ | m, n = 6.9 |
| C-2 | A-2 | 100 | B-1 | 5.7 | (1) | R11 = (CH₂)₄ | R12 = (CH₂)₆ | m = 10.7, n = 4.6 |
| C-3 | A-3 | 100 | B-1 | 6.3 | (1) | R11 = (CH₂)₃ | R12 = (CH₂)₄ | m, n = 8.8 |
| C-4 | A-4 | 100 | B-1 | 6.3 | (1) | R11 = (CH₂)₄ | R12 = (CH₂)₆ | m = 14.5, n = 1.6 |
| C-5 | A-5 | 100 | B-1 | 6.3 | (1) | R11 = (CH₂)₆ | R12 = (CH₂)₂—CHMe—(CH₂)₂ | m, n = 6.5 |
| C-6 | A-6 | 100 | B-1 | 6.3 | (1) | R11 = (CH₂)₆ | R12 = (CH₂)₂—CHMe—(CH₂)₂ | m = 1.3, n = 11.8 |
| C-7 | A-7 | 100 | B-1 | 4.2 | (1) | R11 = (CH₂)₆ | R12 = (CH₂)₂—CHMe—(CH₂)₂ | m = 2.0, n = 18.0 |
| C-8 | A-8 | 100 | B-1 | 6.3 | (1) | R11 = (CH₂)₉ | R12 = CH₂—CHMe—(CH₂)₆ | m = 6.5, n = 3.5 |
| C-9 | A-9 | 100 | B-1 | 6.3 | (1) | R11 = (CH₂)₉ | R12 = CH₂—CHMe—(CH₂)₆ | m = 3.5, n = 6.5 |
| C-10 | A-10 | 100 | B-5 | 4.3 | (2) | o = 9.1, p = 5.5 | | |
| C-11 | A-17 | 100 | B-1 | 6.3 | (3) | R31 = (CH₂)₃ | R32 = (CH₂)₄ | q = 12, r = 5.1 |
| C-12 | A-18 | 100 | B-1 | 6.3 | (3) | R31 = (CH₂)₆ | R32 = (CH₂)₈ | q = 2.7, r = 6.3 |
| C-13 | A-11 | 100 | B-1 | 6.3 | (4) | R41 = (CH₂)₆ | | s = 13.2 |
| C-14 | A-1 | 100 | B-3 | 4.8 | (1) | R11 = (CH₂)₅ | R12 = (CH₂)₆ | m, n = 6.9 |

Regarding the hydroxyl-terminated urethane prepolymers C-1 to C-9 and C-14 in which the structure represented by Structural Formula (1) was contained in the molecule, R13 in Structural Formula (1) was the same as R12.

In the table, notations such as m, n=6.9 or “x, y=A” indicate that the average number of added moles for each of x and y is A. The same applies to the following table.

### <1-4. Production Example of Isocyanate-Terminated Prepolymers D-1 to D-9>

### [Synthesis of Isocyanate-Terminated Prepolymer D-1]

In a nitrogen atmosphere, materials shown in Table 49 were reacted by heating and stirring at a temperature of 90° C. for 3 hours. Thereafter, 2-butanone (MEK) was added to the obtained reaction product to form a solution having a solid content of 50 parts by mass, thereby producing an isocyanate-terminated prepolymer D-1.

TABLE 49

| Material | Parts by mass |
|---|---|
| Raw material polyol A-10 (trade name: | 100 |
| NIPPOLLAN 982, Tosoh Corporation) | |
| Raw material isocyanate B-2 (trade name: | 33.5 |
| MILLIONATE MR200, Tosoh Corporation) | |

### [Synthesis of Isocyanate-Terminated Prepolymers D-2 to D-9]

Isocyanate-terminated prepolymers D-2 to D-9 were prepared in the same manner as in the case of synthesis of the isocyanate-terminated prepolymer D-1 using the types and amounts of starting materials shown in Table 50.

The chemical structures of these isocyanate-terminated prepolymers D-1 to D-9 were identified using ¹H-NMR and ¹³C-NMR. Note that, in Table 50, m, n, o, p, q, r, and s in Structural Formulas (1), (2), (3), and (4) are the average numbers of added moles. Here, PBM means “Parts by mass”. (1) to (4) means “Structural Formula (1)”

TABLE 50

| Isocyanate- | Raw | | Raw | | | | | |
|---|---|---|---|---|---|---|---|---|
| terminated | material | | material | | | | | |
| prepolymer | polyol | | isocyanate | | | | | |
| No. | No. | PBM | No. | PBM | Structure contained in molecule | | | |
| D-1 | A-10 | 100 | B-2 | 33.5 | (2) | o = 9.1, p = 5.5 | | |
| D-2 | A-14 | 100 | B-6 | 78.4 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m, n = 2.7 |
| D-3 | A-15 | 100 | B-6 | 78.4 | (1) | R11 = (CH₂)₆ | $R 12 = {CH}_{2} - CH < \begin{matrix}{( {CH}_{2} )}_{2} \\ {( {CH}_{2} )}_{2}\end{matrix} > CH - {CH}_{2}$ | m = 4.1, n = 1.4 |
| D-4 | A-13 | 100 | B-6 | 70.3 | (4) | $R 41 = {CH}_{2} - CH < \begin{matrix}{( {CH}_{2} )}_{2} \\ {( {CH}_{2} )}_{2}\end{matrix} > CH - {CH}_{2}$ | | s = 5.8 |
| D-5 | A-11 | 100 | B-2 | 33.5 | (4) | R41 = (CH₂)₆ | | s = 13.2 |
| D-6 | A-12 | 100 | B-2 | 28.2 | (4) | R41 = (CH₂)₆ | | s = 20.1 |
| D-7 | A-16 | 100 | B-6 | 70.3 | (4) | R41 = CH₂—CEtBu—CH₂ | | s = 4.6 |
| D-8 | A-10 | 100 | B-4 | 102.2 | (2) | o = 9.1, p = 5.5 | | |
| D-9 | A-1 | 100 | B-2 | 33.5 | (1) | R11 = (CH₂)₆ | R12 = (CH₂)₆ | m:n = 1:1 |

In the isocyanate-terminated prepolymers D-2 and D-3 in which the structure represented by Structural Formula (1) was contained in the molecule, R13 in Structural Formula (1) was the same as at least one selected from the group consisting of R11 and R12. In addition, in the isocyanate-terminated prepolymer D-9 in which the structure represented by Structural Formula (1) was contained in the molecule, R13 in Structural Formula (1) was the same as R12.

### [2. Preparation and Production of Additive Raw Materials for Resin Layer]

### <2-1. Preparation and Production Example of Polyoxyethylene Polyoxypropylene Alkyl Ethers E-1 to E-17>

### [Preparation of Polyoxyethylene Polyoxypropylene Alkyl Ether]

Additives E-1 to E-5 which are polyoxyethylene polyoxypropylene alkyl ethers shown in Table 51 were commercially available products. In addition, polyoxyethylene polyoxypropylene alkyl ethers E-6 and E-7 were synthesized.

### [Synthesis of Polyoxyethylene Polyoxypropylene Alkyl Ether E-6]

169.3 g of 1-octanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

The obtained ethylene oxide adduct was cooled to 130° C., and then 1,132.6 g of propylene oxide (15 mol relative to alcohol) was charged. After completion of the charging, the reaction was carried out at 130° C. for 5 hours to obtain a polyoxyethylene polyoxypropylene octyl ether adduct, which is a block polymer having an average number of added moles of 15 mol of ethylene oxide and 15 mol of propylene oxide.

The obtained polyoxyethylene polyoxypropylene octyl ether adduct was cooled to 80° C., and unreacted ethylene oxide and propylene oxide were removed at 2.5 kPa for 30 minutes. Next, 6.0 g of 90% lactic acid was charged into the autoclave, stirred at 80° C. for 30 minutes, and then extracted to obtain polyoxyethylene polyoxypropylene octyl ether E-6. The structure of R51 and the values of t and u in E-6 are shown in Table 51.

### [Synthesis of Polyoxyethylene Polyoxypropylene Alkyl Ether E-7]

550.0 g of polyoxyethylene methyl ether (trade name: Blaunon MP-550, manufactured by AOKI OIL INDUSTRIAL Co., Ltd., the average number of added moles of 12 mol of ethylene oxide relative to alcohol) and 3.0 g of potassium hydroxide were charged into an autoclave equipped with a stirrer, a temperature controller, and an automatic feed device, and subjected to dehydration at 110° C. and 1.2 kPa for 30 minutes. After completion of the dehydration, nitrogen purging was performed, the temperature was raised to 130° C., and then 871.2 g (12 mol relative to alcohol) of propylene oxide was charged. After completion of the charging, the reaction was carried out at 130° C. for 4 hours to obtain a polyoxyethylene polyoxypropylene methyl ether adduct, which is a block polymer having an average number of added moles of 12 mol of ethylene oxide and 12 mol of propylene oxide.

The obtained polyoxyethylene polyoxypropylene methyl ether adduct was cooled to 80° C., and unreacted propylene oxide was removed at 2.5 kPa for 30 minutes. Next, 6.0 g of 90% lactic acid was charged into the autoclave, stirred at 80° C. for 30 minutes, and then extracted to obtain polyoxyethylene polyoxypropylene methyl ether E-7. The structure of R51 and the values oft and u in E-7 are shown in Table 51. Here, (5) means “Structural Formula (5)”.

TABLE 51

| No. | Material | Structure | | |
|---|---|---|---|---|
| E-1 | Polyoxyethylene polyoxypropylene butyl ether | (5) | R51 = C₄H₉ | t, u = 17 |
| | (trade name: UNILUBE 50MB-26, NOF corporation) | | | |
| E-2 | Polyoxyethylene polyoxypropylene butyl ether | (5) | R51 = C₄H₉ | t, u = 30 |
| | (trade name: UNILUBE 50MB-72, NOF corporation) | | | |
| E-3 | Polyoxyethylene polyoxypropylene butyl ether | (5) | R51 = C₄H₉ | t = 9, |
| | (trade name: UNILUBE 50MB-11, NOF corporation) | | | u = 10 |
| E-4 | Polyoxyethylene polyoxypropylene lauryl ether | (5) | R51 = C₁₂H₂₅ | t, u = 5 |
| | (trade name: NONION A-13PR, NOF corporation) | | | |
| E-5 | Polyoxyethylene polyoxypropylene lauryl ether | (5) | R51 = C₁₂H₂₅ | t, u = 25 |
| | (trade name: NONION A-25B, NOF corporation) | | | |
| E-6 | Polyoxyethylene polyoxypropylene octyl ether | (5) | R51 = C₈H₁₇ | t, u = 15 |
| E-7 | Polyoxyethylene polyoxypropylene methyl ether | (5) | R51 = CH₃ | t, u = 12 |

### <2-2. Preparation and Production Example of Polyether Amine>

### [Preparation of Polyether Amine]

Commercially available products of E-8 and E-9, which are polyether amines as additives, shown in Table 52 were purchased. In addition, a polyether amine E-10 was synthesized.

### [Synthesis of Polyether Amine E-10]

A stirrer was attached to a three-neck flask, and 1,658 g of polyoxyethylene polyoxypropylene octyl ether and 460 ml of acetic acid were charged. 600 ml of a 2 mol/l aqueous sodium hypochlorite solution was added dropwise thereto over 1 hour. A reaction vessel was cooled in an ice bath so that the temperature was maintained in the range of 15 to 25° C. After completion of the dropwise addition, stirring was continued for 1 hour. Dichloromethane was added to the obtained solution, and the aqueous layer was extracted and post-treated and purified by a column to obtain a compound in which a secondary alcohol was converted into a ketone.

The mixture was cooled to 0° C. in an ice bath, 250 ml of a methanol-acetic acid mixed solution (volume ratio of 10:1) was added to 41.4 g of a compound in which the obtained secondary alcohol was converted into a ketone, and 2.7 g of 2-picoline-borane was added. The ice bath was removed, and the mixture was stirred overnight at room temperature in an open system. After concentration, the mixture was cooled to 0° C., 360 ml of a 35% aqueous hydrochloric acid solution was added, and the mixture was stirred at room temperature for 2 hours. An aqueous sodium hydroxide solution was added to make the mixture basic, and the aqueous layer was extracted with dichloromethane and post-treated and purified by a column to obtain a polyether amine E-10. The structure of R61 in E-10 and the values of v and w are shown in Table 52. Here, (6) means “Structural Formula (6)”.

TABLE 52

| No. | Material | Structure | | |
|---|---|---|---|---|
| E-8 | Polyether amine (trade name: | (6) | R61 = CH₃ | v = 6, |
| | JEFFAMINE M-2005, | | | w = 29 |
| | Huntsman Corporation) | | | |
| E-9 | Polyether amine (trade name: | (6) | R61 = CH₃ | v = 1, |
| | JEFFAMINE M-600, | | | w = 9 |
| | Huntsman Corporation) | | | |
| E-10 | Polyether amine | (6) | R61 = C₈H₁₇ | v, w = 15 |

### <2-3. Preparation and Production Example of Polyoxyethylene Alkyl Ether Acetate>

### [Preparation of Polyoxyethylene Alkyl Ether Acetate]

Polyoxyethylene alkyl ether acetate E-11, which is used as an additive and is shown in Table 53, was purchased as a commercially available product. In addition, polyoxyethylene alkyl ether acetates E-12 and E-13 were synthesized.

### [Synthesis of Polyoxyethylene Alkyl Ether Acetate E-12]

55.0 g of polyoxyethylene methyl ether (trade name: Blaunon MP-550, manufactured by AOKI OIL INDUSTRIAL Co., Ltd., the average number of added moles of 12 mol relative to alcohol) and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-12. The structure of R71 in E-12 and the value of x are shown in Table 53.

### [Synthesis of Polyoxyethylene Alkyl Ether Acetate E-13]

169.3 g of 1-octanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

77.4 g of the obtained ethylene oxide adduct and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-13. The structure of R71 in E-13 and the value of x are shown in Table 53. Here, (7) means “Structural Formula (7)”.

TABLE 53

| No. | Material | Structure | | |
|---|---|---|---|---|
| E-11 | Polyoxyethylene lauryl ether | (7) | R71 = C₁₂H₂₅ | x = 5 |
| | acetate (trade name: TAIPOL | | | |
| | SOFT ECA-490, TAIKO OIL | | | |
| | CHEM. Co., Ltd.) | | | |
| E-12 | Polyoxyethylene methyl ether | (7) | R71 = CH₃ | x = 11 |
| | acetate | | | |
| E-13 | Polyoxyethylene octyl ether | (7) | R71 = C₈H₁₇ | x = 14 |
| | acetate | | | |

<Preparation of coarse Particles>

Urethane particles H-1, H-2, and H-3 as coarse particles shown in Table 54 are commercially available products.

TABLE 54

| No. | Material |
|---|---|
| H-1 | Trade name: ART PEARL C-400T (Negami Chemical |
| | Industrial Co., Ltd.) (average particle diameter: 15 μm) |
| H-2 | Trade name: ART PEARL C-600T (Negami Chemical |
| | Industrial Co., Ltd.) (average particle diameter: 10 μm) |

### [3. Production Example of Coating Liquids F-1 to F-44 and F-70 for Forming Resin Layer]

### <3-1. Preparation of Coating Liquid F-1 for Forming Resin Layer>

The types and amounts of materials shown in Table 55 were added to a reaction vessel as materials for a coating liquid F-1 for forming a resin layer and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-1 for forming a resin layer.

TABLE 55

| Material | Parts by mass |
|---|---|
| Hydroxyl-terminated urethane prepolymer C-1 | 100 |
| Isocyanate-terminated urethane prepolymer D-5 | 54.7 |
| Additive E-1 | 7 |
| Carbon black | 35 |
| (trade name: MA8, Mitsubishi Chemical Corporation) | |
| Coarse particles H-1 | 23 |

### <3-2. Preparation of Coating Liquids F-2 to F-44 and F-70 for Forming Resin Layer>

Coating liquids F-2 to F-44 and F-70 for forming a resin layer were prepared by the following method. First, the hydroxyl-terminated urethane prepolymer, isocyanate-terminated prepolymer, additive, carbon black, and coarse particles described in Tables 56-1 and 56-2 were mixed in the same manner as in the case of preparing the coating liquid F-1 for forming a resin layer. Thereafter, 2-butanone (MEK) was added to adjust the viscosity of the liquid to a range of 6 to 10 mPa·s, thereby producing coating liquids F-2 to F-44 and F-70 for forming a resin layer. Here, PBM means “Parts by mass”.

TABLE 56-1

| | Hydroxyl- | | Isocyanate- | | | | | | |
|---|---|---|---|---|---|---|---|---|---|
| | terminated | | terminated | | | | | | |
| | urethane | | urethane | | | | Carbon | Coarse | |
| | prepolymer | | prepolymer | | Additive | | black | particles | |
| | No. | PBM | No. | PBM | No. | PBM | PBM | No. | PBM |
| F-1 | C-1 | 100 | D-5 | 54.7 | E-1 | 7 | 35 | H-1 | 23 |
| F-2 | C-3 | 100 | D-5 | 54.7 | E-1 | 7 | 35 | H-1 | 23 |
| F-3 | C-5 | 100 | D-5 | 54.7 | E-1 | 7 | 35 | H-1 | 23 |
| F-4 | C-7 | 100 | D-5 | 37.2 | E-1 | 6.4 | 32 | H-1 | 21 |
| F-5 | C-13 | 100 | D-3 | 54.7 | E-1 | 7 | 35 | H-1 | 23 |
| F-6 | C-1 | 100 | D-6 | 54.7 | E-1 | 7 | 35 | H-1 | 23 |
| F-7 | C-7 | 100 | D-4 | 37.2 | E-1 | 6.4 | 32 | H-1 | 21 |
| F-8 | C-9 | 100 | D-7 | 54.7 | E-1 | 7 | 35 | H-1 | 23 |
| F-9 | C-1 | 100 | D-1 | 54.7 | E-1 | 7 | 35 | H-1 | 23 |
| F-10 | C-2 | 100 | D-1 | 54.7 | E-1 | 7 | 35 | H-1 | 23 |
| F-11 | C-3 | 100 | D-1 | 54.7 | E-1 | 7 | 35 | H-1 | 23 |
| F-12 | C-4 | 100 | D-1 | 54.7 | E-1 | 7 | 35 | H-1 | 23 |
| F-13 | C-5 | 100 | D-1 | 54.7 | E-1 | 7 | 35 | H-1 | 23 |
| F-14 | C-6 | 100 | D-1 | 54.7 | E-1 | 7 | 35 | H-1 | 23 |
| F-15 | C-7 | 100 | D-1 | 37.2 | E-1 | 6.4 | 32 | H-1 | 21 |
| F-16 | C-8 | 100 | D-1 | 54.7 | E-1 | 7 | 35 | H-1 | 23 |
| F-17 | C-9 | 100 | D-1 | 54.7 | E-1 | 7 | 35 | H-1 | 23 |
| F-18 | C-10 | 100 | D-2 | 54.7 | E-1 | 7 | 35 | H-1 | 23 |
| F-19 | C-10 | 100 | D-3 | 54.7 | E-1 | 7 | 35 | H-1 | 23 |
| F-20 | C-11 | 100 | D-5 | 54.7 | E-1 | 7 | 35 | H-1 | 23 |
| F-21 | C-12 | 100 | D-5 | 54.7 | E-1 | 7 | 35 | H-1 | 23 |
| F-22 | C-13 | 100 | D-1 | 54.7 | E-1 | 7 | 35 | H-1 | 23 |
| F-23 | C-10 | 100 | D-4 | 54.7 | E-1 | 7 | 35 | H-1 | 23 |
| F-24 | C-10 | 100 | D-7 | 54.7 | E-1 | 7 | 35 | H-1 | 23 |

Here, PBM means “Parts by mass”.

TABLE 56-2

| | Hydroxyl- | | Isocyanate- | | | | | | |
|---|---|---|---|---|---|---|---|---|---|
| | terminated | | terminated | | | | | | |
| | urethane | | urethane | | | | Carbon | Coarse | |
| | prepolymer | | prepolymer | | Additive | | black | particles | |
| | No. | PBM | No. | PBM | No. | PBM | PBM | No. | PBM |
| F-25 | C-1 | 50 | D-5 | 54.7 | E-1 | 7 | 35 | H-1 | 23 |
| | C-10 | 50 | | | | | | | |
| F-26 | C-14 | 100 | D-1 | 54.7 | E-1 | 7 | 35 | H-1 | 23 |
| F-27 | C-1 | 100 | D-5 | 54.7 | E-1 | 6.6 | 35 | H-1 | 23 |
| F-28 | C-1 | 100 | D-5 | 54.7 | E-1 | 16.1 | 35 | H-1 | 23 |
| F-29 | C-1 | 100 | D-5 | 54.7 | E-2 | 7 | 35 | H-1 | 23 |
| F-30 | C-1 | 100 | D-5 | 54.7 | E-3 | 7 | 35 | H-1 | 23 |
| F-31 | C-1 | 100 | D-5 | 54.7 | E-4 | 7 | 35 | H-1 | 23 |
| F-32 | C-1 | 100 | D-5 | 54.7 | E-5 | 7 | 35 | H-1 | 23 |
| F-33 | C-1 | 100 | D-5 | 54.7 | E-6 | 7 | 35 | H-1 | 23 |
| F-34 | C-1 | 100 | D-5 | 54.7 | E-7 | 7 | 35 | H-1 | 23 |
| F-35 | C-1 | 100 | D-5 | 54.7 | E-8 | 7 | 35 | H-1 | 23 |
| F-36 | C-1 | 100 | D-5 | 54.7 | E-8 | 6.6 | 35 | H-1 | 23 |
| F-37 | C-1 | 100 | D-5 | 54.7 | E-8 | 16.1 | 35 | H-1 | 23 |
| F-38 | C-1 | 100 | D-5 | 54.7 | E-9 | 7 | 35 | H-1 | 23 |
| F-39 | C-1 | 100 | D-5 | 54.7 | E-10 | 7 | 35 | H-1 | 23 |
| F-40 | C-1 | 100 | D-5 | 54.7 | E-11 | 7 | 35 | H-1 | 23 |
| F-41 | C-1 | 100 | D-5 | 54.7 | E-11 | 6.6 | 35 | H-1 | 23 |
| F-42 | C-1 | 100 | D-5 | 54.7 | E-11 | 16.1 | 35 | H-1 | 23 |
| F-43 | C-1 | 100 | D-5 | 54.7 | E-12 | 7 | 35 | H-1 | 23 |
| F-44 | C-1 | 100 | D-5 | 54.7 | E-13 | 7 | 35 | H-1 | 23 |
| F-70 | C-1 | 100 | D-5 | 54.7 | E-1 | 7 | 35 | H-2 | 20 |

### 1. Production of Electrophotographic Roller>

In the present example, an electrophotographic roller in which an elastic roller provided with an elastic layer formed on an outer surface of a substrate is coated with a resin layer will be described, but the present disclosure is not limited to this configuration.

### [1-1. Preparation of Substrate]

As a substrate, a stainless steel (SUS304) core metal having a diameter of 6 mm was prepared by applying a primer (trade name: DY35-051, manufactured by Dow Toray Co., Ltd.) to a peripheral surface of the core metal and baking the primer.

### [1-2. Preparation of Elastic Layer]

The substrate was placed in a mold, and an addition-type silicone rubber composition obtained by mixing the materials shown in Table 57 was injected into a cavity formed in the mold.

TABLE 57

| Material | Parts by mass |
|---|---|
| Liquid silicone rubber | 100 |
| (trade name: SE6724 A/B, Dow Toray Co., Ltd.) | |
| Carbon black (trade name: | 16 |
| TOKABLACK #4300, Tokai Carbon Co., Ltd.) | |
| Curing control agent (trade name: 1-Ethenyl-1- | 0.01 |
| cyclohexanol, Tokyo Chemical Industry Co., Ltd.) | |
| Platinum catalyst | 0.01 |
| (trade name: SIP6830.3, Gelest, Inc.) | |

Subsequently, the mold was heated to vulcanize and cure the silicone rubber at a temperature of 150° C. for 15 minutes, and the silicone rubber was demolded and then further heated at a temperature of 180° C. for 1 hour to complete the curing reaction, thereby obtaining an elastic roller in which an elastic layer having a diameter of 11.5 mm was provided on the outer periphery of the substrate.

### [1-3. Preparation of Resin Layer]

The elastic roller was held at its upper end with the longitudinal direction oriented vertically and was immersed (dipped) into the coating liquid F-1 for forming a resin layer, thereby coating the surface of the elastic roller with the coating liquid. The obtained coated product was air-dried at normal temperature for 30 minutes, and then dried in a hot air circulating dryer set at 160° C. for 1 hour. In this manner, an electrophotographic roller G-1 in which a resin layer having a thickness of 12 μm was formed on the elastic layer was obtained.

### <2. Measurement of Impedance>

The impedance was measured as follows.

First, as a pretreatment, vacuum platinum vapor deposition was performed on the electrophotographic roller G-1 while rotating, thereby preparing a measurement electrode. For vapor deposition, a vacuum vapor deposition apparatus having a mechanism for holding and rotating a substrate portion of a roller as an object to be deposited in a circumferential direction was used, a roller rotational speed, a vapor deposition distance, and a vapor deposition time were controlled, and vapor deposition was performed so that a film thickness was 100 nm or more. At this time, an electrode having a width of 1.5 cm was produced using a masking tape. By forming the electrode with a film thickness of 100 nm or more, it is possible to minimize the effect of the surface roughness of the electrophotographic roller on the contact area between the measurement electrode and the electrophotographic roller.

Next, an aluminum sheet was wound around the electrode without any gap, and the aluminum sheet was connected to measurement electrodes of an impedance measuring apparatus (trade names: Solartron 1260 and Solartron 1296, manufactured by Solartron) and a high-voltage system (trade names: 6792 and HVA-500, manufactured by Toyo Corporation).

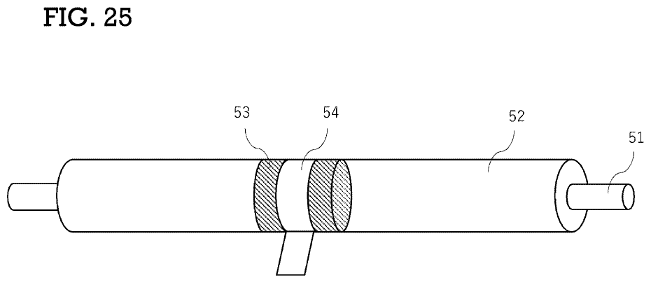

FIG. 25 is a schematic view of a state in which measurement electrodes are formed on the electrophotographic roller. In the drawing, reference numeral 51 denotes a conductive substrate, reference numeral 52 denotes a resin layer, reference numeral 53 denotes a platinum vapor-deposited layer, and reference numeral 54 denotes an aluminum sheet. Although the elastic layer is not illustrated in the drawing, the elastic layer is present between the substrate 51 and the resin layer 52.

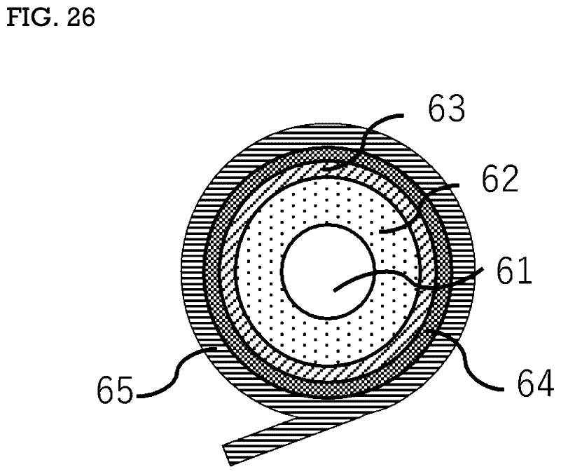

FIG. 26 is a cross-sectional view of a state in which measurement electrodes are formed on the electrophotographic roller. Reference numeral 61 denotes a conductive substrate, reference numeral 62 denotes an elastic layer, reference numeral 63 denotes a resin layer, reference numeral 64 denotes a platinum vapor-deposited layer, and reference numeral 65 denotes an aluminum sheet. Thus, it is important that the resin layer is sandwiched between the conductive substrate and the measurement electrode.

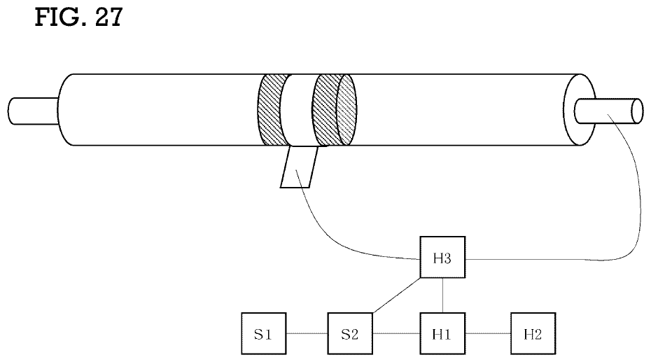

Then, the aluminum sheet was connected to measurement electrodes on a side of an impedance measuring apparatus (S1: Solartron 1260, manufactured by Solartron and S2: Solartron 1296, manufactured by Solartron) and a high-voltage system (H1: trade name: 6792, manufactured by TOYO Corporation, H2: trade name: HVA-500, manufactured by TOYO Corporation, and H3: reference box 6796, manufactured by Solartron). FIG. 27 is a schematic view of the measurement system. Impedance measurement was performed by using the conductive substrate and the aluminum sheet as two electrodes for measurement.

In the impedance measurement, a DC voltage of 50 V and an AC voltage of 50 V were applied in an environment of a temperature of 23° C. and a relative humidity of 50%, and an absolute value of the impedance was obtained at a frequency of 1.0×10⁻¹ to 1.0×10⁵ Hz. Then, the minimum value of the impedance value at a frequency of 1.0×10⁰ to 1.0×10¹ Hz was confirmed. The impedance was measured at the center of the electrophotographic roller in the longitudinal direction.

### <3. Measurement of Surface Potential>

The surface potential of the electrophotographic roller was measured using a charge amount measuring apparatus (trade name: DRA-2000L, manufactured by QEA, Inc.). Specifically, in an environment of a temperature of 23° C. and a relative humidity of 50%, a grid portion of a corona discharger of the charge amount measuring apparatus was disposed so as to maintain a gap of 1 mm from the outer surface of the electrophotographic roller. The grid portion of the corona discharger of the apparatus has a width of 3.0 mm.

Next, a voltage of 8 kV was applied to the corona discharger, the corona discharger was relatively moved at a speed of 400 mm/sec along the axial direction of the electrophotographic roller to charge the surface of the conductive member, and a potential of the outer surface after 0.06 seconds from the passage of the grid was measured. The maximum value among all measurement values obtained at eight positions in the longitudinal direction at 450 intervals in the circumferential direction of the electrophotographic roller was adopted.

### <4. Measurement of Surface Shape>

The surface shape of the developing roller was measured using a confocal laser microscope (trade name: VK-X200, manufactured by Keyence Corporation). Specifically, the developing roller was disposed horizontally, and the position of the objective lens was adjusted so that the apex portion of the outer periphery of the developing roller having a substantially cylindrical shape was brought into focus. An objective lens with an NA of 0.95 and a magnification of 50× was used.

In the shape measurement mode “Expert Mode”, a laser was used as a light source at the time of measurement range adjustment, upper and lower limits of the measurement height range were set, and then the shape was measured by the following setting.
Light source: laser
Brightness adjustment: automatic
Measurement mode: surface shape
Measurement size: standard (1,024×768 pixels)
Measurement quality: high quality Measurement pitch: 0.10 μm
Real Peak Detection (RPD): enabled

The measurement result including the shape information was saved in a file. Next, the following operation was performed by the multi-file analysis application VK-X3000 Multi-File Analysis Software. A substantially cylindrical shape was converted into a planar unevenness shape by second-order surface correction using the surface shape correction in the image processing menu.

Next, in the multiple-line roughness measurement mode in the measurement menu,
a first measurement line was set near the center of a field of view,
a total of 21 measurement lines were set with 10 lines placed on each side of the central line at intervals of 45 lines,
the measurement line was set to be aligned in the circumferential direction,
the measurement type was set to roughness with terminal effect correction enabled and no cutoff applied, and
the mean value of the maximum height roughness Rz of the surface roughness was obtained from the total of 21 lines calculated by the application.

The shape measurement and analysis were performed on a total of nine points (three longitudinal points and three circumferential points) of the developing roller, and the mean value of the respective measured values Rz was defined as the Rz of the developing roller.

### <5. Calculation of Equivalent Circle Diameter and Wall-to-Wall Distance of Carbon Black Dispersed in Resin Layer>

The dispersion particle diameter and the wall-to-wall distance of carbon black dispersed in the resin layer were measured by the following methods.

First, a section (having a thickness of 0.5 to 1.0 mm) was cut out using a razor so that a cross section perpendicular to the longitudinal direction of the electrophotographic roller can be observed. When the adhesion between the substrate and the resin layer is strong and it is difficult to cut out the substrate with a razor blade, the entire substrate is cut out using a metal saw or the like, and then subjected to cross section processing with a focused ion beam (FIB) apparatus.

Next, the section is subjected to platinum vapor deposition, and an image of the resin layer is captured at 15,000× magnification using a scanning electron microscope (SEM) (trade name: JSM-7800F, manufactured by JEOL Ltd.) to obtain a cross-sectional image.

Furthermore, in order to quantify the cross-sectional image obtained by observation with the SEM, the cross-sectional image is converted to an 8-bit grayscale image using image processing software (trade name: Luzex AP, manufactured by Nireco Corporation) to obtain a 256-tone monochrome image. Next, black and white of the image are reversed so that the carbon black in the cross-sectional image becomes white, a threshold value for binarization is set on the luminance distribution of the image based on the Otsu's discriminant analysis algorithm, and then, a binarized image in which the carbon black becomes white and the binder resin portion becomes black is obtained.

Then, for the obtained binarized image, an equivalent circle diameter of the whitened carbon black portion and an adjacent wall-to-wall distance are calculated using image processing software (trade name: Luzex AP, manufactured by Nireco Corporation). The equivalent circle diameter and the adjacent wall-to-wall distance are calculated. In order to eliminate the uncertainty of the calculated value of the carbon black divided at the upper, lower, left, and right ends of the image, a region on the inner side of 0.075 μm in the actual image dimension (in cases where there are characters such as SEM measurement conditions, the region is set 0.075 μm inward from the start of the actual image) is set as the image region, and the equivalent circle diameter and the adjacent wall-to-wall distance for all the carbon blacks in the designated image region are calculated. Then, the arithmetic mean value and the standard deviation are calculated for the distributions of the obtained equivalent circle diameters and the adjacent wall-to-wall distances. The number of images to be subjected to image analysis is not particularly limited even from one, but is set to at least three or more in order to eliminate the influence of a location difference in the longitudinal direction of the carbon black dispersed in the resin layer of the electrophotographic roller.

In addition, the number average diameter of primary particles of carbon black dispersed in the resin was measured with a transmission electron microscope (TEM). First, a thin-section sample was prepared. A known method can be used for preparing the thin section. For example, the sample can be thinned using an ion beam, a diamond knife, or the like. In the present disclosure, a 40 nm-thick thinned sample for observation was prepared using an ultramicrotome (trade name: ULTRACUT-S, manufactured by Leica Microsystems GmbH).

Then, using a transmission electron microscope (trade name: H-7100FA, manufactured by Hitachi High-Tech Corporation), a TEM image was acquired under measurement conditions of a TE mode and an acceleration voltage of 100 kV.

Then, using image analysis software (trade name: WinROOF, manufactured by MITANI CORPORATION), the equivalent circle diameters of 50 arbitrarily selected primary particles of carbon black in the TEM image were measured, and the number average value of the 50 primary particles was taken as the number average diameter of the primary particles.

### (Measurement of DBP Absorption of Carbon Black)

The DBP absorption of the carbon black was measured in accordance with Japanese Industrial Standard (JIS) K6217-4 using a carbon black powder.

### (Measurement of pH of Carbon Black)

The pH of the carbon black was measured in accordance with ASTM D1512 using a carbon black powder.

### 3. Image Evaluation

A process cartridge in which an electrophotographic roller G-1 was mounted as the developing roller 31 of the process cartridge 20 was inserted into an image forming apparatus, and image evaluation was performed.

### [3-1. Evaluation of Fogging]

The prepared process cartridge was mounted in the main body of the image forming apparatus, and was left to stand in an environment of a temperature of 30° C. and a relative humidity of 80% for 24 hours. Thereafter, the potential difference between the developing blade and the electrophotographic roller was set to −300 V using an external high-voltage power supply, and in the same environment, an image of the letter “E” in 4-point size of the alphabet having a print coverage of 2% with respect to the area of the paper was continuously output on JK-Leger paper (trade name, manufactured by JK PAPER LTD.) having a width in a direction perpendicular to the paper conveyance direction that is shorter than a width in a longitudinal direction of the toner carried on the developing roller. For every 3,000 sheets output, a solid white image was output on A4 evaluation paper (GF-C081, manufactured by Canon Inc.), and this was repeated up to 15,000 sheets, and a fogging value was measured by the following method.

A reflective density R1 of the recording material before image formation and a reflective density R2 of the recording material on which the solid white image was output were measured using a reflection densitometer (trade name: TC-6DS/A, manufactured by Tokyo Denshoku Co., Ltd.), and an increase in reflective density (R2−R1) was taken as the “fogging value” of the electrophotographic roller. The reflective density was measured in the entire area of the image printing area of the recording material, and the arithmetic mean value was adopted for the recording material before image formation, and the maximum value was adopted for the recording material on which a solid white image was output. Next, an arithmetic mean value of the fogging values of each image up to 15,000 images was calculated. Note that the smaller the fogging value, the more preferable it is, and normally, toner is not transferred onto a transfer sheet on which a solid white image is formed. In a case where the charge amount of toner is insufficient, the toner moves onto the photosensitive member even at the time of forming a solid white image, and is further transferred onto a transfer sheet to increase the fogging value. The evaluation results are shown in Tables 58-5 to 58-8.

Note that since fogging tends to deteriorate in a high-temperature and high-humidity environment with a temperature of 30° C. and a relative humidity of 80%, evaluation was performed in an environment with a temperature of 30° C. and a relative humidity of 80%.

### [3-2. Evaluation of Image Density Stability]

The prepared process cartridge was mounted in the main body of the image forming apparatus, and was left to stand for 24 hours in an environment of a temperature of 23° C. and a relative humidity of 50%. Thereafter, the potential difference between the developing blade and the electrophotographic roller was set to −300 V using an external high-voltage power supply, and one sheet of a 25% halftone image with respect to solid black, 48 sheets of solid white images, and one sheet of a 25% halftone image with respect to solid black were continuously output in this order on A4 evaluation sheet (GF-C081, manufactured by Canon Inc.). The densities of the obtained halftone images of the first sheet and the 50th sheet were measured using a spectrodensitometer (trade name: 508, manufactured by X-Rite, Inc.), and the density difference between the first sheet and the 50th sheet was obtained. Note that a smaller density difference is preferable. The evaluation results are shown in Tables 58-5 to 58-8.

### Examples 2 to 45

In Examples 2 to 45, electrophotographic rollers G-2 to G-44 and G-70 were each produced in the same manner as in Example 1, except that the coating liquid for forming a resin layer was changed to the coating liquids for forming a resin layer (F-2 to F-44 and F-70) shown in Tables 58-1 to 58-4, and each measurement and evaluation were performed in the same manner as in Example 1. The evaluation results are shown in Tables 58-5 to 58-8.

Since Tables 58-1 to 58-4 are large in size, one table is divided into four. When these tables are combined into a single table, Table 58-1 corresponds to the upper left, Table 58-2 corresponds to the upper right, Table 58-3 corresponds to the lower left, and Table 58-4 corresponds to the lower right. In these tables, Me represents a methyl group, Et represents an ethyl group, and Bu represents a butyl group.

Since Tables 58-5 to 58-8 are large in size, one table is divided into four. When these tables are combined into a single table, Table 58-5 corresponds to the upper left, Table 58-6 corresponds to the upper right, Table 58-7 corresponds to the lower left, and Table 58-8 corresponds to the lower right. In these tables, X represents the total amount (mass %) of the compounds having the structures represented by Structural Formulas (5) to (7) based on the solid content in the coating liquid for forming a resin layer. Here, Ex means Example. (1) to (4) means “Formula (1)” to “Formula (4)”. “ER” means “Electrophotographic roller”. “FRL” means “For forming resin layer”.

TABLE 58-1

| | | | Binder resin structure (structure (1)) | | | |
|---|---|---|---|---|---|---|
| Ex | ER | FRL | Structure (1) | | | |
| 1 | G-1 | F-1 | (1) | R11 = (CH₂)₅ | R12 = (CH₂)₆ | m, n = 6.9 |
| 2 | G-2 | F-2 | (1) | R11 = (CH₂)₃ | R12 = (CH₂)₄ | m, n = 8.8 |
| 3 | G-3 | F-3 | (1) | R11 = (CH₂)₆ | R12 = (CH₂)₂—CHMe—(CH₂)₂ | m, n = 6.5 |
| 4 | G-4 | F-4 | (1) | R11 = (CH₂)₆ | R12 = (CH₂)₂—CHMe—(CH₂)₂ | m = 2.0, n = 18.0 |
| 5 | G-5 | F-5 | (4) | R41 = (CH₂)₆ | | s = 13.2 |
| 6 | G-6 | F-6 | (1) | R11 = (CH₂)₅ | R12 = (CH₂)₆ | m, n = 6.9 |
| 7 | G-7 | F-7 | (1) | R11 = (CH₂)₆ | R12 = (CH₂)₂—CHMe—(CH₂)₂ | m = 2.0, n = 18.0 |
| 8 | G-8 | F-8 | (1) | R11 = (CH₂)₉ | R12 = CH₂—CHMe—(CH₂)₆ | m = 3.5, n = 6.5 |
| 9 | G-9 | F-9 | (1) | R11 = (CH₂)₅ | R12 = (CH₂)₆ | m, n = 6.9 |
| 10 | G-10 | F-10 | (1) | R11 = (CH₂)₄ | R12 = (CH₂)₆ | m = 10.7, n = 4.6 |
| 11 | G-11 | F-11 | (1) | R11 = (CH₂)₃ | R12 = (CH₂)₄ | m, n = 8.8 |
| 12 | G-12 | F-12 | (1) | R11 = (CH₂)₄ | R12 = (CH₂)₆ | m = 14.5, n = 1.6 |
| 13 | G-13 | F-13 | (1) | R11 = (CH₂)₆ | R12 = (CH₂)₂—CHMe—(CH₂)₂ | m, n = 6.5 |
| 14 | G-14 | F-14 | (1) | R11 = (CH₂)₆ | R12 = (CH₂)₂—CHMe—(CH₂)₂ | m = 1.3, n = 11.8 |
| 15 | G-15 | F-15 | (1) | R11 = (CH₂)₆ | R12 = (CH₂)₂—CHMe—(CH₂)₂ | m = 2.0, n = 18.0 |
| 16 | G-16 | F-16 | (1) | R11 = (CH₂)₉ | R12 = CH₂—CHMe—(CH₂)₆ | m = 6.5, n = 3.5 |
| 17 | G-17 | F-17 | (1) | R11 = (CH₂)₉ | R12 = CH₂—CHMe—(CH₂)₆ | m = 3.5, n = 6.5 |
| 18 | G-18 | F-18 | (2) | o = 9.1, p = 5.5 | | |
| 19 | G-19 | F-19 | (2) | o = 9.1, p = 5.5 | | |
| 20 | G-20 | F-20 | (3) | R31 = (CH₂)₃ | R32 = (CH₂)₄ | q = 12, r = 5.1 |
| 21 | G-21 | F-21 | (3) | R31 = (CH₂)₆ | R32 = (CH₂)₈ | q = 2.7, r = 6.3 |

| | | | | | |
|---|---|---|---|---|---|
| 22 | G-22 | F-22 | (4) | R41 = (CH₂)₆ | s = 13.2 |

| | | | | |
|---|---|---|---|---|
| 23 | G-23 | F-23 | (2) | o = 9.1, p = 5.5 |
| 24 | G-24 | F-24 | (2) | o = 9.1, p = 5.5 |

Here, Ex means Example. (1) to (5) means “Formula (1)” to “Formula (5)”.

TABLE 58-2

| | Binder resin structure (structure (2)) | | | | | | |
|---|---|---|---|---|---|---|---|
| Ex | Structure (2) | | | | Additive structure | | |
| 1 | (4) | R41 = (CH₂)₆ | | s = 13.2 | (5) | R51 = C₄H₉ | t, u = 17 |
| 2 | (4) | R41 = (CH₂)₆ | | s = 13.2 | (5) | R51 = C₄H₉ | t, u = 17 |
| 3 | (4) | R41 = (CH₂)₆ | | s = 13.2 | (5) | R51 = C₄H₉ | t, u = 17 |
| 4 | (4) | R41 = (CH₂)₆ | | s = 13.2 | (5) | R51 = C₄H₉ | t, u = 17 |
| 5 | (1) | R11 = (CH₂)₆ | ${H}_{2} - CH < \begin{matrix}{( {CH}_{2} )}_{2} \\ {( {CH}_{2} )}_{2}\end{matrix} > CH - C {H}_{2}$ | m = 4.1, n = 1.4 | (5) | R51 = C₄H₉ | t, u = 17 |
| 6 | (4) | R41 = (CH₂)₆ | | s = 20.1 | (5) | R51 = C₄H₉ | t, u = 17 |
| 7 | (4) | ${H}_{2} - CH < \begin{matrix}{( {CH}_{2} )}_{2} \\ {( {CH}_{2} )}_{2}\end{matrix} > CH - C {H}_{2}$ | | s = 5.8 | (5) | R51 = C₄H₉ | t, u = 17 |
| 8 | (4) | R41 = CH₂—CEtBu—CH₂ | | s = 4.6 | (5) | R51 = C₄H₉ | t, u = 17 |
| 9 | (2) | o = 9.1, p = 5.5 | | | (5) | R51 = C₄H₉ | t, u = 17 |
| 10 | (2) | o = 9.1, p = 5.5 | | | (5) | R51 = C₄H₉ | t, u = 17 |
| 11 | (2) | o = 9.1, p = 5.5 | | | (5) | R51 = C₄H₉ | t, u = 17 |
| 12 | (2) | o = 9.1, p = 5.5 | | | (5) | R51 = C₄H₉ | t, u = 17 |
| 13 | (2) | o = 9.1, p = 5.5 | | | (5) | R51 = C₄H₉ | t, u = 17 |
| 14 | (2) | o = 9.1, p = 5.5 | | | (5) | R51 = C₄H₉ | t, u = 17 |
| 15 | (2) | o = 9.1, p = 5.5 | | | (5) | R51 = C₄H₉ | t, u = 17 |
| 16 | (2) | o = 9.1, p = 5.5 | | | (5) | R51 = C₄H₉ | t, u = 17 |
| 17 | (2) | o = 9.1, p = 5.5 | | | (5) | R51 = C₄H₉ | t, u = 17 |
| 18 | (1) | R11 = (CH₂)₆ | ${H}_{2} - CH < \begin{matrix}{( {CH}_{2} )}_{2} \\ {( {CH}_{2} )}_{2}\end{matrix} > CH - C {H}_{2}$ | m, n = 2.7 | (5) | R51 = C₄H₉ | t, u = 17 |
| 19 | (1) | R11 = (CH₂)₆ | ${H}_{2} - CH < \begin{matrix}{( {CH}_{2} )}_{2} \\ {( {CH}_{2} )}_{2}\end{matrix} > CH - C {H}_{2}$ | m = 4.1, n = 1.4 | (5) | R51 = C₄H₉ | t, u = 17 |

| 20 | (4) | R41 = (CH₂)₆ | s = 13.2 | (5) | R51 = C₄H₉ | t, u = 17 |
|---|---|---|---|---|---|---|
| 21 | (4) | R41 = (CH₂)₆ | s = 13.2 | (5) | R51 = C₄H₉ | t, u = 17 |
| 22 | (2) | o = 9.1, p = 5.5 | | (5) | R51 = C₄H₉ | t, u = 17 |
| 23 | (4) | ${H}_{2} - CH < \begin{matrix}{( {CH}_{2} )}_{2} \\ {( {CH}_{2} )}_{2}\end{matrix} > CH - C {H}_{2}$ | s = 5.8 | (5) | R51 = C₄H₉ | t, u = 17 |
| 24 | (4) | R41 = CH₂—CEtBu—CH₂ | s = 4.6 | (5) | R51 = C₄H₉ | t, u = 17 |

Here, Ex means Example. (1) to (2) means “Formula (2)” to “Formula (4)”. “ER” means “Electrophotographic roller”. “FRL” means “For forming resin layer”.

TABLE 58-3

| | | | Binder resin structure (structure (1)) | | | |
|---|---|---|---|---|---|---|
| Ex | ER | FRL | Structure (1) | | | |
| 25 | G-25 | F-25 | (1) | R11 = (CH₂)₅ | R12 = (CH₂)₆ | m, n = 6.9 |
| | | | (2) | o = 9.1, p = 5.5 | | |
| 26 | G-26 | F-26 | (1) | R11 = (CH₂)₅ | R12 = (CH₂)₆ | m, n = 6.9 |
| 27 | G-27 | F-27 | (1) | R11 = (CH₂)₅ | R12 = (CH₂)₆ | m, n = 6.9 |
| 28 | G-28 | F-28 | (1) | R11 = (CH₂)₅ | R12 = (CH₂)₆ | m, n = 6.9 |
| 29 | G-29 | F-29 | (1) | R11 = (CH₂)₅ | R12 = (CH₂)₆ | m, n = 6.9 |
| 30 | G-30 | F-30 | (1) | R11 = (CH₂)₅ | R12 = (CH₂)₆ | m, n = 6.9 |
| 31 | G-31 | F-31 | (1) | R11 = (CH₂)₅ | R12 = (CH₂)₆ | m, n = 6.9 |
| 32 | G-32 | F-32 | (1) | R11 = (CH₂)₅ | R12 = (CH₂)₆ | m, n = 6.9 |
| 33 | G-33 | F-33 | (1) | R11 = (CH₂)₅ | R12 = (CH₂)₆ | m, n = 6.9 |
| 34 | G-34 | F-34 | (1) | R11 = (CH₂)₅ | R12 = (CH₂)₆ | m, n = 6.9 |
| 35 | G-35 | F-35 | (1) | R11 = (CH₂)₅ | R12 = (CH₂)₆ | m, n = 6.9 |
| 36 | G-36 | F-36 | (1) | R11 = (CH₂)₅ | R12 = (CH₂)₆ | m, n = 6.9 |
| 37 | G-37 | F-37 | (1) | R11 = (CH₂)₅ | R12 = (CH₂)₆ | m, n = 6.9 |
| 38 | G-38 | F-38 | (1) | R11 = (CH₂)₅ | R12 = (CH₂)₆ | m, n = 6.9 |
| 39 | G-39 | F-39 | (1) | R11 = (CH₂)₅ | R12 = (CH₂)₆ | m, n = 6.9 |
| 40 | G-40 | F-40 | (1) | R11 = (CH₂)₅ | R12 = (CH₂)₆ | m, n = 6.9 |
| 41 | G-41 | F-41 | (1) | R11 = (CH₂)₅ | R12 = (CH₂)₆ | m, n = 6.9 |
| 42 | G-42 | F-42 | (1) | R11 = (CH₂)₅ | R12 = (CH₂)₆ | m, n = 6.9 |
| 43 | G-43 | F-43 | (1) | R11 = (CH₂)₅ | R12 = (CH₂)₆ | m, n = 6.9 |
| 44 | G-44 | F-44 | (1) | R11 = (CH₂)₅ | R12 = (CH₂)₆ | m, n = 6.9 |
| 45 | G-45 | F-45 | (1) | R11 = (CH₂)₅ | R12 = (CH₂)₆ | m, n = 6.9 |

Here, Ex means Example. (4) to (7) means “Formula (4)” to “Formula (7)”.

TABLE 58-4

| | Binder resin structure (structure (2)) | | | | | |
|---|---|---|---|---|---|---|
| Ex | Structure (2) | | | Additive structure | | |
| 25 | (4) | R41 = (CH₂)₆ | s = 13.2 | (5) | R51 = C₄H₉ | t, u = 17 |
| 26 | (2) | o = 9.1, p = 5.5 | | (5) | R51 = C₄H₉ | t, u = 17 |
| 27 | (4) | R41 = (CH₂)₆ | s = 13.2 | (5) | R51 = C₄H₉ | t, u = 17 |
| 28 | (4) | R41 = (CH₂)₆ | s = 13.2 | (5) | R51 = C₄H₉ | t, u = 17 |
| 29 | (4) | R41 = (CH₂)₆ | s = 13.2 | (5) | R51 = C₄H₉ | t, u = 30 |
| 30 | (4) | R41 = (CH₂)₆ | s = 13.2 | (5) | R51 = C₄H₉ | t = 9, u = 10 |
| 31 | (4) | R41 = (CH₂)₆ | s = 13.2 | (5) | R51 = C₁₂H₂₅ | t, u = 5 |
| 32 | (4) | R41 = (CH₂)₆ | s = 13.2 | (5) | R51 = C₁₂H₂₅ | t, u = 25 |
| 33 | (4) | R41 = (CH₂)₆ | s = 13.2 | (5) | R51 = C₈H₁₇ | t, u = 15 |
| 34 | (4) | R41 = (CH₂)₆ | s = 13.2 | (5) | R51 = CH₃ | t, u = 12 |
| 35 | (4) | R41 = (CH₂)₆ | s = 13.2 | (6) | R61 = CH₃ | v = 6, w = 29 |
| 36 | (4) | R41 = (CH₂)₆ | s = 13.2 | (6) | R61 = CH₃ | v = 6, w = 29 |
| 37 | (4) | R41 = (CH₂)₆ | s = 13.2 | (6) | R61 = CH₃ | v = 6, w = 29 |
| 38 | (4) | R41 = (CH₂)₆ | s = 13.2 | (6) | R61 = CH₃ | v = 1, w = 9 |
| 39 | (4) | R41 = (CH₂)₆ | s = 13.2 | (6) | R61 = C₈H₁₇ | v, w = 15 |
| 40 | (4) | R41 = (CH₂)₆ | s = 13.2 | (7) | R71 = C₁₂H₂₅ | x = 5 |
| 41 | (4) | R41 = (CH₂)₆ | s = 13.2 | (7) | R71 = C₁₂H₂₅ | x = 5 |
| 42 | (4) | R41 = (CH₂)₆ | s = 13.2 | (7) | R71 = C₁₂H₂₅ | x = 5 |
| 43 | (4) | R41 = (CH₂)₆ | s = 13.2 | (7) | R71 = CH₃ | x = 11 |
| 44 | (4) | R41 = (CH₂)₆ | s = 13.2 | (7) | R71 = C₈H₁₇ | x = 14 |
| 45 | (4) | R41 = (CH₂)₆ | s = 13.2 | (5) | R51 = C₄H₉ | t, u = 17 |

Here, Ex means Example. “ER No.” means “Electrophotographic roller No.”. “PPD” means “Primary particle diameter [nm]”. “DBP abs” means “DBP absorption [ml/100 g]”. MVSP means “Maximum value of surface potential [V]”.

TABLE 58-5

| | | | | | | | | Mean |
|---|---|---|---|---|---|---|---|---|
| | | Carbon black physical properties | | | | Impedance | | value |
| | | PPD | DBP abs | | | [Ω] @1.0 × | MVSP | of Rz |
| Ex | ER No. | [nm] | [ml/100 g] | pH | X | 10¹ Hz | [V] | [μm] |
| 1 | G-1 | 24 | 51 | 2.5 | 3.2 | 9.12E+06 | 5.7 | 7 |
| 2 | G-2 | 24 | 51 | 2.5 | 3.2 | 8.67E+06 | 12.5 | 7 |
| 3 | G-3 | 24 | 51 | 2.5 | 3.2 | 2.32E+07 | 5.5 | 7 |
| 4 | G-4 | 24 | 51 | 2.5 | 3.3 | 1.69E+07 | 6.2 | 7 |
| 5 | G-5 | 24 | 51 | 2.5 | 3.2 | 7.41E+06 | 14.2 | 7 |
| 6 | G-6 | 24 | 51 | 2.5 | 3.2 | 6.52E+06 | 8.1 | 7 |
| 7 | G-7 | 24 | 51 | 2.5 | 3.3 | 1.52E+07 | 13.2 | 7 |
| 8 | G-8 | 24 | 51 | 2.5 | 3.2 | 7.01E+06 | 10.5 | 7 |
| 9 | G-9 | 24 | 51 | 2.5 | 3.2 | 2.79E+06 | 3.2 | 7 |
| 10 | G-10 | 24 | 51 | 2.5 | 3.2 | 2.68E+06 | 2.8 | 7 |
| 11 | G-11 | 24 | 51 | 2.5 | 3.2 | 1.52E+06 | 3.2 | 7 |
| 12 | G-12 | 24 | 51 | 2.5 | 3.2 | 2.83E+06 | 4.5 | 7 |
| 13 | G-13 | 24 | 51 | 2.5 | 3.2 | 3.82E+06 | 4.2 | 7 |
| 14 | G-14 | 24 | 51 | 2.5 | 3.2 | 3.51E+06 | 3.6 | 7 |
| 15 | G-15 | 24 | 51 | 2.5 | 3.3 | 3.39E+06 | 5.1 | 7 |
| 16 | G-16 | 24 | 51 | 2.5 | 3.2 | 4.11E+06 | 4.7 | 7 |
| 17 | G-17 | 24 | 51 | 2.5 | 3.2 | 4.22E+06 | 3.9 | 7 |
| 18 | G-18 | 24 | 51 | 2.5 | 3.2 | 1.89E+06 | 2.6 | 7 |
| 19 | G-19 | 24 | 51 | 2.5 | 3.2 | 1.57E+06 | 3.1 | 7 |
| 20 | G-20 | 24 | 51 | 2.5 | 3.2 | 2.11E+06 | 3.5 | 7 |
| 21 | G-21 | 24 | 51 | 2.5 | 3.2 | 1.98E+06 | 3.8 | 7 |
| 22 | G-22 | 24 | 51 | 2.5 | 3.2 | 2.36E+06 | 3.2 | 7 |
| 23 | G-23 | 24 | 51 | 2.5 | 3.2 | 2.25E+06 | 2.9 | 7 |
| 24 | G-24 | 24 | 51 | 2.5 | 3.2 | 3.55E+06 | 3.6 | 7 |

Here, Ex means Example. “ER No.” means “Electrophotographic roller No.”.

TABLE 58-6

| | | Carbon black dispersion state | | | | | | | |
|---|---|---|---|---|---|---|---|---|---|
| | | Equivalent circle diameter | | | | | | | |
| | | of dispersed particles | | | Wall-to-wall distance | | | | |
| | | Mean | Standard | | Mean | Standard | | | Image |
| | | value | deviation | | value | deviation | | Fogging | density |
| Ex | ER No. | Rc [nm] | σc [nm] | σc/Rc | d [nm] | σd [nm] | σd/d | evaluation | stability |
| 1 | G-1 | 55.2 | 33.1 | 0.600 | 111.6 | 64.1 | 0.574 | 1.4 | 0.05 |
| 2 | G-2 | 55.9 | 32.9 | 0.589 | 108.9 | 62.1 | 0.570 | 2.8 | 0.03 |
| 3 | G-3 | 49.2 | 27.3 | 0.555 | 98.2 | 54.8 | 0.558 | 1.5 | 0.02 |
| 4 | G-4 | 51.7 | 29.6 | 0.573 | 97.9 | 55.2 | 0.564 | 1.4 | 0.03 |
| 5 | G-5 | 52.1 | 31.1 | 0.597 | 102.3 | 57.2 | 0.559 | 2.9 | 0.03 |
| 6 | G-6 | 53.3 | 30.8 | 0.578 | 103.5 | 57.8 | 0.558 | 1.3 | 0.05 |
| 7 | G-7 | 51.3 | 31.2 | 0.608 | 101.5 | 58.2 | 0.573 | 2.5 | 0.03 |
| 8 | G-8 | 50.9 | 30.1 | 0.591 | 101.8 | 57.9 | 0.569 | 2.4 | 0.03 |
| 9 | G-9 | 54.3 | 31.8 | 0.586 | 100.7 | 56.9 | 0.565 | 1.2 | 0.07 |
| 10 | G-10 | 53 | 32.1 | 0.606 | 102.3 | 57.6 | 0.563 | 1.0 | 0.06 |
| 11 | G-11 | 59.2 | 38 | 0.642 | 103.8 | 57.2 | 0.551 | 1.0 | 0.09 |
| 12 | G-12 | 57.1 | 34.9 | 0.611 | 104.3 | 58 | 0.556 | 1.3 | 0.07 |
| 13 | G-13 | 53 | 32 | 0.604 | 105.6 | 57.9 | 0.548 | 1.2 | 0.06 |
| 14 | G-14 | 55.1 | 32.2 | 0.584 | 106.5 | 60.2 | 0.565 | 1.0 | 0.07 |
| 15 | G-15 | 54.2 | 32.2 | 0.594 | 106.1 | 59.9 | 0.565 | 1.5 | 0.09 |
| 16 | G-16 | 51.4 | 30.1 | 0.586 | 105.8 | 60.2 | 0.569 | 1.3 | 0.05 |
| 17 | G-17 | 52.2 | 32.4 | 0.621 | 103.5 | 60.2 | 0.582 | 1.1 | 0.04 |
| 18 | G-18 | 58.1 | 34.1 | 0.587 | 106.8 | 61 | 0.571 | 0.9 | 0.08 |
| 19 | G-19 | 57.1 | 35.2 | 0.616 | 107.6 | 61.2 | 0.569 | 1.0 | 0.07 |
| 20 | G-20 | 58 | 34.7 | 0.598 | 106.5 | 60.9 | 0.572 | 1.1 | 0.07 |
| 21 | G-21 | 59.1 | 34.9 | 0.591 | 104.9 | 61.1 | 0.582 | 1.0 | 0.08 |
| 22 | G-22 | 58.2 | 35.3 | 0.607 | 105.8 | 60.9 | 0.576 | 1.2 | 0.09 |
| 23 | G-23 | 56.1 | 35.2 | 0.627 | 106.8 | 60.9 | 0.570 | 0.9 | 0.07 |
| 24 | G-24 | 57.3 | 35.4 | 0.618 | 103.5 | 58.8 | 0.568 | 1.3 | 0.07 |

Here, Ex means Example. “ER No.” means “Electrophotographic roller No.”. “PPD” means “Primary particle diameter [nm]”. “DBP abs” means “DBP absorption [m;/100 g]”. MVSP means “Maximum value of surface potential [V]”.

TABLE 58-7

| | | | | | | | | Mean |
|---|---|---|---|---|---|---|---|---|
| | | Carbon black physical properties | | | | Impedance | | value |
| | | PPD | DBP abs | | | [Ω] @1.0 × | MVSP | of Rz |
| Ex | ER No. | [nm] | [ml/100 g] | pH | X | 10¹ Hz | [V] | [μm] |
| 25 | G-25 | 24 | 51 | 2.5 | 3.2 | 5.01E+06 | 4.5 | 7 |
| 26 | G-26 | 24 | 51 | 2.5 | 3.2 | 3.11E+06 | 3.5 | 7 |
| 27 | G-27 | 24 | 51 | 2.5 | 3.0 | 8.58E+06 | 4.5 | 7 |
| 28 | G-28 | 24 | 51 | 2.5 | 7.0 | 6.55E+06 | 7.2 | 7 |
| 29 | G-29 | 24 | 51 | 2.5 | 3.2 | 7.92E+06 | 6.8 | 7 |
| 30 | G-30 | 24 | 51 | 2.5 | 3.2 | 7.71E+06 | 6.4 | 7 |
| 31 | G-31 | 24 | 51 | 2.5 | 3.2 | 6.31E+06 | 5.9 | 7 |
| 32 | G-32 | 24 | 51 | 2.5 | 3.2 | 5.47E+06 | 5.7 | 7 |
| 33 | G-33 | 24 | 51 | 2.5 | 3.2 | 7.21E+06 | 6.9 | 7 |
| 34 | G-34 | 24 | 51 | 2.5 | 3.2 | 6.74E+06 | 6.3 | 7 |
| 35 | G-35 | 24 | 51 | 2.5 | 3.2 | 6.32E+06 | 5.1 | 7 |
| 36 | G-36 | 24 | 51 | 2.5 | 3.0 | 5.89E+06 | 5.2 | 7 |
| 37 | G-37 | 24 | 51 | 2.5 | 7.0 | 5.84E+06 | 4.9 | 7 |
| 38 | G-38 | 24 | 51 | 2.5 | 3.2 | 5.10E+06 | 3.9 | 7 |
| 39 | G-39 | 24 | 51 | 2.5 | 3.2 | 2.80E+06 | 4.8 | 7 |
| 40 | G-40 | 24 | 51 | 2.5 | 3.2 | 2.25E+06 | 4.5 | 7 |
| 41 | G-41 | 24 | 51 | 2.5 | 3.0 | 2.11E+06 | 3.8 | 7 |
| 42 | G-42 | 24 | 51 | 2.5 | 7.0 | 2.37E+06 | 4.2 | 7 |
| 43 | G-43 | 24 | 51 | 2.5 | 3.2 | 2.15E+06 | 3.8 | 7 |
| 44 | G-44 | 24 | 51 | 2.5 | 3.2 | 2.27E+06 | 3.8 | 7 |
| 45 | G-70 | 24 | 51 | 2.5 | 3.2 | 8.76E+06 | 5.4 | 5 |

TABLE 58-8

| | | Carbon black dispersion state | | | | | | | |
|---|---|---|---|---|---|---|---|---|---|
| | | Equivalent circle diameter | | | | | | | |
| | | of dispersed particles | | | Wall-to-wall distance | | | | |
| | | Mean | Standard | | Mean | Standard | | | Image |
| | | value | deviation | | value | deviation | | Fogging | density |
| Ex | ER No. | Rc [nm] | σc [nm] | σc/Rc | d [nm] | σd [nm] | σd/d | evaluation | stability |
| 25 | G-25 | 54.3 | 34.1 | 0.628 | 102.7 | 58.1 | 0.566 | 1.6 | 0.04 |
| 26 | G-26 | 53.1 | 33.3 | 0.627 | 100.2 | 57.6 | 0.575 | 1.0 | 0.08 |
| 27 | G-27 | 57.4 | 34.5 | 0.601 | 99.8 | 56.6 | 0.567 | 1.1 | 0.04 |
| 28 | G-28 | 56.1 | 34.2 | 0.610 | 101.2 | 57 | 0.563 | 2.1 | 0.03 |
| 29 | G-29 | 57.2 | 34 | 0.594 | 103.5 | 58.1 | 0.561 | 1.6 | 0.04 |
| 30 | G-30 | 57 | 34.9 | 0.612 | 98.7 | 56.7 | 0.574 | 1.5 | 0.04 |
| 31 | G-31 | 56.2 | 34.5 | 0.614 | 101.7 | 57.1 | 0.561 | 1.6 | 0.03 |
| 32 | G-32 | 55.2 | 34.2 | 0.620 | 102.4 | 58 | 0.566 | 1.3 | 0.04 |
| 33 | G-33 | 56.7 | 33.8 | 0.596 | 100.8 | 57.4 | 0.569 | 1.7 | 0.05 |
| 34 | G-34 | 57.2 | 35.1 | 0.614 | 100.7 | 56.9 | 0.565 | 1.3 | 0.05 |
| 35 | G-35 | 55 | 32 | 0.582 | 102.3 | 57.4 | 0.561 | 1.3 | 0.04 |
| 36 | G-36 | 55.1 | 33.1 | 0.601 | 103.8 | 56.9 | 0.548 | 1.1 | 0.05 |
| 37 | G-37 | 56.1 | 33.8 | 0.602 | 104.6 | 57.3 | 0.548 | 1.0 | 0.07 |
| 38 | G-38 | 55.7 | 33.5 | 0.601 | 105.7 | 61 | 0.577 | 1.1 | 0.05 |
| 39 | G-39 | 58.2 | 35.2 | 0.605 | 114.6 | 67.4 | 0.588 | 1.4 | 0.08 |
| 40 | G-40 | 59 | 37.9 | 0.642 | 130.3 | 77.6 | 0.596 | 1.5 | 0.09 |
| 41 | G-41 | 58.2 | 37.1 | 0.637 | 135.6 | 78.9 | 0.582 | 1.1 | 0.08 |
| 42 | G-42 | 58.3 | 37.2 | 0.638 | 137.8 | 78.2 | 0.567 | 1.3 | 0.06 |
| 43 | G-43 | 58.9 | 37 | 0.628 | 143.5 | 83.2 | 0.580 | 1.0 | 0.09 |
| 44 | G-44 | 57.9 | 37.2 | 0.642 | 127.5 | 74.1 | 0.581 | 1.2 | 0.08 |
| 45 | G-70 | 54.1 | 33 | 0.610 | 110.8 | 63.7 | 0.575 | 2.9 | 0.09 |

The impedance value indicates the minimum value of the impedance value at a frequency of 1.0×10⁰ Hz to 1.0×10¹ Hz. Note that description such as “9.12E+06” indicates “9.12×10⁶”.

### Comparative Example 1

The types and amounts of materials shown in Table 59 were added to a reaction vessel and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-45 for forming a resin layer. Except that the coating liquid F-1 for forming a resin layer was changed to the coating liquid F-45 for forming a resin layer, in the same manner as in Example 1, an electrophotographic roller G-45 was produced and then evaluated. The evaluation results are shown in Table 63.

TABLE 59

| Material | Parts by mass |
|---|---|
| Polytetramethylene glycol ether polyol (trade | 25 |
| name: PTG1000SN, Hodogaya Chemical Co., Ltd.) | |
| Polycarbonate polyol (trade name: T5651, | 75 |
| Asahi Kasei Chemicals Corporation) | |
| Isocyanate | 55.5 |
| (trade name: CORONATE HX, Tosoh Corporation) | |
| Carbon black (trade name: | 30 |
| MA8, Mitsubishi Chemical Corporation) | |
| Coarse particles (trade name: ART | 20 |
| PEARL C-400T, Negami Chemical Industrial Co., Ltd.) | |

### Comparative Examples 2 and 3

Except that the carbon black used in the coating liquid F-1 for forming a resin layer was changed to the materials shown in Table 60, in the same manner as in Example 1, coating liquids F-46 and F-47 for forming a resin layer and electrophotographic rollers G-46 and G-47 were produced, and evaluation was performed. The evaluation results are shown in Table 63. Here, Ex means Example. CE means “Comparative Example”. “ER No.” means “Electrophotographic roller No.”. “CL No.” means “Coating liquid for forming resin layer No.”. PPD means “Primary particle diameter [nm]”. “DBP abs” means “DBP absorption [ml/100 g]”. MA8, MA230, and MA14 are manufactured by Mitsubishi Chemical Corporation.

TABLE 60

| | | | Carbon black material | | | |
|---|---|---|---|---|---|---|
| | | | Material | PPD | DBP abs | pH |
| | ER No. | CL No. | name | [nm] | [ml/100 g] | pH |
| Ex 1 | G-1 | F-1 | MA8 | 24 | 51 | 2.5 |
| CE 2 | G-46 | F-46 | MA230 | 30 | 113 | 3 |
| CE 3 | G-47 | F-47 | MA14 | 40 | 73 | 3 |

### Comparative Examples 4 to 6

Except that the additive used in the coating liquid F-1 for forming a resin layer was changed to the materials and parts by mass shown in Table 61, in the same manner as in Example 1, coating liquids F-48 to F-50 for forming a resin layer and electrophotographic rollers G-48 to G-50 were produced, and evaluation was performed. The evaluation results are shown in Table 63. Here, Ex means Example. CE means “Comparative Example”. ER means “Electrophotographic roller”. FRL means “For forming resin layer”. PBM means “Pants by mass”.

TABLE 61

| | | | Additive | |
|---|---|---|---|---|
| | ER | FRL | Material | PBM |
| Ex 1 | G-1 | F-1 | E-1 | 7 |
| CE 4 | G-48 | F-48 | E-1 | 5.25 |
| CE 5 | G-49 | F-49 | Silane coupling agent (trade name: | 14 |
| | | | A-187, Momentive Inc.) | |
| CE 6 | G-50 | F-50 | Polymer-based dispersant (trade name: | 24.5 |
| | | | Disper byk-185, BYK-Chemie GmbH) | |

### Comparative Example 7

Except that the additive used in the coating liquid F-1 for forming a resin layer was changed to the materials shown in Table 62, in the same manner as in Example 1, a coating liquid F-51 for forming a resin layer and an electrophotographic roller G-51 were produced, and evaluation was performed. The evaluation results are shown in Table 63.

### Comparative Example 8

### <Synthesis of Additive E-15>

An additive E-15, which is a polyether amine, was obtained by synthesizing polyoxyethylene polyoxypropylene decyl ether, oxidizing a secondary alcohol to form a ketone, and then performing reductive amination.

### (Synthesis of Polyoxyethylene Polyoxypropylene Decyl Ether)

205.8 g of 1-decanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

The obtained ethylene oxide adduct was cooled to 130° C., and then 1,132.6 g of propylene oxide (15 mol relative to alcohol) was charged. After completion of the charging, the reaction was carried out at 130° C. for 5 hours to obtain a polyoxyethylene polyoxypropylene decyl ether adduct, which is a block polymer having an average number of added moles of 15 mol of ethylene oxide and 15 mol of propylene oxide.

The obtained polyoxyethylene polyoxypropylene octyldecyl adduct was cooled to 80° C., and unreacted ethylene oxide and propylene oxide were removed at 2.5 kPa for 30 minutes. Next, 6.0 g of 90% lactic acid was charged into the autoclave, stirred at 80° C. for 30 minutes, and then extracted to obtain polyoxyethylene polyoxypropylene decyl ether.

### (Synthesis of Polyether Amine E-15)

A stirrer was attached to a three-neck flask, and 1,688 g of polyoxyethylene polyoxypropylene decyl ether and 460 ml of acetic acid were charged. 600 ml of a 2 mol/l aqueous sodium hypochlorite solution was added dropwise thereto over 1 hour. The reaction vessel was cooled in an ice bath so that the temperature was in the range of 15 to 25° C. After completion of the dropwise addition, stirring was continued for 1 hour. Dichloromethane was added to the obtained solution, and the aqueous layer was extracted and post-treated and purified by a column to obtain a compound in which a secondary alcohol was converted into a ketone.

The mixture was cooled to 0° C. in an ice bath, 250 ml of a methanol-acetic acid mixed solution (volume ratio of 10:1) was added to 41.4 g of a compound in which the obtained secondary alcohol was converted into a ketone, and 2.7 g of 2-picoline-borane was added. The ice bath was removed, and the mixture was stirred overnight at room temperature in an open system. After concentration, the mixture was cooled to 0° C., 360 ml of a 35% aqueous hydrochloric acid solution was added, and the mixture was stirred at room temperature for 2 hours. An aqueous sodium hydroxide solution was added to make the mixture basic, and the aqueous layer was extracted with dichloromethane and post-treated and purified by a column to obtain a polyether amine E-15. The structure of R61 in E-15 and the values of v and w are shown in Table 62.

### <Production of Coating Liquid F-52 for Forming Resin Layer and Electrophotographic Roller G-52>

Except that the additive used in the coating liquid F-1 for forming a resin layer was changed to the additive E-15, a coating liquid F-52 for forming a resin layer and an electrophotographic roller G-52 were produced in the same manner as in Example 1 and then evaluated. The evaluation results are shown in Table 63.

### Comparative Example 9

### <Synthesis of Additive E-16>

315.2 g of 1-hexadecanol (manufactured by Tokyo Chemical Industry Co., Ltd.) and 3.0 g of potassium hydroxide were charged into an autoclave equipped with a stirrer, a temperature controller, and an automatic feed device, and dehydrated at 110° C. and 1.2 kPa for 30 minutes. After completion of the dehydration, nitrogen purging was performed, the temperature was raised to 150° C., and then 858.0 g (15 mol relative to alcohol) of ethylene oxide was charged. The reaction was carried out at 150° C. for 1 hour to obtain an ethylene oxide adduct having an average number of added moles of 15 mol.

90.2 g of the obtained ethylene oxide adduct and 510 ml of a 1 mol/l aqueous sodium hydroxide solution were mixed, 71.1 g of potassium permanganate was added, and the mixture was stirred at room temperature for 6 hours. Thereafter, 760 ml of 2-propanol was added, and the mixture was stirred for 1 hour to quench the excess potassium permanganate, and manganese oxide as a by-product was further filtered. The aqueous layer was extracted with dichloromethane and purified to obtain polyoxyethylene methyl ether acetate E-16. The structure of R71 in E-16 and the value of x are shown in Table 62.

### <Synthesis of Coating Liquid F-53 for Forming Resin Layer and Electrophotographic Roller G-53>

Except that the additive used in the coating liquid F-1 for forming a resin layer was changed to the additive E-16, a coating liquid F-53 for forming a resin layer and an electrophotographic roller G-53 were produced in the same manner as in Example 1 and then evaluated. The evaluation results are shown in Table 63.

### Comparative Example 10

The fogging evaluation and the image density stability evaluation were performed in the same manner as in Example 1, except that the potential difference between the developing blade and the electrophotographic roller was set to 0 V. The evaluation results are shown in Table 63. Here, (5) to (7) means “Formula (5)” to “Formula (7)”.

TABLE 62

| No. | Material | Structure | | |
|---|---|---|---|---|
| E-14 | Polyoxyethylene polyoxypropylene cetyl ether | (5) | R51 = C₁₆H₃₃ | t = 20, |
| | (trade name: UNISAFE 20P-8, | | | u = 8 |
| | manufactured by NOF corporation) | | | |
| E-15 | Polyether amine | (6) | R61 = C₁₀H₂₁ | v, w = 15 |
| E-16 | Polyoxyethylene hexadecyl ether acetate | (7) | R71 = C₁₆H₃₃ | x = 14 |

Here, CE means “Comparative Example”. “ER No.” means “Electrophotographic roller No.”. PPD means “Primary particle diameter [nm]”. “DBP abs” means “DBP absorption [ml/100 g]”. MVSP means “Maximum value of surface potential [V]”. “MV Rs” means “Mean value of Rz [μm]”.

TABLE 63-1

| | | Carbon black physical | | | | | |
|---|---|---|---|---|---|---|---|
| | | properties | | | | | |
| | | PPD | DBP abs | | Impedance [Ω] | MVSP | MV Rs |
| CE | ER No. | [nm] | [ml/100 g] | pH | @1.0 × 10¹ Hz | [V] | [μm] |
| 1 | G-45 | 24 | 51 | 25 | 3.96E+05 | 3.7 | 7 |
| 2 | G-46 | 30 | 113 | 3 | 2.25E+04 | 2.4 | 7 |
| 3 | G-47 | 40 | 73 | 3 | 1.59E+05 | 8.7 | 7 |
| 4 | G-48 | 24 | 51 | 25 | 4.56E+05 | 3.5 | 7 |
| 5 | G-49 | 24 | 51 | 25 | 2.00E+08 | 462.0 | 7 |
| 6 | G-50 | 24 | 51 | 25 | 4.18E+05 | 4.6 | 7 |
| 7 | G-51 | 24 | 51 | 25 | 1.56E+05 | 7.6 | 7 |
| 8 | G-52 | 24 | 51 | 25 | 1.18E+05 | 6.8 | 7 |
| 9 | G-53 | 24 | 51 | 25 | 8.92E+04 | 2.5 | 7 |
| 10 | G-1 | 24 | 51 | 25 | 9.12E+06 | 5.7 | 7 |

Here, CE means “Comparative Example”.

TABLE 63-2

| | Carbon black dispersion state | | | | | | | |
|---|---|---|---|---|---|---|---|---|
| | Equivalent circle diameter | | | | | | | |
| | of dispersed particles | | | Wall-to-wall distance | | | | |
| | Mean | Standard | | Mean | Standard | | | Image |
| | value | deviation | | value | deviation | | Fogging | density |
| CE | Rc | σc | σc/Rc | d | σd | σd/d | evaluation | stability |
| 1 | 92.9 | 60.7 | 0.653 | 146.8 | 95.6 | 0.651 | 3.5 | 0.18 |
| 2 | 88 | 56 | 0.636 | 130.1 | 79.5 | 0.611 | 4.1 | 0.23 |
| 3 | 104 | 79.7 | 0.766 | 205.8 | 130.7 | 0.635 | 6.2 | 0.19 |
| 4 | 86.8 | 57 | 0.657 | 129.8 | 80.1 | 0.617 | 3.8 | 0.2 |
| 5 | 57 | 34 | 0.596 | 112.7 | 63.8 | 0.566 | 14.2 | 0.32 |
| 6 | 87.8 | 55.5 | 0.632 | 130.7 | 79.5 | 0.608 | 4.7 | 0.21 |
| 7 | 89.1 | 57.6 | 0.646 | 148.2 | 98.7 | 0.666 | 5.1 | 0.23 |
| 8 | 92 | 61 | 0.663 | 145.7 | 97.6 | 0.670 | 4.8 | 0.21 |
| 9 | 96.1 | 65 | 0.676 | 152.3 | 100.2 | 0.658 | 8.1 | 0.22 |
| 10 | 55.2 | 33.1 | 0.600 | 111.6 | 64.1 | 0.574 | 15.6 | 0.31 |

In these tables, X represents the total amount (mass %) of the compounds having the structures represented by Structural Formulas (5) to (7) based on the solid content in the coating liquid for forming a resin layer.

The impedance value indicates the minimum value of the impedance value at a frequency of 1.0×10⁰ Hz to 1.0×10¹ Hz.

Examples 1 to 45 show favorable results in the fogging evaluation and the image density stability evaluation. It is presumed that these results were obtained by solving the conflicting problems such as prevention of charge leakage from the toner to the electrophotographic roller and removal of excess charge from excessively charged toner. In addition, it is presumed that, because the width in the longitudinal direction of the toner carried on the electrophotographic roller is longer than the width of the recording material in a direction perpendicular to the conveyance direction of the recording material, the filler transferred from the recording material to the photosensitive drum can be reliably collected into the developing container and can be charged again when carried on the electrophotographic roller, thereby enabling a larger amount of filler to be discharged from the developing device.

It is preferable to use a polyurethane having only a polycarbonate structure and having a combination of Structural Formula (1) and Structural Formula (4). Since an ester structure is present in Structural Formula (2) and Structural Formula (3), and the ester structure is more electrically conductive than the polycarbonate structure, it is considered that the combination of Structural Formula (1) and Structural Formula (4) having only the polycarbonate structure shows favorable results.

In addition, when each of R12 in Structural Formula (1) and R41 in Structural Formula (4) has a side chain hydrocarbon group, a favorable tendency is exhibited. Although the details are not yet clear, it is considered that the side chain hydrocarbon group in the polyurethane structure interacts with the carbon black main body (the surface functional group of the acidic carbon black is treated to be hydrophilic, but the carbon black itself exhibits hydrophobic properties) exhibiting hydrophobic properties. As a result, it is presumed that the dispersibility of carbon black is enhanced, and favorable results are exhibited.

Similarly, in the structure of the additive, favorable results are obtained when the additive contains not only ethylene oxide but also propylene oxide. In addition, the terminal functional group of the additive is most preferably a hydroxyl group, followed by an amine group, and then a carboxylic acid group in order of preference. It is presumed that, when the terminal functional group is a hydroxyl group, favorable results are exhibited because the hydroxyl group is compatible with polyurethane due to possibility of a urethanization reaction, and even when the hydroxyl group is incorporated into the urethanization reaction, it does not inhibit the electrical characteristics of the polyurethane. When the terminal functional group is an amine group, it is moderately compatible with polyurethane because a urethanization reaction is possible; however, when the terminal functional group is incorporated during the urethanization reaction, the electrical characteristics of the polyurethane are affected, and therefore, it is presumed that the case where the terminal functional group is a hydroxyl group exhibited slightly better results. When the maximum height roughness Rz of the outermost surface of the electrophotographic roller is 7.0 μm or more, better results are obtained in the fogging evaluation and the image density stability evaluation.

On the other hand, in Comparative Examples 1 to 10, poor results were obtained in the fogging evaluation and the image density stability evaluation.

In Comparative Example 1, a polyether diol and a polycarbonate diol are used, and both an ether structure and a polycarbonate structure are incorporated in a polyurethane structure. As a result, it is considered that electrical characteristics due to the polycarbonate structure are inhibited by the ether structure, and a desired impedance value cannot be obtained. Therefore, it is considered that favorable results were not obtained.

In Comparative Examples 2 and 3, desired impedance values were also not obtained, and favorable results were not obtained. It is considered that the reason why the impedance value was decreased is that carbon black having a greater number average diameter of primary particles and a greater DBP absorption was used, the structure of the carbon black after milling dispersion was increased, the dispersion particle diameter was increased, and the wall-to-wall distance was also increased.

In Comparative Example 4, a desired impedance value was also not obtained, and favorable results were not obtained. It is considered that the impedance value decreased because the amount of additive was small, the dispersibility of the conductive filler became insufficient, and a conductive path formed by the conductive filler was formed in the surface layer.

In Comparative Example 5, the surface potential was too high, and therefore, favorable results were not obtained in the fogging evaluation and the image density stability evaluation. It is considered that this result occurred because the carbon black was coated with an insulating silane coupling agent, which caused an increase in surface potential.

In Comparative Example 6, the impedance decreased, and the results of the fogging evaluation and the image density stability evaluation became poor. It is considered that the reason for the decrease in impedance is that although a polymer dispersant suitable for dispersing carbon black was used, the dispersibility of the carbon black in the resin was not improved, and furthermore, since a large amount of dispersant was added, the electrical characteristics of the resin were affected.

In Comparative Examples 7 to 9, the impedance decreased, and the results of the fogging evaluation and the image density stability evaluation became poor. It is considered that the reason for the decrease in impedance is that the carbon chains R51, R61, and R71 of Structural Formulas (5), (6), and (7), which were used in Comparative Examples 7 to 9, exceeded the desired ranges, resulting in reduced dispersibility of the carbon black and a decrease in impedance.

Hereinafter, preferred examples of the present disclosure will be exemplarily described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

In the present disclosure, the description “XX or more and YY or less” or “XX to YY” representing a numerical range means a numerical range including a lower limit and an upper limit which are endpoints, unless otherwise specified. When the numerical ranges are listed in stages, the upper limit and the lower limit of each numerical range can be combined as appropriate. In addition, in the present disclosure, the description such as “at least one selected from the group consisting of XX, YY and ZZ” means any of XX, YY, ZZ, a combination of XX and YY, a combination of XX and ZZ, a combination of YY and ZZ, or a combination of XX and YY and ZZ.

The present inventors consider details of solving the problem by the methods described above as follows.

First, the present inventors have studied physical properties of a toner suitable for a charging process in order to solve the above-described problems. As a result, it was found that by coating the surface of the toner particles (developer particles) with surface particles or an organosilicon polymer having an electrical conductivity of 1×10⁻¹⁵ S/m or more different from that of a toner base (developer base) at a coverage of 35% or more, charge can be effectively injected into the toner from a member such as a developing blade. It is presumed that these results were obtained because the surface particles or the organosilicon polymer having an electrical conductivity of 1×10⁻¹⁵ S/m or more function as a conductive path and also functions as a charging site, and when the coverage is set to a certain level or more, the chance of contact between the toner particles and the charging site of the toner particles increases, such that charge transfer between the toner particles is effectively performed.

Furthermore, it has been found that when the surface particles or the organosilicon polymer is fixed to the toner particles so that an adhesion rate is 80% or more, charge can be injected into the toner for a long period of time, and an excellent image can be obtained. These results are presumed to be due to the fact that, as described above, the surface particles or the organosilicon polymer functions as a conductive path and a charging site, and the function can be maintained for a long period of time because the surface particles or the organosilicon polymer adheres to the toner particles.

Furthermore, in order to solve the above-described problems, the present inventors have considered a combination of a developing roller in which a surface layer is formed using a polyurethane having only a polycarbonate structure (hereinafter, referred to as polycarbonate urethane) with a developing blade to which a high voltage is applied.

As a result, although the charge leakage from the toner to the developing roller can be prevented, a new problem that the excessively charged toner adhered to the surface of the developing roller occurred due to the excessively high electrical resistance of the surface layer.

Therefore, the present inventors have studied removal of excess charge from an excessively charged toner. For example, as a result of examining inclusion of a conductive filler in the surface layer, the present inventors have found a new issue that it is difficult to sufficiently disperse the conductive filler in polycarbonate urethane. When the dispersibility of the conductive filler is insufficient, a conductive path formed by the conductive filler in the surface layer may cause charge leakage, or conversely, the expected effect of removing excess charge by the conductive filler may be insufficient.

That is, the present inventors have recognized that it is necessary to develop a novel surface layer capable of removing excess charge while maintaining a high electrical resistance of the surface layer in order to solve the contradictory problems such as prevention of charge leakage from the toner in the surface layer containing polycarbonate urethane and removal of excess charge from excessively charged toner at a high level. Based on such recognition, the present inventors have further studied.

As a result, the present inventors have recognized that, for a developing roller (developer carrying member) including a substrate having a conductive outer surface and a resin layer containing a polyurethane having a polycarbonate structure, the resin layer being provided on the outer surface of the substrate, it is effective to satisfy the following two requirements in order to solve the above two conflicting problems at a high level.

### Requirement (1)

A metal film is directly provided on an outer surface of a developing roller, and in an environment of a temperature of 23° C. and a relative humidity of 50%, a DC voltage of 50 V is applied between the outer surface of the substrate and the metal film, while an AC voltage having an amplitude of 50 V is applied with a frequency varied in a range of 1.0×10⁻¹ to 1.0×10⁵ Hz. At this time, the impedance at the frequency of 1.0×10⁰ to 1.0×10¹ Hz is 1.00×10⁶Ω or more.

### Requirement (2)

In an environment of a temperature of 23° C. and a relative humidity of 50%, a corona discharger having a grid portion having a width of 3.0 mm is disposed so that a distance between the grid portion and the outer surface of the developing roller is 1.0 mm, and a direction of the width of the grid coincides with an axial direction of the developing roller. Then, a voltage of 8 kV is applied to the grid portion, the corona discharger is relatively moved at a speed of 400 mm/sec along the axial direction of the developing roller to charge the outer surface of the developing roller, and a potential of the outer surface after 0.06 seconds from the passage of the grid is measured. The maximum value of the potential at this time is less than 20.0 V.

Hereinafter, the requirements (1) and (2) will be described in detail.

### <Technical Significance of Requirement (1)>

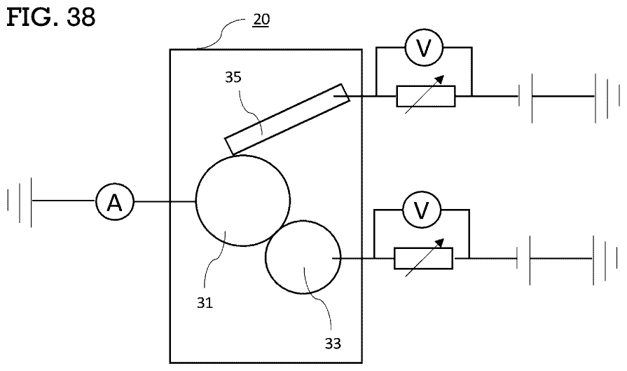

In the requirement (1), a numerical value of the impedance of the developing roller is defined. The impedance is a physical property value indicating charge leakage from the toner to the developing roller. The present inventors measured a current value (leakage current value) flowing through the developing roller when a blade bias is applied to the developing blade according to the circuit diagram illustrated in FIG. 38. As a result, it was found that the current value has a higher correlation with the impedance value of the developing roller than the electrical resistance value of the developing roller.

That is, the charge leakage indicates that it is necessary to consider the influence of not only a resistance component of the developing roller but also an electrostatic capacitance component. This is considered to be because when the electrical characteristics of the developing roller are represented in a pseudo manner by an RC parallel circuit, charge is sufficiently stored in a capacitor component, and a transient state until reaching a steady state in which the resistance component is dominant greatly affects charge leakage.

The voltage application condition for impedance measurement is obtained by superimposing an AC voltage of 50 V on a DC voltage of 50 V. That is, a sine wave having a minimum value and a maximum value of the applied voltage of 0 V and 100 V (Vpp 100 V), respectively, is applied. The value of Vpp 100 V is a value assumed to be the maximum divided voltage applied to the developing roller when a voltage is applied so that a voltage difference of 300 V is applied between the developing roller and the developing blade in an electrophotographic image forming apparatus.

The impedance shows bias dependency, and has a property that the impedance decreases as the bias increases, but it is known that the degree of decrease varies depending on the developing roller. In the conventional impedance measurement of the developing roller, the condition that the voltage application condition is the AC voltage of 1 V is generally used, but under the application condition of the AC voltage of 1 V, the voltage is clearly smaller than the voltage (generally several hundred V) applied between the developing roller and the developing blade in the actual electrophotographic image forming apparatus. Therefore, in many cases, the behavior of the developing roller in the electrophotographic image forming apparatus cannot be accurately simulated, and such conditions are often unsuitable for impedance measurement.

Therefore, in the present disclosure, a voltage application condition simulating a high blade bias applied to an actual electrophotographic image forming apparatus is adopted. In addition, a sine wave having a minimum value of the applied voltage of 0 V simulates a rectangular wave generally used for blade bias application of an actual electrophotographic image forming apparatus.

In the present disclosure, the impedance at the frequency of 1.0×10⁰ to 1.0×10¹ Hz is specified, and a low frequency range of the frequency of 1.0×10⁰ to 1.0×10¹ Hz is a region where the transient state is completed and a steady state in which the resistance component is dominant is reached. That is, the influence of both the electrostatic capacitance component and the resistance component is reflected, and the region is suitable for grasping the charge leakage property from the toner to the developing roller. When the impedance at the frequency of 1.0×10⁰ to 1.0×10¹ Hz is 1.00×10⁶Ω or more, the charge leakage is low, charge leakage from the toner to the developing roller is suppressed under a high blade bias, and a decrease in the charge amount of toner can be prevented. As a result, fogging can be suppressed, and excellent image density stability can be obtained.

The impedance at the frequency of 1.0×10⁰ to 1.0×10¹ Hz is preferably 1.40×10⁶Ω or more. The impedance value is preferably as high as possible. Although an upper limit of the impedance value is not particularly limited, the upper limit may be, for example, 5.00×10⁷Ω or less.

In addition, the minimum value of the impedance at the frequency of 1.0×10⁰ to 1.0×10¹ Hz is preferably 1.40×10⁶Ω or more, more preferably 2.00×10⁶Ω or more, particularly preferably 3.00×10⁶Ω or more, and still more preferably 5.00×10⁶Ω or more. A preferred range of the impedance is 1.00×10⁶Ω or more and 5.00×10⁷Ω or less, preferably 1.40×10⁶Ω or more and 5.00×10⁷Ω or less, more preferably 2.00×10⁶Ω or more and 5.00×10⁷Ω or less, particularly preferably 3.00×10⁶Ω or more and 5.00×10⁷Ω or less, and still more preferably 5.00×10⁶Ω or more and 5.00×10⁷Ω or less.

### <Technical Significance of Requirement (2)>

In the requirement (2), the surface potential of the developing roller is defined. The surface potential of the developing roller indicates a residual charge on the surface of the developing roller, and is a physical property value indicating a degree of excessive charging (charge-up) of the toner. When the surface potential is high, the charge of the excessively charged toner cannot be appropriately controlled, and a decrease in image density or fogging may occur.

Two factors are considered as causes of the decrease in image density. The first factor is that excessively charged toner becomes electrically adhered to the surface of the developing roller, making it impossible to charge the toner subsequently conveyed to the same location. The second factor is that, after the toner is removed from the surface of the developing roller, a residual charge remains on the surface of the developing roller, making it impossible to charge the toner subsequently conveyed to the same location.

In the present disclosure, when a voltage of 8 kV is applied to the grid portion and the corona discharger is relatively moved at a speed of 400 mm/sec along the axial direction of the developing roller, the potential of the outer surface of the developing roller is checked 0.06 seconds after the outer surface passes through the grid portion of the corona discharger. When the maximum value of the potential of the outer surface is less than 20.0 V, it is possible to suppress the occurrence of image defects due to excessive charging of the toner even in an electrophotographic image forming apparatus with a high process speed in which the time until the toner charged by the developing blade is conveyed to the photosensitive member is shorter. Note that a time of 0.06 seconds after passing through the grid portion of the corona discharger simulates a high-process-speed model.

The maximum value of the potential of the outer surface is preferably 15.0 V or less, and more preferably 10.0 V or less. The maximum value of the potential of the outer surface is preferably as low as possible. A lower limit of the maximum value is not particularly limited.

As a preferred range of the maximum value of the potential of the outer surface, for example, 0 V or more and less than 20.0 V, particularly, 0 V or more and 15.0 V or less, and further, 0 V or more and 10.0 V or less are preferable.

By satisfying the requirements (1) and (2), it is possible to solve, at a high level, the conflicting problems such as prevention of charge leakage from the toner to the developing roller and removal of excess charge from excessively charged toner.

There are no particular limitations on the methods for satisfying the requirements (1) and (2). Specifically, as will be described below, examples thereof include methods for improving the dispersibility of the conductive filler by using the following resin layer materials, conductive filler materials, and additives.

There are no particular limitations on the methods for satisfying the requirements (1) and (2). Specifically, as will be described below, examples thereof include methods for improving the dispersibility of the conductive filler by using the following resin layer materials, conductive filler materials, and additives.

Hereinafter, preferred examples of the present disclosure will be exemplarily described in detail with reference to the drawings. However, the dimensions, materials, shapes, relative arrangements, and the like of the components described in the following examples should be appropriately changed according to the configuration of the apparatus to which the present disclosure is applied and various conditions. Therefore, the scope of the present disclosure is not limited unless otherwise specified. Although a plurality of features are described in the examples, all of the plurality of features are not necessarily essential to the disclosure, and the plurality of features may be arbitrarily combined.

### Example 1

### 1. Image Forming Apparatus

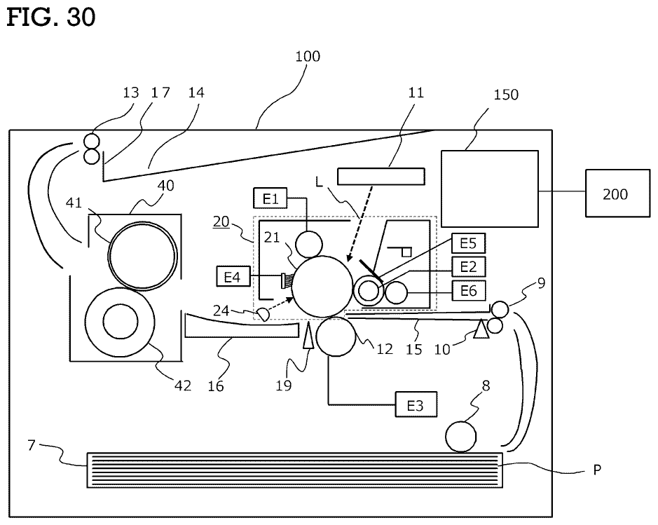

FIG. 30 is a schematic view of an image forming apparatus 100 of the present example. The image forming apparatus 100 of the present example is an electrophotographic laser printer, and can form an image on a recording material P (transfer material) according to image information input from an external device 200 such as a personal computer. Examples of the recording material P include various sheet materials of different materials, for example, paper such as plain paper, cardboard, or talc paper, a plastic film such as a sheet for an overhead projector, a sheet having a special shape such as an envelope and index paper, and cloth. First, the configuration of the image forming apparatus 100 of the present example will be described.

The image forming apparatus 100 includes a scanner unit 11, an electrophotographic process cartridge 20 detachably attachable to the image forming apparatus 100, an image forming unit including a transfer roller 12 that transfers a toner image formed on a photosensitive drum 21 in the process cartridge 20 to a recording material P, a recording material feeding unit that conveys the recording material P to a transfer unit in conjunction with the operation of the image forming unit, a fixing device 40 that fixes the toner image formed on the recording material P by the transfer unit on the recording material P, and a control unit 150 that controls the operation of the image forming apparatus.

When an image forming command is input to the image forming apparatus 100, an image forming process by the image forming unit is started on the basis of image information input from an external device 200 such as a personal computer connected to the image forming apparatus 100.

The control unit 150 is a controller that integrally controls the operation of the image forming apparatus 100. The control unit 150 executes a predetermined image forming sequence by controlling transmission and reception of various electrical information signals, drive timing, and the like. Each unit of the image forming apparatus 100 is connected to the control unit 150. For example, in relation to the present example, a charging power supply E1, a developing power supply E2, a transfer power supply E3, a brush power supply E4, a blade power supply E5, a supply roller power supply E6, a scanner unit 11 (exposure unit), a power supply of a fixing device, a drive motor, and the like are connected to the control unit 150.

### [Image Forming Unit]

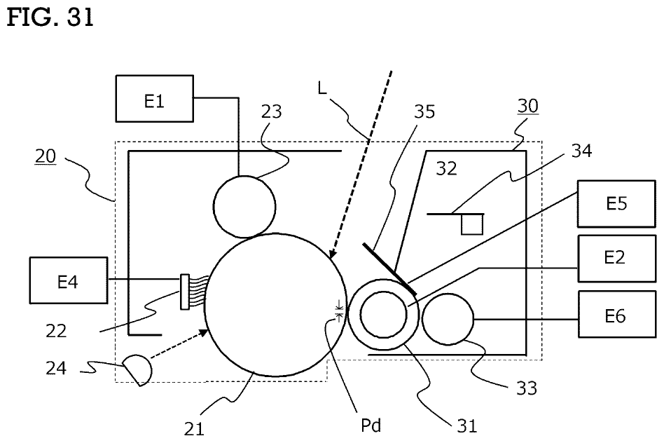

As illustrated in FIG. 31, the process cartridge 20 includes a developing device 30. The developing device 30 includes a developing roller 31 serving as a developer carrying member that carries a developer, a developing container 32 that serves as a frame of the developing device 30, a supply roller 33 that can supply a developer to the developing roller 31, a stirring member 34 that stirs toner serving as a developer in the developing container 32, and a developing blade 35 that uniformizes a toner layer on the developing roller 31. The developing roller 31, the supply roller 33, and the stirring member 34 are rotatably supported by the developing container 32. In addition, the developing roller 31 is disposed in an opening of the developing container 32 so as to face the photosensitive drum 21 serving as an image carrying member. The supply roller 33 is rotatably brought into contact with the developing roller 31, and the toner as the developer stored in the developing container 32 is applied to a surface of the developing roller 31 by the supply roller 33.

The stirring member 34 as a stirrer is provided inside the developing container 32. The stirring member 34 is driven to rotate, thereby stirring the toner in the developing container 32 and feeding the toner toward the developing roller 31 and the supply roller 33. In addition, the stirring member 34 has a role of circulating the toner not used for development but peeled off from the developing roller 31 in the developing container and evening the toner in the developing container.

In addition, the developing blade 35 formed of a stainless steel plate that regulates the amount of toner carried on the developing roller 31 is disposed in the opening of the developing container 32 in which the developing roller 31 is disposed.

The developer supplied to the surface of the developing roller 31 passes through a portion facing the developing blade 35 with the rotation of the developing roller 31, such that the developer is uniformly thinned and has a charge amount suitable for image formation. Note that, in the present example, the photosensitive drum 21 is included in the process cartridge 20, but the developing device 30 may be configured to be detachably attached to the main body of the apparatus.

The developing device 30 of the present example uses a contact development method as a developing method. That is, the toner layer carried on the developing roller 31 is brought into contact with the photosensitive drum 21 in developing region (developing area Pd) where the photosensitive drum 21 and the developing roller 31 face each other. A developing voltage is applied to the developing roller 31 by a developing power supply E2 which serves as a developing voltage application unit. A blade voltage is applied to the developing blade 35 by the blade power supply E5 which serves as a developing blade voltage application unit. In addition, a supply voltage is applied to the supply roller 33 by the supply roller power supply E6 which serves as a supply voltage application unit. As a result, the charge amount of the developer can be controlled to a state suitable for image formation. A common supply source can be used for these voltage application units as necessary.

A voltage is applied to the developing blade with a predetermined potential difference with respect to the developer carrying member, and the predetermined potential difference is set to have the same polarity as the normal charging polarity of the developer.

As a result, when passing through the opposing portion between the developing roller 31 and the developing blade 35, charge is injected into the toner from the developing blade 35. The blade voltage to be applied is preferably 150 V or more and 400 V or less in absolute value with respect to the developing voltage. By applying a blade voltage of 150 V or more in absolute value, a sufficient charge can be injected into the toner. On the other hand, when the voltage is 400 V or more, the current may leak at the end of the developing blade 35, which is not preferable.

Furthermore, the present inventors have found that an effective blade voltage difference with respect to the developing voltage varies depending on the process speed, and that a higher blade voltage is preferably used as the process speed decreases. It is presumed that the following factors are the cause of these results. When the toner passes through the portion opposing the developing blade 35 along with the rotation of the developing roller 31, a portion of the toner carried on the developing roller 31 is dammed up by the developing blade 35 in a region immediately before the portion. Since the dammed toner moves upward on the developing roller 31 or in the direction opposite to the rotational direction of the developing roller 31, toner circulation occurs. Here, in a case where the rotational speed of the developing roller 31 is low, since the amount of toner dammed up per unit time is small, the toner circulation hardly occurs, and the toner carried on the developing roller 31 passes through the opposing portion between the developing roller 31 and the developing blade 35 in a sparse state. It is presumed that, when the toner is in a sparse state, charge transfer between toner particles is less likely to occur, and it is necessary to apply a higher blade voltage in order to impart charge to the toner as a whole. On the other hand, in a case where the rotational speed of the developing roller 31 is high, since the amount of toner dammed up per unit time is large, the toner circulation is more likely to occur, and the toner carried on the developing roller 31 tends to shift from a sparse state to a dense state. It is presumed that, when the toner is in a dense state, charge transfer between the toner particles can be effectively performed, and charge can be imparted to the toner as a whole even at a low blade voltage.

The toner carried on the developing roller 31 is transferred from the developing roller 31 to a surface of the photosensitive drum 21 in accordance with the potential on the surface of the photosensitive drum 21, such that the electrostatic latent image is developed into a toner image. In the present example, the surface of the developing roller 31 is set to −300 V by the developing power supply E2. −300 V is applied to the supply roller power supply E6. In addition, a reversal development method is adopted in which a drum surface potential is uniformly charged to −500 V by a charging unit to be described below, the drum surface potential is attenuated through exposure by a scanner unit to be described below in the printing unit, and then, negatively charged toner adheres to an exposed area. A back contrast Vback, which is the absolute value of the potential difference between the surface of the photosensitive drum 21 of a non-exposed area Vd and the developing roller 31 before passing through the developing area, is 200 V.

In the present example, the ratio of the surface speed of the developing roller 31 to the surface speed of the photosensitive drum 21 (hereinafter, referred to as the developing circumferential speed ratio) is 140%. That is, in the present example, the process speed for printing in the normal mode is set so that the photosensitive drum 21 rotates at a surface speed of 150 mm/sec and the developing roller 31 rotates at 150×1.4=210 mm/sec.

The photosensitive drum 21 is a photosensitive member formed into a cylindrical shape. The photosensitive drum 21 as an image carrying member is rotationally driven at a predetermined process speed in a predetermined direction (clockwise direction in FIGS. 30 and 31) by a motor (not illustrated).

A paper dust collection brush 22 and a charging roller 23 are in contact with the photosensitive drum 21 with a predetermined pressing force. An arbitrary charging roller voltage is applied to the charging roller 23 from the charging power supply E1 to uniformly charge the surface of the photosensitive drum 21 to a predetermined potential. In the present example, the drum surface potential is charged to −500 V by the charging roller 23. In addition, by equalizing the drum surface potential after the transfer using a pre-exposure device 24 in advance, the drum surface potential can be made more uniform when the photosensitive drum is charged by the charging roller 23.

An arbitrary brush voltage is applied to the paper dust collection brush 22 from the brush power supply E4, and paper fibers and paper dust detached from the recording material P and attached to the photosensitive drum are collected. As a result, it is possible to prevent paper fibers and paper dust from interfering with the charging of the photosensitive drum when passing through the charging unit.

The scanner unit 11 as an exposure unit scans and exposes the surface of the photosensitive drum 21 by irradiating the photosensitive drum 21 with a laser beam L corresponding to image information input from an external device using a polygon mirror. By this exposure, an electrostatic latent image corresponding to image information is formed on the surface of the photosensitive drum 21. Note that the scanner unit 11 is not limited to a laser scanner device, and for example, an LED exposure device having an LED array in which a plurality of LEDs are arranged along a longitudinal direction of the photosensitive drum 21 may be adopted. In the present example, a drum surface potential (potential in the exposed area V1) in a solid black portion attenuates to −50 V due to laser exposure by the scanner unit 11.

### [Recovery of Transfer Residual Toner]

In the present example, a so-called cleaner-less configuration is adopted in which transfer residual toner remaining on the photosensitive drum 21 without being transferred to the recording material P is recovered to the developing device 30 and reused. The transfer residual toner is reused in the following steps. The transfer residual toner includes a mixture of toner charged with a positive polarity, which is opposite to the normal polarity in the present example, and toner charged with a negative polarity but lacking a sufficient amount of charge.

By charging these toners to the normal polarity again when passing through the paper dust collection brush 22 and before reaching the contact portion between the charging roller 23 and the photosensitive drum 21, the transfer residual toner is not attached to the charging roller 23 and is along conveyed with the rotation of the photosensitive drum 21. As a result, the charging roller 23 can maintain excellent chargeability.

The transfer residual toner adhering to the surface of the photosensitive drum 21 that has passed through the contact portion with the paper dust collection brush 22 and the contact portion with the charging roller 23 reaches the developing region Pd with the rotation of the photosensitive drum 21. Here, the behavior of the transfer residual toner that has reached the developing region will be described separately for the exposed area and the non-exposed area of the photosensitive drum 21. In the non-exposed area of the photosensitive drum 21, that is, a dark potential portion Vd, the surface potential of the photosensitive drum 21 is greater on the negative polarity side than the developing voltage applied to the developing roller 31. Therefore, the transfer residual toner having a sufficient negative charge moves to the developing roller 31 by Coulomb force due to the electric field and is recovered into the developing container 32. Here, the dark potential portion Vd of the photosensitive drum 21 is not limited to the non-exposed area, and weak exposure may be performed in order to adjust to appropriate Vback when the surface potential of the photosensitive drum 21 is greater on the negative polarity side than the developing voltage applied to the developing roller 31.

The toner recovered in the developing container 32 is stirred with and dispersed in the toner in the developing container 32 by the stirring member 34, and is carried by the developing roller 31 to be used again in the developing process.

On the other hand, in an exposed area V1 of the photosensitive drum 21, since the surface potential of the photosensitive drum 21 is smaller on the negative polarity side than the developing voltage applied to the developing roller 31, the transfer residual toner remains on the surface of the photosensitive drum 21 without being transferred from the photosensitive drum 21 to the developing roller 31 in the developing region. The transfer residual toner remaining on the surface of the photosensitive drum 21 is carried on the photosensitive drum 21 together with other toner transferred from the developing roller 31 to the exposed area, moves to the transfer unit, and is transferred to the recording material P in the transfer unit.

### [Recording Material Feeding Unit]

In parallel with the image forming process described above, the recording material P stored in a paper tray 7 serving as a recording material storage unit is fed in synchronization with the transfer timing of the toner image. Describing the conveying process of the recording material P, first, a paper feed roller 8 feeds the recording material P stored in the paper tray 7. Next, the recording material P is fed to a pair of conveying rollers 9 by the paper feed roller 8, and abuts against the nip of the pair of conveying rollers 9 to correct skew. Then, the pair of conveying rollers 9 is driven in synchronization with the transfer timing of the toner image on the basis of the detection result of the leading end in the conveyance direction of the recording material P by a top sensor 10 as the recording material detector, and conveys the recording material P toward a transfer nip formed by the transfer roller 12 and the photosensitive drum 21 along a conveyance guide 15.

An electric field in a direction in which regularly-charged toner moves from the photosensitive drum to the transfer roller at the transfer nip is formed on the transfer roller 12 by the transfer power supply E3. When the recording material P is conveyed to the transfer nip in synchronization with the image forming timing, the toner image formed on the photosensitive drum 21 is transferred to the recording material P.

The excess charge on the surface of the recording material P to which the toner image is transferred is removed by a discharging needle 19. The recording material P that has passed through the discharging needle 19 is conveyed to the fixing device 40 along a transfer-to-fixing transport guide 16 as a guide member.

### [Fixing Unit]

The recording material P conveyed along the transfer-to-fixing transport guide 16 is conveyed to the fixing device 40. The fixing device 40 includes a fixing film 41, a fixing heater such as a ceramic heater that heats the fixing film 41, a thermistor that measures a temperature of the fixing heater, and a pressure roller 42 that comes into pressure contact with the fixing film 41. When the recording material P passes between the fixing film 41 and the pressure roller 42, the toner on the recording material P is heated and pressurized and fixed to the recording material P.

The recording material P that has passed through the fixing device 40 is discharged to the outside of the image forming apparatus 100 by a discharge roller pair 13, and is stacked on a discharge tray 14. The discharge tray 14 is inclined upward toward the downstream side in the discharge direction of the recording material, and the recording material discharged to the discharge tray 14 slides down the discharge tray 14, such that a trailing end is aligned by a regulation surface 17.

Note that, in the present example, although the process cartridge 20 detachably attached to a main body of the image forming apparatus is used, the present disclosure is not limited thereto, and it is sufficient that a predetermined image forming process can be performed. For example, the process cartridge may be a developing cartridge to which the developing device 30 is detachable, a drum cartridge to which the drum unit is detachable, or a toner cartridge for externally supplying toner to the developing device 30, may have a configuration without a detachable cartridge.

### 2. Developing Roller

The developing roller 31 as a developer carrying member will be described below with reference to the drawings. A developing roller according to at least one aspect of the present disclosure includes a conductive substrate and at least one resin layer provided on an outer peripheral surface of the substrate.

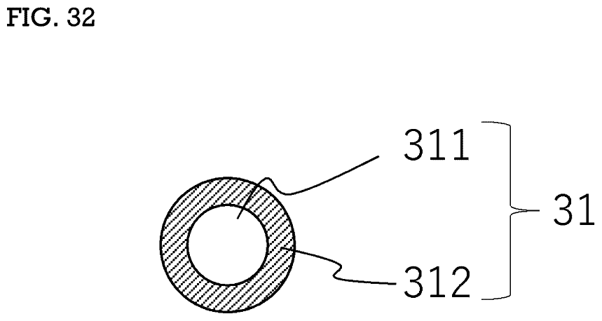

An example of the developing roller is illustrated in FIG. 32. In the developing roller 31 illustrated in the drawing, a resin layer 312 is laminated on an outer peripheral surface of a columnar or hollow cylindrical substrate 311. Note that the configuration of the layer of the developing roller is not limited to the form illustrated in the above drawing.

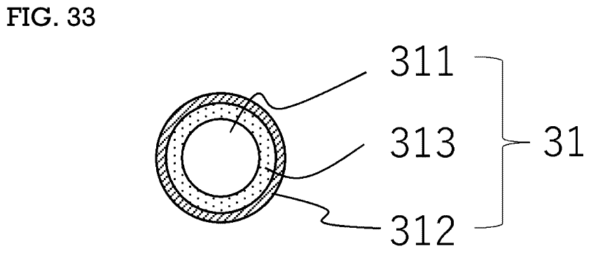

As another form of the developing roller, as illustrated in FIG. 33, an elastic layer 313 may be provided between the substrate 311 and the resin layer 312 provided on the outer peripheral surface thereof.

### [Substrate]

The substrate has a conductive outer surface, and functions as a support member of the developing roller and, in some cases, as an electrode. As a specific example of the substrate, a solid columnar shape or a hollow cylindrical shape is preferable.

The material constituting the substrate can be appropriately selected from materials known in the field of conductive members for electrophotography and materials that can be used as the developer carrying member. Examples thereof include metals represented by aluminum and stainless steel, carbon steel alloys, conductive synthetic resins, and metals or alloys such as iron and copper alloys.

Furthermore, the material constituting the substrate may be subjected to an oxidation treatment or a plating treatment with chromium, nickel, or the like. As the type of plating, either electroplating or electroless plating can be used. From the viewpoint of dimensional stability, electroless plating is preferable.

Examples of the electroless plating used here include nickel plating, copper plating, gold plating, and various other alloy plating. A plating thickness is preferably 0.05 μm or more, and the plating thickness is preferably 0.1 to 30 μm in consideration of a balance between work efficiency and rust prevention capability.

A primer may be applied to the surface of the substrate in order to improve adhesiveness between the substrate and the resin layer. As the primer, a known primer can be selected and used according to the rubber material for forming the conductive layer, the material of the support, and the like. Examples of the material of the primer include a thermosetting resin and a thermoplastic resin, and specifically, materials such as a phenolic resin, polyurethane, an acrylic resin, a polyester resin, a polyether resin, and an epoxy resin can be used.

### [Resin Layer]

The developing roller has a resin layer provided on the outer surface of the substrate. For example, the resin layer is present on the outer surface of the developer carrying member. The resin layer may contain a binder resin. As the binder resin of the resin layer in the developing roller, a polyurethane having a polycarbonate structure is preferably used in order to suppress charge leakage from the toner to the developing roller. That is, the resin layer contains a polyurethane having a polycarbonate structure. Furthermore, in order to sufficiently maintain a light load on the toner and abrasion resistance of the resin layer while suppressing charge leakage from the toner to the developing roller, it is more preferable to use a polyurethane having a structure described below as the binder resin of the resin layer.

It is preferable that the resin layer contains a polyurethane having a polycarbonate structure, and the polyurethane satisfies at least two of the following (A), (B), and (C). All of the following (A), (B), and (C) may be satisfied:
(A) the polyurethane has a structure represented by the following Structural Formula (1) in a molecule;
(B) the polyurethane has, in a molecule, either or both of a structure represented by the following Structural Formula (2) and a structure represented by the following Structural Formula (3);
(C) the polyurethane has a structure represented by the following Structural Formula (4) in a molecule.

That is, the polyurethane preferably satisfies at least one of the following conditions.
The polyurethane has at least a structure represented by Structural Formula (1) and a structure represented by Structural Formula (2).
The polyurethane has at least a structure represented by Structural Formula (1) and a structure represented by Structural Formula (3).
The polyurethane has at least a structure represented by Structural Formula (1) and a structure represented by Structural Formula (4).
The polyurethane has at least a structure represented by Structural Formula (2) and a structure represented by Structural Formula (4).
The polyurethane has at least a structure represented by Structural Formula (3) and a structure represented by Structural Formula (4).

In particular, the polyurethane more preferably has at least the structure represented by Structural Formula (1) and the structure represented by Structural Formula (4) in the molecule from the viewpoint of excellent fogging suppression and image density stability.

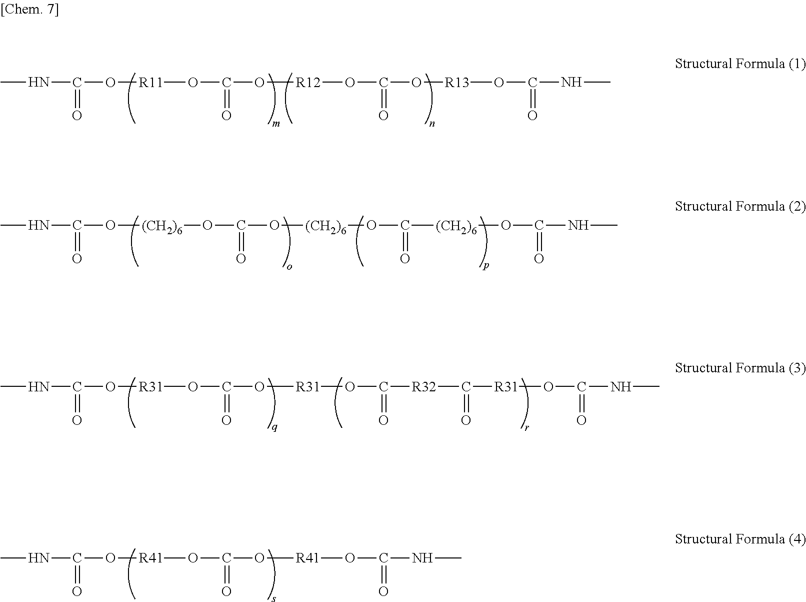

In Structural Formula (1), R11, R12, and R13 each represent a divalent hydrocarbon group having 3 to 9 carbon atoms. However, R11 and R12 are different from each other, and R13 is the same as at least one selected from the group consisting of R11 and R12. m and n are average numbers of added moles and each independently represent a number of 1.0 or more (preferably from 1.0 to 20.0, and more preferably from 2.0 to 12.0).

In Structural Formula (2), o and p are average numbers of added moles and each independently represent a number of 1.0 or more (preferably 1.0 to 15.0, and more preferably 4.0 to 10.0).

In Structural Formula (3), R31 and R32 each independently represent a divalent hydrocarbon group having 3 to 8 carbon atoms. q and r are average numbers of added moles and each independently represent a number of 1.0 or more (preferably from 1.0 to 20.0, and more preferably from 2.0 to 14.0).

In Structural Formula (4), R41 represents a divalent hydrocarbon group having 6 to 9 (preferably 5 to 8) carbon atoms. s is an average number of added moles and represents a number of 1.0 or more (preferably 1.0 to 22.0, and more preferably 4.0 to 18.0).

The structure represented by Structural Formula (1) is a structure obtained by reacting an isocyanate with a copolymerized polycarbonate polyol in which crystallinity is suppressed by linking two carbonate groups via two different hydrocarbon groups. Since the crystallinity is suppressed, the cohesive energy in the soft segment is low, and flexibility and a high volume resistivity can be imparted to the resin layer.

By using the structure of Structural Formula (1) in combination with the structures (2) to (4) described above for the resin layer, the adhesiveness of the resin layer can be reduced. Therefore, adhesion of toner, powder, or the like to the surface of the resin layer can be suppressed, an increase in the electrical resistance value of the surface of the resin layer due to contamination is suppressed, and uniform charging of the toner is easily performed.

In Structural Formula (1), R11 and R12 are each independently a divalent hydrocarbon group having 3 to 9 carbon atoms. R11 and R12 are different from each other, and R13 is the same as at least one selected from the group consisting of R11 and R12.

When the number of carbon atoms in R11 and R12 is 3 or more, in the polyurethane having a polycarbonate structure, the amount of carbonate groups which are polar functional groups and have strong cohesive energy is not excessively increased, and it becomes easier to maintain the resin layer in a flexible state and with a high electrical resistance.

In addition, when the number of carbon atoms in R11 and R12 is 9 or less, the amount of carbonate groups in the polyurethane is not excessively reduced, and the strength of the polymer can be maintained. In addition, since R11 and R12 have different structures, crystallinity of the polymer can be suppressed, and flexibility can be imparted to the resin layer. m and n each independently represent a number of 1.0 or more. The hydrocarbon groups represented by R11, R12, and R13 may have a branched structure or a cyclic structure.

The structures represented by Structural Formula (2) and Structural Formula (3) are structures obtained by reacting an isocyanate with a copolymerized polyol in which a polycarbonate structure and a polyester structure are copolymerized. The crystallinity of the polymer is suppressed by copolymerizing the polycarbonate structure and the polyester structure, and the soft segment is moderately reinforced by introducing an ester group having stronger cohesive energy than the carbonate group, such that abrasion resistance can be imparted to the resin layer.

When the resin layer is formed using a polymer in which the structure represented by Structural Formula (2) and/or Structural Formula (3) is combined with the structure of Formula (1) or (4) described above, a sufficient volume resistivity can be imparted to the resin layer while having an ester group having polarity, and charge leakage from the toner to the developing roller is more easily suppressed.

In Structural Formula (2), o and p each independently represent a number of 1.0 or more.

In Structural Formula (3), R31 and R32 each independently represent a divalent hydrocarbon group having 3 to 8 carbon atoms, and q and r each independently represent a number of 1.0 or more. When the number of carbon atoms in each of R31 and R32 is 3 or more, the amount of the carbonate group and the ester group which are polar functional groups and have strong cohesive energy in the polyurethane is not excessively increased, and the flexibility of the resin layer can be maintained. In addition, when the number of carbon atoms in R31 and R32 are 8 or less, the amount of carbonate groups and ester groups in the polyurethane is not excessively reduced, and abrasion resistance can be imparted to the resin layer.

The structure represented by Structural Formula (4) is a structure obtained by reacting an isocyanate with a highly crystalline polycarbonate polyol in which two carbonate groups are linked via a single hydrocarbon group.

Since this structure has high crystallinity and is easily aligned in the soft segment, abrasion resistance and a high volume resistivity can be imparted to the resin layer. By forming the resin layer using a polymer in which the structure represented by Structural Formula (4) is combined with the structures of Formulas (1) to (3) described above, the hardness of the resin layer does not become excessively high and can be appropriately controlled with ease.

In Structural Formula (4), R41 represents a divalent hydrocarbon group having 6 to 9 carbon atoms, and s represents a number of 1.0 or more. When the number of carbon atoms in R41 is 6 or more, crystallinity is easily exhibited, and abrasion resistance and a high volume resistivity can be imparted to the resin layer. When the number of carbon numbers in R41 is 9 or less, excessive crystallinity can be suppressed, and therefore, by further incorporating at least one of the structures represented by Structural Formulas (1), (2), and (3) in the polymer, an increase in hardness of the resin layer can be suppressed.

The resin layer preferably contains a polymer having a urethane bond, that is, a polyurethane having a polycarbonate structure as a binder resin, and the polymer preferably satisfies at least two selected from the group consisting of (A), (B), and (C) described above. As a result, the resin layer becomes flexible and is less likely to wear.

The structure of the polymer contained in the resin layer of the developing roller can be confirmed by, for example, analysis by pyrolysis GC/MS, FT-IR, or NMR.

The polyurethane having a polycarbonate structure can be produced using (A) a polyol compound (A) and (B) a polyisocyanate compound (B). Usually, the following methods (1) and (2) are used for the synthesis of polyurethane:
(1) a one-shot method of mixing and reacting a polyol component and a polyisocyanate component; and
(2) a method of reacting an isocyanate-terminated prepolymer obtained by reacting a portion of the polyol with an isocyanate, with a chain extender such as a low-molecular-weight diol or a low-molecular-weight triol.

In the present disclosure, the polyurethane may be synthesized by any of the methods described above, but a method of thermally curing a hydroxyl-terminated prepolymer obtained by reacting a raw material polyol with isocyanate and an isocyanate-terminated prepolymer obtained by reacting a raw material polyol with isocyanate is more preferable.

The polyurethane having a polycarbonate structure is preferably a reaction product of a mixture containing a hydroxyl-terminated prepolymer and an isocyanate-terminated prepolymer. The mixture can be used as a coating liquid for forming a resin layer. The polyurethane having a polycarbonate structure is more preferably a reaction product of a mixture containing a hydroxyl-terminated prepolymer and an isocyanate-terminated prepolymer, and a conductive filler and an additive.

When hydroxyl groups, isocyanate groups, or a large number of urea bonds, allophanate bonds, isocyanurate bonds, and the like are present, since a large number of polar functional groups are present in the polyurethane; thus, the water absorption of the polymer increases, and the volume resistivity of the resin layer decreases, and there is a risk of causing charge leakage from the toner to the developing roller. On the other hand, by thermally curing the hydroxyl-terminated prepolymer and the isocyanate-terminated prepolymer, it is possible to obtain a polyurethane having low contents of unreacted polyol and polar functional groups without excessively using isocyanate.

### (A) Polyol Compound

The polyol is selected from known polycarbonate polyols and polyester polycarbonate copolymerized polyols.

Examples of the polycarbonate polyol include the following: polynonamethylene carbonate diol, poly(2-methyl-octamethylene) carbonate diol, polyhexamethylene carbonate diol, polypentamethylene carbonate diol, poly(3-methylpentamethylene) carbonate diol, polytetramethylene carbonate diol, polytrimethylene carbonate diol, poly(1,4-cyclohexanedimethylene carbonate) diol, poly(2-ethyl-2-butyl-trimethylene) carbonate diol, and random or block copolymers thereof.

Examples of the polyester polycarbonate copolymerized polyol include the following: copolymers obtained by polycondensing the polycarbonate polyols with lactones such as F-caprolactone, or copolymers with polyesters obtained by polycondensing diols such as 1,4-butanediol, 1,5-pentanediol, 1,6-hexanediol, 3-methylpentanediol, or neopentyl glycol, and dicarboxylic acids such as adipic acid or sebacic acid.

### (B) Polyisocyanate Compound

The polyisocyanate is selected from commonly used known polyisocyanates, and examples thereof include the following polyisocyanates: toluene diisocyanate (TDI), diphenylmethane diisocyanate (MDI), polymeric diphenylmethane polyisocyanate, hydrogenated MDI, polymeric MDI, xylylene diisocyanate (XDI), hexamethylene diisocyanate (HDI), and isophorone diisocyanate (IPDI). Among them, aromatic isocyanates such as toluene diisocyanate (TDI), diphenylmethane diisocyanate (MDI), polymeric diphenylmethane polyisocyanate, and polymeric MDI are more preferably used. Other polyisocyanates can also be used as long as they do not affect an impedance value and a surface potential.

A ratio of the number of isocyanate groups to the number of hydroxyl groups (hereinafter, also referred to as “ratio of NCO/OH”) is preferably 1.0 to 2.0. When the ratio of NCO/OH is 1.0 to 2.0, a crosslinking reaction proceeds, and bleeding of unreacted components and low-molecular-weight polyurethane, so-called “bleed” is suppressed. The ratio of NCO/OH is more preferably 1.0 to 1.6. When the ratio of NCO/OH is 1.0 to 1.6, bleed is suppressed, and the hardness of the polymer can be suppressed.

A content of the polyurethane in the resin layer is not particularly limited, but is preferably 50 to 95 mass %, more preferably 60 to 80 mass %, and still more preferably 65 to 75 mass %.

### (Conductive Filler)

The resin layer preferably contains a conductive filler in order to obtain electrical conductivity. As the conductive filler in the resin layer, it is more preferable to use an electron conductive agent. The electron conductive agent is a conductive particle exhibiting electronic conductivity, and preferably has a surface functional group capable of interacting with a functional group present in an additive to be described below.

Examples of the electron conductive agent exhibiting these properties include at least one selected from the group consisting of carbon black such as furnace black, thermal black, acetylene black, and Ketjen Black, metal oxide-based conductive particles such as titanium oxide having a surface treated with an acidic functional group, and metal-based conductive particles such as aluminum and iron having a surface treated with an acidic functional group.

Among them, at least one selected from the group consisting of carbon blacks having high stability of surface functional groups is preferably used. The conductive filler preferably contains carbon black. Furthermore, in order to obtain a desired impedance value and surface potential, carbon black having a number average diameter of primary particles capable of achieving higher dispersion in the resin layer of 30 nm or less, a DBP absorption of 90 ml/100 g or less, and a pH of 4.0 or less is particularly preferably used.

However, even when the number average diameter, DBP absorption, and pH of the primary particles of carbon black are within the above ranges, when polycarbonate urethane is used as a binder resin, the carbon black cannot be sufficiently dispersed, and a desired impedance may not be obtained. The reason why the carbon black having the desired material properties cannot be dispersed when polycarbonate urethane is used as a binder resin is not clearly known, but is presumed as follows.

Hydroxyl groups, which are surface functional groups of carbon black, are likely to interact with terminal hydroxyl groups of polycarbonate diol. On the other hand, a structure in which a carbonate bond and a hydrocarbon group are bonded, which is present between two hydroxyl groups of polycarbonate diol, is hydrophobic due to the presence of the hydrocarbon group, and hardly interacts with carbon black. Since hydrophobic groups and hydrophilic groups tend to be structurally more stable when located near other hydrophobic groups and near other hydrophilic groups, respectively, hydrophilic carbon black tends to be located in the vicinity of other hydrophilic carbon black. As a result, it is considered that the carbon black is easily aggregated and hardly dispersed.

In order to sufficiently disperse carbon black in which the number average diameter of primary particles, the DBP absorption, and the pH are in the above numerical ranges using polycarbonate urethane as a binder resin, it is more preferable to add an additive described below.

A content of the carbon black is preferably 30 parts by mass or less with respect to 100 parts by mass of the polyurethane forming the resin layer although it is desirable to add the carbon black so as to have a desired volume resistivity. The content of the carbon black is more preferably 10 to 30 parts by mass and still more preferably 15 to 25 parts by mass.

When the content is 30 parts by mass or less, the distance between the carbon blacks in the coating liquid is appropriately maintained, the collision probability due to Brownian motion or the like of the carbon black is reduced, and the carbon black is less likely to aggregate. Therefore, carbon black is easily dispersed, and dispersion stability is also improved. As a result, carbon black is well dispersed in the resin layer formed by forming the coating liquid. Note that, when the surface of the carbon black is coated with an insulating material such as a silane coupling agent, the carbon black cannot act as a pseudo capacitor, such that both the impedance and the surface potential are high. In addition, a plurality of types of carbon blacks may be used in combination as long as the impedance value and the surface potential are not affected.

### (Additive)

It is also a preferred mode to use an additive for further improving dispersibility of carbon black in a binder resin using polycarbonate urethane. Here, as the additive, for example, a compound having a structure represented by the following Structural Formula (5) can be suitably used. One of the methods for incorporating the additive into the surface layer is a method for incorporating a dispersant in a coating liquid for forming a resin layer. Note that in the surface layer formed using a coating liquid for forming a resin layer containing a compound having a structure represented by Structural Formula (5), the compound may be incorporated at the end of the polymer chain of the polyurethane. Even in this case, the effect of improving the dispersibility of carbon black can be expected, but it is preferable that carbon black is present in the surface layer independently of polyurethane.

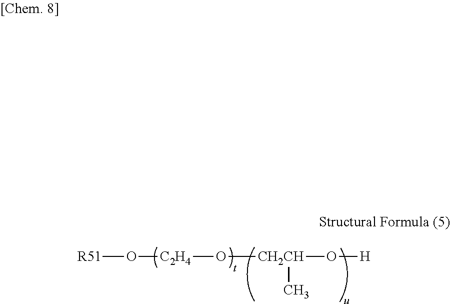

In Structural Formula (5), R51 represents a monovalent hydrocarbon group having 1 to 12 (preferably 3 to 12) carbon atoms. t and u are average numbers of added moles and each independently represent a number of 1 or more (preferably from 5 to 30, and more preferably from 10 to 25).

Structural Formula (5) represents a polyoxyethylene polyoxypropylene alkyl ether, and is a polyether mono-ol having a structure obtained by block addition polymerization of ethylene oxide and propylene oxide. The hydroxyl group at the terminal of the polyether mono-ol interacts with functional groups on the surface of carbon black, which is a conductive filler, via hydrogen bonding, thereby acting as a dispersant for the carbon black. In addition, in order to enhance the effect of carbon black as a dispersant, the carbon black has a structure that is compatible with polycarbonate urethane.

Ethylene oxide is introduced into the structure to ensure uniform presence of the additive in the polycarbonate urethane. This is considered to be because the ethylene group in ethylene oxide is compatible with the hydrophobic hydrocarbon group in the polycarbonate urethane. In addition, propylene oxide is introduced into the structure in order to improve dispersibility of the conductive filler dispersed in the resin layer. This is considered to be due to the interaction between the side chain methyl group of propylene oxide and the conductive filler, which improves the dispersibility of the conductive filler.

R51, which is a monovalent hydrocarbon group having 1 to 12 carbon atoms, is introduced into the structure in order to make the additive uniformly present in the polycarbonate urethane. The monovalent hydrocarbon group is compatible with the hydrophobic hydrocarbon group in the polycarbonate urethane, and the additive can be uniformly present in the polycarbonate urethane. Because the number of carbon atoms is 12 or less, steric hindrance with the polycarbonate urethane is less likely to occur, and the additive tends to be uniformly present.

Since the compound represented by Formula (5) has a monool structure, the compound has lower reactivity than a diol, which makes it less likely to be incorporated during a urethanization reaction between the isocyanate and polyol; thus, the introduction of the ether structure into the polycarbonate urethane is minimized, thereby reducing a risk of a decrease in the resistivity of the polyurethane.

A polyoxyethylene polyoxypropylene alkyl ether can be obtained using commercially available products or by synthesis. The polyoxyethylene polyoxypropylene alkyl ether can be synthesized by performing step (B) after step (A). Note that step (B) may be performed on a commercially available product having a structure completed up to step (A).
Step (A): Reaction of alcohol with ethylene oxide
Step (B): Reaction of product obtained in step (A) with propylene oxide

In step (A), the reaction can proceed by adding ethylene oxide to an alcohol in the presence of a catalyst at 50 to 200° C., and more preferably at 100 to 160° C. Since ethylene oxide has a boiling point of 10.7° C. and is a gas at the above temperature, the reaction is preferably carried out in an environment pressurized in a sealed container. The pressure is preferably 0.1 MPa to 1.0 MPa. The reaction time is not particularly limited, but is preferably about 1 hour to 3 hours in order to reduce a content of unreacted ethylene oxide.

As the catalyst, an acid catalyst or an alkali catalyst can be used, but an alkali catalyst is preferable in order to facilitate purification after completion of the reaction. Examples of the alkali catalyst include hydroxides of alkali metals such as sodium hydroxide and potassium hydroxide, hydroxides of alkaline earth metals such as calcium hydroxide and barium hydroxide, ammonium hydroxide, and tertiary amines. In view of ease of reaction and reaction efficiency, sodium hydroxide and potassium hydroxide are particularly preferable. Examples of the acid catalyst include Brønsted acids such as sulfuric acid and phosphoric acid, and Lewis acids such as stannic chloride and boron trifluoride.

In the case of sodium hydroxide or potassium hydroxide, the amount of catalyst used is preferably 0.1 to 5 mol % based on 1 mol of the alcohol. Ethylene oxide reacts with water to produce ethylene glycol, such that moisture is prevented as much as possible, and a dehydration treatment may be performed before the reaction of step (A) as necessary.

Step (B) can be performed under the same conditions as in step (A). Since propylene oxide has a boiling point of 34.2° C. and is a gas at a reaction temperature of 50 to 200° C., it is preferable to perform the reaction in an environment pressurized in a sealed container. The catalyst used in step (A) may be used as it is or may be newly added. When newly added, the catalyst used in step (A) is preferable.

The compound represented by Structural Formula (5) has a function as a dispersant for carbon black, and is a compound having high affinity with polycarbonate urethane. Usually, a surfactant is used as a method for improving dispersibility and dispersion stability of carbon black. However, the compound represented by Structural Formula (5) is not generally used because the number of functional groups acting on the surface functional group of carbon black is small, and therefore, the surfactant action is weak. As a general dispersant for carbon black, a coupling agent and a nonionic surfactant are utilized.

As the coupling agent, a silane coupling agent, a titanate-based coupling agent, or an aluminum-based coupling agent is used, and as the nonionic surfactant, a polyester-based or polyether-based surfactant is used. However, when these dispersants are added to a level at which the dispersibility of carbon black can be sufficiently enhanced in polycarbonate urethane (mass ratio of 50 to 100% with respect to carbon black), the electrical conductivity of the carbon black or the binder resin is inhibited. On the other hand, when the amount added is set to a level at which the electrical conductivity of the carbon black or the binder resin is not inhibited (mass ratio of 10 to 40% with respect to the carbon black), the dispersibility of the carbon black cannot be obtained.

The amount of the compound represented by Structural Formula (5) is preferably 3.0 to 7.0 mass % based on the solid content in the coating liquid for forming a resin layer. The amount of the compounds represented by Structural Formulas (5) to (7) is more preferably 3.0 to 5.0 mass %. In addition, the total content is preferably 18.9 to 46.0 parts by mass with respect to 100 parts by mass of the carbon black in the coating liquid for forming a resin layer.

When the content of the additive in the coating liquid for forming a resin layer is within the above range, the dispersibility of carbon black in polyurethane is further improved, and a desired impedance value and surface potential can be more easily achieved.

The presence confirmation and quantitative evaluation of the additive in the resin layer can be analyzed by the following method. By cutting out the resin layer of the developing roller and using, for example, ¹H-NMR, ¹³C-NMR, XPS, or FT-IR on the cross-section, the carbonate structure of the binder resin, the ether structure, the amine structure, and the carboxylic acid structure of the additive can be detected in the resin layer, and ratios can be calculated from peak ratios or the like.

In addition, the cross section is immersed in an organic solvent such as 2-butanone (methyl ethyl ketone: MEK) overnight for extraction and analyzing both the extract and the extracted cross section using ¹H-NMR, ¹³C-NMR, XPS, and FT-IR, such that it is possible to determine the ratio of the additive incorporated into the resin during polymerization and the additive not incorporated in the resin.

### (Coarse Particles)

The resin layer may contain coarse particles. The coarse particles may be, for example, spherical particles. A particle diameter of the coarse particle is, for example, preferably in the range of 1 μm to 150 μm, and more preferably in the range of 5 μm to m. Examples of the coarse particles include at least one spherical particle selected from the following particles:
urethane resin particles, acrylic resin particles, phenol resin particles, silicone resin particles, polyacrylonitrile resin particles, polystyrene resin particles, polyurethane resin particles, nylon resin particles, polyethylene resin particles, and polypropylene resin particles. The coarse particles are preferably urethane resin particles.

The developing roller may have an elastic layer formed on the outer surface of the substrate. The developing roller has, for example, an elastic layer between the substrate and the resin layer. The elastic layer is not particularly limited, and a known elastic layer may be used as the elastic layer of the developer carrying member. Examples of the elastic layer include a cured product of an addition cure-type liquid silicone rubber mixture.

### [Production Method]

A method for forming the resin layer is not particularly limited, and examples thereof include a method by spraying with a coating material, dip coating, or roll coating. For example, a coating liquid for forming a resin layer is applied onto the substrate or the elastic layer formed on the outer surface of the substrate by a known method, and heated and dried to form a resin layer. The conditions for heating and drying are not particularly limited, and examples thereof include a method of drying under a condition of 120 to 200° C. A thickness of the resin layer is also not particularly limited, and is preferably 1 to 50 μm, and more preferably 5 to 20 μm.

### [Method for Measuring Various Characteristics of Developer Carrying Member]

### (Impedance)

In the impedance measurement, the response of the developing roller is examined by applying an AC voltage and a DC voltage while varying the frequency. An AC voltage is applied, and a response with no phase shift and a response with a phase shift of π/2 with respect to the applied AC voltage are measured separately, the impedance of the response with no phase shift, which is defined as Z′ (the real part), and the impedance of the response with a phase shift, which is defined as Z″ (the imaginary part), are plotted on a complex plane, and a distance from the origin to the plotted point is calculated as an impedance value.

When the electrical characteristics of the developing roller are represented in a pseudo manner by an RC parallel circuit, the real part with no phase shift represents a resistive component, and the imaginary part with a phase shift represents a capacitive component. Note that the measurement conditions and the meanings of the measured values have been described in <Technical significance of requirement (1)> described above, and thus are omitted in this section.

A method for measuring impedance, a measuring apparatus, and measurement conditions will be described below.

### Method for Measuring Impedance

The impedance of the developing roller can be measured by the following methods (1) and (2):
(1) a method in which a thin film electrode is provided on a surface of a developing roller, and measurement is performed using two terminals of the electrode and the substrate; and
(2) a method in which a developing roller is pressed against a metal drum with a constant load, and measurement is performed with two terminals of the metal drum and the substrate.

Although the impedance can be measured by any method, the method (2) is affected by a nip width and a contact area between the developing roller and the metal drum, and thus, it is necessary to measure the impedance by the developing roller having the same hardness. Therefore, in the present disclosure, measurement is performed by the method (1). Hereinafter, the measurement method (1) will be described, and more specific conditions will be described below.

In the measurement of the impedance, in order to eliminate the influence of the contact resistance between the developing roller and the measurement electrode, it is preferable to deposit a low-resistance thin film on the surface of the developing roller, use the thin film as an electrode, and measure the impedance with two terminals using a conductive substrate as a ground electrode.

Examples of a method for forming the thin film include methods for forming a metal film such as metal vapor deposition, sputtering, application of a metal paste, and attachment of a metal tape. Among them, from the viewpoint of reducing the contact resistance with the developer carrying member, a method for forming a metal thin film such as platinum or palladium as an electrode by vapor deposition is preferable. In the present disclosure, vacuum platinum vapor deposition is employed.

When the metal thin film is formed on the surface of the developing roller, it is preferable to use a vacuum vapor deposition apparatus in which a mechanism capable of holding the developing roller is provided to the vacuum vapor deposition apparatus and a rotation mechanism is further provided to the developing roller having a cylindrical cross section in consideration of simplicity and uniformity of the thin film.

It is preferable that a metal thin film electrode having a width of about 10 mm in a longitudinal direction of the developing roller is formed, and a metal sheet wound around the metal thin film electrode in a direction intersecting the longitudinal direction without a gap is connected to the measurement electrode extending from the measuring apparatus to perform measurement. In the case of a cylindrical developing roller, it is preferable to use a metal sheet wound without a gap in a circumferential direction of the developing roller. As a result, the impedance measurement can be performed without being affected by the fluctuation of the size of the outer edge (the outer diameter in the cylindrical developing roller) in the cross section orthogonal to the longitudinal direction of the developing roller or the surface shape. As the metal sheet, an aluminum foil, a metal tape, or the like can be used.

### Impedance Measuring Apparatus and Measurement Conditions

The impedance measuring apparatus may be any device capable of measuring impedance in a frequency range of 1.0×10⁻¹ to 1.0×10⁵ Hz, such as an impedance analyzer, a network analyzer, or a spectrum analyzer. Among them, it is preferable to use an impedance analyzer for measurement from the viewpoint of the electrical resistance region of the developing roller.

The impedance measurement conditions will be described. The impedance in the frequency range of 1.0×10⁻¹ to 1.0×10⁵ Hz is measured using an impedance measuring apparatus. As the measurement environment, the temperature is 23° C. and the relative humidity is 50%. In consideration of measurement variations, it is preferable to measure at least a total of nine points including three longitudinal points and three rotational directions of the developer carrying member. The voltage application condition is obtained by superimposing an AC voltage of 50 V on a DC voltage of 50 V.

### (Surface Potential)

In an environment of a temperature of 23° C. and a relative humidity of 50%, a corona discharger having a grid portion with a width of 3.0 mm is disposed so that a distance between the grid portion and the outer surface of the developing roller is 1.0 mm, the direction of the width of the grid portion coincides with the axial direction of the developing roller, a voltage of 8 kV is applied to the grid portion, the corona discharger is relatively moved along the axial direction of the developing roller at a speed of 400 mm/sec to charge the outer surface of the developing roller, and the potential of the outer surface 0.06 seconds after the outer surface passes through the grid portion is measured to evaluate the easiness of excessive charging (charge-up) of the surface of the developing roller.

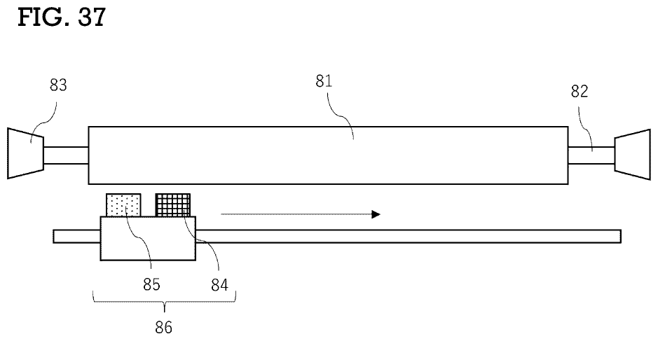

The surface potential of the developing roller can be measured by, for example, the apparatus illustrated in FIG. 37.

Both ends of a substrate 82 of a developing roller 81 are held by a chuck 83, and a measurement unit 86 in which a corona discharger 84 and a surface potential meter 85 are arranged in parallel with a 25 mm spacing is disposed to face a surface of the developing roller 81 at a distance of 1.0 mm. In a state where the developing roller 81 is stationary, a voltage of 8 kV is applied to a grid portion of the corona discharger 84, the measurement unit 86 is moved in an axial direction of the developing roller 81 at a speed of 400 mm/sec, and a surface potential is measured using the surface potential meter 85 at 0.06 seconds after passing the corona discharger 84.

The measurement conditions and the meanings of the measured values have been described in <Technical significance of requirement (2)> described above, and thus are omitted in this section.

Hereinafter, the present disclosure will be described in more detail, but these descriptions are not intended to limit the present disclosure at all.

### [2-1. Preparation and Production of Raw Materials for Forming Resin Layer]

### <2-1-1. Preparation and Production Example of Raw Material Polyol>

Hereinafter, a synthesis example for obtaining a polyurethane resin layer will be described.

### [Measurement of Number Average Molecular Weight of Raw Material Polyol]

The apparatus and conditions used for measuring a number average molecular weight (Mn) in the present production example are as follows.
Measuring apparatus: HLC-8120GPC (manufactured by Tosoh Corporation)
Column: TSKgel Super HZMM (manufactured by Tosoh Corporation)×2 columns
Solvent: tetrahydrofuran (THF) (20 mmol/l triethylamine is added)
Temperature: 40° C.
Flow rate of THF: 0.6 ml/min

Note that the measurement sample was prepared as a 0.1 mass % solution in THF. Further, measurement was performed using a refractive index (RI) detector as a detector.

As a standard sample for preparing a calibration curve, a calibration curve was prepared using TSK standard polystyrene A-1000, A-2500, A-5000, F-1, F-2, F-4, F-10, F-20, F-40, F-80, and F-128 manufactured by Tosoh Corporation. Based on the calibration curve, the number average molecular weight was determined from the retention time of the obtained measurement sample.

### [Preparation of Raw Material Polyol]

Raw material polyols A-1 to A-4 shown in Table 64 were prepared.

TABLE 64

| No. | Raw material polyol |
|---|---|
| A-1 | DURANOL T5652 Mn = 2000 (Asahi Kasei Chemicals |
| | Corporation) |
| A-2 | DURANOL G3452 Mn = 2000 (Asahi Kasei Chemicals |
| | Corporation) |
| A-3 | NIPPOLLAN 982 Mn = 2000 (Tosoh Corporation) |
| A-4 | ETERNACOLL UH-200 Mn = 2000 (UBE Corporation) |

### [Synthesis of Raw Material Polyol A-5]

In a nitrogen atmosphere, 100.0 g of 1,3-propanediol, 49.4 g of adipic acid, and 69.5 g of ethylene carbonate were mixed and heated, and ethylene glycol and water generated from the reaction system were distilled off while the temperature was raised to 200° C. After ethylene glycol and water were distilled off, 15 ppm of titanium tetraisopropoxide was added, and a polycondensation reaction was further carried out under a reduced pressure of 266.7 Pa. The reaction solution was cooled to room temperature to obtain raw material polyol A-5 shown in Table 65. The number average molecular weight of the obtained raw material polyol A-5 was 2,030.

TABLE 65

| | | Dicarboxylic | Ethylene | | Number |
|---|---|---|---|---|---|
| | Diol | acid | carbonate | Ester group/ | average |
| Raw material | (parts | (parts | (parts | carbonate group | molecular |
| polyol No. | by mass) | by mass) | by mass) | (molar ratio) | weight |
| A-5 | 1,3-Propanediol | Adipic acid | 69.5 | 3/7 | 2030 |
| | (100.0) | (49.4) | | | |

### <2-1-2. Preparation of Raw Material Isocyanates>

Raw material isocyanates shown in Table 66 were prepared.

TABLE 66

| No. | Raw material isocyanate |
|---|---|
| B-1 | Diphenylmethane diisocyanate (MDI) |
| | (trade name: MILLIONATE MT, Tosoh Corporation) |
| B-2 | Polymethylene polyphenyl polyisocyanate (Polymeric MDI) |
| | (trade name: MILLIONATE MR200, Tosoh Corporation) |

### <2-1-3. Production Example of Hydroxyl-Terminated Urethane Prepolymer>

### [Synthesis of Hydroxyl-Terminated Urethane Prepolymer C-1]

In a nitrogen atmosphere, materials shown in Table 67 were reacted by heating and stirring at a temperature of 90° C. for 3 hours. Thereafter, 2-butanone (MEK) was added to the obtained reaction product to prepare a hydroxyl-terminated urethane prepolymer C-1 as a solution having a solid content of 50 parts by mass.

TABLE 67

| Material | Parts by mass |
|---|---|
| Raw material polyol A-1 (trade name: DURANOL | 100 |
| T5652, Asahi Kasei Chemicals Corporation) | |
| Raw material isocyanate B-1 (trade name: | 6.3 |
| MILLIONATE MT, Tosoh Corporation) | |

### [Synthesis of Hydroxyl-Terminated Urethane Prepolymers C-2 and C-3]

Hydroxyl-terminated urethane prepolymers C-2 and C-3 were prepared in the same manner as in the case of synthesizing the hydroxyl-terminated urethane prepolymer C-1 using starting materials shown in Table 68.

The chemical structures of these hydroxyl-terminated urethane prepolymers C-1 to C-3 were specified using ¹H-NMR and ¹³C-NMR. Note that, in Table 68, m, n, o, p, q, r, and s in Structural Formulas (1) and (3) are the average numbers of added moles. Here, PBM means “Parts by mass”. (1) and (3) means “Structural Formula (1)” and “Structural Formula (3)”.

TABLE 68

| Hydroxyl- | | | | | | | | |
|---|---|---|---|---|---|---|---|---|
| terminated | Raw material | | Raw material | | | | | |
| urethane | polyol | | isocyanate | | | | | |
| prepolymer No. | No. | PBM | No. | PBM | Structure contained in molecule | | | |
| C-1 | A-1 | 100 | B-1 | 6.3 | (1) | R11 = (CH₂)₅ | R12 = (CH₂)₆ | m, n = 6.9 |
| C-2 | A-2 | 100 | B-1 | 6.3 | (1) | R11 = (CH₂)₃ | R12 = (CH₂)₄ | m, n = 8.8 |
| C-3 | A-5 | 100 | B-1 | 6.3 | (3) | R31 = (CH₂)₃ | R32 = (CH₂)₄ | q = 12, r = 5.1 |

Regarding the hydroxyl-terminated urethane prepolymers C-1 and C-2 in which the structure represented by Structural Formula (1) was contained in the molecule, R13 in Structural Formula (1) was the same as R12.

In the table, notations such as m, n=6.9 or “x, y=A” indicate that the average number of added moles for each of x and y is A. The same applies to the following table.

### <2-1-4. Production Example of Isocyanate-Terminated Prepolymer>

### [Synthesis of Isocyanate-Terminated Prepolymer D-1]

In a nitrogen atmosphere, materials shown in Table 69 were reacted by heating and stirring at a temperature of 90° C. for 3 hours. Thereafter, 2-butanone (MEK) was added to the obtained reaction product to form a solution having a solid content of 50 parts by mass, thereby producing an isocyanate-terminated prepolymer D-1.

TABLE 69

| Material | Parts by mass |
|---|---|
| Raw material polyol A-10 | 100 |
| (trade name: NIPPOLLAN 982, Tosoh Corporation) | |
| Raw material isocyanate B-2 | 33.5 |
| (trade name: MILLIONATE MR200, Tosoh Corporation) | |

### [Synthesis of Isocyanate-Terminated Prepolymer D-2]

An isocyanate-terminated prepolymer D-2 was prepared in the same manner as in the case of synthesis of the isocyanate-terminated prepolymer D-1 using the types and amounts of starting materials shown in Table 70.

The chemical structures of these isocyanate-terminated prepolymers D-1 to D-9 were identified using ¹H-NMR and ¹³C-NMR. Note that, in Table 70, m, n, o, p, q, r, and s in Structural Formulas (2) and (4) are the average numbers of added moles. Here, (2) and (4) means “Structural Formula (2)” and “Structural Formula (4)”. PBM means “Parts by mass”.

TABLE 70

| Isocyanate- | Raw material | | Raw material | | | | |
|---|---|---|---|---|---|---|---|
| terminated | polyol | | isocyanate | | Structure contained | | |
| prepolymer No. | No. | PBM | No. | PBM | in molecule | | |
| D-1 | A-3 | 100 | B-2 | 33.5 | (2) | o = 9.1, p = 5.5 | |
| D-2 | A-4 | 100 | B-2 | 33.5 | (4) | R41 = | s = 13.2 |
| | | | | | | (CH₂)₆ | |

### [2-2. Preparation of Additive Raw Materials for Resin Layer]

### [Preparation of Polyoxyethylene Polyoxypropylene Alkyl Ether E-1]

An additive E-1 which is polyoxyethylene polyoxypropylene alkyl ether shown in Table 71 was a commercially available product. Here, (5) means “Structural Formula (5)”.

TABLE 71

| No. | Material | Structure | | |
|---|---|---|---|---|
| E-1 | Polyoxyethylene polyoxypropylene | (5) | R51 = C₄H₉ | t, u = 17 |
| | butyl ether (trade name: UNILUBE | | | |
| | 50MB-26, NOF corporation) | | | |

### [2-3. Preparation of Coarse Particles]

Urethane particles H-1 as coarse particles shown in Table 72 are commercially available products.

TABLE 72

| No. | Material |
|---|---|
| H-1 | Trade name: ART PEARL C-400T (Negami Chemical Industrial |
| | Co., Ltd.) (average particle diameter: 15 μm) |

### [2-4. Production Example of Coating Liquids for Forming Resin Layer]

### <2-4-1. Preparation of Coating Liquid F-1 for Forming Resin Layer>

The types and amounts of materials shown in Table 73 were added to a reaction vessel as materials for a coating liquid F-1 for forming a resin layer and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-1 for forming a resin layer.

TABLE 73

| Material | Parts by mass |
|---|---|
| Hydroxyl-terminated urethane prepolymer C-1 | 100 |
| Isocyanate-terminated urethane prepolymer D-5 | 54.7 |
| Additive E-1 | 7 |
| Carbon black | 35 |
| (trade name: MA8, Mitsubishi Chemical Corporation) | |
| Coarse particles H-1 | 23 |

### <2-4-2. Preparation of Coating Liquids F-2 and F-3 for Forming Resin Layer>

Coating liquids F-2 and F-3 for forming a resin layer were prepared by the following method. First, the hydroxyl-terminated urethane prepolymer, isocyanate-terminated prepolymer, additive, carbon black, and coarse particles described in Table 74 were mixed in the same manner as in the case of preparing the coating liquid F-1 for forming a resin layer. Thereafter, 2-butanone (MEK) was added to adjust the viscosity of the liquid to a range of 6 to 10 mPa·s, thereby producing coating liquids F-2 and F-3 for forming a resin layer. Here, PBM means “Parts by mass”.

TABLE 74

| | Hydroxyl- | | Isocyanate- | | | | | | |
|---|---|---|---|---|---|---|---|---|---|
| | terminated | | terminated | | | | | | |
| | urethane | | urethane | | | | Carbon | Coarse | |
| | prepolymer | | prepolymer | | Additive | | black | particles | |
| | No. | PBM | No. | PBM | No. | PBM | PBM | No. | PBM |
| F-1 | C-1 | 100 | D-2 | 54.7 | E-1 | 7 | 35 | H-1 | 23 |
| F-2 | C-2 | 100 | D-1 | 54.7 | E-1 | 7 | 35 | H-1 | 23 |
| F-3 | C-3 | 100 | D-2 | 54.7 | E-1 | 7 | 35 | H-1 | 23 |

### [2-5. Production of Developing Roller]

In the present example, a developing roller in which an elastic roller provided with an elastic layer formed on an outer surface of a substrate is coated with a resin layer will be described, but the present disclosure is not limited to this configuration.

### <2-5-1. Preparation of Substrate>

As a substrate, a stainless steel (SUS304) core metal having a diameter of 6 mm was prepared by applying a primer (trade name: DY35-051, manufactured by Dow Toray Co., Ltd.) to a peripheral surface of the core metal and baking the primer.

### <2-5-2. Preparation of Elastic Layer>

The substrate was placed in a mold, and an addition-type silicone rubber composition obtained by mixing the materials shown in Table 75 was injected into a cavity formed in the mold.

TABLE 75

| | Parts |
|---|---|
| Material | by mass |
| Liquid silicone rubber | 100 |
| (trade name: SE6724 A/B, Dow Toray Co., Ltd.) | |
| Carbon black | 16 |
| (trade name: TOKABLACK #4300, Tokai Carbon Co., Ltd.) | |
| Curing control agent | 0.01 |
| (trade name: 1-Ethenyl-1-cyclohexanol, | |
| Tokyo Chemical Industry Co., Ltd.) | |
| Platinum catalyst | 0.01 |
| (trade name: SIP6830.3, Gelest, Inc.) | |

Subsequently, the mold was heated to vulcanize and cure the silicone rubber at a temperature of 150° C. for 15 minutes, and the silicone rubber was demolded and then further heated at a temperature of 180° C. for 1 hour to complete the curing reaction, thereby obtaining an elastic roller in which an elastic layer having a diameter of 11.5 mm was provided on the outer periphery of the substrate.

### <2-5-3. Preparation of Resin Layer>

The elastic roller was held at its upper end with the longitudinal direction oriented vertically and was immersed (dipped) into the coating liquid F-1 for forming a resin layer, thereby coating the surface of the elastic roller with the coating liquid. The obtained coated product was air-dried at normal temperature for 30 minutes, and then dried in a hot air circulating dryer set at 160° C. for 1 hour. In this manner, a developing roller G-1 in which a resin layer having a thickness of 12 μm was formed on the elastic layer was obtained.

### <2-5-4. Details of Method for Measuring Characteristics of Developing Roller>

### (Measurement of Impedance)

The impedance was measured as follows. First, as a pretreatment, vacuum platinum vapor deposition was performed on the developing roller G-1 while rotating, thereby preparing a measurement electrode. For vapor deposition, a vacuum vapor deposition apparatus having a mechanism for holding and rotating a substrate portion of a roller as an object to be deposited in a circumferential direction was used, a roller rotational speed, a vapor deposition distance, and a vapor deposition time were controlled, and vapor deposition was performed so that a film thickness was 100 nm or more. At this time, an electrode having a width of 1.5 cm was produced using a masking tape. By forming the electrode with a film thickness of 100 nm or more, it is possible to minimize the effect of the surface roughness of the developing roller on the contact area between the measurement electrode and the developing roller.

Next, an aluminum sheet was wound around the electrode without any gap, and the aluminum sheet was connected to measurement electrodes of an impedance measuring apparatus (trade names: Solartron 1260 and Solartron 1296, manufactured by Solartron) and a high-voltage system (trade names: 6792 and HVA-500, manufactured by Toyo Corporation).

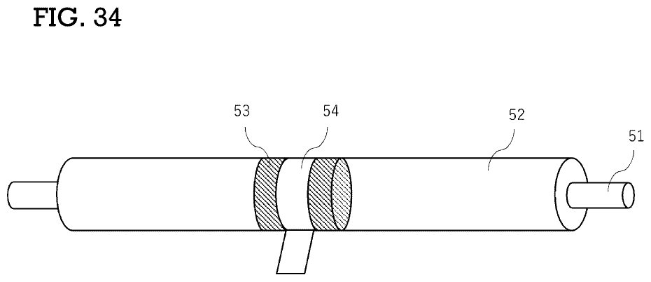

FIG. 34 is a schematic view of a state in which measurement electrodes are formed on the developing roller. In the drawing, reference numeral 51 denotes a conductive substrate, reference numeral 52 denotes a resin layer, reference numeral 53 denotes a platinum vapor-deposited layer, and reference numeral 54 denotes an aluminum sheet. Although the elastic layer is not illustrated in the drawing, the elastic layer is present between the substrate 51 and the resin layer 52.

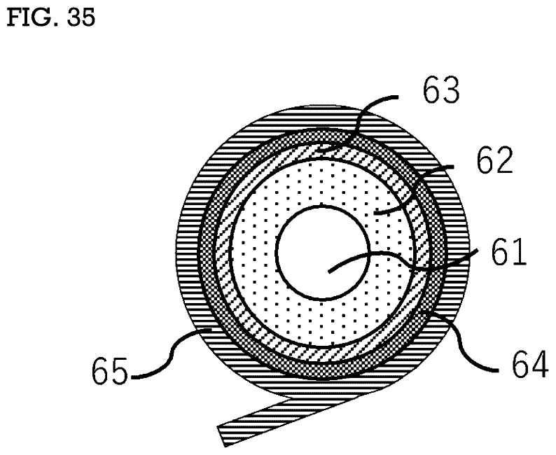

FIG. 35 is a cross-sectional view of a state in which measurement electrodes are formed on the developing roller. Reference numeral 61 denotes a conductive substrate, reference numeral 62 denotes an elastic layer, reference numeral 63 denotes a resin layer, reference numeral 64 denotes a platinum vapor-deposited layer, and reference numeral 65 denotes an aluminum sheet. Thus, it is important that the resin layer is sandwiched between the conductive substrate and the measurement electrode.

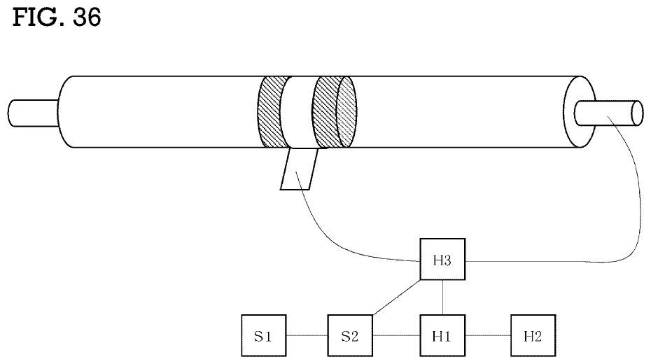

FIG. 36 is a schematic view of the measurement system. The aluminum sheet was connected to measurement electrodes on a side of an impedance measuring apparatus (S1: Solartron 1260, manufactured by Solartron and S2: Solartron 1296, manufactured by Solartron) and a high-voltage system (H1: trade name: 6792, manufactured by TOYO Corporation, H2: trade name: HVA-500, manufactured by TOYO Corporation, and H3: reference box 6796, manufactured by Solartron). Impedance measurement was performed by using the conductive substrate and the aluminum sheet as two electrodes for measurement.

In the impedance measurement, a DC voltage of 50 V and an AC voltage of 50 V were applied in an environment of a temperature of 23° C. and a relative humidity of 50%, and an absolute value of the impedance was obtained at a frequency of 1.0×10⁻¹ to 1.0×10⁵ Hz. Then, the minimum value of the impedance value at a frequency of 1.0×10⁰ to 1.0×10¹ Hz was confirmed. The impedance was measured at the center of the developing roller in the longitudinal direction.

### (Measurement of Surface Potential)

The surface potential of the developing roller was measured using a charge amount measuring apparatus (trade name: DRA-2000L, manufactured by QEA, Inc.) illustrated in FIG. 37. Specifically, in an environment of a temperature of 23° C. and a relative humidity of 50%, a grid portion of a corona discharger of the charge amount measuring apparatus was disposed so as to maintain a gap of 1 mm from the outer surface of the developing roller. The grid portion of the corona discharger of the apparatus has a width of 3.0 mm.

Next, a voltage of 8 kV was applied to the corona discharger, the corona discharger was relatively moved at a speed of 400 mm/sec along the axial direction of the developing roller to charge the surface of the conductive member, and a potential of the outer surface after 0.06 seconds from the passage of the grid was measured. The maximum value among all measurement values obtained at eight positions in the longitudinal direction at 450 intervals in the circumferential direction of the developing roller was adopted.

### 3. Toner

In the present embodiment, toner having a particle diameter of 7 μm and a normal charge polarity that is negative is used. As the toner of the present embodiment, for example, a polymerized toner generated by a polymerization method is employed. In addition, the toner of the present embodiment is a so-called non-magnetic single-component developer that does not contain a magnetic component. The non-magnetic single-component developer is carried on the developing roller mainly by intermolecular force or electrostatic force (image force). In addition, the single-component developer may contain an additive (for example, wax and inorganic fine particles) for adjusting fluidity and charging performance of the toner in addition to the toner particles. The additive may be referred to as an external additive. In the present disclosure, the surface of the toner particles is coated with surface particles or an organosilicon polymer having an electrical conductivity of 1×10⁻¹⁵ S/m or more, which is different from that of the toner base, and toner having a coverage of the surface particles of 35% or more and an adhesion rate of the surface particles of 80% or more is used. The electrical conductivity of the surface particles or the organosilicon polymer is preferably 1.0×10² S/m or less. When the electrical conductivity is greater than 1.0×10² S/m, it is easy to discharge, such that sufficient injection chargeability may not be obtained.

Methods for measuring the electrical conductivity, the coverage, and the adhesion rate will be described below.

In addition, as a method for coating the surface of the toner particles with surface particles or an organosilicon polymer having an electrical conductivity of 1×10⁻¹⁵ S/m or more different from that of the toner base, there is a method for fixing an external additive having an electrical conductivity of 1×10⁻¹⁵ S/m or more to the toner particles. The adhesion rate can be controlled by a material addition order, a temperature during external addition, a rotational speed, and the like when the external additive is added.

Examples of the external additive having an electrical conductivity of 1×10⁻¹⁵ S/m or more include, but are not limited thereto, antimony-tin oxide-titanium oxide, antimony-titanium oxide, antimony-tin oxide, indium-tin oxide, indium-titanium oxide, niobium-tin oxide, niobium-titanium oxide, and zinc oxide.

Next, the organosilicon polymer will be described.

### <Surface Layer Containing Organosilicon Polymer>

When the toner particle has a surface layer containing an organosilicon polymer, the toner particle preferably has a partial structure represented by Formula (1):

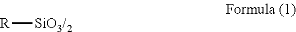

wherein R represents a hydrocarbon group having 1 or more and 6 or less carbon atoms.

In the organosilicon polymer having the structure of Formula (1), one of the four valences of Si atoms is bonded to R, and the remaining three are bonded to O atoms. The O atom is in a state where both of its two valences are bonded to Si, that is, forming a siloxane bond (Si—O—Si). Considering the Si atom and the O atom in the organosilicon polymer, there are three O atoms for every two Si atoms, and therefore, it is expressed as —SiO_{3/2}.

As an example of producing the organosilicon polymer, a sol-gel method is preferable. The sol-gel method is a method in which a liquid raw material is used as a starting material, is subjected to hydrolysis and condensation polymerization, and is converted into a gel through a sol state, and is used to synthesize glass, ceramics, organic-inorganic hybrids, or nanocomposites. By using the production method, functional materials having various shapes such as a surface layer, a fiber, a bulk body, and fine particles can be produced from a liquid phase at a low temperature.

Specifically, the organosilicon polymer present on the surface layer of the toner particles is preferably produced by hydrolysis and polycondensation of a silicon compound represented by alkoxysilanes.

Furthermore, since the sol-gel method starts from a liquid and forms a material by gelating the liquid, various microstructures and shapes can be formed. In particular, when toner particles are produced in an aqueous medium, the hydrophilicity imparted by hydrophilic groups such as silanol groups of organosilicon compounds makes it easier for them to precipitate onto the surface of the toner particles. The microstructure and shape can be adjusted by the reaction temperature, the reaction time, the reaction solvent, the pH, the type and amount of the organometallic compound, and the like.

The organosilicon polymer on the surface layer of the toner particles is preferably a condensation polymer of an organosilicon compound having a structure represented by the following Formula (Z).

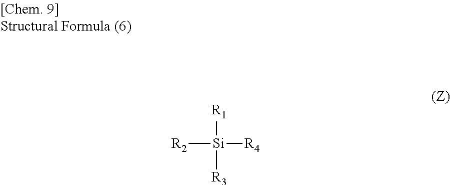

In Formula (Z), R1 represents a hydrocarbon group having 1 or more and 6 or less carbon atoms, and R2, R3, and R4 each independently represent a halogen atom, a hydroxy group, an acetoxy group, or an alkoxy group.

Hydrophobicity can be improved by the hydrocarbon group (preferably an alkyl group) of R1, and toner particles having excellent environmental stability can be obtained. In addition, as the hydrocarbon group, an aryl group which is an aromatic hydrocarbon group, for example, a phenyl group can also be used. When the hydrophobicity of R1 is high, the charge amount fluctuations tend to be large in various environments, and thus, R1 is preferably a hydrocarbon group having 1 or more and 3 or less carbon atoms and more preferably a methyl group in view of environmental stability.

R2, R3, and R4 are each independently a halogen atom, a hydroxy group, an acetoxy group, or an alkoxy group (hereinafter, also referred to as a reactive group). These reactive groups undergo hydrolysis, addition polymerization, and condensation polymerization to form a crosslinked structure, making it possible to obtain toner having excellent member contamination resistance and development durability. Since the hydrolyzability is moderate at room temperature, and from the viewpoint of precipitation onto and coverage of the surface of toner particles, an alkoxy group having 1 to 3 carbon atoms is preferable, and a methoxy group or an ethoxy group is more preferable. In addition, the hydrolysis, addition polymerization, and condensation polymerization of R2, R3, and R4 can be controlled by the reaction temperature, reaction time, reaction solvent, and pH.

In order to obtain the organosilicon polymer used in the present disclosure, one or a plurality of organosilicon compounds (hereinafter, also referred to as trifunctional silanes) having three reactive groups (R2, R3, and R4) in one molecule excluding R1 in Formula (Z) may be used alone or in combination. Furthermore, a content of the organosilicon polymer in the toner particles is preferably 0.5 mass % or more and 10.5 mass % or less.

When the content of the organosilicon polymer is 0.5 mass % or more, the surface free energy of the surface layer can be further reduced, the fluidity is improved, and occurrence of member contamination and fogging can be further suppressed. When the content is 10.5 mass % or less, charge-up is less likely to occur. The content of the organosilicon polymer can be controlled by the type and amount of the organosilicon compound used for forming the organosilicon polymer, the method for producing toner particles during formation of the organosilicon polymer, the reaction temperature, the reaction time, the reaction solvent, and the pH.

The surface layer containing the organosilicon polymer and the toner core particles are preferably in contact with each other without any gap. As a result, the occurrence of bleeding caused by internal resin components or release agents, rather than from the surface layer of the toner particles, can be suppressed, making it possible to obtain toner having excellent storage stability, environmental stability, and development durability.

### [3-1. Method for Producing Toner Particles]

As a method for producing the toner particles, a known method can be used, and a kneading and pulverizing method or a wet production method can be used. A wet production method can be preferably used from the viewpoint of uniformity of the particle diameter and shape controllability. Examples of the wet production method include a suspension polymerization method, a dissolution suspension method, an emulsion polymerization aggregation method, and an emulsion aggregation method.

Here, a suspension polymerization method will be described. In the suspension polymerization method, first, a polymerizable monomer composition, in which a polymerizable monomer for producing a binder resin, a colorant, and if necessary, other additives are uniformly dissolved or dispersed using a dispersing machine such as a ball mill or an ultrasonic dispersing machine, is prepared (step of preparing a polymerizable monomer composition).

At this time, a polyfunctional monomer, a chain transfer agent, a wax as a release agent, a charge control agent, a plasticizer, and the like can be appropriately added as necessary.

Next, the polymerizable monomer composition is added to an aqueous medium prepared in advance, and droplets formed of the polymerizable monomer composition are formed into toner particles with a desired size by a stirrer or a disperser having a high shear force (granulation step).

It is preferable that the aqueous medium used in the granulation step contains a dispersion stabilizer in order to control the particle diameter of the toner particles, to sharpen the particle size distribution, and to suppress coalescence of the toner particles in the production process. The dispersion stabilizer is generally roughly classified into a polymer that exhibits a repulsive force due to steric hindrance and a poorly water-soluble inorganic compound that achieves dispersion stabilization through an electrostatic repulsive force. Since the fine particles of the poorly water-soluble inorganic compound are dissolved with an acid or an alkali, the fine particles can be dissolved and easily removed by washing with an acid or an alkali after polymerization, and thus are suitably used.

After the granulation step or during the granulation step, the polymerizable monomer contained in the polymerizable monomer composition is polymerized at a temperature of preferably 50° C. or higher and 90° C. or lower to obtain a toner particle dispersion (polymerization step).

In the polymerization step, it is preferable to perform a stirring operation so that the temperature distribution in the container becomes uniform. When a polymerization initiator is added, the polymerization can be performed at any timing and for a required time. In addition, the temperature may be raised in the latter stage of the polymerization reaction for the purpose of obtaining a desired molecular weight distribution, and further, in order to remove unreacted polymerizable monomers, by-products, and the like from the system, a portion of the aqueous medium may be distilled off by distillation operation in the latter stage of the reaction or after the completion of the reaction. The distillation operation can be performed under normal pressure or reduced pressure.

The toner particles preferably have a weight average particle diameter of 3.0 μm or more and 10.0 μm or less from the viewpoint of obtaining a high-definition and high-resolution image. The weight average particle diameter of the toner can be measured by a pore electrical resistance method. For example, it can be measured using “Coulter Counter Multisizer 3” (manufactured by Beckman Coulter, Inc.). The toner particle dispersion thus obtained is sent to a filtration step of solid-liquid separating the toner particles and the aqueous medium.

The solid-liquid separation for obtaining toner particles from the obtained toner particle dispersion can be performed by a general filtration method, and thereafter, in order to remove foreign substances that could not be completely removed from the surface of the toner particles, it is preferable to further perform washing by reslurrying, rinsing with washing water, or the like. After sufficient washing is performed, solid-liquid separation is performed again to obtain a toner cake. Thereafter, the toner particles are dried by a known drying method, and if necessary, a group of particles having a predetermined particle diameter is separated by classification to obtain toner particles. At this time, the group of particles having particle diameters outside the predetermined range that are separated may be reused to improve the final yield.

In the case of forming a surface layer having an organosilicon polymer, when forming toner particles in an aqueous medium, the surface layer can be formed by adding a hydrolyzed solution of an organosilicon compound as described above while performing a polymerization step or the like in the aqueous medium. The surface layer may be formed by using the dispersion of the toner particles after polymerization as a core particle dispersion and adding a hydrolyzed solution of an organosilicon compound. In addition, in a case where a non-aqueous medium is used, such as a kneading and pulverizing method, the obtained toner particles can be dispersed in an aqueous medium and used as a core particle dispersion, and the hydrolyzed solution of an organosilicon compound can be added as described above to form the surface layer.

### [3-2. Methods for Measuring Various Properties of Toner Particles]

### <Method for Measuring Adhesion Rate of Surface Particles (External Additive) or Organosilicon Polymer>

160 g of sucrose (manufactured by Kishida Chemical Co., Ltd.) is added to 100 mL of ion-exchanged water and dissolved while heating in a water bath to prepare a sucrose concentrate. In a centrifuge tube (capacity: 50 ml), 31 g of the concentrated sucrose solution and 6 mL of Contaminon N (a 10 mass % aqueous solution of a neutral detergent for precision instrument cleaning at pH 7, containing a nonionic surfactant, an anionic surfactant, and an organic builder, manufactured by Wako Pure Chemical Industries, Ltd.) are added to prepare a dispersion. 1.0 g of toner is added to the dispersion, and the toner lumps are broken up using a spatula or the like.

The centrifuge tube is shaken with a shaker at 350 spm (strokes per min) for 20 minutes. After shaking, the solution is transferred to a glass tube for a swing rotor (volume: 50 mL), and then centrifuged at 3,500 rpm for 30 minutes using a centrifuge (H-9R, manufactured by KOKUSAN Co., Ltd.). It is visually confirmed that the toner and the aqueous solution are sufficiently separated, and the toner separated to the uppermost layer is collected using a spatula or the like. The aqueous solution containing the collected toner is filtered using a vacuum filtration device and then dried in a dryer for 1 hour or longer. The dried product is crushed using a spatula, and the adhesion rate (%) is calculated using fluorescent X-rays. The measurement of fluorescent X-rays of each element conforms to JIS K 0119-1969, and the details are as follows.

As the measuring apparatus, a wavelength-dispersive fluorescent X-ray analyzer “Axios” (manufactured by PANalytical) and the dedicated attached software “SuperQ ver. 4.0F” (manufactured by PANalytical) for measurement condition setting and measurement data analysis are used. Note that Rh is used as the anode of the X-ray tube, the measurement atmosphere is vacuum, the measurement diameter (collimator mask diameter) is 10 mm, and the measurement time is 10 seconds. In addition, a proportional counter (PC) is used to measure light elements, and a scintillation counter (SC) is used to measure heavy elements.

As a measurement sample, about 1 g of the toner after washing with water and the initial toner is placed in a dedicated aluminum ring for pressing having a diameter of 10 mm and leveled, and a pellet formed to a thickness of about 2 mm is prepared by pressing at 20 MPa for 60 seconds using a tablet molding press “BRE-32” (manufactured by Maekawa Testing Machine Mfg, Co., Ltd.).

X-ray fluorescence analysis was performed under the above conditions, and the adhesion rate of the external additive or the organosilicon polymer was calculated using the following formula.

$$Adhesion rate ( \% ) of surface particles ( external additive ) or organosilicon polymer = ( elemental intensity derived from external additive or organosilicon polymer in toner after treatment / elemental intensity derived from external additive or organosilicon polymer in toner before treatment ) \times 100$$

### <Method for Calculating Coverage of Surface of Toner Particle>

### (Method for Acquiring Reflected Electron Image on Surface of Toner Particle)

The coverage of the toner particle surface by the external additive or the organosilicon polymer is calculated using a reflected electron image of the toner particle surface.

The reflected electron image of the surface of the toner particles is acquired using a scanning electron microscope (SEM). The reflected electron image obtained from the SEM is also called a “composition image”, and elements with a smaller atomic number are detected darker, while elements with a larger atomic number are detected brighter.

The toner particles are generally resin particles mainly containing a composition containing carbon as a main component, such as a resin component and a release agent. When the external additive or the organosilicon polymer is present on the surface of the toner particles, in the reflected electron image obtained from the SEM, the external additive or the organosilicon polymer is observed as a bright area and the surface of the toner core particles is observed as a dark area.

The SEM apparatus and observation conditions are as follows.
Apparatus used: ULTRAPLUS manufactured by Carl Zeiss Microscopy, Co., Ltd.
Acceleration voltage: 1.0 kV
WD: 2.0 mm
Aperture Size: 30.0 m
Detection signal: EsB (energy-selective reflection electron)
EsB Grid: 800 V
Observation magnification: 50,000×
Contrast: 63.0±5.0% (reference value)
Brightness: 38.0±5.0% (reference value)
Image size: 1,024×768 pixels
Pretreatment: Toner particles are scattered on carbon tape (no vapor deposition is performed)

The contrast and the brightness are appropriately set according to the state of the apparatus used. In addition, the acceleration voltage and EsB Grid are set so as to achieve items such as acquisition of structure information of the outermost surface of the toner particles, prevention of charge-up of an uncoated sample, and selective detection of high-energy backscattered electrons. The observation field of view is selected near the apex of the toner particle where the curvature is smallest.

(Method for Confirming that Bright Area in Reflected Electron Image is Derived from External Additive or Organosilicon Polymer)

It is confirmed that the bright area in the observed reflected electron image is derived from the external additive or the organosilicon polymer by superimposing the elemental mapping image obtained by energy-dispersive X-ray spectroscopy (EDS) with a scanning electron microscope (SEM) on the reflected electron image.

The SEM/EDS apparatus and observation conditions are as follows.
Apparatus (SEM) used: ULTRAPLUS, manufactured by Carl Zeiss Microscopy, Co., Ltd.
Apparatus (EDS) used: NORAN, manufactured by Thermo Fisher Scientific Inc.
System7, Ultra Dry EDS Detector
Acceleration voltage: 5.0 kV
WD: 7.0 mm
Aperture Size: 30.0 μm
Detection signal: SE2 (secondary electron)
Observation magnification: 50,000×
Mode: Spectral Imaging
Pretreatment: Toner particles are scattered on carbon tape and platinum sputtering is performed.

The mapping image of the inorganic elements derived from the external additive or the organosilicon polymer obtained by the present method is superimposed on the reflected electron image, and it is confirmed that the inorganic atom region of the mapping image and the bright area of the reflected electron image coincide with each other. An area where both the inorganic atom region and the carbon atom region of the mapping image coincide with the bright area of the reflected electron image is regarded as the external additive or the organosilicon polymer.

Note that the organosilicon polymer and silica are distinguished by confirming that a region containing both silicon atoms and carbon atoms correspond to the organosilicon polymer.

### (Method for Calculating Coverage of Surface of Toner Particles by Surface Particles (External Additive) or Organosilicon Polymer)

The coverage is calculated based on an uncoated domain D1, which is not covered by the external additive or the organosilicon polymer, and a coated domain D2, which is covered by the external additive or the organosilicon polymer. The analysis of the domains D1 and D2 is performed using the image processing software ImageJ (developed by Wayne Rashand) on the reflected electron image of the outermost surface of the toner particles obtained by the above method. The procedure is described below.

First, the reflected electron image to be analyzed is converted into 8-bit from Type in the Image menu. Next, the Median radius is set to 2.0 pixels under Filters in the Process menu to reduce image noise. After the observation condition display section shown at the bottom of the reflected electron image is excluded, the center of the image is estimated, and a 1.5 μm square area from the center of the reflected electron image is selected using the Rectangle Tool on the toolbar.

Next, using the Freehand selections function in the Image menu, only the areas where the carbon atom regions of the mapping image and the dark areas of the reflected electron image coincide are selected, and all these areas are filled with black. In addition, all the areas other than the areas where the carbon atom regions of the mapping image coincide with the dark areas of the reflected electron image are filled with white. Next, Threshold is selected from Adjust. In manual operation, 128, which is the midpoint gray level between black and white in an 8-bit image, is selected as the threshold, and Apply is clicked to obtain a binarized image. By this operation, the pixels corresponding to the uncoated domain D1 (toner core particles) are displayed in black (pixel group A1), and the pixels corresponding to the coated domain D2 (external additive or organosilicon polymer) are displayed in white (pixel group A2).

Once again, after the observation condition display section shown at the bottom of the reflected electron image is excluded, the center of the image is estimated, and a 1.5 μm square area from the center of the reflected electron image is selected using the Rectangle Tool on the toolbar.

Next, the scale bar in the observation condition display section displayed at the bottom of the reflected electron image is selected using the Straight Line tool (Straight Line) on the toolbar. In this state, when Set Scale is selected from the Analyze menu, a new window opens, and the pixel distance of the selected straight line is entered in the Distance in Pixels field.

A value of the scale bar (for example, 100) is entered in the Known Distance field of the window, a unit of the scale bar (for example, nm) is entered in the Unit of Measurement field, and when OK is clicked, scale setting is completed.

Subsequently, Set Measurements is selected from the Analyze menu, and Area and Feret's diameter are checked. Analyze Particles is selected from the Analyze menu, Display Result is checked, and OK is clicked to perform domain analysis.

Areas (Area) for each domain corresponding to the uncoated domain D1 formed by the pixel group A1 and the coated domain D2 formed by the pixel group A2 are acquired from the newly opened Results window.

The total area of the uncoated domain D1 obtained is defined as S1 (μm²), and the total area of the coated domain D2 is defined as S2 (μm²). The coverage S is calculated from the obtained S1 and S2 using the following equation.

S (area %)={S2/(S1+S2)}×100

The above procedure is performed on 10 fields of view for the toner particles to be evaluated, and the arithmetic mean value thereof is used as the coverage.

### <Method for Measuring Conductivity of Surface Particles (External Additive) or Organosilicon Polymer>

160 g of sucrose (manufactured by Kishida Chemical Co., Ltd.) is added to 100 mL of ion-exchanged water and dissolved while heating in a water bath to prepare a sucrose concentrate. In a centrifuge tube (capacity: 50 ml), 31 g of the concentrated sucrose solution and 6 mL of Contaminon N (a 10 mass % aqueous solution of a neutral detergent for precision instrument cleaning at pH 7, containing a nonionic surfactant, an anionic surfactant, and an organic builder, manufactured by Wako Pure Chemical Industries, Ltd.) are added to prepare a dispersion. 1.0 g of toner is added to the dispersion, and the toner lumps are broken up using a spatula or the like.

The centrifugal tube is shaken using a shaker (MIGHTYSHAKERAS-1N, manufactured by AS ONE Corporation) at a shaking speed of 300 rpm and a shaking width of 40 mm for 20 minutes.

After shaking, the solution is transferred to a glass tube for a swing rotor (volume: 50 mL), and then centrifuged at 3,500 rpm for 30 minutes using a centrifuge (H-9R, manufactured by KOKUSAN Co., Ltd.). It is visually confirmed that the toner and the aqueous solution are sufficiently separated, and the toner separated to the uppermost layer is collected using a spatula or the like. The resin component of the toner core particles in the collected sample washed with water is burned in air to collect surface particles (external additive) or an organosilicon polymer (hereinafter, referred to as “powder”). The volume resistance of the collected material is measured as follows.

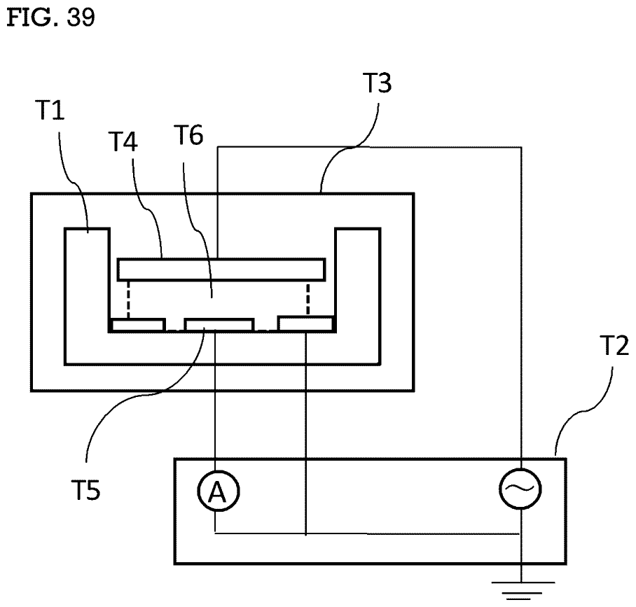

The capacitance and conductivity of air and powder are measured by impedance measurement using a parallel plate capacitor method (FIG. 39).

As the apparatuses, a measurement jig including a four-terminal sample holder SH2-Z (manufactured by TOYO Corporation) (T1) and a torque wrench adapter SH-TRQ-AD (optional) (not illustrated), and a material test system ModuLab XM MTS (manufactured by Solartron) (T2) are used. In addition, a noise-cut transformer NCT-I3 1.4 kVA (manufactured by DENKENSEIKI Research Institute Co., Ltd.) (not illustrated) for suppressing commercial power supply noise and a shield box (T3) for suppressing electromagnetic wave noise are used.

The measurement jig uses a four-terminal sample holder T3 and an optional torque wrench adapter SH-TRQ-AD (not illustrated) and employs parallel plate electrodes including an upper electrode (solid electrode 25 mm in diameter) SH-H25AU (T4) and a lower electrode for liquid/powder (center electrode 10 mm in diameter; guard electrode 26 mm in diameter) SH-2610AU (T5). The configuration enables measurement of a resistance of 0.1Ω to 1 TΩ for an electrical signal up to 500 Vp-p from DC to 1 MHz (FIG. 39).

In addition, in order to adjust the pressure of the sample, a torque wrench adapter SH-TRQ-AD (manufactured by TOYO Corporation) is attached to a micrometer provided in the four-terminal sample holder T1, which is used to measure the film thickness between the upper and lower electrodes. For a torque driver used for pressure control, a torque driver RTD30CN (manufactured by Tohnichi Mfg. Co., Ltd.) and a 6.35 mm square bit are used, such that a configuration capable of controlling the tightening torque at 20.0 cN·m is provided.

In the measurement of the electrical AC characteristics, impedance measurement is performed using a material test system ModuLab XM MTS (manufactured by Solartron) T2. The ModuLab XM MTS (T2) includes a control module XM MAT 1 MHz, a high voltage module XM MHV100, a femto-current module XM MFA, and a frequency response analysis module XM MRA 1 MHz, and uses the control software XM-studio MTS Ver. 3.4 manufactured by the same company. The measurement conditions are set to Normal Mode for measurement only, with an AC level of 0.5 Vrms, a DC bias of 0 V, and a sweep frequency from 1 MHz to 0.01 Hz (12 points/decade or 6 points/decade).

Furthermore, in consideration of noise suppression and reduction in measurement time, the following settings are added for each sweep frequency.
Sweep frequency from 1 MHz to 10 Hz, measurement integration time of 64 cycles
Sweep frequency from 10 Hz to 1 Hz, measurement integration time of 24 cycles
Sweep frequency from 1 Hz to 0.01 Hz, measurement integration time of 1 cycle

The impedance characteristics, which are the electrical AC characteristics of the powder T6, are measured under the above measurement conditions.

By performing the measurement under the above conditions, using a powder measurement jig based on the parallel plate capacitor method, the impedance characteristics of the air and the powder T6 at a film thickness d corresponding to the applied torque can be obtained using the measurement electrode S having a diameter of 10 mm. From the obtained impedance characteristics of the air and the powder T6, data correction processing of the measurement system is performed to obtain highly reliable capacitance C and conductance (electrical conductivity) G. From the obtained capacitance C, conductance (electrical conductivity) G, and the geometrical dimensions of the toner measurement jig (the electrode size S of the parallel plates and the sample film thickness), the dielectric constant and conductivity, which are electrical physical properties, are obtained.

When the four-terminal sample holder SH2-Z (T1) is used for the first time, there is an individual difference in the four-terminal sample holder SH2-Z (T1) used for the powder measurement jig, and thus, it is necessary to perform two verifications in advance to identify optimal measurement conditions.

The first verification is related to the film thickness-dependent characteristics of the four-terminal sample holder (T1). The dependence on the thickness of air (distance between the upper and lower electrodes) is measured, the error between the theoretical and measured values of the capacitance is confirmed, and the optimal range or film thickness value that minimizes the measurement error is identified.

The second verification is the measurement of mechanical error. For the measurement of the sample, a load controlled by torque is applied to maintain a constant volume density. In contrast, in the measurement of air, there is no load. At this time, a film thickness error occurs due to the influence of dimensions such as mechanical machining accuracy. Therefore, the offset value between the load state and the no-load state of the tightening torque control value (6.5 cN·m for this jig) is confirmed and used as the offset correction value.

Specific procedures for sample preparation and measurement are as follows.
(1) The powder T6 is placed on the central electrode portion of the lower electrode, and the powder T6 is formed into a trapezoidal shape having a height of 5 mm.
(2) The lower electrode on which the powder T6 is placed is attached to the four-terminal sample holder SH2-Z (T1), and the upper electrode is lowered.
(3) At this time, the upper electrode T4 is lowered to the upper end of the powder while being kept steady so as not to rotate unintentionally.
(4) The upper electrode T4 is rotated left and right to smooth the powder T6.
(5) Using a micrometer, the film thickness is adjusted to a predetermined film thickness, while keeping the rotation direction of the upper electrode T4 consistent in one direction.
(6) Pressurization is performed using a torque driver suitable for the powder T6.
(7) The sample film thickness is measured using a micrometer.
(8) The impedance measurement is performed under the above conditions.
(9) After the measurement is completed, the upper electrode T4 is raised, and the lower electrode T5 is removed. At this time, the lower electrode is removed with sufficient care so that the powder T6 does not enter the lower electrode contact terminal of the four-terminal sample holder T1, and the lower electrode is protected with a masking tape.
(10) The upper and lower electrodes are cleaned.
(11) The masking tape is removed, and the lower electrode T5 is attached.
(12) The sample film thickness d obtained in step (7) is adjusted so as to be the thickness t of air in consideration of the offset correction in the unloaded state, and the rotation direction of the upper electrode is kept consistent in one direction.
(13) The impedance measurement of air is performed.
(14) When the measurement data of air (dielectric loss tangent; tan δ) measured in step (13) is 0.002 or more in the frequency range of 100 Hz to 0.01 Hz, the cleaning is insufficient, and thus, the operation is performed again from the cleaning process in step (10).

A specific data processing procedure is as follows.
(15) From the measured impedance characteristic of the air, an error in the phase characteristics with respect to the theoretical value is calculated, and phase correction data for the material test system ModuLab XM MTS (manufactured by Solartron) is obtained.
(16) The phase correction data calculated in step (15) is applied to the impedance characteristics of the air measured in step (13) to obtain the impedance characteristics of the air after phase correction processing.
(17) The capacitance Ca is calculated from the admittance Ya=Ga+jωCa of the phase-corrected impedance characteristics of air, and an error from the theoretical value is calculated to obtain correction data a for the film thickness error.
(18) The phase correction processing obtained in step (15) is applied to the impedance characteristics of the powder sample measured in step (8).
(19) By performing calculation on the complex admittance Ym=Gm+jωCm of the phase-corrected characteristics in step (18) using the capacitance Ca of air and its correction data a obtained in step (17), highly reliable relative permittivity and conductivity of the powder sample can be obtained. The electrical conductivity in the present disclosure is a value of conductivity at a frequency of 0.01 Hz.

Hereinafter, the produced toner will be described.

### [3-3. Production Example of Toner]

### <Toner 1>

### (Step of Preparing Aqueous Medium 1)

To 1,000.0 parts of ion-exchanged water in a reaction vessel, 14.0 parts of sodium phosphate (dodecahydrate, manufactured by Rasa Kogyo Co., Ltd.) was added, and the mixture was maintained at 65° C. for 1.0 hours while purging with nitrogen.

Using T.K. Homomixer (manufactured by Tokushu Kika Kogyo Co., Ltd.), an aqueous calcium chloride solution prepared by dissolving 9.2 parts of calcium chloride (dihydrate) in 10.0 parts of ion-exchanged water was collectively added while stirring at 12,000 rpm to prepare an aqueous medium containing a dispersion stabilizer. Furthermore, 10 mass % hydrochloric acid was added to the aqueous medium to adjust the pH to 5.0, thereby obtaining an aqueous medium 1.

### (Hydrolysis Step of Organosilicon Compound for Surface Layer)

In a reaction vessel equipped with a stirrer and a thermometer, 60.0 parts of ion-exchanged water was weighed, and the pH was adjusted to 3.0 using 10 mass % hydrochloric acid. Heating was performed with stirring and the temperature was brought to 70° C. Thereafter, 40.0 parts of methyltriethoxysilane, which is an organosilicon compound for a surface layer, was added, and the mixture was stirred for 2 hours or longer to perform hydrolysis. The end point of the hydrolysis was visually confirmed by observing that the oil and water did not separate and formed into a single layer, and cooling was performed to obtain a hydrolyzed solution of the organosilicon compound for a surface layer.

### (Preparation Step of Polymerizable Monomer Composition)

Styrene: 60.0 parts
Carbon black (Nipex 35): 6.0 parts

The materials were charged into an attritor (manufactured by Mitsui Miike Machinery Co., Ltd.), and further dispersed at 220 rpm for 5.0 hours using zirconia particles having a diameter of 1.7 mm to prepare a pigment dispersion. The following materials were added to the pigment dispersion.
Styrene: 20.0 parts
n-Butyl acrylate: 20.0 parts
Crosslinking agent (divinylbenzene): 0.3 parts
Saturated polyester resin: 5.0 parts
(Polycondensate of propylene oxide-modified bisphenol A (2 mol adduct) and terephthalic acid (molar ratio of 10:12), glass transition temperature Tg=68° C., weight average molecular weight Mw=10,000, molecular weight distribution Mw/Mn=5.12)
Fischer-Tropsch wax (melting point: 78° C.): 7.0 parts

It was kept at 65° C. and uniformly dissolved and dispersed at 500 rpm using a T.K. Homomixer (manufactured by Tokushu Kika Kogyo Co., Ltd.) to prepare a polymerizable monomer composition.

### (Granulation Step)

While maintaining the temperature of the aqueous medium 1 at 70° C. and the rotational speed of the T.K. Homomixer at 12,000 rpm, the polymerizable monomer composition was charged into the aqueous medium 1, and 9.0 parts of t-butyl peroxypivalate as a polymerization initiator was added. Granulation was performed for 10 minutes while maintaining 12,000 rpm with the stirring apparatus as it was.

### (Polymerization Step)

After the granulation step, the stirrer was changed to a propeller-type impeller, polymerization was performed at 70° C. for 5.0 hours while stirring at 150 rpm, the temperature was raised to 85° C., and heating was performed for 2.0 hours to perform a polymerization reaction, thereby obtaining core particles. The temperature of the slurry was cooled to 55° C., and the pH was measured. As a result, the pH was 5.0. While stirring was continued at 55° C., 15.0 parts of the hydrolyzed solution of the organosilicon compound for a surface layer was added to initiate the formation of the toner surface layer. After holding as is for 30 minutes, the slurry was adjusted to pH 9.0 for completing condensation using an aqueous sodium hydroxide solution, and then further held for 300 minutes to form the surface layer.

### (Washing and Drying Step)

After completion of the polymerization step, the slurry of the toner particles was cooled, hydrochloric acid was added to the slurry of the toner particles to adjust the pH to 1.5 or less, the mixture was stirred and left to stand for 1 hour, and then solid-liquid separation was performed with a pressure filter to obtain a toner cake. This was reslurried with ion-exchanged water to form a dispersion again, and then solid-liquid separation was performed using the filter described above. The reslurrying and solid-liquid separation were repeated until the electrical conductivity of the filtrate became 5.0 μS/cm or less, and finally solid-liquid separation was performed to obtain a toner cake.

The obtained toner cake was dried using an air-stream dryer (Flash jet drier, manufactured by Seishin Enterprise Co., Ltd.), and the fine and coarse powder was cut using a multi-division classifier utilizing the Coanda effect to obtain toner particles 1. The drying conditions were set with a blowing temperature of 90° C. and a dryer outlet temperature of 40° C., and the feed rate of the toner cake was adjusted according to a moisture content of the toner cake so that the outlet temperature did not deviate from 40° C. In the present production example, the obtained toner particles 1 were used as toner 1 without adding an external additive.

The evaluation performed on the toner 1 will be described below.

### Method for Measuring Adhesion Rate

The measurement was performed by the method described in <Method for measuring adhesion rate of surface particles (external additive) or organosilicon polymer>. The evaluation results are shown in Tables 77-3 and 77-4.

### Method for Measuring Coverage

The measurement was performed by the method described in <Method for measuring coverage of surface of toner particles>. The evaluation results are shown in Tables 77-3 and 77-4.

### Method for Measuring Conductivity

The measurement was performed by the method described in <Method for measuring conductivity of surface particles (external additive) or organosilicon polymer>. The evaluation results are shown in Tables 77-3 and 77-4.

### Evaluation of Toner Shape Irregularity

The evaluation of toner shape irregularity was performed based on the aspect ratio of the toner. For the measurement of the aspect ratio, “FPIA-3000” (manufactured by Sysmex Corporation) which is a flow-type particle image analyzer was used. Measurement is performed under the measurement and analysis conditions during the calibration operation.

After adding an appropriate amount of alkylbenzene sulfonate, which is a surfactant, as a dispersant to 20 mL of ion-exchanged water, 0.02 g of a measurement sample was added, and dispersion treatment was performed for 2 minutes using a benchtop ultrasonic cleaner/disperser (trade name: VS-150, manufactured by VELVO-CLEAR) at an oscillation frequency of 50 kHz and an electric output of 150 W, thereby obtaining a dispersion for measurement. At this time, the dispersion is appropriately cooled so that the temperature of the dispersion is 10° C. to 40° C.

For the measurement, the flow-type particle image analyzer equipped with a standard objective lens (10×) is used, and a particle sheath “PSE-900A” (manufactured by Sysmex Corporation) is used as a sheath liquid. The dispersion prepared according to the above procedure is introduced into the flow-type particle image analyzer, 3,000 toner particles are measured in the total count mode in the HPF measurement mode, the binarization threshold value at the time of particle analysis is set to 85%, the analysis particle diameter is limited to an equivalent circle diameter of 1.98 μm to 19.92 μm, and the aspect ratio of the toner is obtained.

In the measurement, automatic focus adjustment is performed prior to the measurement using standard latex particles (for example, 5100A (trade name) manufactured by Duke Scientific is diluted with ion-exchanged water). Thereafter, it is preferable to perform focus adjustment every two hours from the start of measurement.

TABLE 76-1

| | | | Organosilicon compound | | | |
|---|---|---|---|---|---|---|
| | | | for surface layer | | | |
| | Parts by | Parts by | | Parts by | External additive | |
| | mass of | mass of | | mass of | | Parts |
| | polymerization | crosslinking | | hydrolyzed | | by |
| | initiator | agent | Type | solution | Type | mass |
| Toner 1 | 9.0 | 0.25 | Methyltriethoxysilane | 15 | — | — |
| Toner 2 | 9.0 | 0.25 | Methyltriethoxysilane | 20 | — | — |
| Toner 3 | 9.0 | 0.25 | Methyltriethoxysilane | 25 | — | — |
| Toner 4 | 9.0 | 0.25 | — | — | Titanium oxide | 1 |
| | | | | | (average particle | |
| | | | | | diameter: 30 nm) | |
| Toner 5 | 9.0 | 0.25 | — | — | Barium titanate | 1 |
| | | | | | (average particle | |
| | | | | | diameter: 53 nm) | |

Here, “Electrical conductivity” means “Electrical conductivity of external additive or organosilicon polymer (S/m)”.

TABLE 76-2

| | Adhesion rate of | Coverage of | |
|---|---|---|---|
| | external additive | external additive | Electrical |
| | or organosilicon | or organosilicon | conductivity |
| | polymer (%) | polymer (%) | (S/m) |
| Toner 1 | 91 | 35 | 1.0E−15 |
| Toner 2 | 92 | 45 | 1.0E−15 |
| Toner 3 | 88 | 55 | 1.0E−15 |
| Toner 4 | 82 | 42 | 3.6E−9 |
| Toner 5 | 84 | 41 | 5.6E−5 |

### <Toners 2 and 3>

Toner was prepared in the same manner as in the toner 1, except that the parts by mass of the hydrolyzed solution in the (polymerization step) were changed as shown in Tables 76-1 and 76-2. The measurement results of the obtained toner 2 and toner 3 are shown in Tables 76-1 and 76-2.

### <Toner 4>

Toner particles were prepared in the same manner as in the toner 1, except that the hydrolyzed solution of the organosilicon compound for a surface layer was not added in the (polymerization step). Titanium oxide (average particle diameter: 30 nm) was fixed to the toner particles by external addition to prepare toner 4. As for the external addition method, the external additive in the amount described in Table 65 was added to 100 parts of toner particles, and mixing was performed at 3,000 rpm for 10 minutes using SUPERMIXER PICCOLO SMP-2 (manufactured by KAWATA MFG. CO., LTD.). The measurement results of the obtained toner are shown in Tables 76-1 and 76-2.

### <Toner 5>

Toner was prepared in the same manner as in the toner 4, except that the type of the external additive was changed as shown in Table 76. The measurement results of the obtained toner 5 are shown in Tables 76-1 and 76-2.

### 4. Image Evaluation and Toner Shape Irregularity Evaluation

The developing roller G-1 was mounted as the developing roller 31 of the process cartridge 20 and inserted into the image forming apparatus, and image evaluation was performed. Note that the service life of the process cartridge 20 including the toner capacity is set to be equivalent to 5,500 sheets based on a 5% print coverage on A4 paper.

### [4-1. Black Fogging]

The prepared process cartridge was mounted in the main body of the image forming apparatus, and was left to stand in an environment of a temperature of 30° C. and a relative humidity of 80% for 24 hours. Thereafter, the potential difference between the developing blade and the developing roller was set to −150 V using an external high-voltage power supply, and in the same environment, on the A4 evaluation sheet (GF-C081, manufactured by Canon Inc.), 8,000 sheets of images in which the letter “E” in 4-point size of the alphabet having a print coverage of 2% with respect to the area of the paper were continuously output. The process speed was set to 150 mm/sec in the normal mode. After performing printing of 8,000 sheets, a white image was output immediately after outputting a black image without changing the potential difference between the developing blade and the developing roller, and the process speed.

A reflective density R1 of the recording material before image formation and a reflective density R2 of the recording material on which a white image was output immediately after outputting a black image were measured using a reflection densitometer (trade name: TC-6DS/A, manufactured by Tokyo Denshoku Co., Ltd.), and an increase in reflective density (R2-R1) was taken as the “fogging value” of the developing roller. The reflective density was measured over the entire region of the image printing area of the recording material, and the maximum value was adopted. Note that the smaller the fogging value, the more preferable it is, and normally, toner is not transferred onto a transfer sheet on which a solid white image is formed. In a case where the charge amount of toner is insufficient, the toner moves onto the photosensitive member even at the time of forming a solid white image, and is further transferred onto a transfer sheet to increase the fogging value. The evaluation results are shown in Tables 77-1 and 77-2.

Note that the criteria for determining fogging are as follows.
A: Very good level (fogging of less than 1.0%)
B: Good level (fogging of 1.0% or more and less than 1.5%)
C: Practically acceptable level (fogging of 1.5% or more and less than 2.5%)
D: Acceptable level (fogging of 2.5% or more and less than 3.5%)
E: Practically undesirable level (fogging of 3.5% or more)

### [4-2. Reversal Fogging]

The prepared process cartridge was mounted in the main body of the image forming apparatus, and was left to stand in an environment of a temperature of 30° C. and a relative humidity of 80% for 24 hours. Thereafter, the potential difference between the developing blade and the developing roller was set to −150 V using an external high-voltage power supply, and in the same environment, on the A4 evaluation sheet (GF-C081, manufactured by Canon Inc.), 8,000 sheets of images in which the letter “E” in 4-point size of the alphabet having a print coverage of 2% with respect to the area of the paper were continuously output. The process speed was set to 150 mm/sec in the normal mode. After performing printing of 8,000 sheets, an image-free white image (so-called solid white) was output without changing the potential difference between the developing blade and the developing roller and the process speed.

Using a reflection densitometer (trade name: TC-6DS/A, manufactured by Tokyo Denshoku Co., Ltd.), the reflective density R1 of the recording material before image formation and the reflective density R2 of the recording material on which the solid white image was output were measured, and the increase in reflective density (R2-R1) was taken as the “fogging value” of the developing roller. The reflective density was measured over the entire region of the image printing area of the recording material, and the maximum value was adopted. The evaluation results are shown in Tables 77-1 and 77-2.

Note that the criteria for determining fogging are as follows.
A: Very good level (fogging of less than 1.0%)
B: Good level (fogging of 1.0% or more and less than 1.5%)
C: Practically acceptable level (fogging of 1.5% or more and less than 2.5%)
D: Acceptable level (fogging of 2.5% or more and less than 3.5%)
E: Practically undesirable level (fogging of 3.5% or more)

### [4-3. Evaluation of Image Density Stability]

The prepared process cartridge was mounted in the main body of the image forming apparatus, and was left to stand for 24 hours in an environment of a temperature of 30° C. and a relative humidity of 80%. Thereafter, the potential difference between the developing blade and the developing roller was set to −150 V using an external high-voltage power supply, and one sheet of a 25% halftone image with respect to solid black, 48 sheets of solid white images, and one sheet of a 25% halftone image with respect to solid black were continuously output in this order on A4 evaluation sheet (GF-C081, manufactured by Canon Inc.). The process speed was set to 150 mm/sec in the normal mode. The densities of the obtained halftone images of the first sheet and the 50th sheet were measured using a spectrodensitometer (trade name: 508, manufactured by X-Rite, Inc.), and the density difference between the first sheet and the 50th sheet was obtained. Note that a smaller density difference is preferable. The evaluation results are shown in Tables 77-1 and 77-2.

Note that the criteria for determining image density stability are as follows.
∘: Good level (less than 0.1)
x: Poor level (0.1 or more)

### [4-4. Toner Shape Irregularity Evaluation]

The prepared process cartridge was mounted in the main body of the image forming apparatus, and was left to stand in an environment of a temperature of 30° C. and a relative humidity of 80% for 24 hours. Thereafter, the potential difference between the developing blade and the developing roller was set to −150 V using an external high-voltage power supply, and in the same environment, on the A4 evaluation sheet (GF-C081, manufactured by Canon Inc.), 8,000 sheets of images in which the letter “E” in 4-point size of the alphabet having a print coverage of 2% with respect to the area of the paper were continuously output. The process speed was set to 150 mm/sec. The aspect ratio of the toner remaining in the developing container of the process cartridge after outputting 8,000 images was evaluated by the method described above. Then, the aspect ratio of the toner after image output was divided by the aspect ratio of the initial toner, and a value obtained by multiplying the obtained value by 100 was calculated and used as an evaluation value of the irregularity. This value is 100% when there is no change from the initial value, and the smaller the value, the more the toner has deformed. Here, Ex means Example. “DR No.” means “Developing roller No.”. MVSP means “Maximum value of surface potential [V]”. T means “Toner No.” “EC” means “Electrical conductivity [S/m]”.

TABLE 77-1

| | | | Impedance | | | | | Adhesion |
|---|---|---|---|---|---|---|---|---|
| | | | [Ω] | MVSP | | EC | Coverage | rate |
| Ex | DR No. | X | @1.0 × 10¹ Hz | [V] | T | [S/m] | [%] | [%] |
| 1 | G-1 | 3.2 | 9.12E+06 | 5.7 | 4 | 3.6E−09 | 42 | 82 |
| 2 | G-1 | 3.2 | 9.12E+06 | 5.7 | 1 | 1.1E−15 | 35 | 91 |
| 3 | G-2 | 3.2 | 1.52E+06 | 3.2 | 5 | 5.6E−05 | 44 | 84 |
| 4 | G-2 | 3.2 | 1.52E+06 | 3.2 | 4 | 3.6E−09 | 42 | 82 |
| 5 | G-3 | 3.2 | 2.11E+06 | 3.5 | 1 | 1.1E−15 | 35 | 91 |
| 6 | G-2 | 3.2 | 1.52E+06 | 3.2 | 1 | 1.1E−15 | 35 | 91 |
| 7 | G-1 | 3.2 | 9.12E+06 | 5.7 | 1 | 1.1E−15 | 35 | 91 |
| 8 | G-1 | 3.2 | 9.12E+06 | 5.7 | 1 | 1.1E−15 | 35 | 91 |
| 9 | G-1 | 3.2 | 9.12E+06 | 5.7 | 1 | 1.1E−15 | 35 | 91 |
| 10 | G-1 | 3.2 | 9.12E+06 | 5.7 | 1 | 1.1E−15 | 35 | 91 |
| 11 | G-1 | 3.2 | 9.12E+06 | 5.7 | 1 | 1.1E−15 | 35 | 91 |
| 12 | G-1 | 3.2 | 9.12E+06 | 5.7 | 1 | 1.1E−15 | 35 | 91 |
| 13 | G-1 | 3.2 | 9.12E+06 | 5.7 | 2 | 1.1E−15 | 45 | 92 |
| 14 | G-1 | 3.2 | 9.12E+06 | 5.7 | 3 | 1.1E−15 | 55 | 88 |

Here, Ex means Example. “DV-BV” means “(Developing voltage)-(Blade voltage) [V]”. “Irregularity” means “Evaluation value of irregularity [%]”.

TABLE 77-2

| | | | | | | Image |
|---|---|---|---|---|---|---|
| | DV − BV | Process speed | Irregularity | Black | Reversal | density |
| Ex | [V] | [mm/sec] | [%] | fogging | fogging | stability |
| 1 | −150 V | 150 | 95.7 | C(1.6) | C(1.6) | ◯(0.05) |
| 2 | −150 V | 150 | 95.9 | B(1.3) | B(1.1) | ◯(0.07) |
| 3 | −150 V | 150 | 95.2 | C(1.8) | C(1.6) | ◯(0.04) |
| 4 | −150 V | 150 | 93.9 | C(2.2) | C(1.9) | ◯(0.04) |
| 5 | −150 V | 150 | 96.3 | B(1.1) | B(1.0) | ◯(0.08) |
| 6 | −150 V | 150 | 96.6 | B(1.2) | B(1.0) | ◯(0.06) |
| 7 | −200 V | 150 | 96.9 | A(0.9) | A(0.8) | ◯(0.05) |
| 8 | −100 V | 150 | 94.0 | C(1.9) | C(1.8) | ◯(0.08) |
| 9 | −300 V | 150 | 98.0 | A(0.7) | A(0.6) | ◯(0.05) |
| 10 | −100 V | 50 | 92.7 | D(2.9) | D(2.6) | ◯(0.09) |
| 11 | −150 V | 50 | 94.5 | C(1.8) | C(1.6) | ◯(0.07) |
| 12 | −100 V | 150 or 50 V | 94.8 | C(1.7) | C(1.6) | ◯(0.08) |
| | or −150 V | (same order | | | | |
| | (same order | as left) | | | | |
| | as right) | | | | | |
| 13 | −150 V | 150 | 96.7 | A(0.9) | A(0.9) | ◯(0.05) |
| 14 | −150 V | 150 | 97.7 | A(0.8) | A(0.7) | ◯(0.04) |

In the table, X represents the total amount (mass %) of the compounds having the structure represented by Structural Formula (5) based on the solid content in the coating liquid for forming a resin layer.

The impedance value indicates the minimum value of the impedance value at a frequency of 1.0×10⁰ Hz to 1.0×10¹ Hz. Note that description such as “9.12E+06” indicates “9.12×10⁶”.

### Example 2

Each measurement and evaluation were performed in the same manner as in Example 1, except that the toner to be filled in the process cartridge 20 was changed to the toner 1. The evaluation results are shown in Tables 77-1 and 77-2.

In addition, under the conditions for measuring reversal fogging, printing of a solid white image was forcibly stopped during printing, and the charge amount (Q/S) of toner per unit area on the developer carrying member was obtained by the following method. The evaluation results are shown in Tables 42 and 43.

### <Method for Measuring Charge Amount (Q/S) of Toner Per Unit Area on Developer Carrying Member>

The amount of toner on the developer carrying member is calculated by suction-collecting the toner using a metal cylindrical tube and a cylindrical filter. The triboelectric charge of the toner on the developer carrying member can be measured by a Faraday-Cage. The faraday cage refers to a double coaxial cylinder, in which the inner cylinder and the outer cylinder are insulated by an insulating member. When a charged body having a charge amount Q is placed in the inner cylinder, it is equivalent to having a metal cylinder having the same charge amount Q due to electrostatic induction. In practice, a suction port is placed on the developer carrying member, and the toner held between the contact portion with the developing blade and the contact portion with the photosensitive drum is sucked up using a vacuum device. The sucked toner is collected by a cylindrical filter paper (cylindrical filter) disposed inside the inner cylinder. The induced charge amount is measured using an electrometer (Keithley 6517A, manufactured by Keithley Instruments, LLC), and the charge amount Q (nC) is divided by the suction area S (cm²) to obtain a charge amount of toner per unit area.

Charge amount of toner per unit area (nC/cm²)=Q/S

### Example 3

Except that the coating liquid for forming a resin layer was changed to the coating liquids (F-2) for forming a resin layer shown in Tables 77-3 and 77-4, a developing roller G-2 was produced in the same manner as in Example 1. Each measurement and evaluation were performed in the same manner as in Example 1, except that the developing roller 31 mounted in the process cartridge 20 was changed to the developing roller G-2 and the toner to be filled was changed to the toner 5. The evaluation results are shown in Tables 77-1 and 77-2. Here, Ex means Example. DR No. means “Developing roller No.”. “CL No.” means “Coating liquid for forming resin layer No.”. (1) to (3) means “Formula (1)” to “Formula (3)”.

TABLE 77-3

| | | | Binder resin structure (structure (1)) | | | |
|---|---|---|---|---|---|---|
| Ex | DR No. | CL No. | Structure (1) | | | |
| 1, 2, | G-1 | F-1 | (1) | R11 = (CH₂)₅ | R12 = (CH₂)₆ | m, n = 6.9 |
| 7~14 | | | | | | |
| 3, 4, 6 | G-2 | F-2 | (1) | R11 = (CH₂)₃ | R12 = (CH₂)₄ | m, n = 8.8 |
| 5 | G-3 | F-3 | (3) | R31 = (CH₂)₃ | R32 = (CH₂)₄ | q = 12, r = 5.1 |

Here, Ex means Example. (2) to (5) means “Formula (2)” to “Formula (5)”.

TABLE 77-4

| | Binder resin structure (structure (2)) | | | | | |
|---|---|---|---|---|---|---|
| Ex | Structure (2) | | | Additive structure | | |
| 1, 2, | (4) | R41 = (CH₂)₆ | s = 13.2 | (5) | R51 = C₄H₉ | t, u = 17 |
| 7~14 | | | | | | |
| 3, 4, 6 | (2) | o = 9.1, p = 5.5 | | (5) | R51 = C₄H₉ | t, u = 17 |
| 5 | (4) | R41 = (CH₂)₆ | s = 13.2 | (5) | R51 = C₄H₉ | t, u = 17 |

In the tables, Me represents a methyl group, Et represents an ethyl group, and Bu represents a butyl group.

### Examples 4 and 6

Each measurement and evaluation were performed in the same manner as in Example 3, except that the toner to be filled in the process cartridge 20 was changed to the toner 4 or the toner 1. The evaluation results are shown in Tables 77-1 and 77-2.

### Example 5

Except that the coating liquid for forming a resin layer was changed to the coating liquids (F-3) for forming a resin layer shown in Tables 77-3 and 77-4, a developing roller G-3 was produced in the same manner as in Example 1. Each measurement and evaluation were performed in the same manner as in Example 2, except that the developing roller 31 mounted in the process cartridge 20 was changed to the developing roller G-3. The evaluation results are shown in Tables 77-1 and 77-2.

### Examples 7 to 11

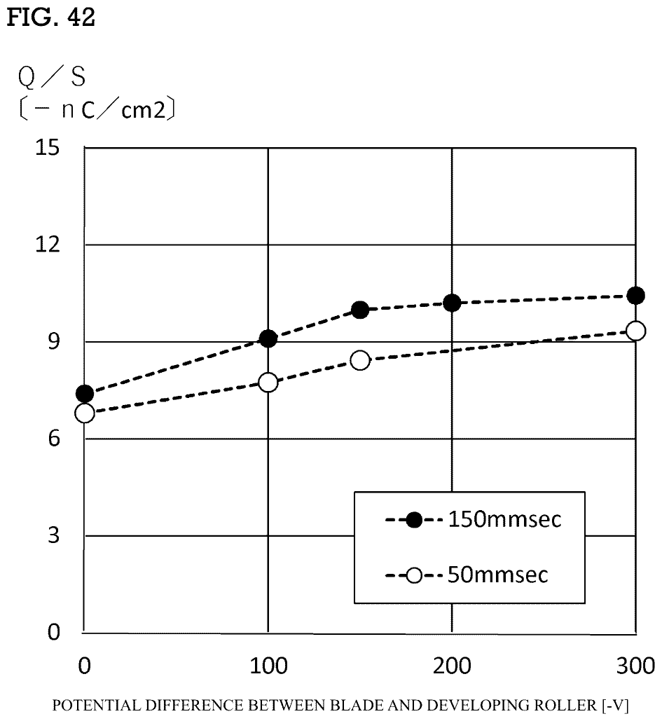

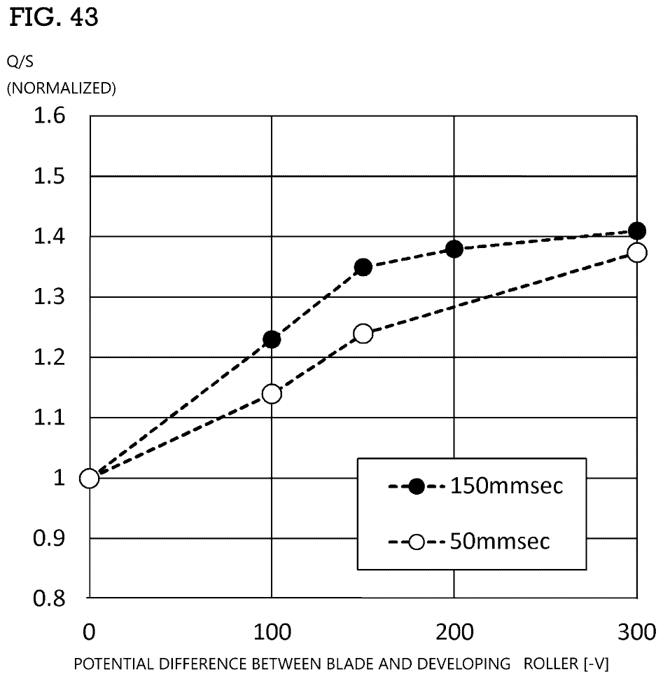

Each measurement and evaluation were performed in the same manner as in Example 2, except that the process speed and the potential difference between the developing blade and the developing roller were changed to those described in Tables 77-1 and 77-2 in the image evaluation and the toner shape irregularity evaluation. The evaluation results are shown in Tables 77-1 and 77-2 and illustrated in FIGS. 42 and 43.

### Example 12

100 sheets of images of the letter “E” in 4-point size of the alphabet having a print coverage of 2% with respect to the area of the paper were continuously output at a process speed of 150 mm/sec in the normal mode. Thereafter, the same image was continuously output at a process speed of 50 mm/sec, which is ⅓ of the normal mode, and the operation was repeated to output a total of 8,000 images. At this time, the potential difference between the developing blade and the developing roller during output at a process speed of 150 mm/sec was set to −100 V, and the potential difference between the developing blade and the developing roller during output at a process speed of 50 mm/sec was set to −150 V to perform image output. The other conditions were measured and evaluated in the same manner as in Example 2. The evaluation results are shown in Tables 77-1 and 77-2.

### Examples 13 and 14

Each measurement and evaluation were performed in the same manner as in Example 1, except that the toner to be filled in the process cartridge 20 was changed to the toner 2 or the toner 3. The evaluation results are shown in Tables 77-1 and 77-2.

### Comparative Example 1

The types and amounts of materials shown in Table 78 were added to a reaction vessel and stirred. Next, 2-butanone (MEK) was added so that the total solid content ratio was 30 mass %, and then mixing was performed using a sand mill. Next, 2-butanone (MEK) was added to adjust the viscosity of the liquid to a range of 6 to 10 mPa·s, thereby producing a coating liquid F-4 for forming a resin layer. Except that the coating liquid F-1 for forming a resin layer was changed to the coating liquid F-4 for forming a resin layer, a developing roller G-4 was produced in the same manner as in Example 1.

Toner was prepared in the same manner as in the toner 4, except that the type of the external additive was changed as shown in Table 79. The measurement results of the obtained toner 8 are shown in Table 79.

Each measurement and evaluation were performed in the same manner as in Example 1, except that the developing roller 31 mounted in the process cartridge 20 was changed to the developing roller G-4 and the toner to be filled was changed to the toner 8. The evaluation results are shown in Tables 80-1 and 80-2.

TABLE 78

| Material | Parts by mass |
|---|---|
| Polytetramethylene glycol ether polyol (trade | 25 |
| name: PTG1000SN, Hodogaya Chemical Co., Ltd.) | |
| Polycarbonate polyol (trade name: T5651, Asahi | 75 |
| Kasei Chemicals Corporation) | |
| Isocyanate | 55.5 |
| (trade name: CORONATE HX, Tosoh Corporation) | |
| Carbon black | 30 |
| (trade name: MA8, Mitsubishi Chemical Corporation) | |
| Coarse particles (trade name: ART PEARL C-400T, | 20 |
| Negami Chemical Industrial Co., Ltd.) | |

Here, “Polymerization initiator” means “Parts by mass of polymerization initiator”. “Crosslinking agent” means “Parts by mass of crosslinking agent”. “Hydrolyzed solution” means “Parts by mass of hydrolyzed solution”. “Adhesion rate” means “Adhesion rate of external additive or organosilicon polymer (%)”. “Coverage” means “Coverage of external additive or organosilicon polymer (%)”. “Electrical conductivity” means “Electrical conductivity of external additive or organosilicon polymer (S/m)”.

TABLE 79

| | | | Organosilicon compound | | | | | | |
|---|---|---|---|---|---|---|---|---|---|
| | | Cross- | for surface layer | | External additive | | Adhesion | | Electrical |
| | Polymerization | linking | | Hydrolyzed | | Parts by | rate | Coverage | conductivity |
| | initiator | agent | Type | solution | Type | mass | (%) | (%) | (S/m) |
| Toner 6 | 9.0 | 0.25 | Methyltriethoxysilane | 12 | — | — | 90 | 30 | 1.0E−15 |
| Toner 7 | 9.0 | 0.25 | Methyltriethoxysilane | — | — | — | 79 | 42 | 1.0E−15 |
| Toner 8 | 9.0 | 0.25 | — | — | Fumed silica | 1 | 85 | 43 | 2.0E−16 |
| | | | | | (average particle | | | | |
| | | | | | diameter: 10 nm) | | | | |

Here, CE means “Comparative Example”. “DR No.” means “Developing roller No.”. MVSP means “Maximum value of surface potential [IV]”. T means Toner No.

TABLE 80-1

| | | | Impedance | | | Electrical | | Adhesion |
|---|---|---|---|---|---|---|---|---|
| | | | [Ω] | MVSP | | conductivity | Coverage | rate |
| CE | DR No. | X | @1.0 × 10¹ Hz | [V] | T | [S/m] | [%] | [%] |
| 1 | G-4 | — | 3.96E+05 | 3.7 | 8 | 2.0E−16 | 43 | 85 |
| 2 | G-4 | — | 3.96E+05 | 3.7 | 4 | 3.6E−09 | 42 | 82 |
| 3 | G-1 | 3.2 | 9.12E+06 | 5.7 | 8 | 2.0E−16 | 43 | 85 |
| 4 | G-4 | — | 3.96E+05 | 3.7 | 5 | 5.6E−05 | 44 | 84 |
| 5 | G-2 | 3.2 | 1.52E+06 | 3.2 | 8 | 2.0E−16 | 43 | 85 |
| 6 | G-4 | — | 3.96E+05 | 3.7 | 1 | 1.1E−15 | 35 | 91 |
| 7 | G-1 | 3.2 | 9.12E+06 | 5.7 | 1 | 1.1E−15 | 35 | 91 |
| 8 | G-1 | 3.2 | 9.12E+06 | 5.7 | 1 | 1.1E−15 | 35 | 91 |
| 9 | G-5 | 6.2 | 2.00E+08 | 462 | 4 | 3.6E−09 | 42 | 82 |
| 10 | G-1 | 3.2 | 9.12E+06 | 5.7 | 6 | 1.1E−15 | 30 | 82 |
| 11 | G-1 | 3.2 | 9.12E+06 | 5.7 | 7 | 1.1E−15 | 42 | 79 |

Here, CE means “Comparative Example”. “DV-BV” means “(Developing voltage)-(Blade voltage) [V]”. “Irregularity” means “Evaluation value of irregularity [%]”.

TABLE 80-2

| | | | Process | Irregu- | | | Image |
|---|---|---|---|---|---|---|---|
| | DV − BV | | speed | larity | Black | Reversal | density |
| CE | [V] | | [mm/sec] | [%] | fogging | fogging | stability |
| 1 | −150 | V | 150 | 91.3 | D(4.3) | D(4.0) | X (0.17) |
| 2 | −150 | V | 150 | 90.6 | D(3.7) | D(3.7) | X (0.18) |
| 3 | −150 | V | 150 | 91.9 | D(4.2) | D(4.1) | X (0.18) |
| 4 | −150 | V | 150 | 91.0 | D(4.3) | D(4.2) | X (0.14) |
| 5 | −150 | V | 150 | 91.7 | D(3.9) | D(3.6) | X (0.13) |
| 6 | −150 | V | 150 | 91.1 | D(4.4) | D(4.0) | X (0.14) |
| 7 | 0 | V | 150 | 91.8 | D(4.2) | D(3.9) | X (0.17) |
| 8 | 0 | V | 50 | 90.9 | D(4.6) | D(4.4) | X (0.15) |
| 9 | −150 | V | 150 | 92.6 | D(3.8) | D(3.9) | X (0.31) |
| 10 | −150 | V | 150 | 91.9 | D(3.9) | D(3.5) | X (0.15) |
| 11 | −150 | V | 150 | 92.2 | D(4.4) | D(4.2) | X (0.16) |

In the table, X represents the total amount (mass %) of the compounds having the structure represented by Structural Formula (5) based on the solid content in the coating liquid for forming a resin layer.

The impedance value indicates the minimum value of the impedance value at a frequency of 1.0×10⁰ Hz to 1.0×10¹ Hz.

### Comparative Examples 2, 4, and 6

Each measurement and evaluation were performed in the same manner as in Comparative Example 1, except that the toner to be filled in the process cartridge 20 was changed to the toner 4, the toner 5, and the toner 1. The evaluation results are shown in Tables 80-1 and 80-2.

### Comparative Examples 3 and 5

Each measurement and evaluation were performed in the same manner as in Comparative Example 1, except that the developing roller 31 mounted in the process cartridge 20 was changed to the developing roller G-1 or the developing roller G-2. The evaluation results are shown in Tables 80-1 and 80-2.

### Comparative Example 5

Each measurement and evaluation were performed in the same manner as in Comparative Example 1, except that the developing roller 31 mounted in the process cartridge 20 was changed to the developing roller G-2. The evaluation results are shown in Tables 80-1 and 80-2.

### Comparative Examples 7 and 8

Each measurement and evaluation were performed in the same manner as in Example 2, except that the process speed and the potential difference between the developing blade and the developing roller were changed to those described in Tables 80-1 and 80-2 in the image evaluation and the toner shape irregularity evaluation. The evaluation results are shown in Tables 80-1 and 80-2 and illustrated in FIGS. 42 and 43.

### Comparative Example 9

Except that the additive used in the coating liquid F-1 for forming a resin layer was changed to the materials and parts by mass shown in Table 81, in the same manner as in Example 1, a coating liquid F-5 for forming a resin layer and a developing roller G-5 were produced. Each measurement and evaluation were performed in the same manner as in Example 1, except that the developing roller 31 mounted in the process cartridge 20 was changed to the developing roller G-5. The evaluation results are shown in Tables 80-1 and 80-2. Here, Ex means Example. CE means “Comparative Example”. DR means “Developing roller”. FRL means “For forming resin layer”.

TABLE 81

| | | | Additive | |
|---|---|---|---|---|
| | | | | Parts |
| | DR | FRL | Material | by mass |
| Ex 1 | G-1 | F-1 | E-1 | 7 |
| CE 5 | G-5 | F-5 | Silane coupling agent | 14 |
| | | | (trade name: A-187, Momentive Inc.) | |

### Comparative Example 10

### [Toner 6]

Toner was prepared in the same manner as in the toner 1, except that the parts by mass of the hydrolyzed solution in the (polymerization step) were changed as shown in Table 79. The measurement results of the obtained toner 6 are shown in Table 79.

Each measurement and evaluation were performed in the same manner as in Example 1, except that the toner to be filled in the process cartridge 20 was changed to the toner 6. The evaluation results are shown in Tables 80-1 and 80-2.

### Comparative Example 11

### [Toner 7]

(Hydrolysis step of organosilicon compound for surface layer) was not performed. Instead, 20 parts of methyltriethoxysilane, which is an organosilicon compound for a surface layer, was added as a monomer during (preparation step of polymerizable monomer composition). In (polymerization step), after cooling to 70° C. and performing pH measurement, no addition of the hydrolyzed solution was performed. While maintaining stirring at 70° C., the slurry was adjusted to pH 9.0 for completing condensation using an aqueous sodium hydroxide solution, and then further held for 300 minutes to form the surface layer. Except for that, toner 7 was produced in the same manner as the toner 1. The evaluation measurement results of the obtained toner 7 are shown in Table 79.

Each measurement and evaluation were performed in the same manner as in Example 1, except that the toner to be filled in the process cartridge 20 was changed to the toner 7. The evaluation results are shown in Tables 80-1 and 80-2.

Examples 1 to 14 show favorable results in the black fogging, reversal fogging, and image density stability evaluation. In addition, the evaluation values for toner shape irregularity also showed favorable results. This result is considered to be due to the fact that, even when the toner is deformed by long-term rubbing between members and becomes less susceptible to triboelectric charging, charge is injected into the toner from the developing blade, and leakage of the injected charge to the developing roller side is suppressed, thereby stabilizing the charge amount of toner. Although the toner having a small charge amount tends to be less likely to be coated on the developing roller, it is considered that the deformed toner is coated on the developing roller and consumed on the paper through the developing step and the transfer step by stabilizing the charge amount of the deformed toner, thereby suppressing accumulation in the developing container. In addition, as a result, it is considered that the black fogging and reversal fogging showed favorable results.

In Example 1 and Comparative Examples 1 to 3, the influence of the developing roller and the toner was compared. In Example 1, a toner containing an external additive as surface particles having an electrical conductivity of 1×10⁻¹⁵ S/m or more and a developing roller having an impedance of 1.00×10⁶Ω or more were used, and favorable results were obtained in all of the evaluation value of toner shape irregularity, black fogging, and reversal fogging. On the other hand, in Comparative Example 2, a toner containing an external additive as surface particles having an electrical conductivity of 1×10⁻¹⁵ S/m or more and a developing roller having an impedance of less than 1.00×10⁶Ω were used. In Comparative Example 3, a toner containing an external additive as surface particles having an electrical conductivity of less than 1×10⁻¹⁵ S/m and a developing roller having an impedance of 1.00×10⁶Ω or more were used. In both Comparative Examples 2 and 3, poor results were obtained in all of the evaluation value of toner shape irregularity, black fogging, and reversal fogging. From the above results, it was found that, in order to achieve the effects of the present disclosure, both the electrical conductivity of the toner and the impedance of the developing roller are important characteristics.

Examples 1 to 6 and Comparative Examples 1 to 6 show the detailed results of investigations on the electrical conductivity of the external additive or the organosilicon polymer as surface particles and the impedance of the developing roller for exhibiting the effects of the present disclosure. When the external additive or the organosilicon polymer as surface particles satisfied both the electrical conductivity of 1×10⁻¹⁵ S/m or more and the impedance of the developing roller satisfied 1.00×10⁶Ω or more, favorable results were obtained for black fogging and reversal fogging.

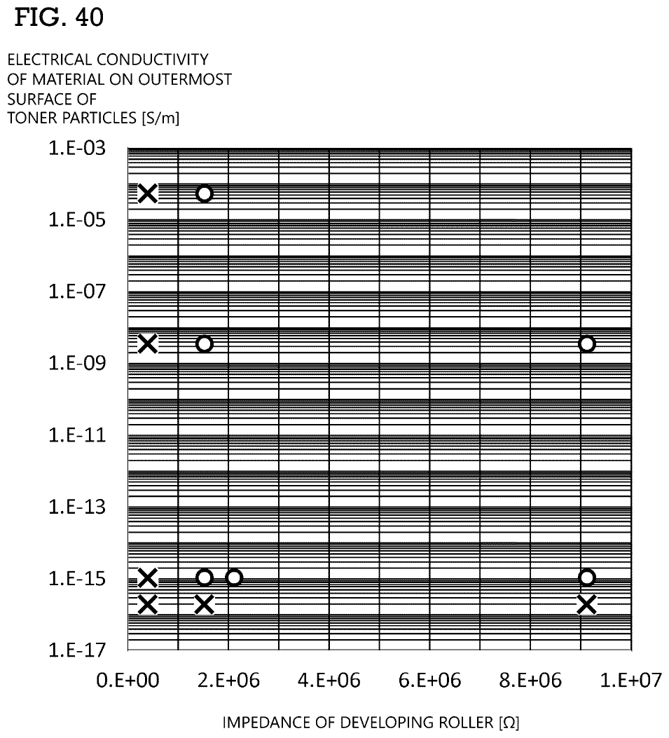

The evaluation results are illustrated in FIG. 40. The drawing is a diagram illustrating the influence of the impedance of the developing roller and the electrical conductivity of the surface particles on blacking fogging and reversal fogging. In the drawing, the conditions in which the black fogging and the reversal fogging were favorable were plotted as o, and the conditions in which the black fogging and the reversal fogging were poor were plotted as x. This result is presumed to be because, when the electrical conductivity of the external additive or the organosilicon polymer as surface particles is less than 1×10⁻¹⁵ S/m, the external additive or the organosilicon polymer as surface particles does not function as a conductive path, and charge is not injected into the toner from the developing blade. In addition, even when the electrical conductivity of the external additive or the organosilicon polymer as the surface particles is set to 1×10⁻¹⁵ S/m or more, it is presumed that, even in a case where charge is injected into the toner from the developing blade, when the impedance of the developing roller is not 1.00×10⁶Ω or more, the charge injected into the toner will leak to the developing roller side, and the toner will not be imparted with charge.

Example 2, Examples 7 to 11, Comparative Example 7, and Comparative Example 8 show the detailed results of investigations on the process speed and the potential difference between the developing blade and the developing roller for achieving the effects of the present disclosure.

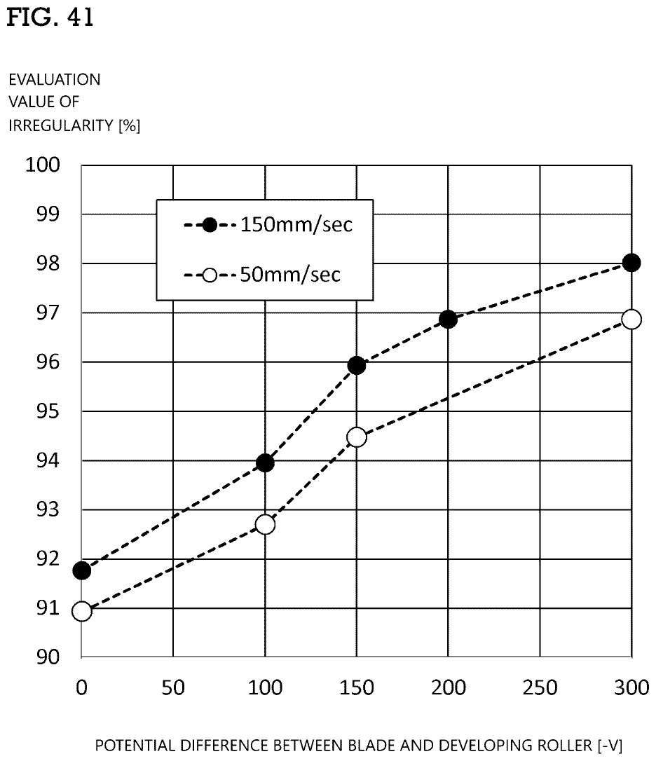

The evaluation results of the toner shape irregularity under each condition are illustrated in FIG. 41. The drawing is a diagram illustrating differences in process speed with respect to the influence of the potential difference between the developing blade and the developing roller on the evaluation value of toner shape irregularity. When the process speed was slower at 50 mm/sec than at 150 mm/sec, the evaluation value of toner shape irregularity in the developing container was smaller, indicating worse results.

In addition, a separate investigation showed that when the process speed was slower at 50 mm/sec than at 150 mm/sec, the charge amount per unit area (Q/S) of the toner became smaller (FIG. 42). The drawing is a diagram illustrating differences in process speed with respect to the influence of the potential difference between the developing blade and the developing roller on the charge amount per unit area. This result is presumed to be because, as described above, when the toner passes through a portion facing the developing blade along with the rotation of the developing roller, in a case where the rotational speed of the developing roller is low, the toner particles pass in a relatively sparse state, such that it is difficult for charge to be transferred between the toner particles, and therefore, a higher blade voltage needs to be applied to impart charge to the toner as a whole. On the other hand, when the rotational speed of the developing roller is high, it is presumed that circulation of the toner is likely to occur in a region immediately before passing through the portion facing the developing blade, and since the toner passes in a relatively dense state, charge can be effectively transferred between the toner particles, making it possible to impart charge to the toner as a whole even with a lower blade voltage.

In Examples 8 and 10, the process speed is different when the potential difference between the developing blade and the developing roller is −100 V. A higher process speed showed favorable results in black fogging and reversal fogging (Tables 77-1 and 77-2). The particle diameter of the deformed toner tended to be about 20% smaller than the particle diameter of the undeformed toner. Accordingly, the present inventors considered that, in order to impart sufficient charge to the deformed toner, it is necessary to increase the Q/S by about 20% compared to the charge amount per unit area (Q/S) of the toner when there is no potential difference between the developing roller and the developing blade.

FIG. 43 is a diagram illustrating differences in process speed with respect to the influence of the potential difference between the developing blade and the developing roller on the charge amount per unit area. The vertical axis of FIG. 41 is normalized by the Q/S when the potential difference between the developing blade and the developing roller is 0 V. As illustrated in FIG. 43, the charge amount per unit area (Q/S) of the toner when the process speed was high at 150 mm/sec was 1.2 times or more compared to that when there was no potential difference, under a potential difference of −100 V between the developing roller and the developing blade, but this was not the case when the process speed was 50 mm/sec. Accordingly, in order to increase the charge amount per unit area (Q/S) of the toner under the condition of a process speed of 50 mm/sec to 1.2 times or more compared to that when there was no potential difference between the developing roller and the developing blade, Example 11 is an example in which, with reference to FIG. 43, the potential difference between the developing blade and the developing roller was increased to −150 V. In Example 11, even when the process speed was slow at 50 mm/sec, more favorable results were obtained in black fogging and reversal fogging.

In Example 12, the results were obtained when an image is output while the potential difference between the developing blade and the developing roller was varied depending on the process speed during printing. Favorable results were shown for both black fogging and reversal fogging.

Examples 2, 13, and 14 show the results of examining the influence of the coverage of the organosilicon polymer on the toner particle surface. By setting the coverage of the surface of the toner particle to 45% or more, better results are shown. This result is presumed to be because, by satisfying these conditions, the organosilicon polymer functioning as a charging site has a significantly increased opportunity to contact between toner particles, and charge transfer between the toner particles is effectively performed.

On the other hand, in Comparative Examples 1 to 13, poor results were obtained in the fogging evaluation and the image density stability evaluation.

In Comparative Examples 1 to 6, it is presumed that, because either the characteristics of the developing roller or the characteristics of the toner, or both conditions were not satisfied, charge could not be stably imparted to the deformed toner after long-term use. In Comparative Examples 1, 2, 4, and 6, a polyether diol and a polycarbonate diol are used in the developing roller G-4, and both an ether structure and a polycarbonate structure are incorporated in a polyurethane structure. As a result, it is considered that electrical characteristics due to the polycarbonate structure are inhibited by the ether structure, and a desired impedance value cannot be obtained.

In Comparative Examples 7 and 8, the potential difference between the developing blade and the developing roller was 0 V, and favorable results were not obtained in the fogging evaluation and the image density stability evaluation. Since the potential difference between the developing roller and the developing blade is 0 V, it is presumed that no charge is injected into the toner.

In Comparative Example 9, the surface potential was too high, and therefore, favorable results were not obtained in the fogging evaluation and the image density stability evaluation. It is considered that, because the carbon black was coated with an insulating silane coupling agent, the surface potential became high, resulting in poor black fogging, reversal fogging, and image density stability.

In Comparative Example 10, as the coverage of the organosilicon polymer decreased, the results of the fogging evaluation and the image density stability evaluation became poor. It is considered that, due to the low coverage of the organosilicon polymer, charge could not be sufficiently injected into the toner as a whole from the developing blade, resulting in poor black fogging, reversal fogging, and image density stability.

In Comparative Example 11, as the adhesion rate of the organosilicon polymer decreased, the results of the fogging evaluation and the image density stability evaluation became poor. It is considered to be caused by the worsening of fogging with use. It is considered that, due to the low adhesion rate of the organosilicon polymer, the organosilicon polymer was detached from the toner particles during long-term use, making it impossible to sufficiently inject charge into the toner as a whole from the developing blade, resulting in poor black fogging, reversal fogging, and image density stability.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-134775, filed Aug. 13, 2024, Japanese Patent Application No. 2024-134785, filed Aug. 13, 2024, Japanese Patent Application No. 2024-134787, filed Aug. 13, 2024, Japanese Patent Application No. 2024-134776, filed Aug. 13, 2024, which are hereby incorporated by reference herein in their entirety.

What is claimed is:

1. A process cartridge comprising:
a developer carrying member configured to carry a developer;
a developing container configured to accommodate the developer carrying member and a developer containing developer particles;
a developing blade configured to regulate the developer on the developer carrying member;
an image carrying member configured to carry a developer image; and
a charging member configured to charge the image carrying member,
wherein the developer carrying member includes a substrate having a conductive outer surface and a resin layer formed on the outer surface of the substrate,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more,
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion,
a surface of the developer particles is coated with surface particles having an electrical conductivity of 1×10⁻¹⁵ S/m or more different from that of a developer base, a coverage of the surface particles is 35% or more, and an adhesion rate of the surface particles is 80% or more, and
a voltage is applied to the developing blade with a predetermined potential difference with respect to the developer carrying member, and the predetermined potential difference has the same polarity as a normal charging polarity of the developer.

2. A process cartridge comprising:
a developer carrying member configured to carry a developer;
a developing container configured to accommodate the developer carrying member and a developer containing developer particles;
a developing blade configured to regulate the developer on the developer carrying member;
an image carrying member configured to carry a developer image; and
a charging member configured to charge the image carrying member,
wherein the developer carrying member includes a substrate having a conductive outer surface and a resin layer formed on the outer surface of the substrate,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more,
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion,
a surface of the developer particles is coated with an organosilicon polymer having an electrical conductivity of 1×10⁻¹⁵ S/m or more different from that of a developer base, a coverage of the organosilicon polymer is 35% or more, and an adhesion rate of the organosilicon polymer is 80% or more, and
a voltage is applied to the developing blade with a predetermined potential difference with respect to the developer carrying member, and the predetermined potential difference has the same polarity as a normal charging polarity of the developer.

3. The process cartridge according to claim 2, wherein the coverage of the organosilicon polymer with respect to the surface of the developer particles is 45% or more.

4. The process cartridge according to claim 1, wherein the predetermined potential difference is 150 V or more.

5. The process cartridge according to claim 1, wherein the predetermined potential difference varies depending on a process speed.

6. The process cartridge according to claim 1, wherein the maximum value of the potential of the outer surface of the developer carrying member is 10.0 V or less.

7. A process cartridge comprising:
a developer carrying member configured to carry a developer;
a developer regulating member configured to contact the developer carrying member and regulate an amount of the developer on the developer carrying member; and
an image carrying member configured to carry a developer image,
wherein the developer carrying member includes a substrate having a conductive outer surface and a resin layer formed on the outer surface of the substrate,
on an outer surface of the resin layer of the developer carrying member, a maximum height roughness Rz of a roughness profile is greater than a volume average particle diameter of the developer,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more,
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion, and
a voltage is applied to each of the developer carrying member and the developer regulating member, and an absolute value of a voltage applied to the developer regulating member is set to be greater than an absolute value of a voltage applied to the developer carrying member.

8. A process cartridge comprising:
a developer carrying member configured to carry a developer;
a developer supplying member configured to supply the developer to the developer carrying member;
a developer regulating member configured to contact the developer carrying member and regulate an amount of the developer on the developer carrying member; and
an image carrying member configured to carry a developer image,
wherein the developer carrying member includes a substrate having a conductive outer surface and a resin layer formed on the outer surface of the substrate,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more,
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion, and
a voltage is applied to each of the developer carrying member, the developer regulating member, and the developer supplying member, an absolute value of a voltage applied to the developer regulating member is set to be greater than an absolute value of a voltage applied to the developer carrying member, and an absolute value of a voltage applied to the developer supplying member is set to be equal to or greater than the absolute value of the voltage applied to the developer carrying member.

9. The process cartridge according to claim 7, wherein the polyurethane having the polycarbonate structure satisfies at least two of the following (A), (B), and (C):
(A) the polyurethane has a structure represented by the following Structural Formula (1) in a molecule;
(B) the polyurethane has, in a molecule, either one or both of a structure represented by the following Structural Formula (2) and a structure represented by the following Structural Formula (3); and
(C) the polyurethane has a structure represented by the following Structural Formula (4) in a molecule, 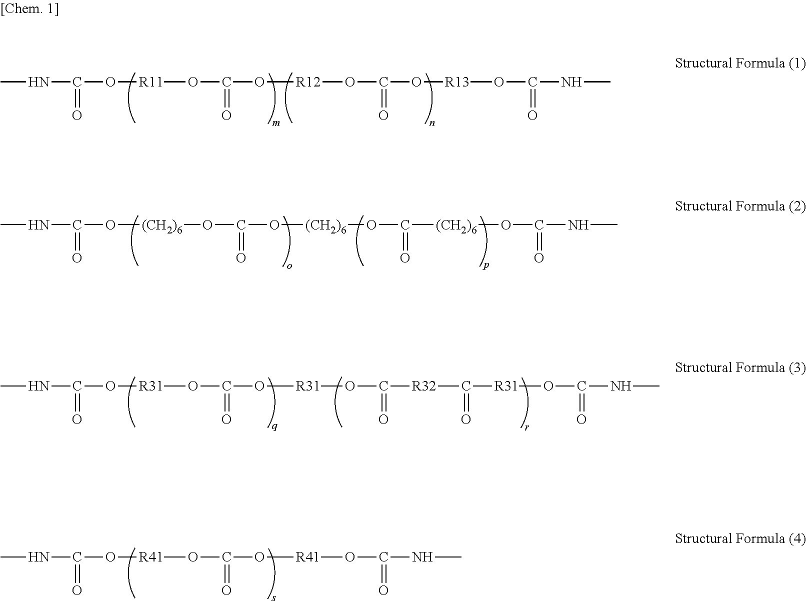
in Structural Formula (1), R11, R12, and R13 each represent a divalent hydrocarbon group having 3 to 9 carbon atoms, provided that R11 and R12 are different from each other, R13 is the same as at least one selected from the group consisting of R11 and R12, and m and n are average numbers of added moles and each independently represent a number of 1.0 or more,
in Structural Formula (2), o and p are average numbers of added moles and each independently represent a number of 1.0 or more,
in Structural Formula (3), R31 and R32 each independently represent a divalent hydrocarbon group having 3 to 8 carbon atoms, and q and r are average numbers of added moles and each independently represent a number of 1.0 or more, and
in Structural Formula (4), R41 represents a divalent hydrocarbon group having 6 to 9 carbon atoms, and s is an average number of added moles and represents a number of 1.0 or more.

10. The process cartridge according to claim 7, wherein the resin layer contains a conductive filler.

11. The process cartridge according to claim 10, wherein an arithmetic mean value Rc of equivalent circle diameters of carbon black contained in the conductive filler in the resin layer is 60.0 nm or less, and
σc/Rc is 0.000 to 0.650, where a standard deviation of the equivalent circle diameters of the carbon black is σc.

12. The process cartridge according to claim 10, wherein an arithmetic mean value d of wall-to-wall distances of carbon black contained in the conductive filler in the resin layer is 80.0 to 150.0 nm, and
σd/d is 0.000 to 0.600, where a standard deviation of the wall-to-wall distances is σd.

13. The process cartridge according to claim 10, wherein a number average diameter of primary particles of carbon black contained in the conductive filler in the resin layer is 30 nm or less.

14. The process cartridge according to claim 10, wherein a DBP absorption of carbon black contained in the conductive filler in the resin layer is 90 ml/100 g or less, and
a pH of the carbon black is 4.0 or less.

15. The process cartridge according to claim 7, wherein the resin layer contains at least one selected from the group consisting of a compound having a structure represented by the following Structural Formula (5), a compound having a structure represented by the following Structural Formula (6), and a compound having a structure represented by the following Structural Formula (7), 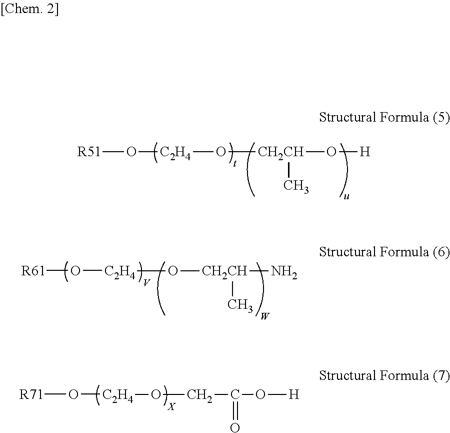
in Structural Formula (5), R51 represents a monovalent hydrocarbon group having 1 to 12 carbon atoms, and t and u are average numbers of added moles and each independently represent a number of 1 or more,
in Structural Formula (6), R61 represents a monovalent hydrocarbon group having 1 to 8 carbon atoms, and v and w are average numbers of added moles and each independently represent a number of 1 or more, and
in Structural Formula (7), R71 represents a monovalent hydrocarbon group having 1 to 12 carbon atoms, and x is an average number of added moles and represents a number of 1 or more.

16. The process cartridge according to claim 8, wherein the absolute value of the voltage applied to the developer regulating member is set to be greater than the absolute value of the voltage applied to the developer supplying member.

17. A process cartridge comprising:
a developer carrying member configured to carry a developer;
a developing container configured to accommodate the developer carrying member and the developer;
an image carrying member configured to carry a developer image developed with the developer supplied from the developer carrying member, the developer image being directly transferred from the image carrying member to a transfer material;
a charging member configured to charge the image carrying member;
a developing blade configured to regulate the developer on the developer carrying member; and
an applying member configured to apply a bias having the same polarity as a normal charging polarity of the developer to the developing blade,
wherein the developer carrying member includes a substrate having a conductive outer surface and a resin layer formed on the outer surface of the substrate,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more, and
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion.

18. The process cartridge according to claim 17, wherein a maximum height roughness Rz of a surface of the developer carrying member is 7.0 μm or more.

19. The process cartridge according to claim 17, wherein a width in a longitudinal direction of a region carrying the developer on the developer carrying member is greater than a width of the transfer material in a direction perpendicular to a conveyance direction of the transfer material, to which the developer image obtained by developing an electrostatic latent image formed on the image carrying member with the developer, is transferred.

20. A process cartridge comprising:
a developer carrying member configured to carry a developer;
a developing container configured to accommodate the developer carrying member and the developer;
an image carrying member configured to carry a developer image; and
a charging member configured to charge the image carrying member,
wherein the developer carrying member and the image carrying member are brought into contact with each other at a developing region to form an image, and, during image formation, surfaces of the developer carrying member and the image carrying member are in contact with each other at different surface speeds,
the developer carrying member includes a substrate having a conductive outer surface and a resin layer formed on the outer surface of the substrate,
the resin layer contains a polyurethane having a polycarbonate structure,
a metal film is directly provided on an outer surface of the developer carrying member,
in an environment of a temperature of 23° C. and a relative humidity of 50%, when a DC voltage of 50 V is applied between the outer surface of the substrate and the metal film, while an AC voltage having an amplitude of 50 V is applied with a frequency varied in a range of 1.0×10⁻¹ to 1.0×10⁵ Hz, an impedance at a frequency of 1.0×10⁰ to 1.0×10¹ Hz is 1.00×10⁶Ω or more,
in an environment of a temperature of 23° C. and a relative humidity of 50%, a maximum value of a potential is less than 20.0 V, the potential being measured when a corona discharger having a grid portion with a width of 3.0 mm is disposed so that a distance between the grid portion and the outer surface of the developer carrying member is 1.0 mm, and a direction of the width of the grid portion coincides with an axial direction of the developer carrying member, a voltage of 8 kV is applied to the grid portion, the corona discharger is relatively moved along the axial direction of the developer carrying member at a speed of 400 mm/sec to charge the outer surface of the developer carrying member, and a potential of the outer surface is measured 0.06 seconds after the outer surface passes through the grid portion, and
on an outer surface of the resin layer of the developer carrying member, a maximum height roughness Rz of a roughness profile is greater than a volume average particle diameter of the developer.
